(19) United States
(12) Patent Application Publication
(10) Pub. No.: US 2026/0069972 A1
(43) Pub. Date: Mar. 12, 2026

(54) CONTROLLABLY VIEWABLE TRANSPARENT DISPLAY FOR GAMING

(71) Applicants: James Andrew Aman, Celebration, FL (US); Jeffrey Paul Cheesman, Hamburg, NJ (US)

(72) Inventors: James Andrew Aman, Celebration, FL (US); Jeffrey Paul Cheesman, Hamburg, NJ (US)

(21) Appl. No.: 19/322,831

(22) Filed: Sep. 9, 2025

Related U.S. Application Data
(60) Provisional application No. 63/692,768, filed on Sep. 10, 2024.

(51) Int. Cl. A63F 13/52; A63F 13/211; G06F 3/01

(52) U.S. Cl. CPC A63F 13/52; A63F 13/211; G06F 3/017

(57) ABSTRACT

A gaming system comprising at least one transparent display where at least two gamers are standing on opposite sides of the display. The first gamer is wearing a first pair of filtering glasses that limit the first gamer to seeing only a first stream A of images comprising video being emitted by the transparent display. The second gamer is wearing a second pair of filtering glasses that limit the second gamer to seeing only a second stream B of images comprising the emitted video. Each gamer perceives different augmentations of the opposing player as the game is operated causing the video comprising the A and B streams. The system further comprises an additional display functioning like the first display but separated to form an interior corridor, where a projector is running on rails within the corridor to create a movable ghost image via a pepper's mill apparatus.

### CROSS-REFERENCE TO RELATED APPLICATIONS

The present application is related to the following six (6) U.S. Patents: 1) U.S. Pat. No. 10,719,134 entitled INTERACTIVE OBJECT TRACKING MIRROR-DISPLAY AND ENTERTAINMENT SYSTEM filed on May 9, 2018, 2) U.S. Pat. No. 10,688,378 entitled PHYSICAL-VIRTUAL GAME BOARD AND CONTENT DELIVERY SYSTEM filed on Jul. 4, 2018, 3) U.S. Pat. No. 10,861,267 entitled THEME PARK GAMIFICATION, GUEST TRACKING AND ACCESS CONTROL SYSTEM filed on Aug. 4, 2018, 4) U.S. Pat. No. 10,974,135 entitled INTERACTIVE GAME THEATER WITH SECRET MESSAGE IMAGING SYSTEM filed on Sep. 27, 2018, 5) U.S. Pat. No. 11,025,892 entitled SYSTEM AND METHOD FOR SIMULTANEOUSLY PROVIDING PUBLIC AND PRIVATE MESSAGES filed on Apr. 4, 2019, and 6) U.S. Pat. No. 10,857,450 entitled PHYSICAL-VIRTUAL GAME BOARD AND CONTENT DELIVERY PLATFORM filed on Aug. 9, 2019.

### FIELD OF INVENTION

The present invention relates to using engineered light sources for controllably and dynamically emitting one or more preferably narrow bands of blue, green, and red color primaries in combination with the use of substances for coating surfaces, where the substances such as nanoparticles, dyes, pigments, fluorescers, and electrochromic polymers operate to scatter, absorb, fluoresce, and/or transmit one or more of the multiple emitted narrow bands such that the combined system can cause changes to the perceived color of a surface by altering the emitted narrow bands. The color changing surfaces are also operable in the non-visible spectrum including ultraviolet (UV) and infrared (IR), where the functionality is shown to be useful for identifying and tracking objects. The engineered light and changeable color surfaces are shown to be useful for use in various game access points used in a physical-virtual interactive gaming system, where the surfaces of game objects are made to change color in response to changes in the game state.

### BACKGROUND OF THE INVENTION

The related applications specify many novel apparatus and methods that are usable with an interactive gaming system at a destination such as a theme park, museum, cruise ship, or otherwise some location for gaming and preferably a location where guests (non-gamers) and gamers aggregate for a real-world physical experiences. Many of the purposes for the prior related teachings where to determine destination experience related data based upon the guest's normal interactions with the destination, where normal interactions included standalone guest experiences implemented by the destination, e.g., a ride at a theme park or viewing a given artwork at a museum. This normal guest experience related data preferably included at least which destination activities or experiences a guest consumed, partook of, participated in, etc., the timing of their consumed experience(s) as well as their on-going current location within the destination (prior referred to as “guest location tracking.”)

The prior related applications also taught a preferred interactive gaming system comprising a multiplicity of “game access points” layered into or “on-top” of the destination forming an interconnected gamification layer, where the interactive gaming system interacted with the guests pulling and pushing the guests throughout the destination to these game access points for game interactions comprising an on-going game. Preferable game access points were physical, spatially distributed and permanently embedded throughout the destination. At least some of the game access points comprised means for providing (virtual) “secret messages” including both private video and private audio, where the secret messages were emitted from a newly taught type of public/private display or projector that simultaneously emitted a traditional public video and public audio. Thus, the interactive gaming system was referred to as “physical-virtual” (“PV”) where the gaming augmentations are spatially embedded into the destination and the destination's surfaces, as opposed to “augmented reality” (“AR”) where the augmentations are created on a mobile device and inserted/overlaid/positioned into the guest's view of a destination surface.

Using the unique “privately encoded public light” of a simultaneous public video and private video by a display or projector, a game access point could be substantially hidden or embedded into the surface of the destination's game access point, thematically blending into the destination so as to minimize detractions to the guest experience of the “non-gamers.” This privately encoded public light could then provide secret messages to guests (i.e., “gamers”) of the destination playing a destination wide game. Projectors allowed the secret messages to be spatially mapped onto virtually any shaped surface. Thus, unlike augmented reality (AR), the gaming augmentations (in this example unique secret messages) where spatially embedded directly into/onto the complex surface structures of a destination, either directly emitted from the surface (using a display) or directly reflecting off the surface (using a projector), thus providing a significantly more “real-feel” experience than augmentations overlaid by a smartphone AR app or AR glasses that essentially float the augmentation interposed into the gamer's view of the destination.

The prior applications taught the use of normal guest experience related data (determined as the guest-gamer interacted “normally” with the destination's traditional implemented experiences) for affecting the interactive game experiences provided by the gamification layer. Conversely, the prior applications also taught using interactive game data (or “game state data”) determined by the interactive gaming system to alter one or more otherwise traditional destination experiences, thereby customizing/personalizing the “normal” destination experience of the guest-gamer.

### SUMMARY OF THE INVENTION

Teachings of the present invention generally include the following four objectives: (1) means for providing controllable passive and active color-changing surfaces, (2) means for improving gamer gesture detection when the gamer is using an article (such as a wizard's wand or light saber) to gesticulate commands and data input at a game access point, (3) means for improving the gamer's integrated and continuous perception of physical-virtual (PV) interaction, and (4) means for improving the perception of continuous gaming experiences between various modes of a multimodal interactive game.

Regarding objective (1) “means for providing controllable passive and active color-changing surfaces,” the taught means include selectively changing the perceived color of a surface using controlled dynamic emission of narrow frequency-bands of light from an engineered light source in combination with passive and active narrow frequency-band responsive surface coatings, various types of surface coatings are taught comprising passive substances such as nanoparticles, dyes, pigments, and fluorescers that have pre-known spectral responsivity including the ability to scatter (reflect), absorb, fluoresce, or transmit light, where especially the extinction of light (scattering and absorbing) is limited to a narrow band of a primary color (UV, blue, green, red, or IR). Coatings are shown to comprise one or more layers of substances to form a more complex spectral response. Coating layers may also comprise active substances such as electrochromic polymers or electrophoretic (“e-ink”) materials that can change their spectral response in response to an applied voltage. In addition to the color-changing surfaces, engineered lights sources are taught that emit light in narrow bands designed to be substantially either reflected, absorbed, fluoresced, phosphoresced, or transmitted by a given substance in a given coating, where for example the engineered light is created using lasers or LEDs with or without additional color filters. By dynamically altering the emission of the narrow bands of light from the engineered light sources, it is shown that a gamer will perceive an article or surface that uses a color-changing coating to be changing in color as the spectral response of the coating changes in response to the changing spectral emissions.

Regarding objective (2) “means for improving gamer gesture detection when the gamer is using an article (such as a wizard's wand or light saber) to gesticulate commands and data input at a game access point,” it is first noted that natural gesture input is a well-studied field where at least one goal is to allow for a more natural physical-virtual (“mixed reality”/“MR”) experience, such as moving of a gamer's hands, to be repeatably and accurately translated into meaningful gamer indications or “commands.” In many real-world and virtual experience situations gesturing includes the holding of an instrument, or article. For example, wizards hold wands, jedi knights hold light sabers and writers hold pens. In these examples, the wand, light saber, and pen are all abstracted herein as “articles.” At destinations, it is typical to sell articles aligned with the destination's themed experiences, and what is ideal is to allow these purchased articles to become gesture input devices at destination game access points. This is problematic as the range of shapes, colors, surface reflectivity properties, and other optical characteristics of the articles make it challenging to implement a more generalized image processing algorithm, where generalized means that preferably a single algorithm/gesture input system could adapt to any number of articles held by any number of persons wearing any variations of clothing all in multiple possible lighting situations.

In the prior related applications as well as the prior art, articles were augmented to include means for emitting or reflecting preferably non-visible energy, where sensors such as a camera could then detect this energy for determining article movement in for example a minimum of 2 degrees-of-freedom (“DoF”) up to a maximum of 6 DoF (yaw, pitch, and roll). The present invention uses an exemplary article of a wizard's wand to teach the implementation of non-visible (preferably IR reflective) markers combined with RF tags for providing a uniform dataset of inputs across multiple possible articles (e.g., wands, light sabers, pens), where the uniform “cross-article datasets” as inputs are then processed using a generalized 6 DoF gesture input algorithm that includes steps for reducing noise caused by at least: a) gamer skin, b) gamer clothing, c) the non-article background, and d) environment lighting conditions. The solution is preferable because it at least: 1) maintains the original look of the article by using non-visible augmentations, 2) creates a single dataset for generalized detection and processing regardless of the article type and instance, 3) significantly reduces noise created by non-articles such as the gamer and the non-article background, and 4) is passive.

The cross-article uniform dataset comprises at least (i) static article characteristics data and, (ii) dynamic article form and movement data. Static article characteristics data (i) preferably includes an article class (e.g., a “Harry Potter Wand”), an article type (e.g., a “Harry” vs. “Voldemort” character wand), and an article instance (such as a unique serial number associable with a unique gamer), where article class and/or type includes associated static article form data for describing the anticipated dynamic article form and movement data (ii). Static article form data for example includes 2D or 3D definitions of the article's marker(s) (size, shape, orientation, relative position, etc.) with respect to other markers on the same article and/or the article itself. Static article form data (ii) preferably also includes optical properties per marker (e.g., indicating one or more frequency range spectral responses). This static article characteristics data (i) allows the article to be interoperable between different gaming modalities, where each modality may implement a different generalized gesture input algorithm, even using different sensor technology(s).

Article class and type data is useful for example to define the types of possible gestures and their meaning, e.g., a wand can input “mid-size” spell motions, a light saber inputs “large-size” fight motions while a pen inputs “small-size” writing motions—each with different anticipated gesture trajectory resolutions and gesture segment combinations. Defined gestures for any given class/type can have pre-associated command meanings (“start sequence,” “stop sequence,” “game input xyz”) or have override meanings based upon the game state and/or article instance, thus providing a standardized gesture language that can be adapted (thus, interoperable) across different modalities of the same game, or even different games played in the same modality. The ability to associate gestures at the class, type or article level provides for an inheritable/overridable “polymorphic” gesture hierarchy.

Static article characteristics data (i) optionally includes information regarding characteristics of the gamer, for example gamer skin color, current clothing, biometrics such as a facial image(s), or other information that is useful for at least segmenting the gamer from the article and other background information when the article's movements are being tracked.

The static article characteristics data (i) is preferably encoded into and electronic tag and detectable by electronic field interaction with the tag, e.g., using RFID or NFC technologies. As will be clear to those familiar with computing systems, the data (i) may be fully represented on the electronic tag and thus immediately available to the sensing apparatus at a gesture input game access point, or may be minimally represented (e.g., simply by a unique article ID) whereby after detection by the sensing apparatus of the unique article ID the remainder of the static article characteristics data (i) is retrieved from a database using at least in part the article ID, where many intermediate combinations are possible.

The article form and movement data (ii) preferably includes real-time sensed article (foreground) “6 DoF” movement data sampled at a given spatial-temporal frequency based upon the gesture input apparatus of a particular game access point. A preferred gesture input apparatus is a camera with a given temporal frequency of 60 captured “frames per second” (60 fps), where a “generalized article tracking” algorithm processes these 60 fps to first segment the article (foreground) from the non-article (background) based at least in part upon the expected spectral response of the article's surface coating, the expected article shape, as well as expected spectral responses of the gamer's skin and possibly clothing, and then determines the location of one or more markers on the article's surface based at least in part upon the anticipated spectral response of each marker as well as each marker's relative location with respect to the article and other markers on the article, where the located markers tracked over multiple image frames provides the real-time article movement data. During processing of the sensed data by the generic tracking algorithm, static article characteristic data (e.g., anticipated article shape, size and surface spectral response, marker shape, size, relative location and spectral response, and gamer skin and clothing spectral responses) (i) is accessed prior to image processing based at least in part upon information determined by reading the article's electronic tag, such that the “raw” sensed data (e.g., the 60 fps) is converted into article meta-data (e.g., the sampled movement data) for gesture (trajectory path segment) interpretation.

Regarding (objective 2 as affected by objective 1), i.e., means for improving gamer-article gesture detection given means for selectively changing the perceived color of an article surface, articles are shown to include color-changing surfaces including specific spatially segmented color-changing markers where color changes can be caused in the non-visible spectrum such as infrared (IR). The articles are shown to be tracked by sensors such as a camera, where the fields-of-view of one or more cameras form a tracking volume, and where the tracking volume is substantially illuminated by one or more engineered light sources. The space outside of the tracking volume is shown to be illuminated by another light source, where the one or more cameras capture images (e.g., 60 fps) in-phase with the light emitted by the engineered source(s) but preferably out-of-phase with the light emitted by the other light source(s), where the net effect is the brighten the foreground and darken the background, and where the engineering light is controllably altered for example to coincide with the capturing of every other (“A-B”) image such that upon A-B comparison analysis the article's markers appear to change in intensity (or “blink”) between A-B images.

The engineered light source(s) emitting light in-phase with the tracking camera(s) are shown to cause different combinations of narrow bands in either the visible or non-visible spectrums to be emitted for sensing in alternate images (described as “alternating frames A and B”) captured by the camera(s), such that the comparison of the alternating frames reveals spatially limited areas (i.e., “markers”) on the color-changing surface of the article that have significantly different “A/B” spectral response (e.g., fluorescing an “n2” color band strongly during the capture of “frame A” while absorbing the same “n2” strongly during the capture of “frame B,”) where this A/B difference in spectral response is herein referred to as “blinking,” and is shown useful for article identification and marker tracking. A preferred camera design is taught that comprises the use of one or more multispectral or hyperspectral sensors, where the sensor(s) captures narrow spectral bands substantially corresponding to the pre-known/designed reflection/absorption bands of the article's surface coating as well as the pre-known/designed bands of light controllably emitted from the engineered light source.

Regarding objective (3) “means for improving the gamer's integrated and continuous perception of physical-virtual (PV) interaction,” the controllable color changing surfaces are shown to be usable in “light field game access points,” such as a ride line at a theme park or an exhibit in a museum. Virtually any object or surface comprising a game access points can use a color changing coating ranging from small articles to entire walls. The spatial volume light fields can be generated by a multiplicity of synchronized engineered light sources such that various combinations of narrow band lighting can be emitted throughout the entire field or within specific locations of the field, thus covering multiple or only specifically intended surfaces. Individual engineered light sources may comprise light field shaping lenses to better control the placement of the field, or alternately may be movable projectors, where projectors optionally allow projecting mapping of moving images onto the surfaces.

Using these light field game access points, guests that are not gamers view a volume of the game access point and perceive a specific general lighting effect, whereas one or more gamers alternately and simultaneously perceives a substantially different lighting effect in the same viewing volume, and where this alternate lighting effect for example calls attention to game clues or secret messages. Gamers are shown to be optionally wearing active filtering glasses, where the glasses are also timed with the emissions from the engineered light sources, such that some of the emissions are transmitted by either or both of the right-left lenses of the gamer's glasses, and where other emissions are blocked by either or both of the glass's lenses, thereby supporting various 2D and 3D effects that can be concealed from non-gamers. It is also shown that the color changing surfaces can be made to appear to change colors to the unaided eye not using active filtering glasses, and as such lighting effects can be provided to non-gamers. Additional teachings provide from translucent surfaces that are either back-lit and/or front-lit with projection mapped lighting from engineered light sources, where the translucent surface for example then appears as a talking head of a first kind to a non-gamer viewing without active glasses and a talking head of a second kind to one or more select gamers simultaneously viewing with active glasses.

Further regarding objective (3) “means for improving the gamer's integrated and continuous perception of physical-virtual (PV) interaction,” additional teachings include using the color changing surfaces in an “article illumination and tracking station,” where the tracking station determines the ongoing trajectory of the 3D gesticulations of the article (such as a wizard's wand or light saber) being manipulated by a gamer within a tracking volume and provides information based upon these trajectories to a game access point working as a part of a larger interactive gaming system. The 3D space of the tracking volume is shown to be illuminated by one or more engineered light sources such that for example when the gamer presents their article into the tracking volume, the tracking station detects the article's presence, determines the gamer ID or article ID, and interacts with the interactive gaming system to determine a colorization change, where the determined change is preferably based at least in part upon any one of or any combination of the static article characteristics data (i), the gamer and the gamer's game state with respect to the interactive gaming system, and/or alternatively the colorization change confirms the article's proper positioning within the tracking volume. As the article is thereafter gesticulated by the gamer, and in accordance with at least the tracked trajectory and the game being played, the tracked changes preferably cause the interactive gaming system to make additional changes to the engineered light, or any active elements of the article's colorization coating, to effect additional color changes.

Still regarding objective (3), the functions of the article illumination and tracking station are then combined with a “visualization station” to create a “power casting game access point,” where a gamer's gesticulated article movements are transformed by the interactive gaming system using the visualization station into augmentations of a person being viewed behind (or through) the visualization station, where the visualization station is for example a transparent display or non-transparent display with an opening for example allowing the person to place their face into the display for viewing from the gamer's perspective.

Additional teachings expand the power casting game access point that allows a single gamer to create visual augmentation effects with respect to a passive non-gamer, to become a “gamer competition game access point,” where at least two gamers simultaneously and in opposition gesticulate their gaming articles to create real-time augmentation effects interposed between their viewing position and the position of their opponent. Real-time augmentations are shown to include changes to transparent display visualization stations situated essentially in front of each gamer, where the opposing displays emit augmentation images out-of-phase with each other and in phase with their opponent's active glasses such that a gamer's glasses are open for viewing when an augmentation is being emitted by their opponent's visualization station, but closed for viewing when an augmentation is being emitted by their own visualization station.

Also shown with respect to the gamer competition game access point, additional viewing augmentations are provided by a holographic display interposed between the two opposing visualization stations and preferably moved about by a guided rail system such that the holograms generated by the display can be moved back-and-forth closer and then further away to-and-from a particular gamer. The hologram is for instance generated using a beam splitter that is guided by the rails along a line parallel and in between the two opposing gamers, where the beam splitter is oriented at substantially a 45° angle with respect to the gamer's viewing perspective. Projectors are then placed on the same rail system and off to either side of the rails such they their out-of-phase timed emissions are reflected off the beam splitter and into the views of either opponent, all timed with the particular gamer's glasses. Thus, each gamer in alternating temporal viewing “sub-channels” timed with their active glasses is able to see either 2D or 3D augmentations provided by the combination of the visualization station situated directly in front of their opponent and the hologram situated in front of their opponent's visualization station.

Also regarding objective (3) “means for improving the gamer's integrated and continuous perception of physical-virtual (PV) interaction,” additional teachings include modifications provided to a display and preferably the public-private display (with or without the mirror) taught in the related application U.S. Pat. No. 10,719,134 entitled INTERACTIVE OBJECT TRACKING MIRROR-DISPLAY AND ENTERTAINMENT SYSTEM filed on May 9, 2018. Specific modifications include placing one or more RFID readers behind the display for the purpose of reading an electronic tag embedded inside the article (such as a wand), where the tag preferably includes an article ID. The modified display provides the interactive gaming system with the article ID along with the ID of the reader, where the reader ID is translatable into the spatial portion of the display where the gamer is currently touching the tip of their article (comprising the electronic tag) to the display. The interactive gaming system then interacts with the display to cause a visualization change to the display preferably including the determined current spatial display location of the gamer's article such that the gamer perceives that for example a virtual game character currently being displayed “receives” or “transfers” power from or to the gamer substantially at the time the gamer taps their article tip to the display.

And finally, regarding objective (4) “means for improving the perception of continuous experience between various modes of a multimodal interactive game,” a convincing continuous gamer experience is taught to be enhanced by the transfer of context between game modes, for example where a first mode (of a multimodal game) is a console-based video game, a second mode is a game access point at a destination, a third mode is a game coloring book with image capture app, a forth mode is an interactive board game with replaceable gamer overlays which can be game coloring book pages, and a fifth mode is a schoolwork app. Transferred context preferably comprises (4.i) foreground (including character, especially the gamer's “character”/avatar), (4.ii) background scene colors (which might be originally chosen/reset within any of the available game modes and should therefore preferably transfer automatically between modes), (4.iii) virtual world physics (for example equations or parameters determining or effecting how the virtual foreground objects are determined/calculated/portrayed to move and behave with respect to the virtual “world” environment/background, for example in a video game), and (4.iv) critical game-object functions (what key game objects, such as a wand, light saber or pen are able to do inside the virtual world in response to character gestures).

Some multimodal game modes such as the coloring book with image capture or schoolwork app can for example be influenced using transferred content (e.g., images transferred from a video game or park ride physics transferred from destination gamification layer), where these same modes then also amend this transferred content for use in other still other modes or the original transferring mode, where amending for example includes altering character or scene colors, altering in-game physics, or otherwise altering physical or virtual object behaviors. So for example a gamer rides a custom “adjustable physics” ride at a theme park, where the adjustment parameters are alterable within safety limits as determined by the theme park, and where for example parameters cause tradeoffs between vehicle capabilities such as maximum velocity and turning radius for a self-driven vehicle on a shared race car track, and these adjustable parameters are provided as transferred context to a schoolwork app in which a homework lesson is used to calculate and simulate various alternate settings and upon completion of the homework final settings are transferred back to the theme park such then when the student returns and is identified prior to their next ride experience, their race car's parameters are reset accordingly. Gamer achievements determined in any mode, especially for example the schoolwork app mode, can be transferred as content for effecting the game play options and functions of any other mode.

To best achieve the gamer perception of a continuous experience (for example, when starting a video game, moving to an interactive board game and then playing a theme-park destination game) it is for example desirable that: 1) the gamer's (virtual) avatar is both customizable and that these customizations follow the gamer consistently from mode-to-mode, 2) the virtual world the avatar interacts with is both customizable and carries similar look (background colors) and feel (virtual world physics), 3) the critical game objects exhibit behaviors and functions that are at least consistent and are potentially customizable and preferably responsive to the accumulated game state (for example the gamer's avatar's wand should have increased/decreased “powers” based upon the gamer's current game state such as location, points, etc., and 4) and associated physical “real-world” game access points should exhibit functions and behaviors in accordance (“locked” to) the current virtual world context. What is needed and described herein are technical means for exchanging context between modes of a continuous multimodal game such that that gamer perceives effective continuity of experience.

Given the state-of-the-art in light emission technology including lasers, LEDs, lamps, and light filtering materials, as well as reflecting, absorbing, fluorescing and light transmitting surface coating technologies such as nanoparticles, dyes, pigments, fluorescers, electrochromic polymers, and electrophoretic materials, it is possible to create systems using the teachings provided herein to provide controllable surface color changing effects especially in relation to an interactive gaming system. Given the state-of-the-art in multi-spectral and hyperspectral sensors, along with the combined engineering lighting and coatings, it is possible to enhance article gesticulation tracking as described herein. Given the state-of-the-art in displays, projectors, projection mapping, and holograms along with the combined engineered lighting, coatings, and enhanced article tracking, it is possible to create new types of highly interactive physical-virtual experiences where gamers compete with themselves, other gamers and virtual game characters in physical settings that are augmented in real-time to enhance the visual experience of the gamer(s) with spatially embedded virtual effects. It is now possible to tightly integrate “cross-gaming” experiences through generalized gesture input, associated and responsive game behaviors and visual output, and mode context sharing thereby enabling multimodal gaming with the enhanced perception of a continuous game experience across various modes of play.

The present invention is anticipated to offer significant benefits for continuous experience multimodal physical-virtual games, where modes include video games, interactive board games, destination experiences, and where modes are further extended to include substantially educational experiences.

### DESCRIPTION OF FIGURES

The present application teaches many new apparatus and methods, some of which are dependent upon or otherwise derivatives of the present inventors' prior teachings as referenced to in the CROSS-REFERENCE TO RELATED APPLICATIONS section above. To help the reader with correlations between the present application and these related PRIOR ART applications from the present inventors, wherever reasonably possible figures, portions of figures or elements of figures from the PRIOR ART have been copied forward into the present figures. Furthermore, wherever reasonably possible these element have been labeled according to the same labels used in the PRIOR ART. These copied elements with equivalent labeling are meant to help with cross-referencing and should not be considered as necessarily an exact equivalence, but rather a careful reading of the present teachings along with the related art will make clear the novel art taught herein.

FIG. 1A depicts a PRIOR ART “Harry Potter” “wizard's wand” 5 sold by Universal Studios based upon the teachings of Kawash et al., U.S. Pat. No. 10,134,267 issued on Nov. 20, 2018. The Kawash invention teaches an article 5 (the wand) including a single point (the tip 5t) on the article that comprises a retroreflector 5t-r. The prior art teachings provide technical improvement for tracking the tip 5t-r of the wand 5 but not any other portion of the article (such as the shaft 5s of the wand), where the single point 5t-r provides for tracking with two degrees of freedom (“2 DoF”), for example representable as an X, Y location in a flat plane.

FIG. 1B depicts an article 12 of the presentation, in general any article, but for example as shown a “wizard's wand” comprising a shaft 12s and tip 12t. Tip 12t comprises the combination of a reflector or retroreflector 12t-r and an embedded electronic tag 12id (where for example the tag 12id is based upon either of RFID or NFC technology). Shaft 12s comprises one or more substantially non-visible reflective markings such as 12m-r1, 12m-r2 and 12m-r3, where the preferred non-visible tracking energy is infrared (IR). Shaft 12s further comprises one or more substantially non-visible absorptive markings such as 12m-a1, 12m-a2, 12m-a3 and 12m-a4, where again the preferred non-visible tracking energy is IR. The quality of substantially non-visible means that the same markers 12m-r1, 12m-r2 and 12m-r3 and 12m-a1, 12m-a2, 12m-a3 and 12m-a4 interact with the visible spectrum in such a way as to be minimally to not perceivable to the unaided eye.

FIG. 2A depicts a high-level component diagram of a PRIOR ART “6P 3D laser projection system.” The system generates 2 distinct narrow bands of each of the primary colors (blue, green, and red), where the bands form 2 distinct “rgb triplets,” namely “rgb1” and “rgb2.” The combination of each “3P” (three primary) triplet thus being “6P” spectral output 63-so-1.

FIG. 2B depicts the well-known spectral response 2o-sr of the human eye of an person-observer 2o. The 6P spectral output 63-so-1 is shown as vertically oriented bars approximately aligned to the eye's spectral response 2o-sr, where each bar is labeled with a number (such as “445” for the b1=blue 1 bar), where this number represents what is known as the “center frequency” of the narrow band of light. It is well-known that the human eye does not substantially differentiate between the primary bands of b1 and b2, g1 and g2, or r1 and r2, such that regardless of the blue, green, or red narrow band being emitted, the eye perceives simply blue, green, or red light.

FIG. 2C depicts a pictorial representation of PRIOR ART “6P 3D glasses” that use what is known as a “dichroic filter” applied to each left and right lens of the glasses in order to for example only transmit the “rgb1” triplet through the right lens (shown on the left side) and only transmit the “rgb2” triplet through the right lens (shown on the left side). As is well known in the art, supplying slightly offset images of the same scene to the left and right eyes at substantially the same moment in time creates the perception of 3D.

FIG. 2D is a direct copy of FIG. 2h shown in PRIOR ART U.S. Pat. No. 11,025,892 entitled SYSTEM AND METHOD FOR SIMULTANEOUSLY PROVIDING PUBLIC AND PRIVATE MESSAGES filed on Apr. 4, 2019. FIG. 2h of the prior art (herein FIG. 2D), further adapts the PRIOR ART 6P 3D projectors (FIG. 2A) and dichroic glasses (FIG. 2C) to provide for what was referred to in the PRIOR ART U.S. Pat. No. 11,025,892 as a “4 sub-channel” system, where each sub-channel allows for a distinct stream of images to be viewed by an observer 2o. Two distinct “spatial sub-channels” are formed by using dichroic glasses, such as 14-9-1 and 14-9-2, where both lenses of 14-9-1 transmit the rgb1 triplet and block the rgb2 triplet, and where glasses 14-9-2 conversely pass the rgb2 triplet, blocking the rgb1 triplet. Each of these glasses 14-9-1 and 14-9-2 where then further adapted in the PRIOR ART to additionally comprise an active filter supplying at least 2 “temporal sub-channels” per each “spatial sub-channel,” therefore distinct sub-channels in all.

FIG. 3A depicts a secession of 4 spectral response graphs from left-to-right including (1) the human eye 2o spectral response 2o-sr (the same as shown in FIG. 2B) comprising the three primary colors 2o-srb (blue), 2o-srg (green) and 2o-srr (red), (2) any individual color (such as 2o-srb (blue), 2o-srg (green), or 2o-srr (red)) represented as a generic “color x” spectral response curve 2o-csr, (3) the generic spectral response 13s-sr of a substance 13s (such as a nanoparticle, pigment, dye, quantum dot, etc.) caused by the ability of the substance 13s to scatter, absorb or otherwise transmit light of a given frequency, and (4) the generic spectral output of a light source 63e such as a laser system (see FIG. 2A), an LED, or any light source being filtered into or otherwise emitting a narrowband spectral output 63e-so.

FIG. 3B depicts an engineered light source 63 emitting two distinct spectral outputs 63e-1-so, 63e-2-so comprising substantially non-overlapping frequencies (e.g., b1 and b2, or g1 and g2, or r1 and r2) within a range of frequencies 2o-csr perceived as a primary color x (blue 2o-srb, green 2o-srg, or red 2osrr) by an observer 2o, where the emissions impinge upon an engineered coating 12g comprising a tri-color-bands absorbing and/or reflecting layer 13-3ar comprising some combination of absorbing and/or reflecting substances on top of a broadband reflecting and/or absorbing layer 13-1ra. Tri-color-bands layer 13-3ar comprises a combination of one or more light absorbing substances 13s-1 and one or more light reflecting/scattering substances 13s-2. Reflected emissions 13s-1-re received by an observer 2o based upon spectral output 63e-1-so being substantially absorbed by a substance 13s-1 are perceived as very low in intensity and therefore dark or “black,” whereas reflected emissions 13s-2-re received by an observer 2o based upon spectral output 63e-2-so being substantially reflected (scattered) by a substance 13s-2 are perceived as much higher intensity and therefore a particular color (such as blue, green, or red) depending upon the spectral range 2o-csr.

FIG. 3C depicts the blue 2o-srb, green 2o-srg, and red 2o-srr spectral responses of the human eye overlaid with the six (6) spectral outputs of PRIOR ART 6P lasers projectors (shown as vertical bands b1, b2, g1, g2, r1, and r2) and 5 absorption curves (spectral responses 13s-1b-sr, 13s-1g-sr, 13s-1r1-sr, 13s-1r2-sr, and 13s-1r3-sr) of 5 exemplary dyes, respectively, sold by QCR Solutions (VIS441A, VIS523A, VIS593A, VIS603A, and VIS637A). What can be seen is that spectral output of 6P laser light represented as bands b1, g1, and r1 are largely absorbed by tri-color-bands absorbing layer 13-3a comprising exemplary dyes VIS441A, VIS523A, and VIS603A, where the spectral output b1, g1, and r1 is operated upon (absorbed and otherwise transmitted) by layer 13-3a to become minimal reflected emissions 13s-1b-re, 13s-1g-re, and 13s-1r-re, respectively (perceived by eye as substantially black). Conversely, bands b2, g2, and r2 are substantially transmitted by layer 13-3a, such that an underlaying broad-band reflecting layer (13-1r, not depicted) can then operate on emitted bands b2, g2, and r2 to cause significant reflections (not labeled) to be perceived by the human eye as colorization (e.g., substantially white). FIG. 3D, like FIG. 3C, depicts the same blue, green, red spectral responses of the human eye along with the same 6 spectral outputs of PRIOR ART 6P lasers (vertical bands b1, b2, g1, g2, r1, and r2), where an additional 3 exemplary spectral outputs (b3, g3, and r3) have been depicted. Also shown are 9 absorption curves (not labeled for clarity) of 9 exemplary dyes sold by QCR Solutions (VIS423A, VIS441A, VIS465A, VIS503A, VIS523A, VIS548A, VIS593A, VIS603A, and VIS637A,) various combinations of which may comprise tri-color-bands absorbing layer 13-3a. Careful observations will show that for every triplet b1-b2-b3, g1-g2-g2, or r1-r2-r3 it is possible to create a first and second coating (thus a 13-3a-1 and 13-3a-2, not depicted) each comprising only two of the three dyes with peak frequencies centered in a given triplet color (i.e., blue, green, or red eye response,) where each coating shares one of the three dyes and has a second dye not shared by the other coating.

FIG. 3E, similar to FIG. 3B, depicts an engineered light source 63 emitting two distinct spectral outputs 63e-1-so, 63e-2-so (e.g., b1 and b2, or g1 and g2, or r1 and r2) preferably comprising substantially non-overlapping frequencies within a range of frequencies 2o-csr perceived as a primary color x (blue, green, or red) by an observer 2o, where the emissions impinge upon an engineered coating 12g. In the present FIG. 3E, coating 12g comprises the combination of a non-visible (UVA, NIR) to visible, tri-color bands (fluorescer) layer 13-5 on top of a broadband absorbing layer 13-1a. Top tri-color bands layer 13-5 comprises one or more light fluorescent substances 13s-3. Fluorescent substance 13s-3 comprises a spectral response 13s-3-sr that substantially overlaps with spectral output 63e-1-so and causes output 63e-1-so to be substantially absorbed and reemitted as at a different (“stokes shifted”) peak frequency as fluorescent energy 13s-3-fe, which is then perceived by the human vision system as a substantially bright colorization within coating 12g. In contrast, minimal reflected emissions 63e-2-re are received by an observer 2o based upon spectral output 63e-2-so being substantially absorbed by article coating 12g bottom layer 13-1a (comprising a broadband absorber) and are therefore perceived as very low in intensity hence dark or “black.”

FIG. 3F depicts the well-known nominal luminosity response of the human eye which plots the relative sensitivity of the eye to the visible spectrum of frequencies. Overlaid onto this graph are the spectral emissions of PRIOR ART 6P lasers projectors (vertical bands b1, b2, g1, g2, r1, and r2). Also shown are the approximate relative ratios of each combination of emitted blue light b1-b2, emitted green light g1-g2, and emitted red light r1-r2.

FIG. 3G is a table where the rows represent six different exemplary colors (comprising “tristimulus” blue, green, and red-light components) intended to be perceived by a person when looking at an exemplary coating being illuminated by a preferred engineered light source 63. The light source 63 emits two distinct narrow bands of preferably closely collocated but non-overlapping frequencies within each of blue, green, and red spectral responses of the human eye (see for example FIGS. 3A, 3B, 3C, 3D and 3E). An exemplary coating substantially absorbs the “locked” narrow bands of spectral output denoted as b1, g1, and r1, and substantially reflects the “free” narrow bands of engineered light 63 denoted as b2, g2, and r2 (see especially FIGS. 3C and 3D for examples coatings). The table provides settings to the relative emission levels of the reflected bands to cause a given perceived color (row) when looking at an article with special coating 12g, as well as settings to the emission levels of the absorbed bands to offset the respective reflected band settings such that the net (average) emissions of reflected and absorbed bands (b1, b2, g1, g2, r1, and r2) continues to be perceived as substantially “white light” of a constant luminance to a person.

FIG. 3H depicts the well-known spectral response (reflectance versus ultraviolet-to-visible-to-infrared spectrum frequency) of human skin (responses shown for Caucasian and Black/African). These responses have been superimposed with nine (9) vertical narrow bands of representative energies labeled “u1,” “b1,” “b2,” “g1,” “g2,” “r1,” “r2,” “n1,” and “n2.” For each narrow band, there are shown two circles representing engineered coating reflectance values of substantially 0 (no reflectance) to roughly 40% reflectance. Of these two circles per each narrow band, one circle is darkened to represent a possible article coating reflectance created from the combination of appropriate substances, where these darkened circles are connected by dashed lines to emphasize a comparison in the net spectral response of the engineered article coating compared to the spectral response of human skin, where using a multi or hyperspectral sensor substantially filtered to detect one or more of these nine (9) bands, the article coating is readily distinguishable from any type of skin response greatly aiding in the differentiation during image processing of the article from for example the hand of a gamer holding the article.

FIG. 3I depicts the public-domain available spectral response of two variations (“Compact WO3” or “CWO3,” and “Porous WO3” or “PWO3”) of an electrochromic material showing the transmission of frequency ranging from UVA to visible to NIR. Overlaid onto this electrochromic material spectral response chart are the nine (9) vertical narrow bands of representative energies labeled “u1,” “b1,” “b2,” “g1,” “g2,” “r1,” “r2,” “n1,” and “n2,” (as just depicted with respect to FIG. 3H,) where it can be seen that material PWO3 provides a switchable window at least for the visible and NIR bands (i.e., “b1,” “b2,” “g1,” “g2,” “r1,” “r2,” “n1,” and “n2”), while material CWO3 provides a switchable window for the UVA band(s) (i.e., at least one UVA band “u1”). An electrochromic film/material acting as a switchable window is referred to as a substantially absorptive (black, colored)/substantially transmissive (transparent) layer 13-4b, where switchable window layer 13-4b is transitioned via an electrical charge applied by an embedded, wirelessly powered switch 13-4s, where the applied charge causes a change of state from substantially not transmitting the desired narrow bands to substantially transmitting the desired narrow bands, all as will be well understood by those familiar with electrochromic materials.

FIG. 3J depicts the PRIOR ART “3 color e-ink” technology that is being adapted herein as an absorptive (black)—reflective (white, colored) layer 13-4a for use in creating a specially engineered coating.

FIG. 3K depicts an e-ink “ball”/“particle” that is further adapted over the PRIOR ART of FIG. 3J to use a herein taught special engineered coating 12g for providing for example tri-color-bands absorber, or tri-color-bands reflector/fluorescer light operations.

FIG. 3L depicts an e-ink “ball”/“particle” that is further adapted over the PRIOR ART of FIG. 3J to be in the form of a PRIOR ART “microsphere retroreflector” 9-1, where a traditional microsphere retroreflector 9-1 is well-known to capture impinging light and to readmit this light in substantially the same trajectory as the impinging light, thus “retro-reflecting” the light substantially back in the direction from which it came. Traditional microspheres use a reflecting coat 9-1 comprising a broadband reflective material such as an aluminum, where the present invention anticipates applying a tri-color-bands absorbing layer 13-3a over this (or any variation) traditional reflective coating 9-1, the combination then becoming tri-color-bands retroreflector coat 9-2.

FIG. 4A depicts a specially coated “generic” article 12g, where a generic article 12g can be any object of virtually any size and shape (including exemplary toy wand article 12 of FIG. 1B). This preferred “generic”/“any object”/“any surface” specially coated article 12g comprises a colorization that operates upon impinging light to absorb a first set of at least three distinct narrow-bands of colored light (e.g., “tri-color bands” b1, g1, r1, thus a band of a blue, a green, and a red), while also reflecting and/or fluorescing a second set of at least three distinct narrow-bands of colored light (e.g., “tri-color bands” b2, g2, r2).

FIG. 4B through 4K depict the article special coating 12g of FIG. 4A as nine (9) exemplary variations (12g-1 though 12g-10,) where each variation comprises two or more representative/“conceptual” layers of substances for causing by different means the desired effect of coating 12g, which is to operate on light controllably emitted in various combinations of narrow bands by an engineered light source, such that a person viewing a specially coated article perceives a change in the article's colorization while also simultaneously not perceiving any substantial change in the light colorization as emitted by the engineered light source. For each variation 12g-1 though 12g-10, the representative layers are conceptual layers in that they may or may not be applied as multiple layers, or any given portrayed layer may itself comprise multiple layers “in production” or otherwise. In general, all coatings 12g-1 through 12g-9 comprise a bottom layer that is a “catch all” broadband operator that is either absorbing or reflecting any of the light being transmitted through the upper layers, where coating 12g-10 comprises an unspecified bottom layer, representing the optional nature of the bottom layer for all coating variations. Upper layers in general comprise substances for operating upon light in any of the well-known ways including reflecting (scattering,) absorbing, transmitting, fluorescing, and phosphorescing. Most upper layers are passive requiring no energy, but some upper layers are active employing for example electrochromic or electrophoretic materials, thus providing an electronically switchable layer. An optional “surface smoothing”/transparent layer is also discussed as this layer is known to affect the light operations of some substances, and also otherwise to address issues of durability and layer application.

FIGS. 5A and 5B combine to show two different light sources such as the sun emitting broadband spectral output 64-so and an engineered light emitting limited narrow bands of spectral output 63-so-1, where both sources comparatively illuminate both a non-specially-coated broadband reflecting material such as a white piece of paper 11 and a specially-coated tri-color-bands absorbing and/or reflecting and/or fluorescing article such as toy want 12. What is shown and discussed is the various perceptions of light 2o-pl-1, 2o-pl-2, 2o-pl-3, 2o-pl-4, 2o-pl-5 and 2o-pl-6 of the light sources, paper 11, and article 12.

FIGS. 5C and 5D combine to show a single engineered light source 63-1 emitting a first combination of limited narrow bands of light comprising spectral output 63-1-so2 (FIG. 5C) and then a second combination of limited narrow bands of light comprising spectral output 63-1-so3 (FIG. 5D,) where each of outputs 63-1-so2 and 63-1-so3 comparatively illuminate both a non-specially-coated broadband reflecting material such as a white piece of paper 11 and a specially-coated tri-color-bands absorbing and/or reflecting and/or fluorescing article such as toy want 12. What is shown and discussed is the various perceptions of light 2o-pl-7, 2o-pl-8, 2o-pl-9, 2o-pl-10, 2o-pl-11 and 2o-pl-12 of the light 63-1-so2 and 63-1-so3, paper 11, and article 12.

FIG. 6A depicts three different light sources including engineered light source 63-2, filtered engineered light source 63-3 and filtered natural light source 64w, for providing spectral emissions 63-2-so, 63-3-so and 64w-so, respectively, to be reflected off for example articles 12 (a wand) and 11 (a white piece of paper) causing color perceptions by person 2o (not wearing active filtering glasses 14) and gamer 2s (wearing active filtering glasses 14). When using engineered light sources such as 63-2 and 63-3 (either in combination with or without a natural light source 64w,) if the emissions 63-2-so and 63-3-so, respectively, are timed to be either or both in-phase or out-of-phase with active filtering glasses 14 worn by gamer 2s, it is possible to cause gamer 2s to perceive a different color of articles 11 and/or 12 based upon the same emissions 63-2-so and 63-3-so, respectively, than as would be perceived by person 2o. Engineered light sources 63-2 and 63-3 are both show with optional light shaping filters 73-2 and 73-3, respectively.

FIG. 6B is a series of eight exemplary and representative control signals (63cs-1 through 63cs-8) individually or in combination controlling engineered lights sources 63 such as exemplary light sources 63-1, 63-2 and 63-3, (see prior FIGS. 3B, 5B, 5C, 5D, and 6A as well as upcoming FIGS. 7A, 7B, 8A, and 8B,) as well as active filter lenses employed in glasses 14 and magnifying glass 15, where active filter lenses can be used by a gamer 2s to see private images or “privately encoded light” being emitted by the light sources 63, where the timing of the control signals and thus the perception of the emitted spectral output of sources 63 that can be publicly perceived by a person 2o, as well as any privately encoded light that can only be seen by a gamer 2s, can be incorporated as a function of an interactive gaming system implemented at a destination.

FIG. 7A depicts a light field game access point 30-1 (for example used in a ride or ride line at a theme park) where a non-gamer 2o and a gamer 2s wearing controlled active filter glasses 14 are both looking at an article 12-2 that is a translucent material (for example in the approximate shape of a human head). The engineered light sources including area lighting 63, interior projector 21-p3 and exterior projector 21-p4 work in combination using synchronized control signals to cause the gamer 2s to perceive translucent article 12-2 to be showing for example a ghoul face talking while non-gamer 2o perceives translucent article 12-2 to be showing for example a talking head of a ride-guide.

FIG. 7B depicts the light field game access point 30-1 of FIG. 7A in a larger setting/perspective including a multiplicity of shaped adjustable engineered lights 30-sal, each comprising an engineered light source 63 emitting through a light shaping filters 73 and controllably moved/adjusted by optional mechanical drives 74. The emitted shaped light field 63lf is controlled for example by a synchronized light source controller 30-1c receiving input from an interactive gaming system 48. Also depicted are articles such as 12-1 and 12-3 which can be any object or otherwise surface preferably coated with a specially engineered coating 12g, such that the article's colors (as perceived by a person 2o not looking through an active filter 14 or 15, or a gamer 2s looking through an active filter 14 or 15) can in different ways be controllably changed based upon the timed spectral emissions of the synchronized engineered light sources 63. Article 12-2 along with interior projector 21-p3 and exterior projector 21-p4 are also shown (see FIG. 7A). Access point 30-1 additionally comprises gamer glasses controller 30-comm for emitting control signals such as 63cs-5 (see FIG. 6B) for controlling either of glasses 14 or magnifying glass 15, gamer glasses location detector 30-det for determining the approximate current location of either of glasses 14 or magnifying glass 15 being worn/used by a gamer 2s, and guided rail car position sensor 52 for determining the current location of a ride car transporting a gamer 2s or non-gamer 2o (if the access point 30-1 is being used in combination with automated rail transportation, such as a theme park ride).

FIG. 8A depicts an article illumination and tracking station 30-ts comprising the combination of an article tracking station 30-ot, an article colorizing light source 30-ls and optionally synchronized area lighting 63-3. In general, tracking station 30-ot prescribes a 3D tracking volume 30-tv in which a gamer 2s moves about a game article 12 such as a toy wand comprising a special coating 12g. Cameras and/or sensors 30-ot-cam1 through 30-ot-cam4 within station 30-ot are used as image processing input to track the 3D path of the wand 12 for conversion into “spells” that are preferably used as input into an interactive gaming system 48 (not depicted). Colorizing light source 30-ls, preferably in communications with gaming system 48, is operated at least in part to respond to the input spells to cause a colorization change in the appearance of the wand 12. The gamer 2s receives different possible visualization effects either wearing or not wearing active lenses such as 14. Area lighting 63-3 can provide additional visualization effects, but also can be operated out-of-phase with the tracking cameras such as 30-ot-cam1 so as to effectively “dim” the background as opposed to the tracking volume 30-tv which is the foreground comprising the moving wand 12, where the dimming is helpful for segmenting the background from the foreground during image processing/wand article 12 3D tracking.

FIG. 8B depicts a gamer 2s gesticulating an article/wand 12 within the tracking volume 30-tv of a tracking station 30-ot while the tracking volume 30-tv is being imaged 30-ot-cam-img by at least one sensor/camera 30-ot-cam, and where sensor/cameras such as 30-ot-cam are synchronized to be in-phase with engineered lighting 63-2 of light source 30-ls (see also FIG. 8A) and preferably includes a light shaping filter 73. A preferred structure of key components in a sensor/camera such as 30-ot-cam includes a lens 30-ot-cam-ln receiving light into a frequency beam splitter 30-ot-cam-bs that separates the visible light to be received by sensor 30-ot-cam-vl from the infrared light to be received by the sensor 30-ot-cam-ir. Both sensors 30-ot-cam-vl and 30-ot-cam-ir are preferably multi-spectral or hyper-spectral and each may comprise an optional light field micro lens 30-ot-cam-lf1 and 30-ot-cam-lf2, respectively.

FIG. 8C is a table depicting the anticipated color and intensity effects caused by narrowband lighting emitted by in-phase engineered light 63 as temporally alternating images A and B are captured by a sensor/camera, such as 30-ot-cam, of objects located within tracking volume 30-tv, where objects for example include portions of a gamer 2s including skin and clothing, an article 12 such as a wand being gesticulated, and some possible background including a non-gamer 2o. Alternating images A and B are for example captured each at 30 frames-per-second (fps), where the interleaved A-B pair achieves 60 fps.

FIG. 9A depicts a power casting game access point 30-2 comprising an article illumination and tracking station 30-ts (see FIGS. 8A, 8B, and 8C) for interacting with a gamer 2s to determine one or more commands such as a spell based upon the gamer 2s's tracked gesticulations of an article 12. Tracked gesticulations are translated into “powers,” “commands,” etc., for example activating changes to a visualization station 30-vs-1 comprising a display 22-1 (or projector [not depicted] illuminating a surface 22-1), where the display surface 22-1 preferably includes an opening 22-1o into which a non-gamer 2o for example inserts their (real) head, where the changes include different images displayed or projected in combination with the non-gamer 2s's real head. Powers may also cause changes to the emitted lighting in the article illumination and tracking station 30-ts such that the gamer 2s perceives color changes to the article 12, for example timed to occur substantially simultaneously with changes to images displayed or projected in the visualization station 30-vs-1. Non-gamer 2o is optionally standing on haptic feedback floor 24, such that vibrations and other tactile effects can also be provided to the non-gamer 2o.

FIG. 9B depicts a top view of a gamer competition game access point 30-3 comprising a power casting game access point 30-3-g1 (see FIG. 9A) being used by a first gamer 2s-g1, a power casting game access point 30-3-g2 being used by a second gamer 2s-g2, and an interposing effects station 30-3-ie. First gamer 2s-g1 uses power casting game access point 30-2-g1 to capture real-time gesticulation of article 12-g1 by the first gamer 2s-g1, where the translated powers based upon tracked gesticulations cause visualization changes to visualization station 30-vs-2-g1 (nearest to and in front of second gamer 2s-g2) and effects projected from first gamer projector 21-p5-g1 and reflected off beamsplitter 30-bs (thus appearing as a hologram). Second gamer 2s-g2 likewise uses game access point 30-2-g2. Effects projectors 21-p5-g1 and 21-p-g2 along with beamsplitter 30-bs are mounted onto a movable rail system 30-mr-1 and 30-mr-2 for adjusting the interposed location. Visualization changes and effects are timed for example to a temporal sub-channel 1 to be received by first gamer 2s-g1 wearing glasses 14-g1 synchronized to be open for sub-channel 1, and closed for sub-channel 2, where second gamer 2s-g1 wearing glasses 14-g2 conversely receives their visualizations and effects on sub-channel 2 but not sub-channel 1.

FIG. 10A depicts a ride/show/presentation game access point 30-4 comprising an interactive gaming system 48 in communications with external triggers and timing control 30-et for substantially providing the “situational input” of one or more non-gamers 2o or gamers 2s, synchronized light source controller 30-1c for controlling one or more light sources such as projectors 21-p6 and 21-p7 for providing visual experiences to people 2o and 2s, gamer glasses controller 30-comm for providing signals to active filter lenses such as glasses 14-h1, 14-h2, 14-v1, and 14-v2 being worn by people 2o and 2s, and mobile computing device 2a for exchanging information with people 2o and 2s. Game access point 30-4 also comprises at least one projection surface 30-4s for receiving projected light emitted by projectors 21-p6 and 21-p7 to be reflected for viewing to people 2o and 2s.

FIG. 10B depicts the four variant glasses 14-h1, 14-h2, 14-v1, and 14-v2 being portrayed with key internal components for accomplishing the functionality discussed in relation to FIG. 10A.

FIG. 10C provides two tables analyzing the division of luminance between each of the four (4) separate spatio-temporal subchannels supported by each of projectors 21-p6 and 21-p7 as discussed in FIG. 10A, ultimately showing that each subchannel can receive “sufficient” light for a traditional viewing experience.

FIG. 11 depicts a secret guidance game access point 30-5 comprising an article illumination and tracking station 30-ts (see FIG. 8A) working in combination with guidance area 30-5-a comprising one or more illuminating objects 30-5-io. The depicted floor illuminating objects 30-5-io comprises a preferably translucent layer 30-5-io-tl affixed on top of an engineered backlight 30-5-io-b1 that functions similar to engineered lighting 63 (see e.g., FIGS. 6A, 7A, 7B, 8A, and 9A) to controllably emit any of a number of possible narrow bands of non-visible or visible energy, optionally emitted in-phase with glasses 14 or magnifying glasses 15 such that only a gamer 2s wear looking through filters 14 or 15 is able to see the illumination effect. Floor backlight 30-5-io-b1 is optionally affixed upon contact/pressure or otherwise proximity sensing layer 30-5-io-cs for determining if the guidance object is currently being engaged/contacted/approached for example by a gamer 2s or some other person.

FIG. 12A depicts a tap-magic display game access point 30-6 where a gamer 2s using an article 12 (e.g., a toy wand) touches or “taps” the tip 12t of the article 12 to a portion of a display 20-3 (or otherwise gaming surface,) where the tip 12t with embedded electronic tag 12id is either in contact with, or in sufficient proximity to, optionally a touch sensitive surface 20-3ts of a display 20-3, but otherwise one of a preferable multiplicity of electronic tag 12id sensors such as 20-3-1, 20-3-2, or 20-3-3. Each of sensors 20-3-1, 20-3-2, or 20-3-3 may be implemented using different wireless technologies, such as typically longer-read distance RFID sensors 20-3-rf1, 20-3-rf2, or 20-3-rf3, respectively, or such as typically shorter-read distance NFC sensors 20-3-nfc1, 20-3-nfc2, or 20-3-nfc3, respectively. Display 20-3 is preferably a “public-private” (dual-panel) display 20-3dp taught in the related cross-reference applications, where it is well-known that any LCD based display 20-3 (with a single, dual, or more panels) further comprises a backlight 20-3bl. Other traditional (non-“public-private”) non-LCD displays 20-3 (such as displays using “OLED” technology,) do not further comprise a backlight 20-3bl. Preferably electronic tag 12id is an “NFC” tag and as such readers 20-3-1, 20-3-2 and 20-3-3 are implemented as NFC readers 20-3-nfc1, 20-3-nfc2, or 20-3-nfc3, respectively, and can be positioned between optional touch surface 20-3ts and display 20-3dp (of any technology) as opposed to behind display 20-3dp and possibly behind a backlight 20-3bl (as would be traditionally necessary for implementation using RFID readers 20-3-rf1, 20-3-rf2, or 20-3-rf3).

FIG. 12B is a front-view drawing of the same arrangement of components as depicted in FIG. 12A, accept that display 20-3 is shown as contained with display enclosure 20-3e, where enclosure 20-3e comprises additional tag reader 20-3-4 (not depicted, but understood to be substantially underneath visible tap area 20-3-4ta). Depicted on the face of display 20-3 (within dashed rectangles representing tap-areas 20-3-1ta, 20-3-2ta and 20-3-3ta for taping the tip 12t of article 12 for the detection of electronic tag 12id) are the three display-sense areas corresponding to underlaying electronic tag 12id sensors/readers 20-3-1, 20-3-2 and 20-3-3, respectively. Within each display-sense area tap-area 20-3-1ta, 20-3-2ta and 20-3-3ta there is show a preferable visible indication such as “1,” “2,” and “3” being displayed by display 20-3, such that a gamer 2s is thereby directed or otherwise understands to touch the article tip 12t with electronic tag 12id to any of these indicated locations so as to cause an interaction with the game access point 30-6 and preferably an interactive gaming system, where thereafter preferably the content of the display 20-3 is changed based at least in part upon which of one or more tap-areas 20-3-1ta, 20-3-2ta and 20-3-3ta was actually tapped by the gamer 2s's article tip 12t.

FIG. 13A depicts a video game, game access point 30-7 where gamer 2s uses a computing device/console 20-4 to play a video game, where the video game is a modality of a multimodal game, and where device 20-4 optionally comprises sensors such as camera 20-4c for capturing gamer 2s information, such as gamer characteristics static data comprising facial image(s) and or body/clothing image(s), and where video game play results in the creation of game data and metrics usable across various modalities of a multimodal game.

FIG. 13B depicts a destination guest tracking system 46 as described in the prior cross-referenced art where a gamer 2s for example affixes a wearable tracking RFID tag 16 to their ankle and is tracked by a multiplicity of passive RFID transponders placed throughout a destination for tracking the gamer's destination activities, where the destination tracked activities are a part of a destination physical-virtual game (conducted by an “interactive gaming system”) that is a modality of a multimodal game, and where destination guest tracking system 46 data specifically, and otherwise destination interactive gaming system data, are game data and metrics usable across various modalities of a multimodal game.

FIG. 13C depicts a tap-magic display game access point 30-6 where a gamer 2s uses an article 12 such as a wizard's wand to tap a display 20-3 for providing input where the display 20-3 reads the electronic tag 12id embedded in the tip 12t of the wand 12 (see FIGS. 1B, 12A and 12B,) and where the game access point 30-6 is preferably used as a part of a destination physical-virtual (conducted by an “interactive gaming system”) game that is a modality of a multimodal game, thus any data determined by or associated with game access point 30-6 is usable across various modalities of a multimodal game.

FIG. 13D depicts a coloring book game access point 30-8 comprising one or more coloring pages 70-2 for allowing a gamer 2s to provide game character colorization input, where a game coloring page 70-2 is captured by an image capture and processing device such as smartphone 15c (or a tablet 17c not shown but specified in the prior art) for input into any one or more modalities of a multimodal game.

FIG. 13E depicts an interactive game board game access point 30-9 comprising an interactive game board as described in the prior cross-referenced art for use by a gamer 2s, where the game board interacts with one or more computing devices executing a game app such as a tablet 20-4 (or smartphone not depicted) and is a modality of a multimodal game, and where interactive game board play results in the creation of game data and metrics usable across various modalities of a multimodal game.

FIG. 13F depicts a schoolwork app game access point 30-10 where a gamer 2s uses a computing device such as a laptop 20-4 to interact with a schoolwork app, where the schoolwork app is a modality of a multimodal game, and where usage of the schoolwork app results in the creation of game data and metrics usable across various modalities of a multimodal game.

FIG. 14 is a flow-diagram showing interactivity between various game access points, where for example one or more gamers play any variation of an interactive board (or card) game 30-9, where in the process steps of game play a game state is updated in a shared game database 48-db and both of “local” and “remote” tasks may be generated and update shared assigned tasks data 48-at. Local tasks may for example be completed by a gamer using game access points such as schoolwork app 30-10, video game 30-7 or coloring book 30-8, where during game access point activities the access point updates the game state comprising shared database 48-db and upon sufficient local task progress or completion the game access point also updates shared performed tasks 48-pt. Remote tasks may for example be completed by a gamer by performing any of tracked destination activities 46 including the use of destination game access points such as a tap-magic display 30-6, a secret path 30-5, a ride/show/presentation 30-4, a gamer competition 30-3, or a power casting station 30-2, where during game access point activities the access point updates the game state comprising shared database 48-db and upon sufficient remote task progress or completion the game access point also updates shared performed tasks 48-pt. All game access points have access to assigned tasks 48-at, performed tasks 48-pt and the on-going game state in database 48-db such that the gamer's activities, whether local or remote, can affect any other activity thus increasing the sense of continuous game-play and deepening game engagement.

In the following description, numerous specific details are set forth, such as examples of specific components, types of usage scenarios, etc. in order to provide a thorough understanding of the present disclosure. It will be apparent, however, to one skilled in the art that the present disclosure may be practiced without these specific details and with alternative implementations, some of which are also described herein. In other instances, well known components or methods have not been described in detail in order to avoid unnecessarily obscuring the present disclosure. Thus, the specific details set forth are merely exemplary. The specific details may be varied from and still be contemplated to be within the spirit and scope of the present disclosure.

### DETAILED DESCRIPTION OF THE INVENTION

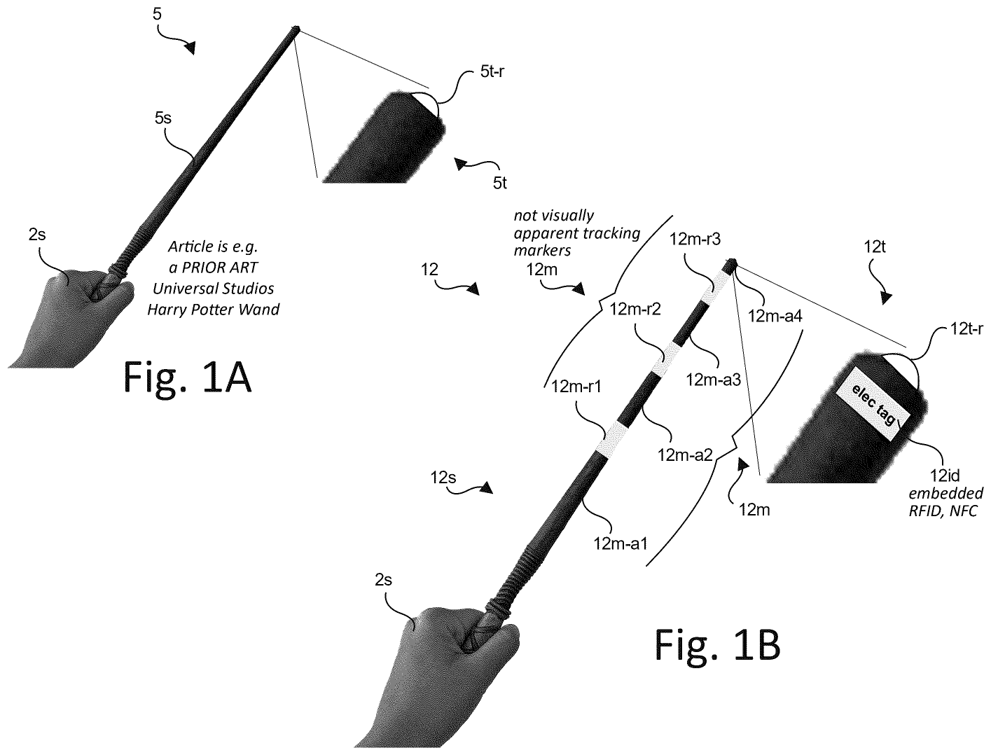

Referring to FIG. 1A, there is shown a PRIOR ART “Harry Potter” “wizard's wand” 5 as sold by Universal Studios based upon the teachings of Kawash et al., U.S. Pat. No. 10,134,267 issued on Nov. 20, 2018. The Kawash invention teaches an article 5 (the wand) including a single point (the tip 5t) on the article that comprises a retroreflector 5t-r. The teachings provide technical improvement for tracking the tip 5t-r of the wand 5 but not any other portion of the article (such as the shaft 5s of the wand), where the single point 5t-r provides for tracking with two degrees of freedom (“2 DoF”), for example representable as an X, Y location in a flat plane.

There are many different types (i.e., recognizable forms comprising at least shapes and exterior colorings) of “wizard's wands” sold as interactive toys for use at Universal Studios Harry Potter World, where a type is based upon a character in the Harry Potter stories (e.g., “Harry,” “Professor Snape,” or “Voldemort”). What is desirable is for an interactive “physical-virtual” game being played by gamers at a theme park such as Universal to respond differently based upon a determination made by the interactive game regarding the type of wand 5 being used by the gamer 2s. What is further desirable is that the types of gestures (movements of the wand by a gamer 2s, also referred to as “trajectories” or “paths”) that are interpretable are allowed to vary wand-type by wand-type. For example, the same basic gesture (wand 5 movement trajectory(s)/path(s)) made on one type of wand 5 (e.g., a “Harry Potter wand”) is interpreted by the interactive gaming system to be a different “command” from the gamer 2s than the same gesture made by the same or different gamer 2s using a different type of wand 5 (e.g., a “Voldemort wand”).

Further, it is desirable that the command be based not only upon the type of wand 5 being used by the gamer 2s, but also the individual gamer 2s themselves that includes a known “game state” with respect to the game (see the related teachings for a better description of “game state,” but which in general means all the known data with respect to the gamer 2s playing a game including current “level,” “points,” “accomplishments” down to individual “activities done,” “questions answered right or wrong,” etc.). Thus, both the recognized type of article 5 (e.g., a type of wizard's wand, but not limited to a wand, e.g., alternately a type of light saber or type of writing pen) and the individual gamer 2s's current game state are preferably allowable to affect the “powers” (spells) than can be enacted by any given specifically recognized gesture of the article. This combination enables a “variable game effectiveness” that increases the gamer's experience of game relatedness and furthermore as will be discussed upcoming, the gamer 2s's experience of continuity within and across different modalities of game play.

As will be well understood by those familiar with image processing, generalized (“multi-article” “multi-type”) gesture recognition is non-trivial to implement. Creating a single camera apparatus and image processing algorithm that can track any type of article 5 (with different possible size, shape, and surface colors) being gesticulated by any gamer 2s (with different possible size, shape, and skin color) wearing any clothes (with different shapes and textures) in any environment (lighting and background) is ideal but problematic. As prior stated in the summary above, this is problematic as the range of shapes, colors, surface reflectivity properties, and other optical characteristics of the articles 5, the gamers 2s and the background make it challenging to implement a generalized image processing algorithm. These are all well-known and well-understood realities for gesture input systems.

FIG. 1A representing the prior art shows that the use of IR tracking energy reflecting off a single point (article tip 5t-r) of an article 5 (such as a wand) can be implemented somewhat “generically” for any gamer 2s, in a controlled/known location, using any wand type (given that all wand types have a distal end tip for the placement of a retroreflector thus becoming 5t-r with a relatively unobstructed view with respect to the camera/sensor apparatus).

Referring next to FIG. 1B there is depicted an article 12, in general any article preferably held by a gamer in one or both hands for the purpose of making meaningful (i.e., with respect to any of game modalities) article movements or gestures, but for example as shown a “wizard's wand” comprising a shaft 12s and tip 12t. While not all articles 12 have well defined or even somewhat defined “tips,” some typical articles such as but not limited to wands, swords, light sabers, pens, guns, etc., do comprise a distal end tip such as 12t, where, as taught by Kawash, tip 12t preferably includes a retroreflector (or at least a reflector) that preferably operates (reflects) within a narrow band of non-visible tracking energy (such as what is known as “near IR”/NIR). The present invention further teaches the inclusion in/near the tip 12t of an embedded electronic tag 12id (where for example the tag 12id is based upon either of RFID or NFC technology).

Still referring to FIG. 1B, many types of articles, especially for use a toys in a modality of a game, that comprise a tip such as 12t further comprise a shaft such as 12s, where the shaft protrudes from a proximal end (“hilt,” “handle”) being held in the gamer 2s's hand, extending to the distal end tip 12t. For articles 12 that comprise a shaft or elongated body extending between the article handle and preferably article a tip 12t, the present invention prefers the inclusion of some combination of one or more non-visible markers, where non-visible markers include absorptive markers such as 12m-a1, 12m-a2, 12m-a3 and 12m-a4 as well as reflective (or retroreflective, or even fluorescent) markers such as 12m-r1, 12m-r2 and 12m-r3. The use of applying reflective, retroreflective, fluorescent, or absorptive markers to objects in order to increase object recognition and tracking is well known in the art, and many appropriate compounds are available including dyes, inks, pigments, multi-layer dielectrics.

Each of the compounds that can be chosen have a given spectral response, where the present invention prefers the use of compounds that are substantially transparent or transmissive in the visible spectrum so as to be “not visually apparent” to the unaided eye. At least one company, Opthentic Corp located in Santa Clara, CA, sells compounds for reflecting near-infrared (NIR), where the compounds are otherwise not visually apparent. The present inventor has used compounds from Opthentic for applying NIR reflective marks such as 12m-r1, 12m-r2 and 12m-r3 (12m collectively), where then given the general absorptive nature of the materials used for articles such as the Harry Potter wands, at least where the materials are coated with a dark or generally black (and in particular NIR absorptive/NIR black) color, the remaining “unmarked” portion of the wand shaft 12s segments into the equivalent of applied absorptive markers 12m-a1, 12m-a2, 12m-a3 and 12m-a4 (12m collectively).

Thus, as depicted in FIG. 1B, the present invention prefers the use of NIR/non-visible tracking energy to be absorbed, reflected, fluoresced, or retroreflected using any combination of applied compounds, where the combination of the applied compounds and the existing “natural” spectral response of article 12's remaining surface area create one or more tracking marks with a pre-known spectral response.

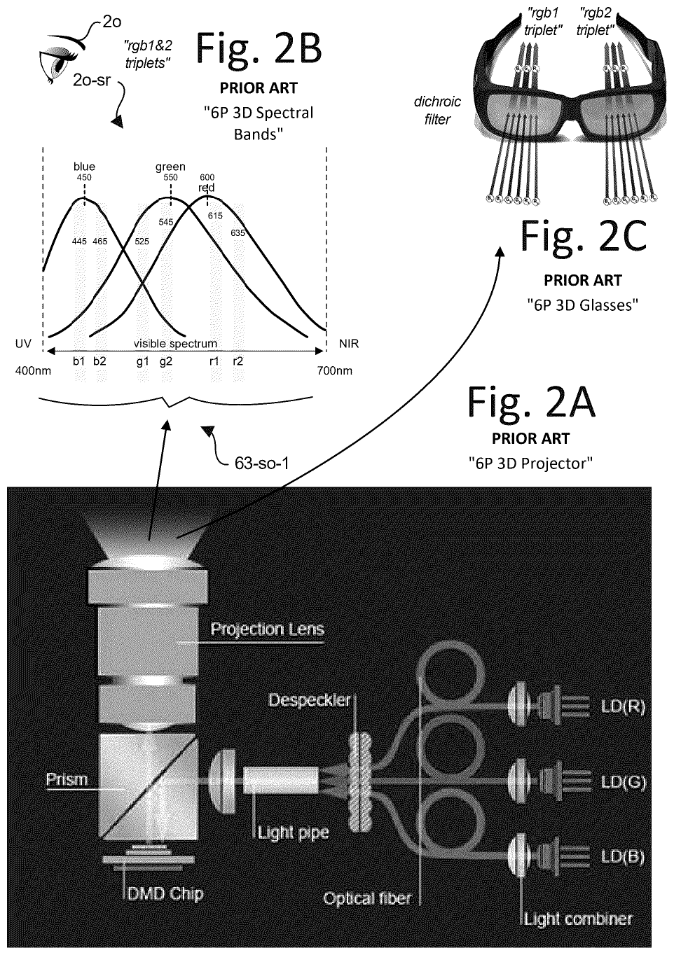

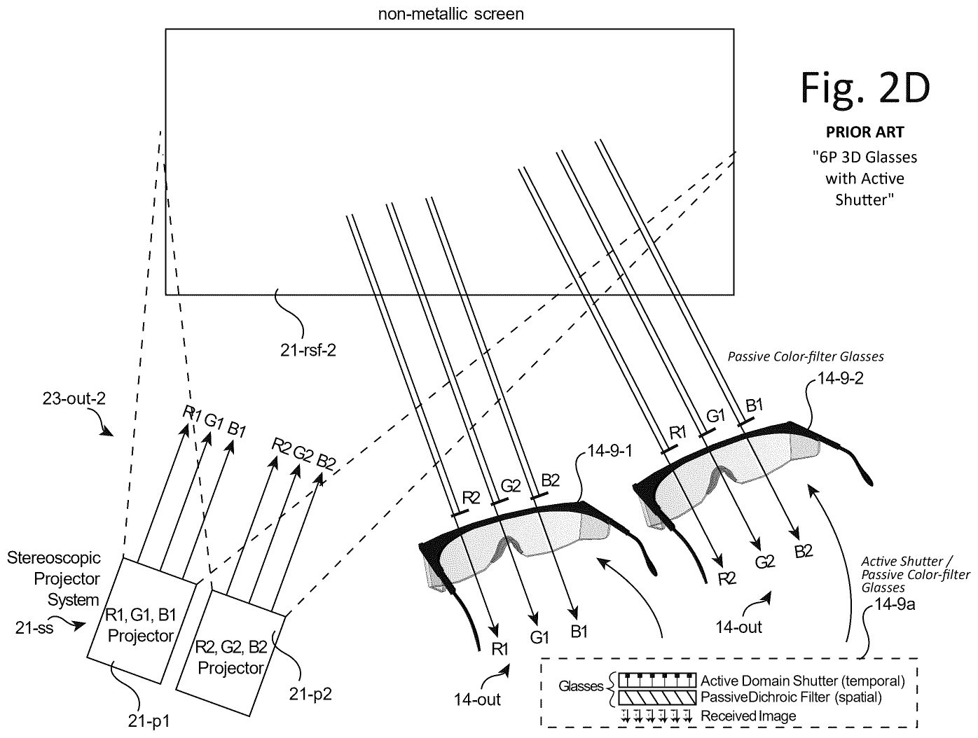

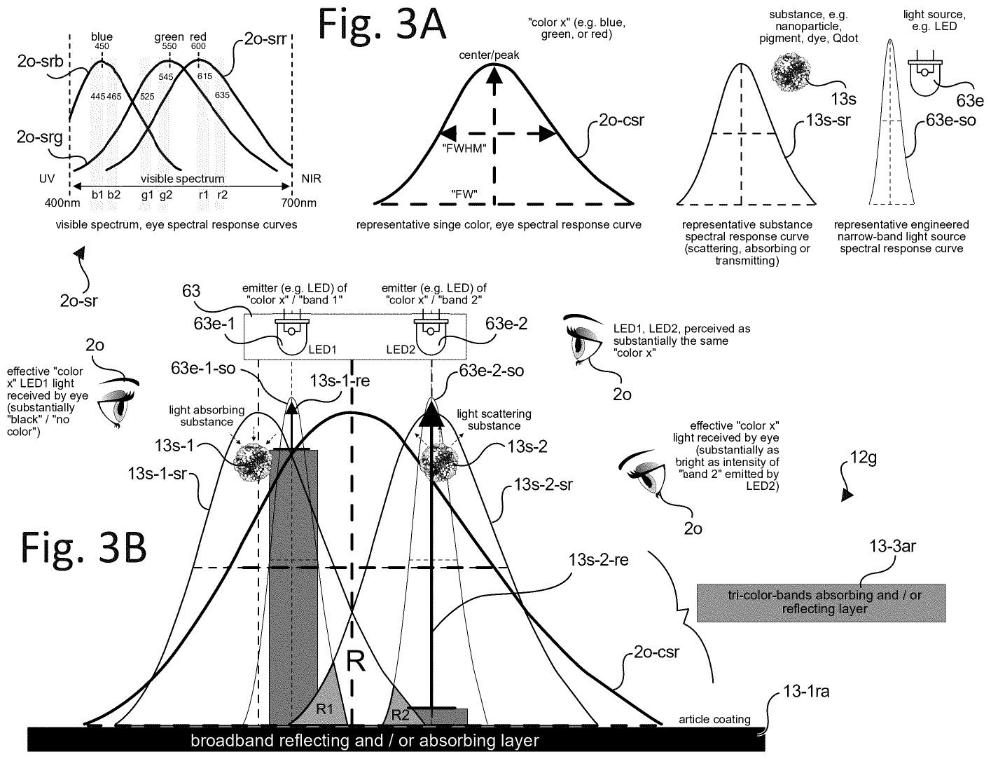

As will be discussed especially in relation to FIGS. 1C, 2A and 2B, the spectral responses of the article 12's surface or at least one or more of the markers 12m are specifically chosen/engineered to be clearly distinguishable from the spectral response of human skin. Also as depicted, the present invention prefers the inclusion of an embedded electronic tag (RFID, NFC, or otherwise capable of wireless communication) comprising article ID 12id within the article 12, where tag 12id is situated “within” or “near” the article tip 12t. And finally, the present invention prefers the use of a reflector or retroreflector 12t-r in the tip 12t of the article 12.

Still referring to FIG. 1B, the combination of 1) tip reflector 12t-r (preferably located at a distal point on the article 12 (prior art 5) that is highly or most likely to be continuously visible during article 12 gesticulation), 2) article body/shaft 12s markers (referred to as 12m collectively, exhibiting any tracking energy spectral response such as absorptive, reflective, or fluorescent within a detectable threshold, where the markers 12m are placed on one or more locations of the article shaft 12s that are likely to be consistently visible throughout an extended range of gesticulations as viewed from a select sensor/camera perspective, where the markers 12m preferably provide article 12 shape and size information), and 3) electronic tag 12id comprising wirelessly accessible information, are usable to provide an important “cross-article” uniform dataset for use in implementing a generic article 12/gesture tracking solution, where cross-article refers to articles 12 of for example different types, shapes and colors such as found on and across different types of wands, types of light sabes, type of pens, types of swords, etc. This uniform dataset comprises (i) static article information (pre-known, “a priori” information) retrievable from tag 12id or from a database external to article 12 based at least in part upon information retrievable from tag 12id, as well as (ii) dynamic article information (real-time movement, “a posteriori” information) determined by processing sensor real-time data captured in relation to retro-reflector 12t-r and markers 12m with respect to the static pre-known and retrieved information concerning the article, gamer, background, etc.

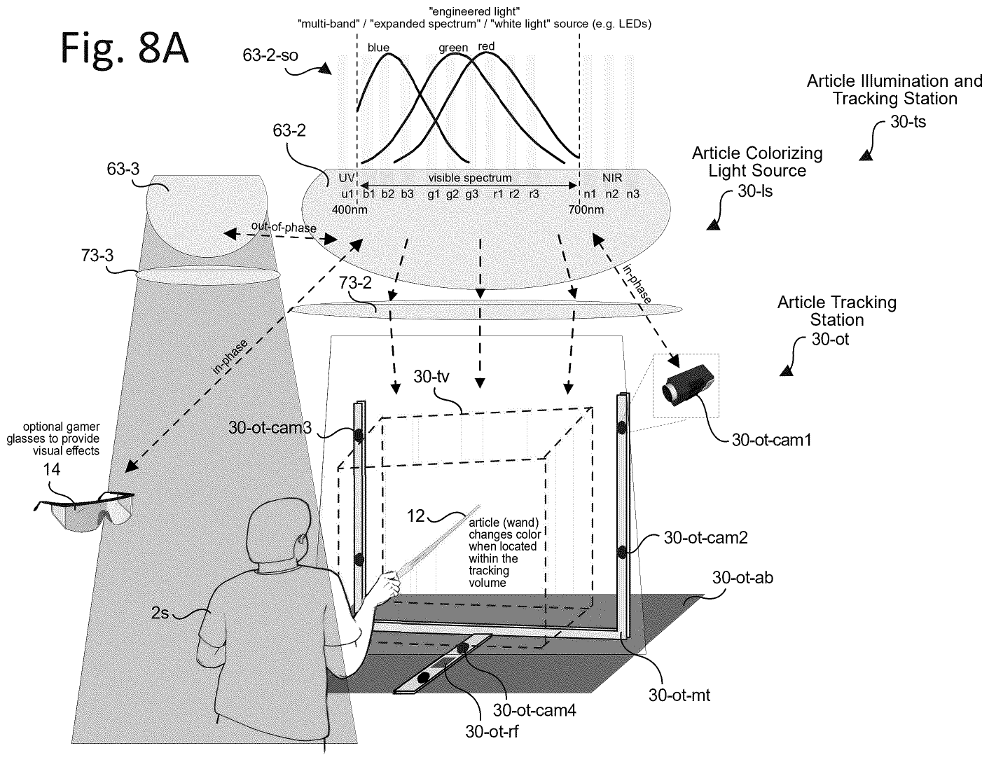

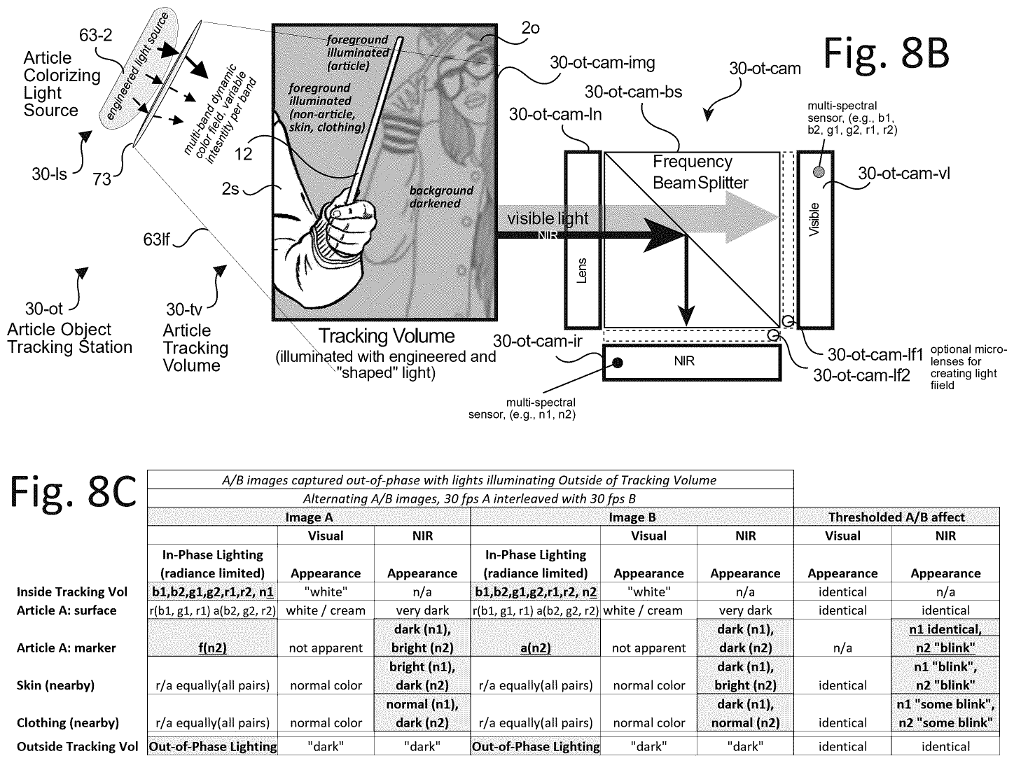

Regarding preferable and sufficient static article information (i) for use in processing dynamic article information (ii), electronic tag 12id minimally comprises a unique ID and/or otherwise any other needed or desirable information to assist in generalized article tracking as described herein or as will be well understood by those skilled in the art of object tracking and image analysis. In the case of a unique ID being minimal static information (i.a), the ID can for example be associated with any one of the gamer 2s, an avatar associated with the gamer 2s, the article 12 itself without reference to the gamer, or otherwise some uniquely identifying information such as a “gamer ticket number,” where the ID itself once retrieved from tag 12id can be used by the retrieving game access point (see for example the article tracking station 30-ot in FIG. 8A) to access a database separate from the article retrieving additional sufficient static article information (i.b), where (i.a) and (i.b) comprise (i) or at least a portion of (i) as taught herein.

Referring next to FIG. 2A, there is depicted a high-level component diagram of a PRIOR ART “6P 3D laser projection system.” The purpose of the PRIOR ART system is to generate two distinct “left” and “right” eye images emitted as temporally or spatially combined spectral output 63-so-1, each image comprising distinct spectral emissions of preferably non-overlapping (with respect to emitted frequencies in the visible spectrum) narrow bands of red, green, and blue. Hence, each distinct left-eye and right-eye image comprises 3 distinct narrow bands of the primary (red, green, and blue) colors. For example, the right-eye image comprises the “rgb1 triplet” (i.e., r1-g1-b1), whereas the left-eye image comprises the “rgb2 triplet” (i.e., r2-g2-b2). This combination of 2 images each comprising distinct “3 P”rimary color bands yields a combined “6P” (“six primaries”) of spectral output 63-so-1 being emitted from the PRIOR ART projector.

Referring next to FIG. 2B, there is depicted the well-known spectral response 20-sr of the human eye of a person-observer 20 overlaid with the spectral output 63-so-1 emitted by a PRIOR ART 6P 3D projector system. The human eye spectral response 20-sr describes the absorption by the eyes of a person 20 to frequencies of “visible” light that become the three sensed primary colors (blue, green, and red) from which the human vision system then derives a full gamut of colors. The “blue” cones of the human eye are typically sensitive to visible light from 380 nm to 550 nm, peaking at 450 nm. The “green” cones are sensitive between 430 nm to 670 nm, peaking at 550 nm, whereas the “red” cones range from 500 nm to 760 nm, peaking at 600 nm.

Overlaid onto this graph of the human eye spectral response 20-sr are the 6 vertical bands representing the narrow laser light emitted by the PRIOR ART 6P projector system. Each vertical band represents 1 of the “6P” bands, where the PRIOR ART emitted bands are known to have the following central frequencies: 445 nm for b1 (“blue 1”), 465 nm for b2, 525 nm for (“green 1”) g1, 545 nm for g2, 615 nm for (“red 1”) r1, and 635 nm for r2. What is also known and apparent from the overlaid depictions of 20-sr and 63-so-1, is that the human vision system cannot readily distinguish between two different narrow spectral bands of the same blue, green, or red primary color (e.g., b1 and b2 are substantially indistinguishable to the human eye as are g1 and g2, as well as r1 and r2.

Hence, the narrow bands b1 (centered at 445 nm) and not substantially spectrally overlapping with b2 (centered at 465 nm) are both perceived by the human vision system as “blue.” Likewise, g1 (525 nm) does not overlap with g2 (545 nm) while both bands are perceived as “green” and r1 (615 nm) does not overlap with r2 (635 nm) while both bands are perceived as red. A commercial 6P 3D projector takes advantage of this inability of the human eye in order to create a “left-eye” image using for example the “rgb triplet” 1 comprising the emitted bands b1, g1, and r1, and a “right-eye” image alternating comprising b2, g2, and r2 (the “rgb triplet” 2). For research on 6P technology and the prior art, the interested reader is directed to “Stereoscopic laser display system using six primary colors,” Rohwer, et al., INFINTEC GmbH, Germany.

What is important to understand is that triplets of narrow bands of non-overlapping primary colors are able to form distinct images to a viewer, where the chosen centered frequencies are important for determining a final color gamut, but can be centered at other frequencies, still providing the ability to generate distinctly filterable images (using a dichroic filter, see FIG. 2C). For example, the PRIOR ART already includes “9P” systems, with 3 distinct narrow bands such as b1, b2, and b3 for each primary color such as blue. Hence, the present invention should not be limited to the use of the PRIOR ART 6P narrow bands as depicted or otherwise as exist in the market, as other centering frequencies are possible per each band, all as will be well understood by those familiar with 6P systems and the human eye spectral response.

Referring next to FIG. 2C, there is shown a pictorial representation of a pair of PRIOR ART “6P 3D glasses” for use in combination with the PRIOR ART 6P 3D projector of FIG. 2A. As depicted, both the left and right lenses of the PRIOR ART glasses naturally receive the 6P emission 63-so-1 from the PRIOR ART projector, where the right lens comprises a first formulation of a dichroic filter to transmit the rgb1 triplet while simultaneously blocking the rgb2 triplet, and where the left lens comprises a second formulation of a dichroic filter to oppositely transmit the rgb2 triplet while blocking the rgb1 triplet. Thus, an image formed by the 6P 3D projector using the rgb1 triplet becomes a distinct right-eye image, while the image formed using the rgb2 triplet becomes a distinct left-eye image, where then as is well-known the combination of two slightly spatially offset left and right eye images combine in human visual perception to create the well-known 3D effect.

Referring next to FIG. 2D, there is provided a direct copy of FIG. 2h shown in PRIOR ART U.S. Pat. No. 11,025,892 entitled SYSTEM AND METHOD FOR SIMULTANEOUSLY PROVIDING PUBLIC AND PRIVATE MESSAGES filed on Apr. 4, 2019. FIG. 2h of the PRIOR ART is showing the same 6P 3D technology as depicted in FIGS. 2A (one 6P projector) and 2C (3D glasses) that have been further adapted to provide up to for distinct spatial-temporal sub-channels, where each sub-channel provides a separate and distinct series of viewable images.

The adaptations that are most important to see are that glasses 14-9-1 and 14-9-2, unlike the PRIOR ART glasses of FIG. 2C, include the same dichroic filter on both their right and left lenses, where for example a first dichroic filter is used on the left and right lenses of glasses 14-9-1 to substantially transmit the rgb1 triplet while blocking the rgb2 triplet, and where then a second first dichroic filter is used on the left and right lenses of glasses 14-9-2 to oppositely substantially transmit the rgb2 triplet while blocking the rgb1 triplet. Thus, a person 20 wearing glasses 14-9-1 sees a first series of images emitted by projector 21-p1 as spectral output 23-out-2 (akin to PRIOR ART spectral output 63-so-1, see FIG. 2B) using the rgb1 narrow bands, whereas a different person 20 wearing glasses 14-9-2 sees a second series of images emitted by projector 21-p2 as spectral output 23-out-2. It is also noted that the PRIOR ART U.S. Pat. No. 11,025,892 also discussed combining two “3P” projectors 21-p1 and 21-p2 into a single 6P projector system, similar to the PRIOR ART 6P projector shown in FIG. 2A.

Also taught in the PRIOR ART U.S. Pat. No. 11,025,892 was a further modification to the standard PRIOR ART 6P 3D glasses (see FIG. 2C), where glasses 14-9-2 and 14-9-2, each comprising a dichroic filter, also comprise an active shutter. While the dichroic filters are described in U.S. Pat. No. 11,025,892 as forming “2 spatial sub-channels,” the active shutter's are described as capable of forming at least “2 temporal sub-channels,” where a temporal sub-channel was described as a distinct sequence of image frames transmitted when the active shutter is operated to be open/transmitting. For example, the emission 23-out-2 from the projectors 21-p1 and 21-p2 preferably comprises 120 images (frames) per second (i.e., 120 fps), where these frames form two interleaved A/B temporal sub-channels such that a two different gamers, each wearing glasses of type 14-9-1, limited to see/transmitting the rgb1 spatial sub-channel, can then view either of two temporal sub-channels A or B, thus the single pair of glasses 14-9-1 supports viewing on either of a spatial-temporal sub-channel rgb1-A or rgb1-B. Likewise, glasses 14-9-2 support viewing on either of a spatial-temporal sub-channel rgb2-A or rgb2-B, all as will be understood by a careful reading of the PRIOR ART U.S. Pat. No. 11,025,892.

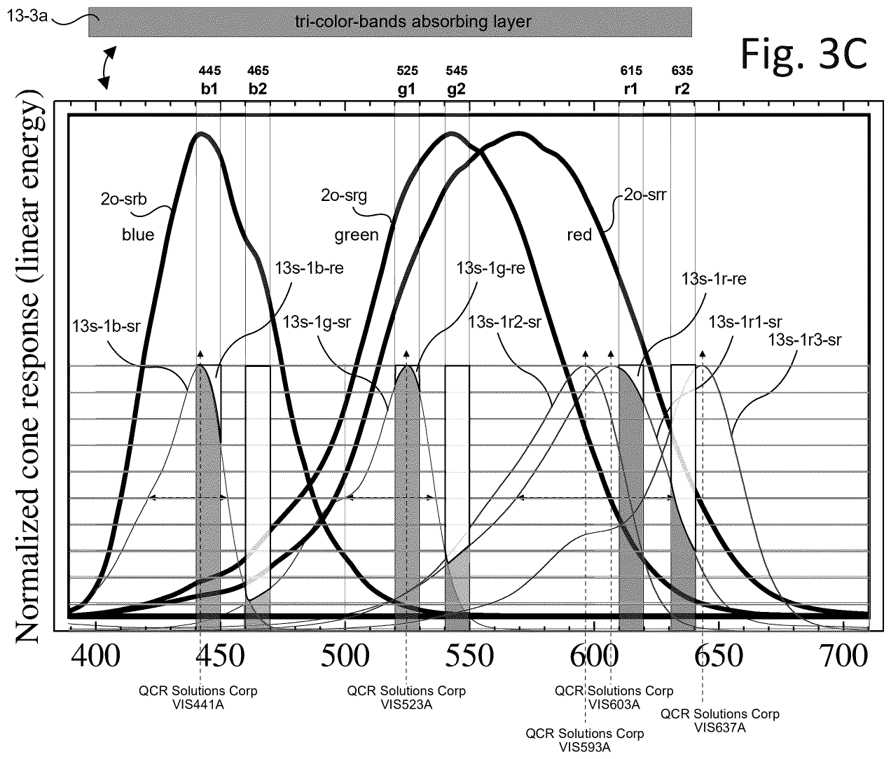

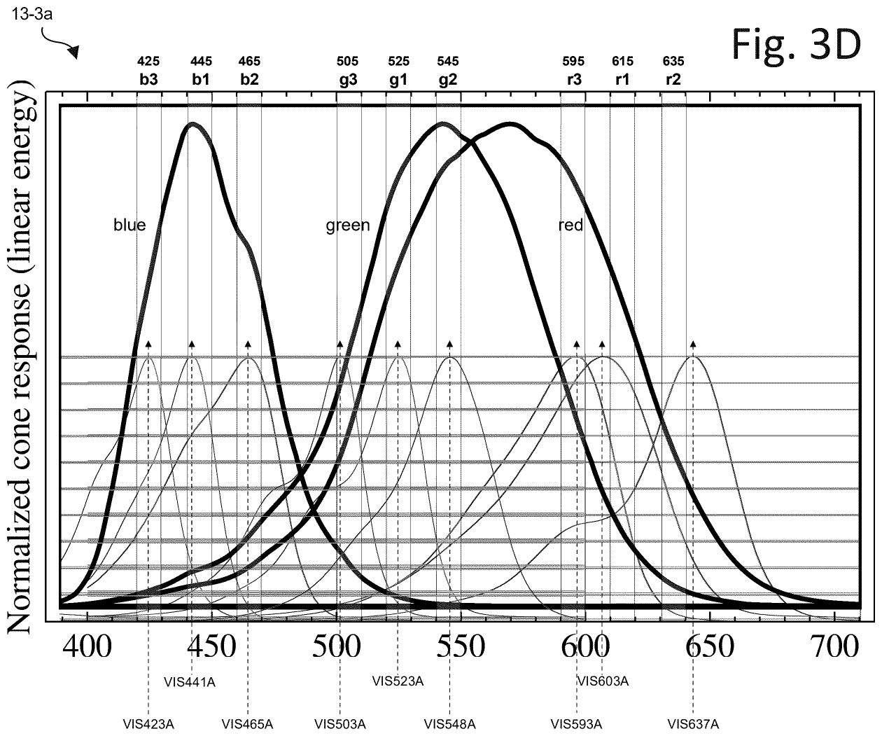

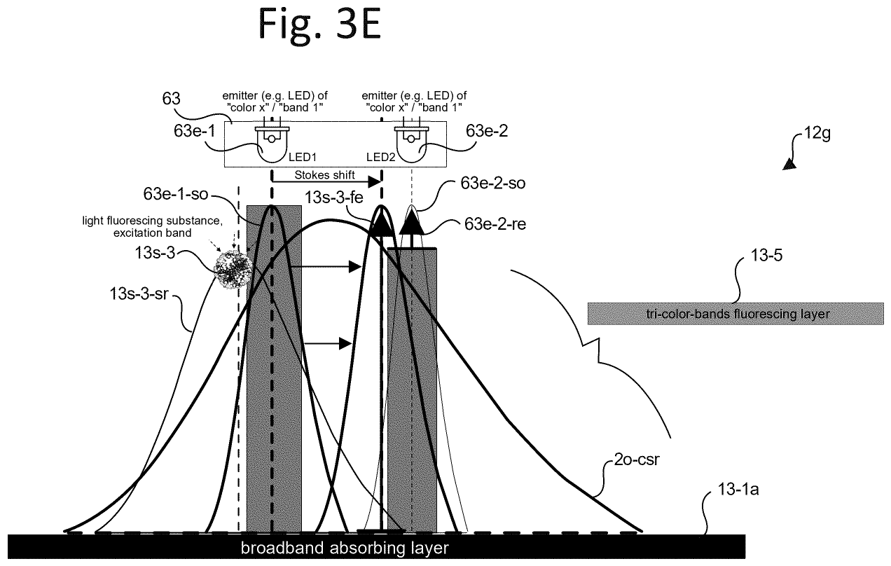

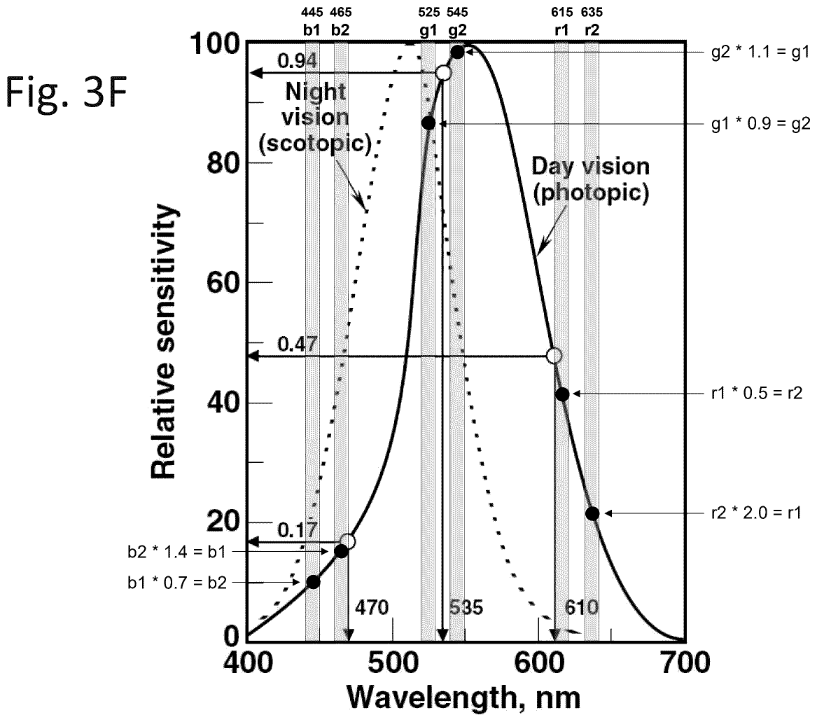

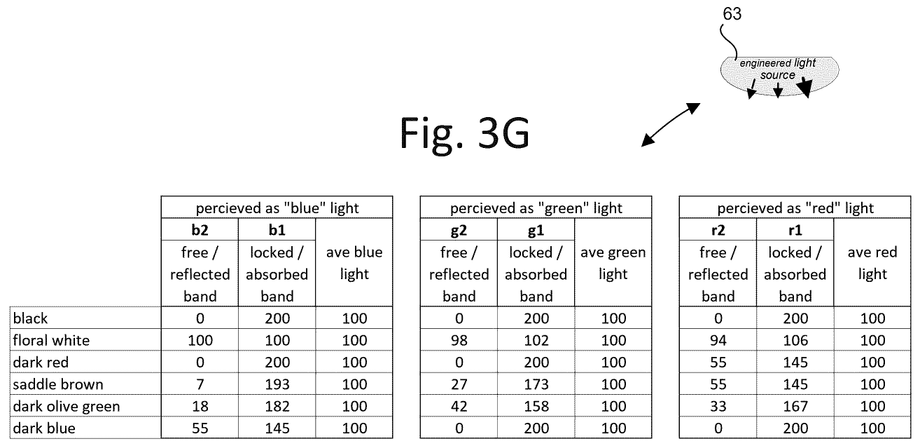

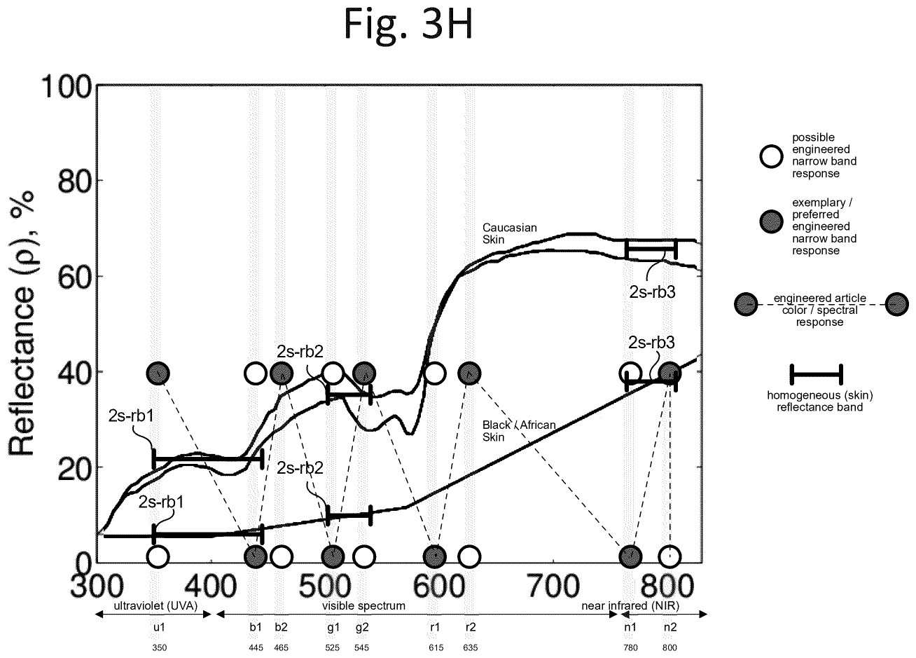

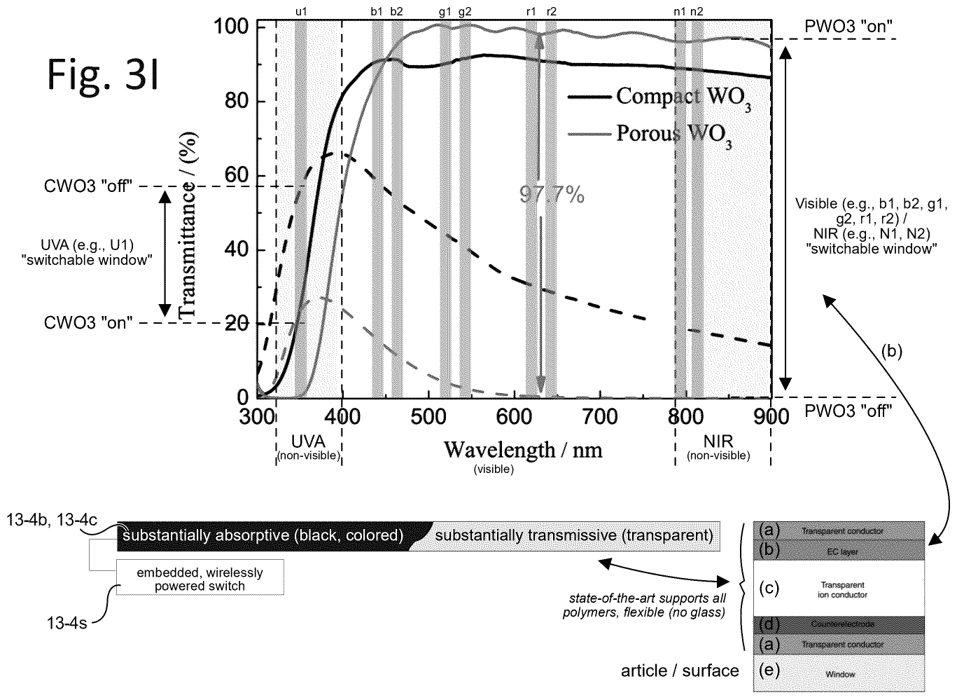

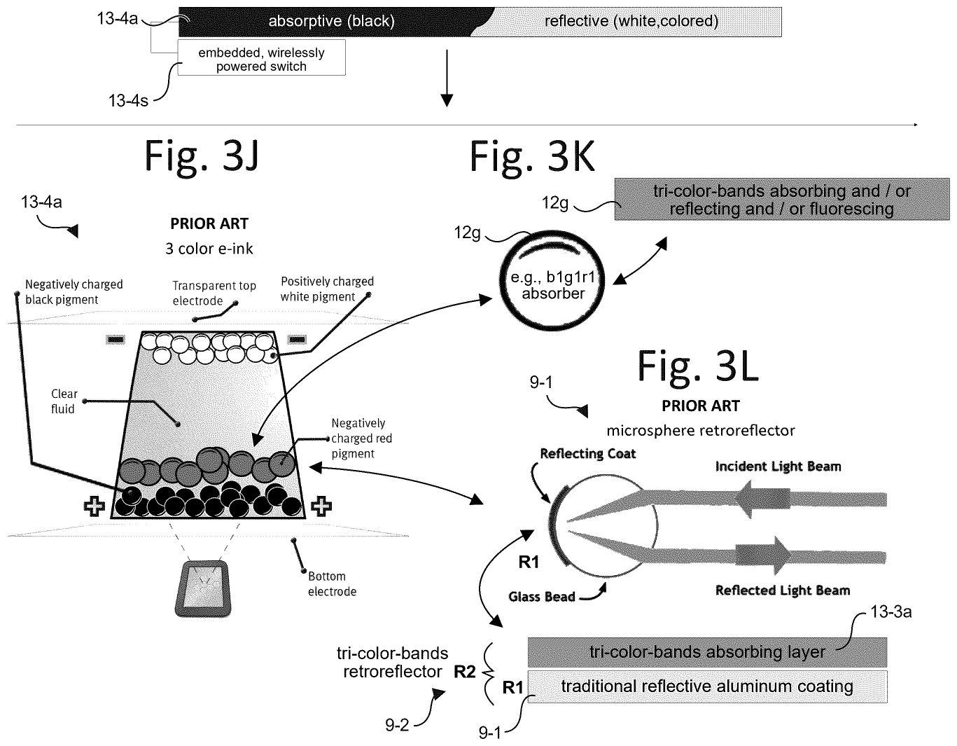

Referring next to FIG. 3A, there is depicted a secession of 4 spectral response graphs from left-to-right including (1) the human eye 20 spectral response 20-sr (the same as shown in FIG. 2B) comprising the three primary colors 20-srb (blue), 20-srg (green) and 20-srr (red), (2) any individual color (such as 20-srb (blue), 20-srg (green), or 20-srr (red)) represented as a generic “color x” spectral response curve 20-csr, (3) the generic spectral response 13s-sr of a substance 13s (such as a nanoparticle, pigment, dye, quantum dot, etc.) caused by the ability of the substance 13s to scatter, absorb, fluoresce, or otherwise transmit light of a given frequency, and (4) the generic spectral output of a light source 63e such as a laser system (see FIG. 2A), an LED, or any light source being filtered into or otherwise emitting a narrowband spectral output 63e-so.

The purpose of leftmost graph (1) is to create the concept of a “generic color x” spectral response 20-csr (graph (2)), where this generic response 20-csr can then be discussed in relation to both the generic spectral responses 13-s-sr of substances 13s (graph (3)) and the generic spectral outputs 63-e-so of light sources (“emitters”) 63e (graph (4)). Referring to graph (2) depicting the generic response 20-csr, as is well known to those in the art of optics and light waves, a spectral response such as 20-csr has critical features including the “center/peak frequency” of the response as well as the “full width at half the energy maximum” (i.e., “FWHM”). These critical features also apply to the discussion of spectral response 13s-sr and spectral emission 63e-so.

Referring to graph (3), those familiar with the art of material substances will be familiar with the general differences between dyes and pigments for which there is ample teaching in the public domain and for which the present invention provides no new teaching, other than the strategies for combining any of various well-known dyes and pigments as material substances substantially exhibiting the preferred center frequencies and FWHMs. Likewise, there is substantial teaching in the public domain regarding what are sometimes referred to generally as “nano-substances,” “nanomaterials,” or “nanoparticles,” herein including what are also referred to as “quantum dots.” What is of main interest regarding the present teachings is that these nanomaterials can in general be “engineered” with respect to at least their center frequency and often their FWHMs. Thus, the “frequency location” and “shape” of the spectral response 13s-sr can to a larger degree be manipulated or otherwise constructed using a nano material or “nanoparticle.”

The interested reader is for example directed to the website of “nanoComposix” (headquartered in San Diego, CA) that is a provider of nanoparticles, where the website provides links to information especially teaching about the “optical properties of nanoparticles.” As described, “Plasmonically generated colors are unique in that the optical properties of metal nanoparticles can be tuned by changing size, shape, and material composition. Nanoparticles can be engineered to absorb, scatter, or both absorb and scatter. Since the particle colors depend upon size and shape, very subtle changes can be made without requiring a new formulation to be developed. If only very small changes in color are required, for example, the dimension of the nanoparticles can be increased or decreased by just a few nanometers. This level of synthetic control provides an unprecedented level of tunability which cannot be achieved using standard dye and pigment technology.”

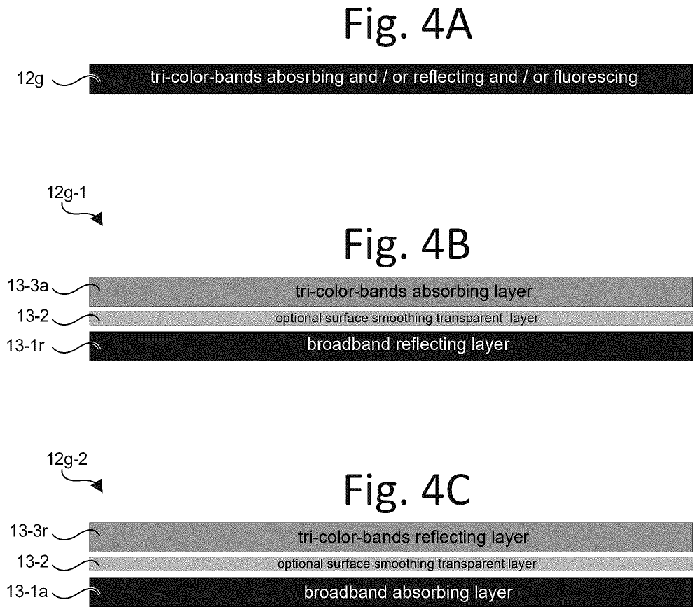

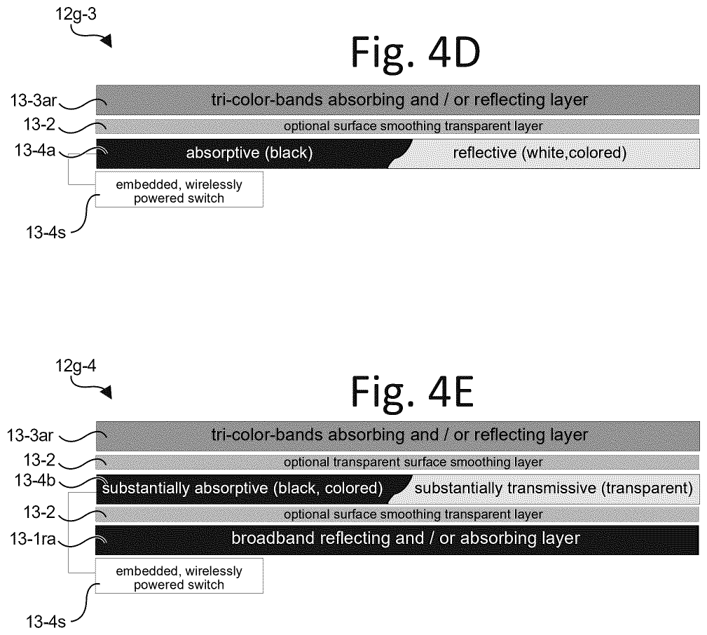

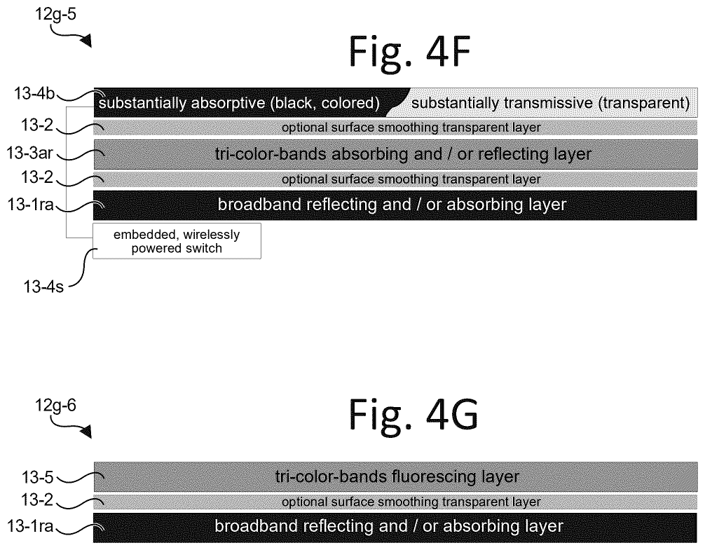

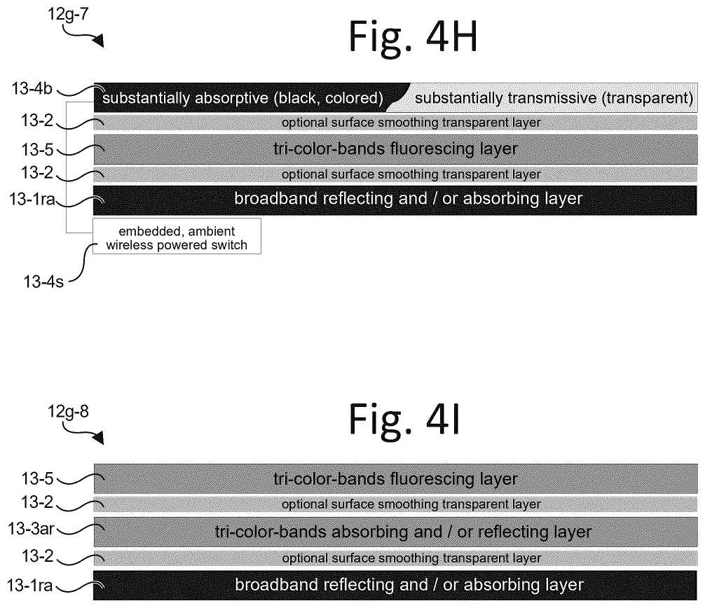

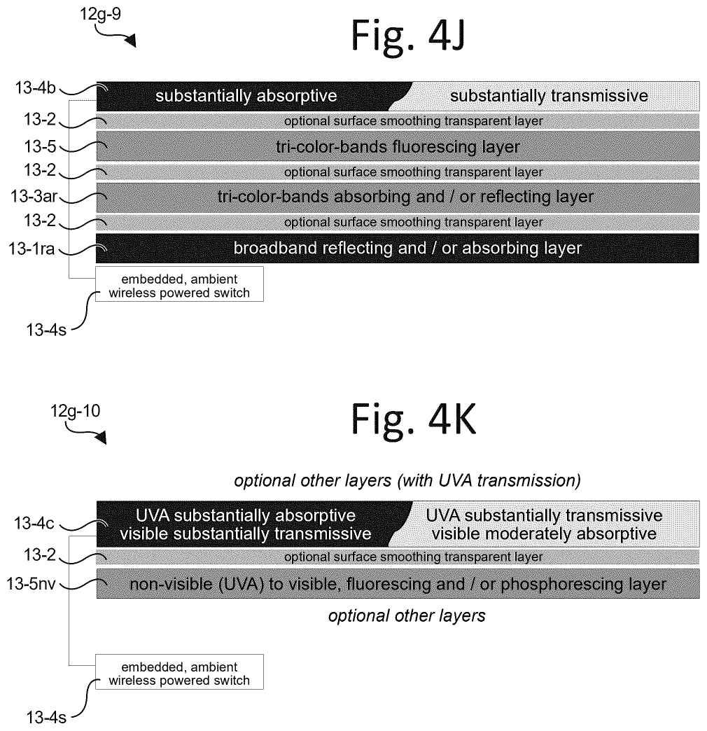

What is most important to understand from the perspective of the present teachings is that it is possible to create various coatings (see FIGS. 4A through 4K) comprising one or more substances 13s (of any type including dyes, pigments, nanomaterials, electrochromic materials, fluorescers, phosphors, etc.), where each substance 13s is limited in its spectral response 13s-sr to operate/respond over a limited full width half maximum (FWHM) centered at a certain frequency (color) within the spectrum ranging from ultraviolet-to-visible-to-infrared. What is preferred is that the central frequency of a specific substance 13s (graph 3) used in the formulation of a coating is substantially aligned with the central frequency of at least one narrow band of spectral output 63e-so emitted by a light source 63e (graph 4) such as a “6P laser” taught in the PRIOR ART and currently available in the market, or an LED either existing the market or an existing LED combined with a filter for creating the desired spectral output 63e-so, all as will be understood by those familiar with lasers, LEDs, light sources and light filters (see for example ThorLabs “4-wavelength high-power LED source” that is an LED switching controller for combining up to 4 individual narrow-band LEDs into a single collimated light output using narrow-band LEDs provided as “LED options”). (Those familiar with the pace of technological development will understand that new substances 13s and lights sources 63e will continue to become available and can be used in combination with the present teachings, thus the present teachings with respect to specific currently available technologies should not be limited but rather considered as exemplary, as future technologies are possible for use without departing from the spirit and scope of the invention.)

Still referring to FIG. 3A, what is further desirable is that for example three different substances (each being of any kind) are combined into a single coating, and where each of the three is centered within a different primary color eye response blue 20-srb, green 20-srg, or red 20-srr. For example, the central frequency of a first substance is substantially aligned to correspond with the narrow band b1 (or b2, or some other potential b3), while a second substance substantially aligns with the band g1 (g2 or g3), and a third substance aligns with the band r1 (r2 or r3). (Again, the bands such as b1, b2, g1, g2, r1, or r2 themselves can be centered at different frequencies than those shown herein or that currently exist in standard 6P or 9P projector technology, where what is preferred is that they remain substantially within their associated eye responses 20-srb, green 20-srg, or red 20-srr, respectively. What is then further desirable is that within a spectral eye response (for example blue 20-srb), a given substance causes a spectral response 13s-sr at the centered frequency such as b1 (such as absorbing or scattering (reflecting) that frequency band b1) that is then opposite to the coating's response substantially beyond the FWHM of the given substance response 13s-sr, such that if the given substance 13s tends to absorb the primary colored b1 light than preferably outside of the FWHM of the substance 13s's spectral response 13s-sr, yet within the response curve 20-srb, the coating tends to reflect (scatter) or otherwise transmit any primary colored blue light (such as a band b2 or even b3). The following FIG. 3B provides a more in-depth discussion.

Referring next to FIG. 3B, there is shown the spectral response of conceptual coating 12g comprising the combination of a light absorbing substance 13s-1 and a light scattering substance 13s-2. The absorbing of substance 13s-1 is depicted as having spectral response 13s-1-sr, while the scattering of substance 13-s-2 is depicted as having spectral response 13s-2-sr. Each of spectral responses 13s-1-sr and 13s-2-sr have a center/peak (the vertical dashed lines roughly bisecting the response curve) and a FWHM (the horizontal dashed lines roughly bisecting the response curve), all as will be well understood by those familiar with spectral response curves. Spectral responses 13s-1 and 13s-2 are depicted with respect to a generic “color x” spectral response 20-csr also having both a center/peak and a FWHM.

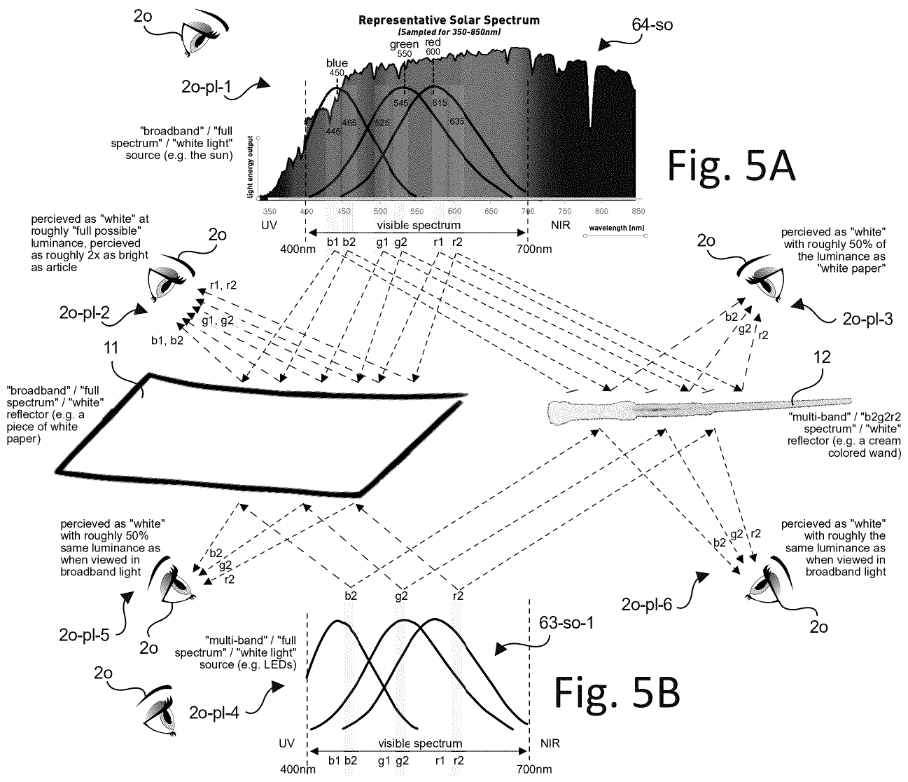

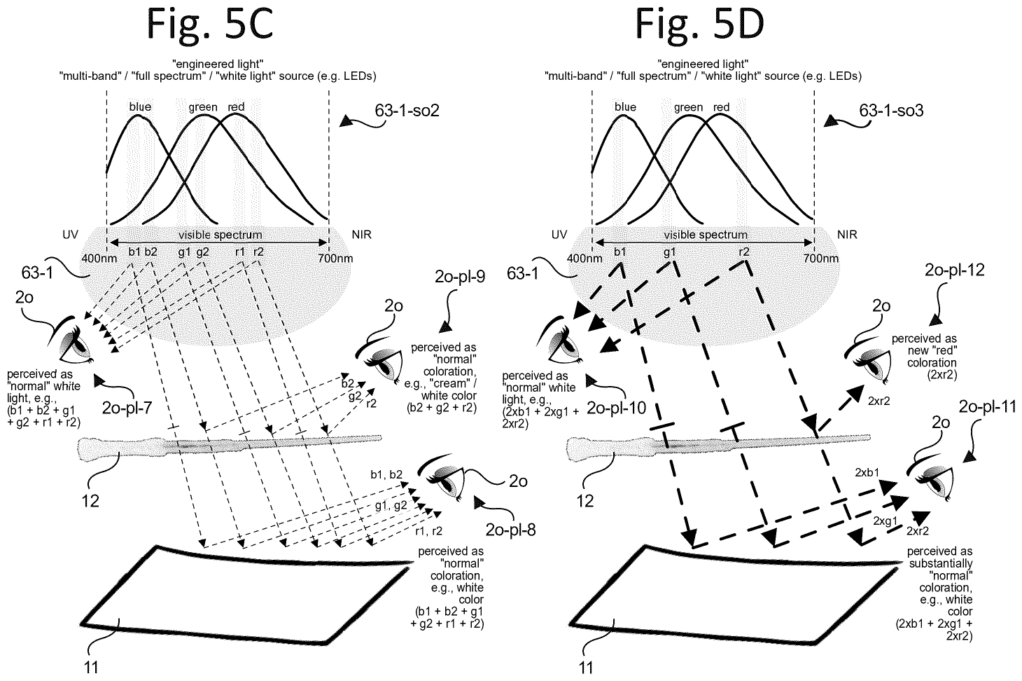

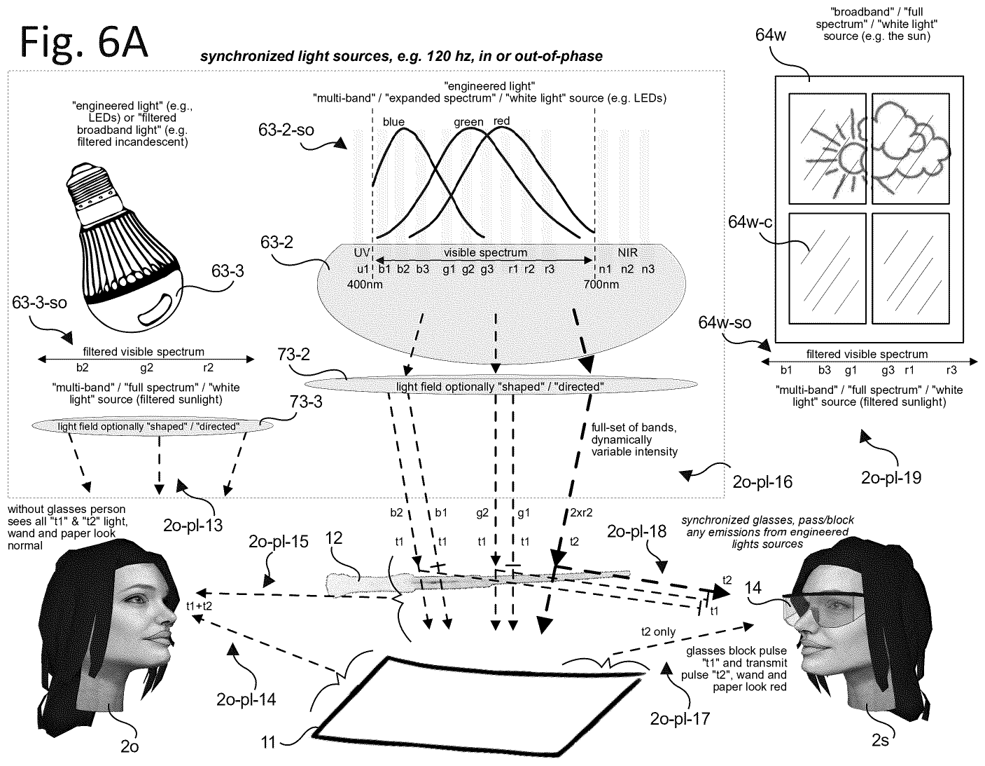

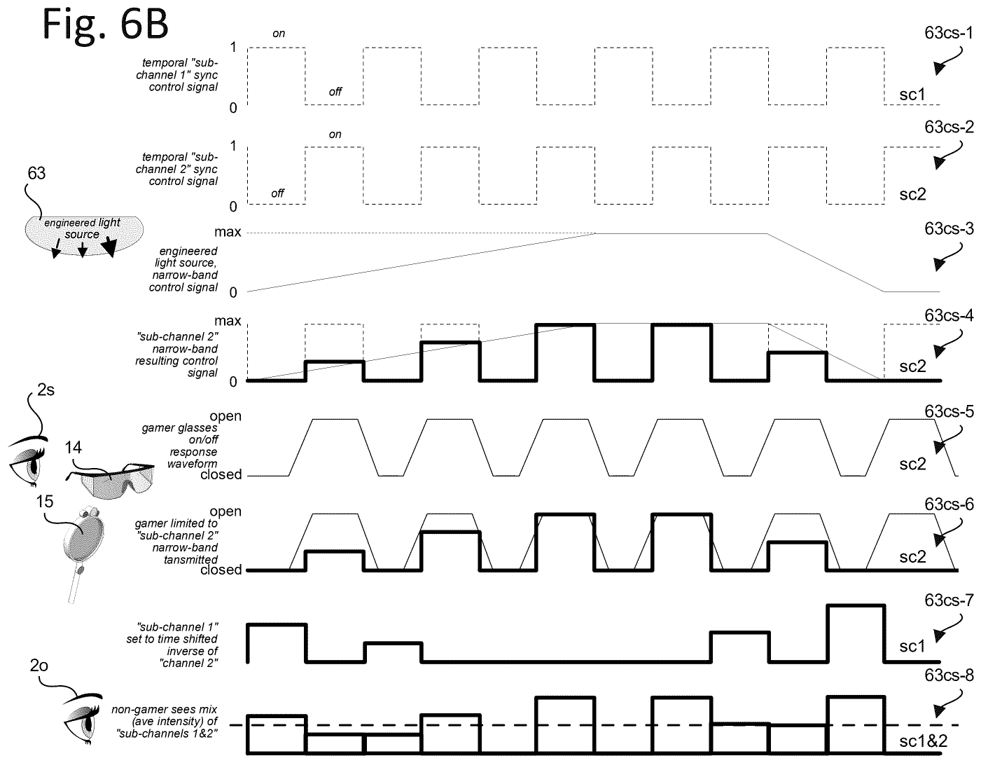

Still referring to FIG. 3B, further depicted is engineered light source 63 comprising two narrowband emitters 63e-1 and 63e-2 emitting spectral output 63e-1-so and 63e-2-so, respectively, where both spectral outputs have a center/peak and a FWHM. There are many possible technologies for use as narrowband emitters 63e-1 and 63e-2 such as but not limited to an LED, lasers, or even “white” light passing through a narrowband filter. For example, emitters 63e-1 and 63e-2 may comprise laser(s) such as found in the PRIOR ART “6P” (or “9P”) projection system depicted in FIG. 2A, or even broad band “white” light emitters combined with narrowband/“notch” transmission filters, all as will be well understood by those familiar with the art of light sources and filters. Therefore, while the preferred embodiment of an engineered lights source 63 (or any of its variants such as 63-1 of FIGS. 5C and 5D, or 63-2 and 63-3 of FIG. 6A) comprise narrowband LED emitters, any other suitable technology for emitting a similar narrowband spectral output are considered to fall within the present teachings, as new narrowband light sources are also anticipated to be developed, and as such the present teachings should not be limited based upon the type of emission technology.

A careful review of FIG. 3B will show that spectral output 63e-1-so substantially overlaps spectral response 13s-1-sr causing reflected emissions 13s-1-re, where reflected emissions 13s-1-re are depicted by the short vertical bar with an arrowhead pointing up centered at the center/peak of output 63e-1-so. As will also be evident, spectral output 63e-2-so substantially overlaps spectral response 13s-2-sr causing reflected emissions 13s-2-re, where reflected emissions 13s-2-re are depicted by the tall vertical bar with an arrowhead pointing up centered at the center/peak of output 63e-2-so. It is further noted that spectral absorbing response 13s-1-sr overlaps with spectral scattering response 13s-2-sr in the region denoted as “R,” that spectral absorbing response 13s-1-sr overlaps reflected emissions 13s-2-re in the region denoted as “R2,” and that spectral scattering response 13s-2-sr overlaps reflected emissions 13s-1-re in the region denoted as “R1,” where it is desirable to at least minimize R1 and R2, if then not also R.

Still referring to FIG. 3B, the following key observations are made. The unaided eye 20 looking at light source 63 will not perceive any substantial difference between spectral output 63e-1-so or 63e-2-so. For example, if emitter 63e-1 is an LED or laser(s) generating output 63e-1-so that is substantially aligned with “g1” centered at 525 nm (see FIG. 3A), and emitter 63e-2 is an LED or laser(s) generating output 63e-2-so that is substantially aligned with “g2” centered at 545 nm (see FIG. 3A), then to person 20 both will appear to be “green,” without substantial color distinction, all as is well-known to those familiar with the human vision system. (Likewise, if the two emitters 63e-1 and 63e-2 were outputting narrow bands “b1” and “b2,” or “r1” and “r2,” the observer 20 would perceive “blue” or “red,” respectively, without substantial color distinction.)

However, assuming emitter 63e-1 emits narrow band g1 while emitter 63e-2 emits narrow band g2, if only emitter 63e-1 of light source 63 is turned “on,” thus causing spectral output 63e-1-so as g1, while emitter 63e-2 is essentially turned “off,” thus causing no spectral output 63e-2-so as g2, person 20 looking at article coating 12-c will perceive the reflected spectral emission 13s-1-re, perceiving coating 12-c to be substantially black (i.e., perceiving at least minimal to no green,) while still also perceiving the light emitted from source 63 to be green. Conversely, if only emitter 63e-2 of light source 63 is turned “on,” thus causing spectral output 63e-2-so as g2, while emitter 63e-1 is essentially turned “off,” thus causing no spectral output 63e-1-so as g1, person 20 looking at article coating 12-c will perceive the reflected spectral emission 13s-2-re, perceiving coating 12-c to be substantially green, or substantially comprising green, while still also perceiving the light emitted from source 63 to be green. Thus, a key aspect of the present invention is taught that the color of an article (any surface) can be caused to change to the perception of a person 20 by controllably emitting different narrow bands (such as 63e-1-so and 63e-2-so) of light from an engineered light source 63, given that the article's coating 12-c comprises substances with substantially different spectral responses to the different emitted narrow bands.

Still referring to FIG. 3B, while it is preferred that region “R” denoting the overlap in spectral responses 13s-1-sr and 13s-2-sr of two substances such as 13s-1 and 13s-2, respectively, be minimal, where substances 13s-1 and 13s-2 are essentially operating (i.e., absorbing, scattering, fluorescing, transmitting, etc.) within the substantially same “color X” (blue, green, or red) spectral response 20-csr, what is of greater importance is that regions “R1” and “R2” are minimized during the design of any given article coating 12-c. As a careful consideration will show, region “R1” represents the extent to which a particular substance such as 13s-2 will “operate” in response to spectral output such as 63e-1-so intended to be otherwise primarily “operated” upon by substance 13s-1. In the present depiction, it will then be clear that scattering substance 13s-2 will scatter some of spectral output 63e-1-so, thus increasing reflected emissions 13s-1-re and thereby causing a person 20 to perceive more luminance, where a minimal luminance of any color (such as blue, green, or red) will still appear as substantially black. (Those familiar with coatings will also understand that this “substance interference” can also be mitigated by applying differing substances in layers, such that upper layers are not affected by lower layers, see for examples upcoming FIGS. 4B through 4K.)

Conversely, absorbing substance 13s-1 will absorb some of spectral output 63e-2-so, thus decreasing reflected emissions 13s-2-re and thereby causing a person 20 to perceive less luminance, but still of the same color (all as will be well understood by those familiar with the human vision system). As those familiar with the various possible substances such as nanoparticles (and otherwise nanomaterials including quantum dots,) pigments, dyes, etc., will understand, it is possible to combine one or more individual substances, each with narrow band spectral responses, to achieve the types of coatings 12-c as taught herein, all as to be discussed further with respect to FIGS. 3C, 3D, 3E, and 4A through 4K.

And finally, still referring to FIG. 3B, while it is portrayed in a two-narrow-band per color arrangement (such as b1 and b2 within blue, or g1 and g2 within green) with the center/peaks of the resulting reflected emissions such as 13s-1-re and 13s-2-re straddling either side of the person 20's eye spectral response 20-csr for the given “color x,” this is not mandatory and in a three-narrow-band per color arrangement (such as b1, b2 and b3 within blue, for example using the PRIOR ART “9P” laser projector technology) this is at least possible if the middle band (e.g., b2) substantially aligns with the center/peak of the “color x” response 20-csr, such that the remaining two narrow bands (e.g., b1 and b3) may then straddle the center/peak of response 20-csr. As will be recognized by a careful review of the present application, the preferred narrow bands b1, b2, g1, g2, r1, and r2, as depicted in FIGS. 2B, 3A, 3C, 3E, 3H, 3I, 5A, 5B, 5C, 5D, 6A, and 8A, are substantially situated in pairs off-center and therefore not straddling the center/peak of their respective color responses ranges 20-srb, 20-srg, and 20-srr (see FIG. 3A,) where this choice is predicated on the center/peaks preferably used in the existing PRIOR ART “6P” projector systems. (It is noted that FIG. 3D showing nine (9) narrow bands does provide for a different arrangement of band peaks versus color eye response peaks.) A careful consideration will show that while the choice to align narrowband frequency colors (i.e., b1, b2, g1, g2, r1, and r2) with the PRIOR ART 6P or even 9P projector systems, thus integrating more readily with exiting projector technology, is not necessary as many possible choices for with six (6) to nine (9) or more narrow bands are possible without departing from the spirit and teachings of the present invention.

Those familiar with both the physics of light and the human visual system will understand that the blue (higher) wavelengths carry more energy with respect to the green wavelengths and then more yet with respect to the red wavelengths, and that the human eye's sensitivity to the different blue, green and red frequency ranges 20-srb, 20-srg, and 20-srr (see FIG. 3A) are also non-uniform (see FIG. 3F,) such that the choice of where to locate the center/peak of an individual narrow band (such as b1 or b2, or even b1, b2, and b3 if three color bands are used per any color) is optimized based upon several factors including the band's frequency range, the power of the light source and the human eye's response within the given band's range, all of which is outside of the scope of the present teachings, although ample teachings can be found in the public domain especially with respect to “6P” or “9P” laser projector systems. Again, in the present teachings it is preferred but not required that for a “6P” system the narrow bands such as b1, b2, g1, g2, r1, and r2 as discussed herein are substantially aligned with any of the PRIOR ART “6P” systems, which creates advantages for the integration of the present invention with such projector systems, especially for exemplary applications in theme park, museum, or theater settings.

Referring next to FIG. 3C, and as depicted in prior FIGS. 2B and 3A, there is shown the well-known spectral response of the human eye, where the response is labeled like FIG. 3A per each color band, hence blue 20-srb, green 20-srg, and red 20-srr. Like FIGS. 2B and 3A, overlaid onto these three human eye spectral curves are the six narrow bands representing the PRIOR ART laser emissions found in at least some 6P laser projector systems, labeled as b1, b2, g1, g2, r1, and r2. Where FIG. 3B portrays an idealized spectral response 13s-1-sr of a given substantially light absorbing substance 13s-1, where the response 13s-1-sr is shown in an exemplary alignment with respect to the spectral response 20-csr of “any color x” (such as 20-srb, 20-srg, and 20-srr,) FIG. 3C now shows the five (5) actual spectral responses 13s-1b-sr, 13s-1g-sr, 13s-1r1-sr, 13s-1r2-sr, and 13s-1r3-sr of five (5) different commercially available and exemplary absorber dyes, respectively, as sold by QCR Solutions overlaid onto the blue, green, and red spectral responses (20-srb, 20-srg, and 20-srr, respectively) of the human eye.

In FIG. 3C, the three (3) taller vertical dark grey areas (not labeled) shaded within narrow bands b1, g1, and r1 represent the anticipated substantial absorption of the emitted energies b1, g1, and r1, whereas the remaining non-absorbed b1, g1, and r1 light (depicted as white triangular areas at the top of the dark grey areas) is the anticipated reflected emissions 13s-1b-re, 13s-1g-re, and 13s-1r-re, respectively. These reflected emissions 13s-1b-re, 13s-1g-re, and 13s-1r-re (all “dim” reflections appearing as substantially no-color to the human eye,) are based upon the spectral output of lights sources portrayed as bands b1, g1, and r1, as operated upon (mainly absorbed) by the commercial dyes VIS441A, VIS523A, and VIS603A, with depicted responses 13s-1b-sr, 13s-1g-sr, and 13s-1r1-sr, respectively. (Note that dyes VIS593A and VIS637A are not presently being considered and therefore responses 13s-1r2-sr and 13s-1r3-sr should be ignored, where dyes VIS593A and VIS637A will be discussed later as exemplary alternatives to dye VIS603A for substantially operating upon narrow band r1, where other similar alternative dyes are available but not shown for operating upon narrow bands b1 and g1.)

The three (3) shorter vertical dark grey areas (not labeled) shaded within narrow bands b2, g2, and r2 represent the anticipated minimal absorption of the emitted energies b2, g2, and r2, whereas the remaining non-absorbed b2, g2, and r2 light (depicted as taller white areas on top the shorter dark grey areas) is the anticipated reflected emissions (also not labeled,) respectively. These more substantial reflected emissions will appear to be “bright” reflections of blue, green, and red to the human eye, and are based upon the spectral output of lights sources portrayed as bands b2, g2, and r2, respectively, as operated upon (minimally to somewhat absorbed) by the commercial dyes VIS441A, VIS523A, and VIS603A, with responses 13s-1b-sr, 13s-1g-sr, and 13s-1r1-sr, respectively. (Again, note that dyes VIS593A and VIS637A are not currently under consideration.)

As a careful consideration will show, and as will be discussed further going forward, by controllably emitting different luminance levels of light corresponding to narrow bands b1, b2, g1, g2, r1, and r2 (thus “engineered light,”) it is possible to cause a coating of an article/any surface to appear to change in coloration, which is a critical aspect of the teachings of the present invention. As will also be well understood by those familiar with coatings and substances such as nanoparticles, dyes, pigments, and fluorescers, and based upon a careful reading of the present teachings, the choices for narrowband emission frequencies for b1, b2, g1, g2, r1, and r2 as well as the selected substances for operating on these bands (such as dyes VIS441A, VIS523A, and VIS603A) have a significant number of variations, and as such the teaching provided herein, such as with respect to the present figure and upcoming FIG. 3D, should be considered as exemplary for teaching core principles and therefore not unnecessarily limited to specific narrow bands or substances, etc.

Still referring to FIG. 3C it is well known that dyes “operate” on the impinging light (e.g., b1, b2, g1, g2, r1, and r2) to extinguish this light primarily by the process of absorption, where the light that is not extinguished by the dye is substantially transmitted through dye (e.g., an upper coating layer,) in this case to an underlaying layer of substance(s) that is preferably a visible broad-band (i.e., “white” in appearance) reflector (thus scattering broadband light). Thus, the perception of the human eye will be to see the entire broadly reflected visible spectrum (as would be reflected by the underlying layer) “less” the substantially absorbed bands of b1, g1, and r1 (the taller vertical dark grey areas), and somewhat “less” the partially absorbed bands b2, g2, and r2 (the smaller vertical dark grey areas).

To be discussed further going forward, at least using what is herein referred to as an “engineered light source,” it is possible to simultaneously increase the emitted b1 light while decreasing the emitted b2 light, or vice versa, in some relative incremental proportions, such that the human eye perceived combination of emitted blue (b1-b2) light remains constant during the increasing and decreasing, while at the same time the combination of perceived blue (b1-b2) light reflected from the coating such as described in the present figure changes. Thus, by likewise also adjusting the emitted levels of g1 and g2, as well as r1 and r2, the light emitted by a tristimulus adjustable engineered light source is operated upon by a specialized coating such as herein taught to cause appropriately coated surfaces to controllably change their color appearance to the perception of the human eye, while at the same time the engineered light source maintains a substantially “unchanging” white (blue, plus green, plus red) appearance.

Still referring to FIG. 3C, and now considering only the three (rightmost) dyes VIS593A, VIS603A, and VIS637A as they alternatively operate considering only (rightmost) bands r1 and r2, it is noted that dye VIS593A absorbs roughly half-as-much of the r1 light as compared to VIS603A (where this decrease is undesirable,) but then also absorbs substantially none of the r2 light as compared to VIS603A (which is desirable,) such that the net difference in reflected emissions between r1 and r2 would be similar between dyes VIS593A and VIS603A. It is also important to see that both VIS593A and VIS603A absorb roughly the same amounts of g2 (the absorption of which is undesirable). As will be understood by those familiar with substance mixtures and concentrations, it is possible to create differences in the net absorption of light by also considering the relative concentrations of a dye (such as VIS593A and VIS603A) in a coating, thus the concentration of VIS593A can be increased as a means of absorbing more of the r1 light, still having a (desirable) much lesser effect on the g2 and r2 light.

Those familiar with dyes will also understand that it is possible to shift their peak frequencies, typically to a lower energy, for example by combining the dye with particular type of solvent. In some cases, this “red shift” of the peak frequency is known to shift by at least 5 nm to 10 nm, and thus it is also possible to consider the spectral response of the substance and its “carrier medium” (such as a solvent or binder,) where then for example dye VIS593A could be red shifted closer to VIS603A to provide a still better alternative to dye VIS603A as compared to the un-shifted VIS593A. (As will be clear to those familiar with substances, similar consideration and alternative substances choices can be made for the “blue” bands such as b1 and b2 as well as the green bands such as g1 and g2.)

Still referring to FIG. 3C, there is no requirement that for example narrow bands “1” (i.e., b1, g1, and r1) are substantially absorbed while narrow bands “2” (i.e., b2, g2, and r2) are substantially reflected, nor is there a requirement that each of bands “1” or bands “2” be operated upon similarly. For example, it is noted that dye VIS637A substantially absorbs narrow band r2 while then also only somewhat absorbing band r1, netting a similar absolute difference when compared to the operation of VIS603A on bands r1 and r2. Hence, it is possible to use the combination of VIS441A, VIS523A, and VIS637A (and not VI603A nor VIS5593A) to create a coating layer 13-3a that substantially absorbs or otherwise minimizes the reflected emissions of b1, g1, and r2, while then also minimally absorbing or otherwise maximizing the transmission of emissions of b2, g2, and r1 (to an underlying broadband reflecting layer so as to be substantially reflected). A careful consideration will show that an article using such an alternative coating of VIS441A, VIS523A, and VIS637A can still be caused to controllably change color using the same proposed “6P” engineered light, where the engineered light controls spectral outputs r1 and r2 differently than would be controlled for use with the combination of dyes VIS441A, VIS523A, and VIS603A.

And finally, still with respect to FIG. 3C and in particular the alternative use of dye VIS637A as opposed to VIS603A, it is noted that the human eye is more sensitive to the narrow band r1 centered at 615 nm than to the r2 band centered at 635 nm (see FIG. 3F). A review of FIG. 3F will also show that the human eye is more sensitive to b2 than b1, and g2 than g1, such that the “tri-color-band” of b2-g2-r1 is anticipated to be better for causing perceived coloration changes than the tri-color-band of b1-g1-r2. A “free” tri-color-band is herein referred to as the combination of narrow bands such as b2-g2-r1 (or alternatively as first discussed b2-g2-r2) designed in combination with a coating to controllably cause a colorization change to an article/surface, whereas a “locked” tri-color-band is herein referred to as the combination of narrow bands such as b1-g1-r2 (or alternatively b1-g1-r1) designed in combination with a coating to be substantially absorbed, thus causing substantially no colorization changes to the article/surface. It should be understood that a “free tri-color-band” implies that there is at least one narrow band (such as b2, g2, and r1) for affecting each human eye color response 20-srb (blue,) 20-srg (green,) and 20-srr (red,) respectively, where it is possible and even useful to have multiple “free” narrow bands for a single color (e.g., b2 and b3 for blue, g2 and g3 for green, or r1 and r3 for red). Likewise, a “locked tri-color-band” is not restricted to having only three (3) locked narrow bands, such as b1, g1, and r2, where in general the teachings provided herein are made more adaptive, extendable, and useful with an increase in the number of possible free and locked narrow bands per each color blue, green, and red.

As will also be clear from a careful reading of the present teachings, especially to those familiar with coatings and substances, there is no requirement that any given single narrow band (such as b1, b2, g1, g2, r1, or r2) achieve its “free” or “locked” property based upon the operation of a given type of substance (such as a nanoparticle, dye, pigment, or fluorescer,) as different narrow bands within the same coating may be caused to be free or locked by using different substances or even combinations of different substances (such as layers of substances as discussed in FIGS. 4B-4K). What is preferred is that a coating comprise at least one free tri-color-band comprising three (3) narrow bands such as b2, g2, and r1 that are usable to provide for article colorization changes, and at least one locked tri-color-band comprising three (3) narrow bands such as b1, g1, and r2 that are usable to provide for engineered light balancing as the free bands are adjusted, where this light balancing (see FIG. 3G) works to ensure that the engineered light source appears to remain at a constant colorization (e.g., white light comprising equal blue, green, and red) and at a constant brightness (as affected by the emitted luminance of the component blue, green, and red light).

Referring next to FIG. 3D, there is shown much of the same information as FIG. 3C, namely the blue, green, and red human eye response curves, the six (6) spectral emissions of PRIOR ART 6P lasers projectors (shown as vertical bands b1, b2, g1, g2, r1, and r2), and the five (5) QCR Solutions dyes VIS441A, VIS523A, VIS593A, VIS603A, and VIS637A with respective absorption curves. In addition, there is now shown three (3) more exemplary spectral outputs “b3” centered at 425 nm, “g3” centered at 505 nm, and “r3” centered at 595 nm, as well as four (4) more dyes VIS423A, VIS465A, VIS503A, and VIS548A.

The reader is again reminded that any zero or more of the nine (9) distinct bands of spectral output could be centered at different peak frequencies than depicted (and also have different FWHMs) and therefore also different peak frequencies (and FWHMs) than those already implemented in the PRIOR ART 6P and 9P laser projector technologies. What is important to see is that all exemplary bands b1, b2, and b3 preferably emit light within a range of frequencies that will be perceived individually or in combination by the human vision system as “blue.” Likewise, g1, g2, and g3 are detected as “green” by the human vision system and r1, r2, and r3 are detected as “red.” The careful reader will also see that at least g1 and g2 fall within the “red eye response curve” (20-srr, see FIGS. 3A and 3C,) and that at least r1 and r3 fall within the “green eye response curve” (20-srg).

What is also insightful to understand is that existing “tristimulus” (blue, green, red) emission systems such as most of today's displays and projectors create the perception of a full gamut of colors (therefore colors substantially spanning all visible frequencies) based upon emitting different luminosity levels of the same three limited (“tristimulus”) centered frequencies of a single band of “b1,” “g1,” and “r1.” For example, a tristimulus display might emit blue at a relative luminance of “0” (on an “8-bit” “RGB” scale from 0=no emission, to 255=maximum emission,) while emitting green at 255 and red at 255, noting that the emitted center frequency in at least some tristimulus (OLED) displays of blue is substantially 460 nm, of green is substantially 520 nm, and of red is substantially 630 nm, whereas “yellow” is considered to be roughly centered at 580 nm. Hence, the tristimulus display never actually emits spectral output at 580 nm (“yellow,”) but none-the-less causes the perception of yellow to the human vision system by controllably emitting “0, 255, 255” of “blue-green-red” centered light.

The careful observer will understand that the present invention could use for example the “free” color bands (e.g., b2, g2, r2) centered within the given “eye response” colors (e.g., 20-srb, 20-srg, and 20-srr, respectively) to act as the “tristimulus” of a traditional projector to be reflected off the surface of a specially coated article (as herein taught) and then received in combination by the human vison system for perception as any color within a gamut of colors allowed for the b2, g2, r2 center frequencies and emitted luminance (as will be understood by those familiar with tristimulus color systems and color gamut's). What a careful understanding will also show is that the present invention additionally uses at least one “locked” tri-color band (e.g., b1, g1, and r1,) also preferably centered within the given “eye response” colors (e.g., 20-srb, 20-srg, and 20-srr, respectively,) but also preferably not substantially overlapping the spectral output of bands b2, g2, and r2, to ensure that the total perceived emission of blue light (i.e., the total luminance of b1+b2,) as well as green light (g1+g2,) and red light (r1+r2) does not substantially change as the emissions of free colors bands such as b2, g2, and r2 are changed (see FIG. 3G for more details).

Those familiar with the human vision system will also understand that by using any one or more additional locked colors (e.g., b3, g3, and/or r3) these additional locked colors while not substantially affecting the perception of the coating by an observer, can combine with other locked bands such as b2, g2, and r2 to “mix with” b2, g2, and r2 to be better perceived by the human vision system as substantially similar in color to free bands b1, g1, and r1, respectively, (i.e., as opposed to the perception of bands b2, g2, and r2 not mixed with bands b3, g3, and/or r3) and thus the present system should not be limited to a single tri-color free band working in combination with a single tri-color locked band. As the careful reader will also note, it is also possible to narrow or widen the FWHM of any particular free or locked band (i.e., with respect to the representations depicted herein, with respect to the existing 6P or 9P art, or with respect to each other during implementation) in order to achieve a better similarity in color between corresponding combinations of free and locked bands, regardless of whether or not multiple locked bands are used, thus the present invention should be understood as teaching a combination of free bands for use in manipulating the perceived color of a special coating, and locked bands for use in manipulating the perception of an engineered light source to be substantially “unchanging” while the free or locked bands are altered in their luminance emissions, while then also minimally impacting the perception of the special coating.

Using a novel combination of “free” (able to reflect) and “locked” (substantially absorbed) tristimulus-bands (herein called “tri-color-bands,”) the present teachings provide for what appears to the human eye to be a consistent “white light” source illuminating any specially coated article/surface, where then the surface color of the specially coated article can be substantially changed to virtually any color in a wide color gamut, again without any perceived substantial change to the white light source.

What is also important to understand is that the preferred system using the herein taught “engineered light source,” causing for example different levels of “free” band emissions (such as but not limited to b1, g1, and r1) along with balancing emissions of “locked” band emissions (such as but not limited to b2, g2, and r2,) uses “color pairs” of “free” and “locked” narrow bands (e.g., the blue pair b1 and b2, the green pair g1 and g2, and the red pair r1 and r2) that are more rather than less collocated on the frequency spectrum, all still staying within their respective eye color response curves. For example, in the present FIG. 3D, the center frequency of b3 is centered at 425 nm, while the center frequency of b2 is centered at 465 nm, thus center-to-center separated by 40 nm. However, b1 and b2 are only separated by 20 nm, which is preferable when considering that the spectral response of typical articles (wall paint, furniture fabric, clothing, skin, etc.) will tend to “operate” on closer frequencies (such as 445 nm b1 and 465 nm b2) with substantially the same response (e.g., reflecting, absorbing, transmitting at certain levels) as compared to further separated frequencies (such as 42 nm b1 and 465 nm b2). Thus, one object of the present teachings is that the human eye always substantially perceives the engineered light source to be emitting white light, while specially coated articles appear to be changing color over time, while also the coloration of all other “not specially coated articles” remains substantially consistent (thus being benefited by the use of narrow bands that are more rather than less collocated on the frequency spectrum within a given eye color response).

Those familiar with the human vision system and color gamut's, as well as light sources and the many various substances that can operate on light, will also understand that while a “tri-color-band”/“tristimulus” system is preferred (in that it at least is the most common type of system,) it is also possible to implement for example a “four-stimulus” (or more) system that emits for example 4 different “free”-“locked” pairs aligned across the combination of the three human eye color response curves (20-srb, 20-srg, and 20-srr).

It is important to see that that a single intended “color stimulus” (such as the blue stimulus, green stimulus, or red stimulus) covering a determined frequency range (such as known for blue, green, and red curves 20-srb, 20-srg, and 20-srr, respectively) be implemented with at least two narrow “color-bands” (at least one “free” and at least one “locked”) (such as b1 and b2 for the blue stimulus, g1 and g2 for green stimulus, and r1 and r2 for red stimulus,) where the spectral output of the free and locked color-bands emitting a single color (blue, green, or red) are preferably closely collocated in the visible spectrum and staying within the determined frequency range for their intended color, where the color-bands do not substantially overlap in their spectral output, and where the at least one “free” narrow band and at least one “locked” color band are separated in center “peak” frequencies by sufficient spectral distance such that a special coating for articles comprising one or more substances operates on at least one “free” band to substantially reflect the emitted light and at least one “locked” band to substantially not-reflect the emitted light.

Still referring to FIG. 3D, and further with reference to the teachings of U.S. Pat. No. 11,204,455 entitled SPECTRALLY SCULPTED MULTIPLE NARROWBAND FILTRATION FOR IMPROVED HUMAN VISION, issued Dec. 21, 2021, there are advantages to selecting tri-color-bands that are substantially outside of the frequency range substantially centered between the peak frequencies of the human eye color responses blue 20-srb, green 20-srg, and red 20-srr, where at least one advantage is to lessen or alleviate the experience of “color-blindness.” For example, spectral emissions in the frequency range centered at roughly 485 nm (between b2 centered at 465 nm and g3 centered at 505 nm) lies between the human eye's receptors for blue and green and can contribute to color blindness. Likewise, spectral emissions in the frequency range centered at roughly 560 nm (between g2 centered at 545 nm and r3 centered at 595 nm) lie between the human eye's receptors for green and red and can also contribute to color blindness.

Regarding this consideration, the present inventors prefer to treat especially tri-color-band g2 centered at 545 nm as a “locked” band, thus not contributing substantially to the colorization of a specially coated article as herein taught (i.e., by being substantially absorbed by the coated article rather than reflected,) where its reflection could contribute to “confusion” for a color-blind individual between the colors green and red. To a lesser extent but for a similar reason, tri-color-bands b2 centered at 465 nm and r3 centered at 595 nm are also preferred as a locked bands. What will be clear to those familiar with color-blindness, as well as by a careful reading of the PRIOR ART of U.S. Pat. No. 11,204,455 and the teachings provided herein, it is possible to choose narrow bands of visible light for controllable emission by an engineered light source (such as taught herein) to be favorable for the reduction in at least the experience of color-blindness when looking at a specially coated article as herein taught, while also creating an improvement in color sharpness even for those that are not otherwise color-blind. As prior discussed, the choice of any particular tri-color band (each comprising at least one “free” band and at least one “locked” band,) for example but not limited to b1-g1-r1, b2-g2-r2, or b3-g3-r3 (or even additional color bands such as b4-g4-r4,) is not limited to the center-peak frequencies herein preferred and discussed, but is rather limited as herein described in general terms such as not overlapping another band, being within a given eye color response, and being either locked or free.

Still referring to FIG. 3D, a careful consideration will also make clear that there are advantages to having more than one locked band (e.g., locking both b3 and b1) within a given color (e.g., blue,) or alternatively, creating a locked band to have a wider FWHM than a free band, such as combining the range of b3 through b1 into a single locked band (wider than in comparison to free band b2). At least one advantage of a locked set of frequencies that range over more than one spectrally emitted band (such as b3 and b1) of an engineered light source is that the engineered light source is then able to emit more blue light that does not affect the colorization of a specially coated article as herein taught, while then at the same time this more emitted blue light (and in a similar consideration more green and red light) allows the engineered light source to more closely achieve what is typically referred to as “broadband white light,” whereby all non-specially coated articles will maintain their “truest colorizations” (where true means what the non-specially coated article would look like in direct sunlight).

Another trade-off consideration is that increasing the number of locked bands per color, or the frequency range of any locked band per color, will cause the specially coated article to become “darker” under normal broadband white light, such as daylight (i.e., because “more locked bands” means more absorption within the coating, means a darker appearance for the coating). This is a useful tradeoff because being darker may be the color choice for some specially coated articles, whereas for other specially coated articles, the preferred colorization could be lighter or “whiter,” or at least more reflective in any one or more of the blue, green, or red color bands. A careful consideration of FIGS. 4A through 4K will show that the present invention teaches means for allowing a specially coated article to have a “natural” “white-light” colorization that substantially ranges from white to black with color variations, while then also when under engineered light still being “colorizable,” all as herein taught.

Still referring to FIG. 3D, it is also advantageous to have at least three bands (such as b1, b2, and b3 for blue, g1, g2, and g3 for green, and r1, r2, and r3 for red) per each eye color response blue, green, and red, respectively. One advantage is the ability to support two distinct special article coating arrangements, each providing independently controllable article colorization using engineered light. To best understand this teaching, consider a first special tri-color-band coating comprising the six (6) locked bands (b1, b2, g1, g2, r3, and r1) and the three (3) free bands (b3, g3, and r2,) where the remainder of the “unaddressed” visible spectrum not represented by the frequency ranges of these collected nine (9) locked and free bands is for example any of absorptive or reflective, thus the unaddressed portion of the visible spectrum provides a range of “natural” “white light” colorization opportunities, all as will be understood by those familiar with the colorization of materials.

For example, if the first coating is meant to appear substantially white in normal white light, then preferably the remaining unaddressed visible spectrum includes substances for substantially reflecting this unaddressed light, where then a careful consideration will show that across the visible spectrum, the first special coating substantially reflects all visible light except the six (6) locked bands (b1, b2, g1, g2, r3, and r1) which are substantially absorbed. When this first coating is viewed under engineered light that is only emitting the locked bands b1 and/or b2, g1 and/or g2, and r3 and/or r1 frequencies which are substantially absorbed by the first coating, then that article will appear to be substantially black. As will be understood by those familiar with the colorization of materials, the natural white light appearance of the first coating does not need to be “white,” but can be any color by determining which portions of the unaddressed visible spectrum are being absorbed or reflected.

Again, what is important is that a substantially natural white special coating reserves six (6) locked bands (e.g., b1, b2, g1, g2, r3, and r1) (also understanding that the remaining portion of the visible spectrum is then already essentially “free” to be colorized especially by changing the emissions of free color bands b3, g3, and r2,) and conversely for a naturally black special coating to reserve three (3) narrow free bands (e.g., b3, g3, and r2,) such that using these reserved narrow bands the coating's colorization can be manipulated by an engineered light source (also understanding that the remaining portion of the visible spectrum is then already essentially “locked” to be absorbed especially by changing the emission of locked color bands b1, b2, g1, g2, r3, and r1).

Still referring to FIG. 3D, with this understanding of a preferred first special tri-color-band coating, a second special tri-color-band coating for example comprises the locked six (6) bands (b1, b3, g1, g3, r3, and r2) and the free bands (b2, g2, and r1,) where the remainder of the “unaddressed” visible spectrum not represented by the frequency ranges of these collected nine (9) locked and free bands is for example any of absorptive or reflective, thus the unaddressed portion of the visible spectrum provides for a range of “natural” “white light” colorization opportunities, all as will be understood by those familiar with the colorization of materials.

A careful consideration of these teachings for a “two-coating” system will show that 1) it is necessary to have a common set of three (3) locked bands (e.g., b1, g1, and r3,) 2) it is necessary for the first coating to have its own free bands (e.g., b3, g3, and r2) and that the second coating lock these same bands (b3, g3, and r2,) and 3) it is necessary for the second coating to have its own free bands (e.g., b2, g2, and r1) and that the first coating lock these same bands (b2, g2, and r1). In this configuration, as an engineered light source is controlled to emit different luminance levels of bands b3, g3, and r2, this will necessarily affect the colorization of any article/surface using the first coating without having any substantial effect on any article/surface using the second coating, or on any non-specially coated article/surface. Likewise, as an engineered light source is controlled to emit different luminance levels of bands b2, g2, and r1, this will necessarily affect the colorization of any article/surface using the second coating without having any substantial effect on any article/surface using the first coating, or on any non-specially coated article/surface.

It is also noted that while the common set of three (3) locked bands (e.g., b1, g1, and r3) could be omitted from the first and second coatings, doing so prohibits the system from using these common bands for “balancing” the changing emitted luminance's of the free bands, where maintaining the balance allows the engineered light to continually emit a mixed luminance of blue, green, and red light necessary to be continually perceived by the human vision system as a substantially unchanging white light source with a substantially unchanging brightness, while at the same time allowing for changes in the free tri-color-bands b3, g3, and r2 to cause colorization changes in the first coating and for changes in the free tri-color-bands b2, g2, and r1 to cause colorization changes in the second coating (see also FIG. 3G for more explanation).

And finally with respect to FIG. 3D, adding a third coating could be done by creating a fourth set of tri-color-bands (b4, g4, and r4) to operate as free bands for the third coating, but otherwise to be operate as locked bands in the first and second coatings. Also, the third coating must necessarily lock both the common locked bands of (b1, g1, and r3) as well as the first coating's free bands of (b3, g3, and r2) and the second coating's free bands of (b2, g2, and r1).

Referring next to FIG. 3E, similar to FIG. 3B, there is depicted an engineered light source 63, generic “color x” eye response 20-csr and article with coating 12g. What is different in FIG. 3E as compared to FIG. 3B is that coating 12g now alternately comprises a top tri-color bands (fluorescer) layer 13-5 comprising one or more light fluorescent substances 13s-3 and a bottom layer comprising a broadband absorber 13-1a. Like FIG. 3B, engineered light source 63 emits at least two distinct spectral outputs 63e-1-so, 63e-2-so (one output to cause article colorization, and the other output to substantially not cause article colorization) preferably comprising substantially non-overlapping frequencies within a range of frequencies 20-csr perceived as a primary color x (blue, green, or red) by an observer 20, where the emissions impinge upon an engineered coating 12g with spectral responses matched with the spectral outputs. In layer 13-5, a fluorescent substance 13s-3 comprises a spectral response 13s-3-sr that substantially overlaps with spectral output 63e-1-so, and preferably has minimal to no overlap with spectral output 63e-2-so.

In operation, when LED 63e-2 of light source 63 is turned on and emitting, the resultant spectral output 63e-2-so is then substantially fully absorbed by broadband absorbing bottom layer 13-1a, such that an observer would perceive minimal reflected emission 63e-2-re off coating 12g, and as such perceive coating 12g to be dark or even black (at least with respect to the emitted color X, such as a blue, a green, or a red LED). As those familiar with fluorescent substances will understand, and in contrast, when LED 63e-1 of light source 63 is turned on and emitting, the resultant spectral output 63e-1-so is also substantially fully absorbed but now by top layer 13-5 substance 13s-3, where substance 13s-3 than reemits (“fluoresces”) emissions 13s-3-fe at a peak frequency that has been shifted with respect to the peak frequency of output 63e-1-so by an amount referred to as the “stokes shift.” This shifted fluorescent emission 13s-3-fe is then perceived by the observer as a particular color, thus contributing to the “colorization” of the article comprising coating 12g.

There are many fluorescent substances available in the marketplace, such as “Alexa Flour” dyes sold by Thermo Fisher Scientific that absorb in the non-visible spectrum, where the stoke's shift is typically (but not always) “downward” towards the longer references (i.e., “red-shifted.”) Other suppliers such as NCC specialize in the manufacturing and otherwise sale of invisible/“non-visible” UV/IR fluorescers that absorb in the UV and IR portions of the spectrum but then reemit/fluoresce as visible light. The present invention should not be limited to any particular fluorescent material for use as 13g, and even more specifically should not be limited as depicted in the present FIG. 3E to having an absorption spectral response 13s-3-sr that is necessarily within the “color-x” spectral response 20-csr (that is necessarily in the visible spectrum, hence in the blue 20-srb, green 20-srg, or red 20-srr spectral response of the human vision system as discussed above). Thus, the absorption spectral response 13s-3-sr could alternatively be outside of the given color-x, and even outside of the visible spectrum, thus for example in the UV or IR frequency ranges.

What is more important is that the fluorescent emissions 13s-1-re are within the given color-x of a corresponding “locked” band (in this case LED2 63e-2 with spectral output 63e-2-so,) such that it is possible to cause using the engineered light source a perceivable difference in the color (i.e., “color-x”) of the article with coating 12g by turning on a first combination of one or more LEDs (or any light emission such as a laser light) to substantially cause minimal reflection/emission from the coating 12g, thus appearing to be without colorization, verse turning on a different combination of a second one or more LEDs to substantially cause a significant reflection/emission from coating 12g, thus appearing to have colorization. What is also important is that the perception of the color and brightness of the light being emitted by the engineered light source 63 remains substantially the same to an observer (even as the colorization of the coating 12g appears to be changing) regardless of whether the first or second combination of LEDs is turned on.

The following two examples, “case 1” and “case 2,” are intended to teach key alternatives with respect to the component configuration and operation of a coating comprising a tri-color-band (fluorescer) layer 13-5. In case 1, narrowband light source “LED1” (or any equivalent such as a laser light source) emits a spectral output 63e-1-so that is substantially within the spectral response 20-csr of a given color X as perceived by the human vision system (i.e., blue, green, or red,) as depicted in the present FIG. 3E. Additionally, narrowband light source “LED2” (or any equivalent such as a laser light source) emits a spectral output 63e-2-so that is also substantially within the spectral response 20-csr of a given color X, while also preferably not substantially overlapping output 63e-1-so, and while preferably also having a peak frequency that is closer in frequency range to the peak frequency of 63e-1-so rather than further away (again, as depicted in FIG. 3E). In case 2, and not as depicted in present FIG. 3E, LED1 emits a non-visible energy such as UV or IR and its spectral output 63e-1-so is therefore not within, or at least not substantially within, spectral response 20-csr. However, in both case 1 and case 2, the fluorescent substance 13s-3 comprising the top layer 13-5 of coating 12g substantially absorbs the spectral output 63e-1-so for readmission as fluorescent emissions 13s-3-fe that are within the spectral response 20-csr, and furthermore are preferably close in peak frequency and even overlapping with the frequencies of spectral output 63e-2-so (as depicted in FIG. 3E).

The careful reader will note that a goal of the present invention it to at least and preferably in operation ensure that an observer does not perceive any substantial color or brightness change when looking directly at an engineered light source 63, even as the source 63 controllably operates to turn on and off its various constituent narrowband emitters (such as 63e-1 and 63e-2 in the present FIG. 3E and discussion). In case 1, the preferred operation is to turn on for example LED1 63e-1 and turn off LED2 63e-2 at any given time, or vice versa, where each of LED1 and LED2 is operated at a sufficiently similar luminance and is a sufficiently close in frequency range such that both the brightness and color of LEDs 1 and 2 are perceived as substantially identical to an observer looking at light source 63. As prior discussed, even as the observer notices no perceivable change in color or brightness in light source 63, for example as LED1 is turned on (and LED2 is preferably simultaneously turned off,) where LED1 therefore causes fluorescent emissions 13s-3-fe, the observer does perceive at least some amount (brightness) of color X in the coating 12g. In contrast as prior discussed, when LED2 is turned on and LED1 is preferably simultaneously turned off, the coating 12g appears to lose its color X while the engineered light source 63 appears to remain the same color and brightness.

Those familiar with color perception of the human vision system will also recognize that it is possible to use for example a third LED3, emitting at a different frequency range preferably but not necessarily within the same color X frequency range, where the third LED3 is turned on for example whenever LED2 is turned on, such that the combination of the light emitted by LED3 and LED2 is perceived to be substantially the same color and brightness as LED1. In this alternative, the spectral output of LED3 is preferably also absorbed by the coating 12g, similar to the spectral output of LED2, such that LED3 contributes to the perceived color and brightness of the light source 63, but otherwise does not substantially change the perceived color or brightness of coating 12g. Based upon a careful reading of the teachings provided herein, and an understanding of the various coating materials in the marketplace as well as light sources and the human vision system, it will be clear that many other variations are possible, not just with respect to the teachings related to FIG. 3E, such that the teachings herein should be understood to be extensible through the use of variations to accomplish the desired goals of at least a light source 63 that changes imperceptibly to an observer while at the same time causing a specialized coating to perceptibly change in colorization.

Still referring to FIG. 3E, and now specifically to case 2 as mentioned above, LED1 emits a non-visible spectral output 63e-1-so (such as UV or IR) that is substantially outside of color x spectral response 20-csr, while still also still causing a fluorescent emission 13s-3-fe that remains within the color x response 20-csr, similar to case 1. The careful observer will note that in case 2, LED2 is preferably always turned on (regardless of the on-off state of LED1) and also never contributing to any substantial colorization to coating 12g, while also the spectral output of LED2 provides a consistent perception of color and brightness being emitted from light source 63. In case 2, when LED1 is turned on (and LED2 is also on,) LED1's spectral output being substantially non-visible, it will cause substantially no perception of color or brightness change with respect to the light source 63. However, since the fluorescent substance 13s-3 is matched (i.e., “engineered”) to substantially absorbed this non-visible spectral output of LED1, and then to emit the visible fluorescent emissions 13s-3-fe, when LED1 is turned on the observer will perceive a change in the color X component of coating 12g. Based upon a careful reading and consideration, it will also be clear that it is possible to combine case 1 and case 2. In this alternative “case 3,” the LEDS 1 and 2 are operated exactly like case 1, and then LED3 is used to emit a non-visible spectral output for “adding” additional colorization or brightness to the coating 12g while not also creating any perception change to the colorization or brightness of light source 63.

And finally, still with respect to FIG. 3E and more specifically coating 12g variation comprising a tri-color-bands (fluorescer) layer 13-5, it is possible using a non-visible (such as UV or IR) light sources for 63e-1 to otherwise cause the engineered light to appear off or very dim to the observer, while the 12g coated article alternately appears to be “unnaturally” bright, what is often referred to as a “glow-in-the-dark” affect.

Those familiar with UV energy will note that at least what is known as UVA is present in natural sunlight, and as such any special coating comprising UVA excited fluorescers would then tend to fluoresce in the presence of natural light, which a careful consideration will show can be undesirable for use in the presently taught “color changing” coatings. In relation to upcoming FIG. 3I, the present invention will teach the uses of an electrochromic material that switches between two states, a first state that is substantially transmissive to UVA energy and a second state that is substantially not-transmissive to UVA energy. When combined as a upper layer overlaying fluorescer layer 13-5, any one or more UVA fluorescing substances responding to any one or more UVA narrow bands such as a “u1” (downshifted to blue,) a “u2” (downshifted to green,) and a “u3” (downshifted to red,) it is then possible to controllably switch “off” the electrochromic “UVA window” to substantially block any UVA from reaching the UV fluorescing substances of layer 13-5 of the coating 12g for example to block fluorescing when in natural light, and then to switch “on” the electrochromic UVA window to substantially the transmit engineered light source 63 emitted UVA energy, such as u1, u2, u3, etc., thus causing at least any of the “glow-in-the-dark,” “color enhancing,” or even “blinking” u1, u2, or u3 to “blink” or increase the perception of color X in the article/surface coating.

Referring next to FIG. 3F, there is shown the well-known nominal luminosity response of the human eye which plots the relative sensitivity of the eye to the visible spectrum of frequencies. This luminosity response has been overlaid with the six (6) vertical bands b1, b2, g1, g2, r1, and r2, representing the peak frequencies of PRIOR ART 6P lasers projectors. The intersection of each vertical band with the luminosity response has been marked with a black circle and based upon these approximations rough estimates are provided showing the scalar relationship between the color band pairs b1 and b2, g1 and g2, as well as r1 and r2. For example, the human eye is almost 50% more receptive to blue light emitted at the preferred free narrow band corresponding to b2 (465 nm) as compared to the locked band b1 (445 nm) (where eye sensitivity at b2 frequencies equals roughly 1.4 times the sensitivity at b1 frequencies). Likewise, eye sensitivity to free band g2 is roughly 10% greater than locked band g1, whereas sensitivity to free band r2 roughly half the sensitivity to locked band r1, all as a careful consideration of the present figure will show.

Given this understanding, the present invention anticipates benefits to using r1 as a free band with r2 being the corresponding locked band, such that eye sensitivity is always greatest with respect to the free bands (e.g., b2, g2, and r1) versus the “balancing” locked bands (e.g., b1, g1, and r2,) all as also prior discussed in relation to FIG. 3D. Anticipated benefits include creating a greater perceived range of colorization using the more sensitive bands b2, g2, and r1. However, it is noted that for simplicity, in upcoming FIGS. 5A, 5B, 5C, 5D, and 6A, all “2” bands (i.e., b2, g2, and r2) are depicted as free and therefore substantially reflecting/“article colorization” bands, where all “1” bands (i.e., b1, g1, and r1) are depicted as locked and therefore substantially not-reflecting bands, where it should also be understood that either of these alternatives is sufficient and that even more alternatives are possible as will be clear from a careful reading and consideration of the teachings provided herein.

Referring next to FIG. 3G, there is shown a table with six rows of exemplary colors labeled black, floral white, dark red, saddle brown, dark olive green, and dark blue, and three column groups labeled “perceived as . . . ” “blue light,” “green light,” and “red light.” Each column group comprises three columns labeled “free reflected band” (the “2” bands,) “locked absorbed band” (the “1” bands,) and “ave(erage) . . . light.” Like a typical tristimulus blue, green, red system, the “2”/“free reflected bands” indicate a relative portion (0% to 100% max) of a b2, g2, and r2 necessary to create the perception of the color specified in the row. These are exemplary colors where it should be understood that the blue, green, and red light emitted by an engineered light source is controllable to different relative luminance's, and to the extent that these relative luminance are reflected in similar relative proportions off substances comprising the special coating, a person viewing the special coating will substantially perceive the (an) intended color. To achieve reflection in similar relative proportions, it is desirable that the substances (and their solvents, binders, etc.) have a reflectance that is substantially the same (e.g., all “2” reflecting substances exhibit a substantially equal reflectance ideally between 40% to 60%, all as will be understood by those familiar with coatings and especially substance mixtures for creating colorization.

Still referring to FIG. 3G, it is also an object of the present invention that a person looking at an engineered light source will perceive substantially white light, even dimmable white light, even while the engineered light source is controllably altering the luminance levels of the free bands (such as b2, g2, and r2 in one configuration). To accomplish this object, the present invention teaches the use of “balancing” “locked” bands, for example as listed in the table the “1” bands of b1, g1, and r1. Careful consideration will show that since the free “2” bands can range between essentially 0% to 100% of some maximum spectral output, the locked “1” bands must therefore range between 200% (i.e., when the corresponding “1” band is 0%) and 100% (i.e., when the corresponding “1” band is also 100%,) such that the average of a color “1” and “2” pair, such as b1-b2, g1-g2, or r1-r2, remains constant (at 100% of some maximum value) for both the given color blue, green, or red, and across all three colors blue, green, and red.

Referring still to FIG. 3G, but also in consideration of the teachings with respect to at least FIG. 3D for supporting a “two-coating” system, for each first and second coating there is one free band and two locked bands, one locked band is “common” to both coatings, and the other locked band for each coating substantially matches the narrow band frequency peak and FWHM of the corresponding free band of the other coating (again, see FIG. 3D for more detail). However, a careful reading of these teachings will show that the spectral output (luminance) of the “other matching” locked band for one coating is actually the emitted spectral output (luminance) of the corresponding free band, where the first coating for example reflects this single spectral output while the second coating absorbs the same single spectral output.

Hence, with respect to FIG. 3G, for a two-coating system it's the common bands (e.g., with respect to the discussion in FIG. 3D, bands b1, g1, and r3,) that range from 200% to 400% (acting as the “absorbing”/“balancing” bands depicted in the present figure). For example, in the prior discussed two-coating system, the free bands of the first coating were b3, g3, and r2 (where each can range from 0% to 100% of some maximum,) and for the second coating were b2, g2, and r1 (where also each can range from 0% to 100% of some maximum,) and thus a careful consideration will show that the common locked band b1, g1, and r3 must range from 200% to 400% in order to maintain a continual white light balance for the engineered light.

Still referring to FIG. 3G, it should therefore be understood that the table is providing examples in a “1—coating” system, and that in a “2-or-more—coating” alternative system, any similar table would require additional columns for indicating the preferred emissions of the additional bands (i.e., in addition to the “1”s and “2”s presently depicted). As a careful reading of the present invention will also show, in coatings that are employing a tri-color-bands (fluorescer) layer 13-5 (e.g., see the discussion related to prior FIG. 3E,) it is possible to add light emitters such as 63e-1 for emitting non-visible UV or IR light that ultimately causes fluorescence by layer 13-5 in the visible spectrum, and thus visible coating/article colorization. A careful consideration of this alternative non-visible-light case will show that when using at least non-visible light emitters within a combination of light emitters comprising an engineered light source 63, the considerations for “light balancing” (e.g., between the spectral outputs of a b1 vs b2 emitter) in order to maintain the perception of substantially white light can be achieved differently than as depicted in the FIG. 3E.

Thus, it should be understood that the present FIG. 3E is exemplary of a 1-coating system and is useful for understanding the apparatus and methods for 1) maintaining a consistent perception of an unchanging white light when a person is looking at the engineered light source, even as various emitters comprising the light sources are altered in their emission luminance, while also 2) allowing for the changing of the coloration perceived by a person of a specially coated article by changing individual light emitters within the engineered light source. Furthermore, it should also be understood that even in a 1-coating system, it is possible and useful to add for example a third light emitter per color blue, green, and red, such as b3, g3, and r3, where a third emitter/band b3, g3 or r3 is used in a combination with any of the 1's or 2's bands to help balance the perceived engineered light source white light and/or article colorization, where this third band approach is considered to be increasingly useful as the peak frequency of a 1 band such as b1 is further separated from the peak frequency of a 2 band such as b2 (because this separation is expected to increase the likelihood of a person perceiving a color difference, all as will be understood by those familiar with the human vision system and based upon a careful reading of the present invention).

Still referring to FIG. 3G, and now providing an example alternative consideration of a system using one or more non-visible emitters within the engineered light source along with a fluorescent layer 13-5, if a “free band” such as b2, g2, or r2 is shifted from (a) using visible light to be substantially reflected by a coating substance operating in the visible spectrum, to (b) using non-visible light to be absorbed by fluorescent substance for fluorescing in the desired visible blue, green, or red spectral response of the human vision system, than it is possible as prior discussed to leave the locked band visible emitters b1, g1, and r1 always on (thus providing the perception of continuous white light, i.e., causing no engineered light color change,) while then turning on any one or more of the non-visible b2, g2, or r2 emitters to then cause visible fluorescence and hence article colorization.

Referring next to FIG. 3H, there is shown a public domain accessible spectral response showing the reflectance of some types/colors of human skin (specifically Caucasian and Black/African representing the greatest range of reflectivity differences,) where the response is shown across the ultraviolet-to-visible-to-near infrared spectrum. Also depicted is an exemplary set of nine (9) vertically oriented narrow frequency bands labeled along the lower spectrum axis as “u1” (1 ultraviolet, centered at 380 nm), “b1,” “b2” (2 blues, centered at 445 nm and 465 nm, respectively), “g1,” “g2” (2 greens, 525 nm, 545 nm), “r1,” “r2” (2 reds, 615 nm, 635 nm), and “n1,” and “n2” (2 near infrareds, 780 nm, and 800 nm).

(It is noted that these bands, such as b1, b2, g1, g2, r1, and r2, were correspondingly named and preferably align with similarly named bands in other Fig.'s including 2B, 3A, 3C, 3D, 3F, 3I, 5A, 5B, 5C, 5D, 6A, and 8A, although it should also be understood that the choice of the center/peak of each band, as well as its FWHM can be adjusted without departing from the teachings provided herein, and as such the various bands should be considered as preferred and exemplary, but not as limiting to the present invention.)

Still referring to FIG. 3H with special reference to the chart key shown on the right, there is also depicted three exemplary “homogenous (skin) reflectance bands” 2s-rb1 (spanning u1 to b1), 2s-rb2 (spanning g1 to g2), and 2s-rb3 (spanning n2 to n3), where these horizontally oriented reflectance bands 2s-rb1, 2s-rb2, and 2s-rb1 are each depicted twice, a first time shown generally overlapping the Caucasian reflectance curves, and a second time shown generally overlapping the Black/African reflectance curve. As with the center/peaks and FWHMs of narrow bands u1, b1, b2, g1, g2, r1, r2, n1, and n2, the center and width of reflectance bands 2s-rb1, 2s-rb2, and 2s-rb1 is representative of a purpose and thus where still accomplishing the taught purpose can be adjusted, where the purpose of the band is to span a portion of the spectrum where the spectral response of preferably any human skin (such as but not limited to Caucasian or Black/African American) is substantially consistent, thus generally reflecting or absorbing that spanned portion of the spectrum consistently (i.e., a minimum “net reflectance change” across the band).

However, as will become clear as described further below, it is also possible to locate a “reflectance band” such as 2s-rb1, 2s-rb2, and 2s-rb1, to span a portion of the spectrum where the reflectance/absorbance of human skin of human skin is changing substantially over that band (such as for example between roughly 600 nm and 625 nm, thus a maximum “net reflectance change.”) As a careful reading of the present invention will show, what is of most importance is that the absolute net reflectance change in an article color is differentiable across at least one “reflectance band” (comprising any two narrow bands) as substantially different from (either greater or lesser) the net reflectance change of any type of human skin within the same narrow band.

Still referring to FIG. 3H, what is also important to see is that within the visible spectrum white (Caucasian) skin tends to be reflective and black (African American) skin tends to be absorptive, whereas both skin colors tend to be reflective in the IR spectrum especially around 800 nm and longer wavelengths (deeper infrared,) where it is also noted that the typical accepted range of non-visible NIR frequencies start around 700 nm to 700 nm. What is also important to see is that along at least three spans of the visible-to-IR spectrum, 2s-rb1, 2s-rb2 and 2s-rb3, the absolute value in the difference of reflectance (i.e., “net reflectance change,”) regardless of skin type (i.e., Caucasian, or Black/African) is roughly 0% minimum to 10% maximum.

As will be discussed, especially in relation to the collective teachings related to FIGS. 3A through 4K, it is possible to create coatings (12g, 12g-1, 12g-2, 12g-3, 12g-4, 12g-5, 12g-6, 12g-7, 12g-8, 12g-9, and 12g-10) for articles 12 (or virtually any surface) from a variety of substances (nanoparticles, nanomaterials, pigments, dyes, fluorescers, etc.), where the combination of one or more substances creates a distinct spectral response at least within one or more reflectance bands such as 2s-rb1, 2s-rb2, and 2s-rb1, where this distinct spectral response exhibits a net reflectance change that is detectably different from (either greater than or less than) any type of human skin's net response over the same reflectance band, and where for illustrative purposes this teaching is shown for a wide spectral response across the entire exemplary coating/“engineered article uv-visible-ir color” (and therefore covering all one or more reflectance bands) as represented by the dashed lines connecting the darkened circles in the present figure.

Still referring to FIG. 3H, for any article 12 (or any surface) using a special “engineered” article coating such as herein taught and comprising selected substances with reflectance properties such as represented by the darkened circles of the present figure, a careful review will show that over the same three exemplary spans of the spectrum, 2s-rb1, 2s-rb2 and 2s-rb3, the absolute value in the difference of reflectance is roughly 40%, and could be engineered to be more or less in absolute value, where most importantly this engineered absolute value over at least one span such as 2s-rb1, 2s-rb2 and 2s-rb3, (i.e., 40%) is detectable and differentiable from the absolute value of any skin reflectance measured over the same span (i.e., 0% to 10%). Thus, as to be discussed more in relation to FIGS. 8B and 8C, the article 12 (foreground) is more readily segmented from gamer 2s's skin. It is further noted that cotton, polyester, and other clothing materials are anticipated to also show an absolute value of difference over the three spans 2s-rb1, 2s-rb2 and 2s-rb3 of appreciably less than 40% (where this could be increased for example to 60%,) thus also making clothing readily segmented from article 12, all as will be understood by those familiar with image processing in general, and then also familiar with multispectral and hyperspectral cameras in particular (to be discussed further in relation to FIG. 8B).

Referring next to FIG. 3I, there is shown a graph taken from the article entitled “Ultra-large optical modulation of electrochromic porous WO3 film and the local monitoring of redox activity,” from Cai, et. al, published in Chemical Science July 2016. Electrochromic films (or materials) are well-known and have the general ability to switch states based upon an applied electric field, where the states alter any of the operations of transmission, absorption, reflectance and/or emittance of light. For more examples, the reader is also directed to a European Coatings/Coating Technologies web article dated Feb. 11, 2015 discussing electrochromic polymers created in the laboratory of John Reynolds, a professor in the School of Chemistry and Biochemistry and the School of Materials Science and Engineering at the Georgia Institute of Technology.

Referring first to the Reynolds electrochromic polymers (not depicted,) the polymers properties include switching “between a colored and colorless state by applying a brief pulse of electrical current and do not need a continuous power supply. To maintain the colorless state, a brief refresh pulse needs to be applied approximately every 30 min; however, the colored state can be stable for up to several days. The materials can switch from about 10% transmittance to 70% transmittance—and back—in a few seconds. The electrochromic materials rely on a reduction-oxidation (redox) reaction triggered by the application of an electrical potential provided by a simple coin battery: a positive one volt causes the glasses to be clear, while a minus one volt switches to the color.” In general, electrochromic materials operate over the visible spectrum and especially for the purposes taught herein, can be considered a “switchable window” usable in an upper layer of a specially engineered coating for either “closing” to block the transmission of light to a lower layer in the coating, or “opening” to allow light to transmit to a lower layer, to be operated upon (e.g., absorbed, reflected, fluoresced, phosphoresced) by the lower layer, and then potentially to transmit back through the upper layer window. (See “substantially absorptive (black, colored)/substantially transmissive (transparent)” electrochromic switchable window 13-4b in FIGS. 4E, 4F, 4H, and 4J.)

Still referring to FIG. 3I, and now specifically referring to the Cai, et. al “electrochromic porous WO3 film” as presently depicted, there is shown the spectral response of two variations (“Compact WO3” or “CWO3,” and “Porous WO3” or “PWO3”) over frequencies ranging from UVA to visible to NIR. Overlaid onto this electrochromic material spectral response chart are the nine (9) vertical narrow bands (also depicted in FIG. 3H) of representative energies labeled “u1,” “b1,” “b2,” “g1,” “g2,” “r1,” “r2,” “n1,” and “n2.” In general, with respect to the spectral response of variations Compact WO3 and Porous WO3, note that there are two sets of curves one with darker lines and the other lighter (grey) lines, and for each set, one solid line and one dashed line. The lighter line set represents the “Compact WO3” electrochromic material while the darker line set represents the “Porous WO3” electrochromic material. Both the Compact and Porous materials switch from a substantially opaque state (substantially black to some colorization) to a substantially transmissive state (transparent) with and applied voltage which triggers the “reduction-oxidation (redox) reaction.” While the research paper is mainly focused on describing the process for creating the two different materials (demonstrated on a glass substrate, as opposed from Reynolds' materials which being in an ink form are readily suitable for other substrates including plastics,) the quantitative performance testing of the two different materials was focused on “transmittance modulation” (the net min-to-max transmission of light through the electrochromic “window” as the window switches between states) and “coloration and bleaching speed” (the “switching from opaque to transparent” and back again of the electrochromic “window”).

Still referring to FIG. 3I and the materials from Cai, et. al, the herein referred to “switched on”/transparent state represents the solid lines where the materials show maximum transmission of light. In particular, Cai is highlighting the better visible light “ultra-large transmittance modulation reaching 97.7% at 633 nm” achieved with the Porous WO3 material (this is compared to only a 61.5% transmittance modulation at 633 nm for the Compact WO3 film). Cai further reports that the Porous WO3 material can switch states from transparent to opaque in 6 seconds (herein referred to as “switched off,”) and then from colorless back to transparent (“switched on”) in 2.7 seconds, compared to 6.9 s and 1.9 s for the Compact WO3 material. The present inventors note that while these switching times are roughly 2 orders of magnitude too slow for use in display technology (noting however that other electrochromic materials have been identified that for example switch at speeds closed to liquid crystals (LCD) and thus are approaching usability in displays,) such slower switching speeds are more than acceptable for the proposed uses in layers of color-changing specially coated articles as herein taught.

Referring still to FIG. 3I, and in particular the light gray solid and dashed curves representing the “Poruous WO3” electrochromic material, a careful review will show that the “transmittance modulation” of the herein “switchable window” achieves roughly 90% transmission across the green and red eye response (20-srg and 20-srr not shown, see e.g., FIGS. 3A and 3C) ranging from 500 nm to 650 nm, this is favorable as compared to the Reynolds' solution achieving 70% transmittance. Even in the higher frequency blue eye response (20-srb,) the Porous WO3 material reaches roughly 60% transmittance at the b1 band (445 nm) and then increases into the 90% and over levels in the lower frequencies such as green and red. However, for the present application, both materials from Reynolds (70% transmittance) and Cai Porous WO3 (60%-90%+transmittance) are sufficient, as well as many other well-known electrochromic materials of which Reynolds and Cai are merely representative. Hence, as a switchable window (see element 13-4b in 4E, 4F, 4H, and 4J, and see element 13-4c in FIG. 4K) these and other current and yet to be developed electrochromic materials are considered to be sufficient for accomplishing the present teachings for a color changing specially coated article.

Referring still to FIG. 3I, the electrochromic film/materials of Cai and Reynolds are typically referred to in the art as an “EC (electrochromic) layer” (b) (see bottom right of FIG. 3I,) where this layer further requires additional layers (a) “transparent conductor,” (c) “transparent ion conductor,” and (d) “counterelectrode.” It is well-known in the art that each of these layers (a), (c), and (d) as well as electrochromic “EC layer” (b) can be implemented with polymers and are therefore flexible and applicable beyond a traditional glass substrate (such as a house window,) and thus are applicable to the “any article” “any surface” herein taught for use with a special article coating.

Regarding a flexible “transparent conductor” layer (a), the interested reader is for example directed to an article entitled “Conductive plastic uses sandwiched materials for extra transparency,” interviewing lead researcher Jay Guo, published Jul. 7, 2020, in the New Atlas/Materials website. Regarding a flexible “transport ion conductor” layer (c), the interested reader is for example directed to the research article entitled “Highly Stretchable and Transparent Ionic Conductor with Hovel Hydrophobicity and Extreme Temperature Tolerance,” Shi, etc. al, published Mar. 19, 2020, in the journal Research. Regarding a flexible “counterelectrode” layer (d), the interested reader is for example directed to the research article entitled “Conducting Polymers as Cost Effective Counter Electrode Material in Dye-Sensitized Solar Cells,” Gunasekera, et. al, published Oct. 15, 2019, in Springer/Solar Energy.

Referring again exclusively to FIG. 3I, and now the performance of the Compact WO3 material, what is noted is the “UVA switchable window” (for example, for regulating the transmittance of at least one proposed narrow band of UVA energy labeled “u1”) that is anticipated herein and made possible from a reverse consideration of the Compact WO3 traditional functionality. Specifically, when the Compact WO3 material is switched “on,” typically for the purpose of transmitting a greater amount of visible light, a careful consideration of the present figure will show that the (dashed black) transmittance curve “red-shifts” (to the right) and thus blocks more of for example narrow UVA band u1. Conversely, when the Compact WO3 material is switched “off,” typically for the purpose of transmitting a lesser amount of visible light, a careful consideration of the present figure will show that the (solid black) transmittance curve “blue-shifts” (to the left) and thus transmits more of for example narrow UVA band u1. (To the left of the figure, this has been labeled as the “UVA (e.g., U1) ‘switchable window’.”)

Hence, a careful consideration will show that at least the Compact WO3 electrochromic material can be operated to switch between a substantially lesser to a substantially greater transmission of at least one narrow band (e.g., u1) of UVA light. As was prior discussed in relation to FIG. 3E, UVA light is well known for causing fluorescence in at least the visible spectrum, where this fluorescence is taught herein to either provide a colorization change to a specially coated article, or to enhance a colorization change (by augmenting the engineered reflection of visible light in free bands such as b2, g2, and r2). UVA is also known to be useful for causing phosphorescence, or the “glow-in-the-dark” effect, where UVA simulates a substances to continually emit light even after the stimulus UVA energy is removed (see discuss related to element 13-5nv in FIG. 4K).

Regarding the use of a herein taught switchable window using an electrochromic switchable film/material (see element 13-4b in 4E, 4F, 4H, and 4J, and especially for switching in non-visible UV light see element 13-4c in FIG. 4K) what can be seen is that the purpose of the window is to allow light to selectively transmit to a lower layer of a special article coating (such as layer 13-1ra of FIG. 4E, 13-3ar, 13-1ra of FIG. 4F, 13-5, 13-1ra of FIG. 4H, 13-5, 13-3ar, 13-1ra of FIG. 4J, and 13-5nv of FIG. 4K) to be operated upon and potentially retransmitted back through the window to a possible view to be perceived as a colorization. Another purpose of the electrochromic film/material is to provide for a base colorization when the window is closed (where the colorization is provided by the light absorbance spectral response of the film/material).

Those familiar with the broad-spectrum composition of sunlight (see sunlight spectral output 64-so in FIG. 5A) will also understand that any special coating including a UVA activated fluorescer or phosphorescer will substantially be “always activated” to fluoresce or phosphoresce, respectively, at least when exposed to sunlight, where a careful consideration of the present teachings will show that this is not a preferred effect. What is preferred and herein taught is a composite coating that can be controllably activated (using an electrochromic UV window such as 13-4c depicted in the present FIG. 3I and FIG. 4K) to cause for example non-visible light (such as UVA, or IR using window 13-4b) to fluoresce or phosphoresce into at least the visible spectrum causing an article colorization, where the article receives a wireless signal to a preferably article embedded powered switch 13-4s (see FIGS. 4E, 4F, 4H, 4J, and 4K) for activating and deactivating the electrochromic window and therefore the transmittance of the non-visible light for then causing the activation of fluorescence and phosphorescence. It is noted that switching these non-visible windows 13-4c, 13-4b to the not-transmitting mode of operation will substantially prohibit sunlight from activating any lower layer fluorescer or phosphorescer, all as will be understood by those familiar with the necessary arts and a careful considerations of the teaching provided herein.

In at least one use case example, a material that includes either of a fluorescer layer (element 13-5 in FIGS. 4H and 4J) or non-visible fluorescer/phosphorescent layer (element 13-5nv in FIG. 4K) that is situated “underneath” an electrochromic switchable window 13-4b or 13-4c, respectively,) can be controllably caused by the present invention to be substantially inactive (i.e., not fluorescing or not phosphorescing, respectively) when the article is determined to for example be in the presence of sunlight (such as a toy wand 12 in FIG. 1B being carried about outdoors in a theme park).

In order to cause the otherwise normally sunlight activated fluorescent layer 13-5 or phosphorescent layer 13-5 to remain inactivated, the present system transmits a “close window” wireless signal to window switch 13-4s embedded within the article, where switch 13-4s then employs preferably ambient harvested or otherwise stored energy (e.g., an embedded battery) to cause the necessary window 13-4b or 13-4c, respectively, to return to or maintain a “substantially absorptive”/block, colored (non-transmissive) state. Alternatively, when indoors, or otherwise preferably under the primary illumination of an engineered light source such as 63-2 of FIG. 6A, where the engineered light source 63-2 is capable of emitting non-visible energy such as UVA and IR, the present system transmits an “open window” wireless signal to window switch 13-4s, where switch 13-4s then employs preferably ambient harvested or otherwise stored energy to cause the necessary window 13-4b or 13-4c, respectively, to return to or maintain a “substantially transmission”/transparent state. Thus, the present invention teaches a special article coating capable of working in combination with an engineered light source to controllably fluoresce or phosphoresce in response to visible or non-visible energy, where this control is be especially useful in combination with an interactive gaming system for essentially triggering the article coating fluorescence or phosphorescence based at least in part upon a determined game state.

In a more detailed second exemplary use case, a gamer at a theme park is playing a park-wide interactive game and has accumulated sufficient points to earn a reward. Using these points, the gamer is able to for example hold or place their article (such as toy wand 12) in either an open location (such as a hotel room) or closed location (such as within a “magic box” with lid,) where once within the location that is primarily illuminated by an engineered light source or otherwise any light source capable of emitting the necessary non-visible “excitation”/activation energies, the system provides a wireless signal to open a UVA window 13-4c of FIG. 4K to expose phosphors in a phosphorescent layer 13-5 to the UVA energies emitted by the light source such as 63-2 of FIG. 6A, where the UVA energies are sufficient for causing visible light phosphorescence of the article (a glow-in-the-dark effect) that might last for minutes to hours or more. Many other alternative use cases will be obvious to those skilled in the art of gaming, theme parks, and other types of destinations where especially physical virtual “PV” games can be implemented.

Referring next collectively to FIGS. 3J, 3K, and 3L, there is shown a PRIOR ART 3-color e-ink/“electrophoretic” material (also known generically as “e-paper”) for use as an absorptive (black)/reflective (white, colored) layer 13-4a preferably as a bottom layer within a specially engineered coating 12g-3 (see FIG. 4D). Those familiar with electrophoretic displays will understand that they can be made to be flexible and formed to a flat or contoured surface. With respect to the present invention, what is important is electrophoretic layer 13-4a can be switched using low power to alternate for example between black, white and red (where it is understood that the present invention should not be limited to a 3-color electrophoretic material, as a 2-color/blank-white material is also widely available, as well a newer multi-color materials, all any variation of which can accomplish at least some of the key goals taught for layer 13-4a). In any case, by switching the current (opaque) color (such as black, white, red, or other) of layer 13-4a, this switchable layer 13-4a then acts to absorb or reflect any light impinging upon it as a means of then changing the color (i.e., actively colorizing) the article (such as wand 12) using the specialized coating. (Note that the switching is accomplished preferably using an embedded switch 13-4s with embedded or harvested power, all as prior discussed in relation to FIG. 3I.)

Any of the internal “balls” or “particles” used within the electrophoretic material, such as the larger “negatively charged red pigment” shown in PRIOR ART FIG. 3J, can be further adapted to use a specialized coating as taught herein, such as tri-color-bands absorber/tri-color-bands reflector/fluorescer 12g (see FIG. 3K and FIGS. 4A through FIG. 4K). Those familiar with a traditional 3-color e-ink display will understand that they typically comprise the colors of black, white, and red, where the color red is shown in this PRIOR ART diagram of FIG. 3J to be the larger particles floating above the smaller black particles and below the smaller white particles. The functioning of electrophoretic displays is well-known in the art, and as such will not be discussed in detail herein. What the careful reader will understand, is that by for example coating these depicted “negatively charged red pigment” particles with a coating 12g, it is then possible to cause these “12g” particles to rise to the surface of the material/layer 13-4a, whereby the coating 12g will then interact with an engineered light source 63 so as to cause dynamic colorization changes as the configuration of frequencies emitted by source 63 is changed, thus changing the color of the specially coated article without requiring any additional changes to the arrangement of the charged particles (such as black, white, and colored 12g particles).

In yet another variation of the traditional PRIOR ART electrophoretic display (either 2-color, 3-color, or multi-color,) any of the particles is switched from the traditional fully-coated particle (i.e., the entire outer surface is a color such as black, white, or red,) to what is known in the art as a microsphere retroreflector 9-1. The construction and operation of microsphere retroreflectors 9-1 are well-known, and as such will not be further addressed herein, suffice it to say that a microsphere retroreflector (or a “cube-corner” retroreflector that can also use with the herein taught coating 12g and engineered light source 63) is useful for returning a greater amount of impinging light back in the direction it was received (i.e., “retroreflecting,”) as opposed to diffusely reflecting the impinging light, for which there are many uses.

Referring specifically to FIG. 3L, the traditional microsphere retroreflector 9-1 comprises a reflective coating over a portion of its outer surface, where this reflective coating is traditionally a broadband reflector (“mirror”) often comprising a metal such as aluminum. The present invention anticipates a novel electrophoretic material or display wherein at least one of the balls/particles is a traditional microsphere retroreflector 9-1, as well as a further adapted electrophoretic material or display where the at least one microsphere retroreflector 9-1 is further coated with a tri-color-bands absorbing top layer 13-3a, in combination forming microsphere retroreflector 9-2. In a first use case where the traditional electrophoretic material/display for example replaces the traditional “negatively charged red pigment” particles with traditional “broadband” microsphere retroreflectors 9-1, it is possible for example to switch the material between a first state of “black and white” (e.g., used in a daylight digital signage at a highway intersection) and a second state of “black and retroreflective” (e.g., now allowing the digital signage to be “lit” by the headlamps of on-coming cars and creating a brighter nighttime reflection, all as will be well understood by those familiar with the use of retroreflectors especially in roadway applications,) or even some combination thereof such as “black and partial-white/partial-retroreflective.”

In a second use case where the traditional electrophoretic material/display for example replaces the traditional “negatively charged red pigment” particles with further adapted “specially coated” microsphere retroreflectors 9-2, it is possible to make a traditional tablet or smartphone display that uses the special formulation of an engineered coating for any of: 1) limiting the reflected frequencies of traditional ambient light, such as sunlight, where the limitation of reflection for example includes the absorption of frequencies centered between the peak blue and peak green absorption of the human vision system, and/or between the peak green and the peak red absorption of the human vision system, which absorption is known to improve color readability at least for color blind individuals (see for example FIGS. 8A, 8B, 12, 13, and 14 of U.S. Pat. No. 11,204,455 entitled SPECTRALLY SCULPTED MULTIPLE NARROWBAND FILTRATION FOR IMPROVED HUMAN VISION, issued Dec. 21, 2021,) or 2) limiting the reflected frequencies of an engineered light 63, where the limitation of reflection for example includes the reflecting of free-bands such as b2, g2, and r2, and the absorption of lock-bands such as b1, g1, and r1, or any alternative combination of bands as taught herein or otherwise as anticipated herein, and including any of the operations on light not limited to reflection and absorption but at least also including fluorescence and phosphorescence.

It is noted that both the traditional PRIOR ART electrophoretic materials, and the further adapted electrophoretic materials taught herein, are usable in any of coatings 12g as taught herein, preferably as an electronically switchable bottom layer/broadband absorber or reflector, and specifically as discussed in relation to coating 12g-3 of FIG. 4D. As such, both of use cases 1 and 2 described above are applicable to the anticipated specially coated articles of the present invention, for example the specially coated articles may support improved vision for at least the colorblind, and/or exhibit color “changeability” when used with an engineered light source 63. The many advantages of the use of electrophoretic layer 13-4a will be apparent based upon a careful reading of the present application, especially in consideration of the use in surface coatings for virtually any article to be then viewable under an engineered light source 63.

Referring next and collectively to FIG. 4A depicting general coating 12g, and FIGS. 4B through 4K depicting variations of 12g including 12g-1 through 12g-10 (respectively,) each of the coatings 12g-1 through 12g-10 comprise one or more layers of substances for operating on light, where operating is herein used to refer to any and all light-substance interactions including reflecting/scatting, absorbing, fluorescing, phosphorescing, and transmitting. Layers are depicted conceptually, where it is not the purpose of the present invention to teach specific chemical formulations of substrates and substances comprising any given layer, but rather to teach how any number of formulations comprising a given layer, already well known in the art of coatings, or the construction of which would be well understood by those familiar with the art of coatings and substances, can provide one or more narrow frequency bands of operation on light, and then further how “lower” layers (such as 13-1r of FIG. 4B) can add additional operations on light with respect to any light transmitted by an “upper” layer (such as 13-3a of FIG. 4B).

It is even shown how an upper layer (such as 13-4a of FIG. 4D, 13-4b of FIGS. 4E, 4F, 4H, and 4J, or 13-4c of FIG. 4K) can have switchable operations on light, for example switching from broadband absorptive (black) to broadband reflective (white) such as when using electrophoretic material 13-4a, or switching from broadband substantially absorptive (black) to broadband substantially transmissive (transparent) such as when using electrochromic material 13-4b, where when layer 13-4b is operating as mainly transmissive, the upper layer 13-4b then enables a lower layer (such as 13-1ra of FIGS. 4E, 4F, 4H, and 4J, 13-3ar of FIGS. 4F and 4J, and/or 13-5 of FIGS. 4H and 4J) to contribute operations to the overall spectral response of the coating. In this sense, any given coating comprising at least one switchable layer (such 13-4a, 13-4b, or 13-4c—see FIG. 4K) can have two or more distinct coating spectral responses based upon the state of any of its one or more switchable layers.

What will also be understood by those familiar with coatings is that although these many taught and various “layers,” comprising variations of general coating 12g, are depicted as being in some sense separately created, constructed, and/or applied onto each other (e.g., in FIG. 4B broadband reflecting lower layer 13-1r is applied to (imbued within) an article surface first, after which optional surface smoothing layer 13-2 is then applied to lower layer 13-1r, and finally upper tri-color bands absorbing layer 13-3a is then applied to mid-layer 13-2, or optionally to bottom layer 13-1r,) there is no requirement in the present invention that limits any of the layers explicitly taught or implied by the teachings from being created/constructed and/or then applied as a single layer or combination layer, all as will be understood by those familiar with substances and formulations of appliques.

What is important to see is that the depicted layers teach light operations that individually and in combination with other layer(s), however created/constructed or applied, provide for coatings with a desired switchable or non-switchable spectral response, where a careful reading of the present invention will show that it is the constructed spectral response, preferably comprising one-or-more narrow bands of light operation, that when combined with controllably adjusted engineered light emitted in one-or-more narrow bands, where the emitted narrow band(s) are either corresponding or not corresponding (in terms of center/peak frequencies) to a narrow band(s) of light operation constructed in a coating, can be used to alter a person's perception of the current color of a coated article 12 (or any surface).

Referring next to FIG. 4A, there is shown generic special coating 12g for application onto virtually any surface (i.e., “any article,”) where coating 12g is engineered to operate upon light being emitted from an engineered light source 63, such that changes in the emitted frequencies of source 63 cause the perception of color changes in the coating 12g (hence discernible changes in the light being reflected off the specially coated article) while simultaneously not causing a substantial (or at least undesirable or otherwise unacceptable) perception of color change for either the light being emitted by source 63, or for other surfaces (therefore the light reflecting off other surfaces) that have not been coated with a special coating 12g (e.g., clothing and skin).

The preferred coating 12g comprises at least three narrow bands of spectral response, at least one spectral response for each of the three primary colors blue, green, and red perceived by the human vision system, where the at least one response is caused by one or more substances and/or materials for effectively operating upon the light emitted by the engineered source 63, such as by absorbing the light, thusly named “tri-color-bands absorbing.” Alternatively, or additionally, the preferred coating 12g performs the operations of “tri-color-bands reflecting and/or fluorescing” and as such the coating 12g works by any combination of well-known light operations including absorption, reflecting, and fluorescing as well as phosphorescing and transmitting, such that the current spectrum of light being emitted by the engineered light source 63, for example appearing white in color, is altered by any of these coating 12g light operations so that the coating appears to substantially change its colorization controllably corresponding to the light emitted by the source 63.

Although preferred as the minimum composition for providing the maximum potential in colorization changes, coating 12g is not meant to be limited to “tri-color-bands” (accomplished by any combination of light operations) as a coating 12g could alternatively comprise less or more than 3 bands of spectral responses caused by substances for operating across the spectrum of light emitted by the engineered light source 63. For example, a single-narrow-band coating could substantially absorb g1 while substantially transmitting all other light (thus including g2,) where then this all other transmitted light (including g2) is then reflected by a bottom layer broadband reflector. As a careful consideration will show, this “single-band” absorber can operate with an engineered light source 63 emitting at least dual-band g1/g2 engineered light to either cause a coating 12g colorization appearing to include green by emitting g2 light from the source 63, or appearing to not include green by emitting g1 light from the source 63, where this exemplary single-band coating 12g then reflects g2 and absorbs g1, all as should be clear from a careful reading of the invention thus far.

A dual-band coating 12g might comprise a fluorescent substance that absorbs uv1 and then fluoresces a green such as g2, while also absorbing g2. In operation, if an engineered light source 63 is only emitting green light as g2, (and not also emitting uv1,) then this exemplary dual-band coating 12g appears to not include any green colorization, whereas when the light source does then emit uv1 (either still or no longer emitting g2,) then the exemplary dual-band coating 12g appears to include a green colorization. Many other possibilities exit, as will be clear from a careful reading and consideration of the present teachings including the discussions of upcoming FIGS. 4B through 4K, as well as FIGS. 5A through 5D, and FIG. 6A, and as such the present invention should not be limited to any of the specific examples of coating configurations taught herein, but rather to the scope of possibilities enabled by the general principles taught herein using the specific examples.

Referring next to FIG. 4B, there is shown a first variation 12g-1 of generic special coating 12g, where variation coating 12g-1 comprises for example three layers starting with bottom broadband reflecting layer 13-1r, followed by optional surface smoothing transparent layer 13-2, followed by top tri-color-bands absorbing layer 13-3a. The bottom broadband reflecting layer 13-1r is substantially white in colorization, therefore reflecting at least substantially all of the visible frequencies that transmit through upper layers 13-2 and 13-3a. This reflecting layer 13-1r may or may not include broadband reflecting of the non-visible spectrum including UV and IR light.

Optional surface smoothing layer 13-2 for example comprises a nano-particle coating such as such as sold by NEI Corporation under the name of “Nanomyte” abrasion resistant coatings. Of particular interest is the ability of the Nanomyte coating to smooth out the surface to which it is applied, and being transparent, thus forming a smooth surface for the application of a next layer without otherwise altering any of the light operations of either the applied-on layer (below) or the applied-to layer (above). Those familiar with nanoparticle substances, for example as discussed herein for use as narrow-band absorbers or reflectors/scatterers, will appreciate that the performance of the applied nanoparticle substances is potentially degraded when the applied-to surface is rough and otherwise optically non-uniform. The Nanomyte coating is representative, and other transparent smoothing coatings are available and are anticipated to become available, as such the present invention should not be limited to only this Nanomyte material for use as an optional surface smoothing layer 13-2, as other solutions are anticipated and fall within the present scope. It is also noted (although not depicted) that it can be beneficial to also apply a transparent smoothing layer 13-2 to any of the uppermost layers in any of the coating variations 12-g1 through 12-g10, where benefits also include abrasion resistance, and when combined with a UV absorber, such an outer protective layer has advantages for slowing the degradation of certain substances used in lower layers such as dyes that are more prone to what is known as “color fading” due to extended exposure to the sunlight/UV radiation. For the remainder discussion of variation coatings with respect to FIG. 4C through FIG. 4K, the description of layer 13-2 will not be repeated.

Still referring to FIG. 4B, uppermost tri-color-bands absorbing layer 13-3a for example includes one or more dyes (such as discussed in relation to FIG. 3A, 3B, 3C, or 3D,) or any other substances such as pigments or nanoparticles that provide the desired spectral response, where many dyes, pigments, and nanoparticles are available for consideration. What is preferred is that for each of the spectral responses of the human vision system, namely blue 20-srb, green 20-srg, and red 20-srr (see for discussion FIG. 3A,) layer 13-3a comprises at least one substance of any type such as a dye, pigment, or nanoparticle, that absorbs a preferably narrow range of frequencies (a “band”/“narrow band”) comprising the spectral range of a given eye response 20-srb, 20-srg, and 20-srr, where each spectral range blue, green, and red could employ the same or different types of substances. It is noted that the preferred FWHM for any given absorption substance is less than 50 nm, and/or at least with a spectral response shape that has at least one sharper/steeper slope on either side of the peak frequency, where a careful consideration of this steeper slope will show that it is then possible to emit a narrow band of light on the side of this steeper slope that is closer to the peak frequency without causing substantial absorption.

For example, in reference to FIG. 3C, compare the absorption curve of dye VIS441A (in the blue range 20-srb) to that of dye VIS603A (in the red rang 20-srr,) and note that VIS441A has a steeper slope to the right of the center peak frequency of 441 nm, as compared to the more protracted slopes of the VIS603A response centered at 603 nm. In practice, this allows for example narrowband light b2 centered at 465 nm (within 20 nm of VIS441A dye peak response at 441 nm) to be minimally absorbed and therefore maximally reflected, whereas narrowband light r2 centered at 635 nm (within 20 nm of VIS603A dye peak response at 603A) is more substantially absorbed and therefore less maximally reflected.

As prior discussed, although many of the exemplary teachings herein provided assume the use of emitted pairs of narrow bands per each eye-response color blue, green, and red, such as b1-b2, g1-g2, and r1-r2 shown in FIG. 3C, where these band-pairs are centered within 20 nm of each other and thus less likely to be perceived as different colors by the human vision system, it is possible to implement essentially a first “locked” band such as b1 that comprises a narrower FWHM and is more centrally aligned to the absorbing substance (such as VIS441A,) and to offset this with a second “free” band such as b2 that comprises a wider FWHM, even a FWHM that straddles the locked band spanning for example more of the entire range of the eye's spectral response for the given color (in this case blue). Alternatively, for a given locked band such as exemplary b1, it is possible to have two or more free bands, such as b2 and b3, that together “combine” or “add” for the human vision system to create the perception of the substantially the same color as b1.

There is also no requirement herein that the “combining” bands (two or more) be limited to frequencies within the given color's human eye spectral response, such as 20-srb in the case of blue. What is preferred, is that the engineered light source has two sets of light emitters for causing the human vision system to perceive each of the blue, green, red colors associated with receptors of the human eye, where each set comprises one or more light sources such as a laser or LED, where a person looking at the engineered light cannot perceive a substantial difference between the color or brightness of either set (hence both sets when emitting independent of each other appear to be substantially the same color and brightness,) and where one set emits frequencies that are more substantially absorbed, reflected, fluoresced, or phosphoresced by the special coating 12g (or any of its many possible variations such as 12-g1 through 12-g10) than frequencies emitted by the other set.

Referring next to FIG. 4C, bottom broadband reflecting layer 13-1r is replaced in variation coating 12g-2 with a broadband absorbing layer 13-1a, while top tri-color-bands absorbing layer 13-3a is replaced with top tri-color-bands reflecting layer 13-3r, and where middle optional surface smoothing layer 13-2 remains the same. A careful consideration will show that the basic principles are the same between variation coatings 12g-1 and 12g-2, and that what is mostly different is that the perceived color of a surface/article will be white/lighter for coating 12g-1 and black/darker for coating 12g-2. Those familiar with the spectral properties of substances will also recognize that some substances such as dyes tend to be best as absorbers while other substances such as nanoparticles can be good choices for narrowband reflectors/scatterers.

Referring next to FIG. 4D, the bottom layer of coating variation 12g-3 comprising an electrophoretic material 13-4a as discussed in relation to FIGS. 3J, 3K and 3L, where material 13-4a can be switched based upon signals from embedded, wirelessly powered switch 13-4s between functioning as 1) a substantially broadband absorptive (black) material (therefore acting like broadband absorbing layer 13-1a,) and 2) a substantially broadband reflective (white, or a limited color) material (therefore acting like broadband reflecting layer 13-1r). Furthermore, it is possible to combine absorbing substances with reflecting/scattering substances to implement a combined tri-color-bands absorbing and/or reflecting layer 13-3ar (thus including functions of either or both tri-color-bands absorbing layer 13-3a and tri-color-bands reflecting layer 13-3r,) and where middle optional surface smoothing layer 13-2 remains the same. A careful consideration will show that the basic principles are the same between passive variation coatings 12g-1 (appearing white/lighter) and 12g-2 (appearing black/darker) and active coating 12g-3 that can be electronically transitioned between these two white/black states.

Referring next to FIG. 4E, in yet a different variation coating 12g-4, the bottom layer 13-1ra implements any of a broadband reflecting and/or absorbing function (where a careful consideration will show that a combination of partial reflection and partial absorption across the visible spectrum will be perceived as a color,) where unlike coating 12g-3 and bottom layer 13-4a, this bottom layer 13-1ra is passive and cannot therefore be switched from a first set of substantially absorbing to a second state of substantially reflecting. However, a careful understanding of the teachings related to exemplary variation coatings 12g-1 through 12g-10 will show, addition variations are possible such as replacing the current coating 12g-4 passive bottom layer 13-1ra with the active bottom layer 13-4a for coating 12g-3, and as such the present exemplary coating 12g-1 through 12g-10 should not be considered as limiting, but rather as teaching core principals for combining both passive and/or active layers of light operating substances and materials, even combining any of these layers where technically possible but still providing the anticipated functions.

Still referring to FIG. 4E, top passive tri-color-bands absorbing and/or reflecting layer 13-3ar is the same as depicted in FIG. 4D, as is optional transparent surface smoothing layer 13-2 (now optionally used twice). What is mostly different about variation coating 12g-4 is the insertion of a third “light operation layer,” in this case electrochromic material layer 13-4b (see FIG. 3I) that is capable of being electronically (actively) switched between the states of substantially absorptive (black, colored) and substantially transmissive (transparent).

The colorization changing possibilities of coating 12g-4 are significant, where for example the top layer 13-3ar comprises tri-color-band absorbing dyes such as discussed in relation to FIGS. 3C and 3D, thus allowing for color variations when combined with the selective emissions of a light source 63, where then layer 13-3ar transmits any emissions of source 63 that are not absorbed by the narrow tri-color bands in 13-3ar. This transmitted spectral output from source 63 is either then substantially absorbed appearing as black or partially absorbed and reflected, appearing as some color, when layer 13-4b is being operated in its “non-transmissive” mode, or are further substantially transmitted through layer 13-4b to reach bottom layer 13-1ra for then being more fully absorbed or reflected, when layer 13-4b is being operated in its “transmissive” mode, thus allowing for additional color variations under the control switch 13-4s, all as will be understood by a careful reading of the present invention and by those familiar with coatings in general and electrochromic materials in particular.

Referring next to FIG. 4F, a careful comparison with FIG. 4E will show that coating 12g-5 has the same layers as coating 12g-4, where essentially the middle and top “light operating layers” have been transposed (note that the optional surface smoothing layers are not considered to be “light operating layers”). A further consideration will show that coating 12g-5 thus has the active ability to be essentially “responsive to color variation” by light source 63 when top layer 13-4b is operating in the “transparent” mode (thus light source 63 emissions are substantially transmitted to the middle tri-color-bands layer 13-3ar,) or to be essentially “non-responsive to variation” by light source 63 when top layer 13-4b is operating in the “non-transparent” mode (thus light source 63 emissions are substantially block from reaching the middle tri-color-bands layer 13-3ar).

Referring next to FIG. 4G, coating 12g-6 is comparable to coating 12g-2 of FIG. 4C, where tri-color-bands reflecting layer 13-3r of 12g-2 creates color variations by operating to reflect variously emitted narrow bands of spectral output from source 63, and tri-color-bands fluorescing layer 13-5 of coating 12g-6 creates color variations by alternatively first absorbing various spectral output from source 63 and then second fluorescing a color in the visible spectrum, thus resulting in a somewhat similar “reflect/fluoresce” vs. absorb light operation response.

Like coating 12g-2, coating 12g-6 then also comprises a bottom layer 13-1ra for providing a “base colorization” (that essentially does not substantially vary with the varying emission of light source 63) by operating in a substantially broadband (or at least “broader-band”) manner to perform any combination of desired reflecting and/or absorbing (where this layer 13-1ra is capable of implementing any of the functions of a broadband reflecting layer 13-1r of coating 12g-1, or the functions of a broadband absorbing layer 13-1a of coating 12g-2).

Just as bottom layer 13-1ra essentially represents the combination of the possible functions of layers 13-1r and 13-1a, it should also be understood that a reflecting/fluorescing tri-color-bands layer combining fluorescing layer 13-5 and reflecting layer 13-3r is also possible (although not depicted in any of coatings 12g-1 through 12g-10, thus again demonstrating the instructive but not limiting nature of the present teachings). And finally, fluorescing layer 13-5 can be constructed to absorb in any of visible or non-visible frequency bands and then preferably (but not limited to) fluorescing in the visible spectrum to affect the perceived colonization of the coating 12g-6, where fluorescing in the non-visible spectrum is also useful for assisting in what is referred to as object tracking via image analysis (see especially upcoming FIGS. 8A, 8B, and 8C).

Referring next to FIG. 4H, a careful comparison will show that coating 12g-7 of the present figure is like coating 12g-6 of FIG. 4G with an additional third/top layer comprising electrochromic material 13-4b like the top layer of coating 12g-5 in FIG. 4F. In another comparison, coating 12g-7 is like coating 12g-5, except that the middle layer is a tri-color-bands fluorescing layer 13-5, rather than a tri-color-bands absorbing and/or reflecting layer 13-3ar as included with coating 12g-5. As prior mentioned in relation to coating 12g-6 of FIG. 4G, the present invention anticipates many coating variations not specifically taught as coatings 12g-1 through 12g-10, such as a new coating similar to 12g-7, where the middle layer performs for example some combination of light operations including absorbing, reflecting, fluorescing, and transmitting, even phosphorescing (see coating 12g-10,) where these operations preferably act each of the three color ranges blue, green, and red, and are thus “tri-color-bands” (preferably narrow-bands,) where it is also then understood that while tri-color-bands is preferred, the color changing aspects with respect to a engineered light source 63 are possible even with a single-color-band or a dual-color-band, etc.

Still referring to FIG. 4H, electrochromic layer 13-4b can actively switch states under the control of embedded switch 13-4s between substantially absorptive (thus appearing black or at least colored) to substantially transmissive (thus transparent), where substantially at least refers to an amount of absorption vs. transmission, such as 90% absorptive and 10% transmissive, or 30% absorptive and 70% transmissive, depending upon the mode, and where it is understood that these properties will realistically vary across the non-visible and visible portions of the spectrum. Thus, a preferred electrochromic material for use in layer 13-4b can be selected based upon its absorption vs. transmission “window” that is optimized for UV, visible, some portion of visible, or IR energy, or any combination thereof, where different materials have different performance and new materials are anticipated.

Referring next to FIG. 4I, there is shown coating 12g-8 that is like coating 12g-6 of FIG. 4G with a middle tri-color-bands absorbing and/or reflecting layer added, such that the combination of fluorescing top layer 13-5 and absorbing/reflecting middle layer 13-3ar represent a possible combination of absorbing/reflecting/fluorescing/transmitting/(and even phosphorescing) as discussed above, where it should then be understood that it is also possible to reverse the ordering of the top and middle layers, or even to combine the two layers, as well as some other mixes of operations and layers as may be considered as preferred with respect to manufacturing and/or performance.

Referring next to FIG. 4J, coating 12g-9 is like coating 12-g8 with a top electrochromic layer 13-4b added, where again the specific material selected for use as the electrochromic layer is ideally suited to the frequencies selected for at least the fluorescing layer 13-5 (e.g., top layer 13-4b acts as more substantially a switchable UV window with some visible light switching, or more substantially as a switchable visible light window with some UV and/or IR switching).

Referring next to FIG. 4K, coating 12g-10 is representative of the concept of how the any of the layers comprising individual coatings 12g-1 through 12g-9 can be considered in any combination as themselves limited combinations for application onto a surface and or some other limited combination (collectively referred to in the present figure as “optional other layers.”) Furthermore, UV window electrochromic material layer 13-4c is representative of how any particular layer that operates across a larger portion of the spectrum (ranging from UV through visible into IR,) can be limited to instead substantially operate on a lesser portion of the spectrum, in this case where layer 13-4c acts specifically as a UVA window (see FIG. 3I for more discussion) as opposed to a more expansive visible light window as possible using any electrochromic material such as in a layer 13-4b.

Referring now collectively to FIGS. 4A through 4K, it is again emphasized that these variation combinations of layers are exemplary, where it will be obvious based upon a careful consideration of the taught purposes and goals of the present “special coatings” that many other variations are possible, where any variation preferably interacts with (i.e., performs “light operations upon”) light emitted from an “engineered light source” so as to create the perception that the coating is changing in colorization as the light source varies its spectral output, while at the same time the light source is perceived as not substantially changing in colorization and brightness.

Referring next to specifically to FIGS. 5A, 5B, 5C, 5D, 6A, 8B, 8C, 9A, 9B, and 11, each of these figures either directly depicts an “article” 12, as a toy wand 12, or in the case of FIG. 8C refers in a table to “Article . . . surface” and “Article . . . marker.” The word article is broadly used herein as referring to any object, a toy wand 12 being an example, but then even more broadly as any surface, where a special coating 12 can be applied to virtually any surface, thus making the article/surface a potential color changing surface when being illuminated by an engineered light source. The “any surface” does not need to be a movable surface, but for example could be a wall, and could be any material including plastic, wood, metal, and even fabrics. For these specific figures and their teachings, the article 12, represented as an exemplary toy wand 12, should be understood to comprise a special coating 12, in any of its variations 12g-1 through 12g-10, or any other variations that will be obvious from a careful consideration of the present teachings. It is also noted that in FIGS. 5A through 5D, a white piece of paper 11 that does not comprise a special coating 12g and is a broadband reflector is being used as a means of comparison with the article 12.

Referring now exclusively to FIGS. 5A, at the top of FIG. 5A there is shown a chart of the “representative solar spectrum” available in the public domain depicting the spectral output 64-so of the sun, where as those familiar with light sources in general and the output of the sun in particular will understand, the output 64-so is “broadband” and comprises emission across the entire spectrum from UV through visible light and lower in frequency through NIR/IR light. Overlaid onto spectral output 64-so is the chart of the spectral response of the human vision system as depicted for example in FIG. 3A, where a person 20 perceives this broadband sunlight 64-so as white perceived light 2o-pl-1.

Still referring to FIG. 5A, when broadband white light spectral output 64-so reflects of a substantially white/broadband reflecting surface, such as a piece of white paper 11, a person 20 perceives this reflection as also substantially broadband white perceived light 2o-pl-2, where it should be understood that the perceived brightness of 2o-pl-2 is significantly less than the perceived brightness of 2o-pl-1. Furthermore, when looking at an article 12 comprising a preferred tri-color-bands absorbing and/or reflecting and/or fluorescing coating 12g (in any of its many possible variations,) what is preferred for coating 12g in some use cases is that the reflection off article 12 is a combination of blue, green, and red and thus also perceived as substantially white perceived light 2o-pl-3, where a careful consideration will also show that the perceived brightness of light 2o-pl-3 is less than 2o-pl-2 (at least because as depicted some of the spectral output 64-so represented as narrow locked bands b1, g1, and r1 while being reflected off white paper 11 is substantially absorbed by article 12, thus reducing the brightness of article 12 as compared to paper 11).

Referring now to FIG. 5b, in comparison to broadband spectral output 64-so, at the bottom of FIG. 5B there is shown spectral output 63-so-1 that represents the emissions of an engineered light source 63 comprising for example at least the narrow tri-color bands of b1, b2, g1, g2, r1, and r2, where in FIG. 5B individual light sources (such as LEDs or lasers) for emitting free bands b2, g2, and r2 are “turned on” and emitting while individual lights sources for locked bands b1, g1, and r1 are “turned off” and not emitting, where this emitted b2, g2, r2 free light is perceived by person 20 as white perceived light 2o-pl-4. As will be clear to a person familiar with light sources, the perception 2o-pl-4 of engineered light source 63 spectral output 63-so-1 while being substantially white light will also be significantly less bright than the perception 2o-pl-1 of sunlight 64-so. Spectral output 63-so-1 comprising free tri-color bands b2, g2, and r2 reflecting off white paper 11 (a broadband reflector) will be perceived as substantially white light 2o-pl-5, and reflecting off white article 12 (operating in net as a tri-color-narrowband reflector) will also be perceived as substantially white light, in this case 2o-pl-6.

A careful consideration of FIG. 5B with sole illumination being engineered light source 63 currently emitting spectral output 63-so-1 comprising only the three tri-color free narrow bands b2, g2, and r2, as compared to FIG. 5A with sole illumination being the sun emitting broadband spectral output 64-so, a person 20 will perceive the whiteness and brightness of paper 11 (thus 2o-pl-5) and article 12 (thus 2o-pl-6) to be substantially the same in the arrangement of FIG. 5B, whereas in the arrangement of FIG. 5A the brightness of article 11 (thus 2o-pl-2) will be perceived as at least 2× the brightness of article 12 (thus 2o-pl-3). Furthermore, this perceived brightness of for example paper 11 in the arrangement of FIG. 5B (thus 2o-pl-5) is expected to be at most 50% of the perceived brightness of the arrangement of FIG. 5A (thus 2o-pl-2,) based upon the additional portions of the visible spectrum being emitted by the sun beyond the narrow bands b2, g2, and r2, let alone the substantially increased luminance of the sun assuming direct lighting, all as will be understood by those familiar with light sources and the human vision system.

Referring next to the combination of FIG. 5C and FIG. 5D, both figures portray an engineered light source 63-1 capable of emitting combinations of tri-color narrowband spectral output (e.g., as emitted by a combination of emitters such as LEDs, lasers as taught in the PRIOR ART projectors mentioned in FIG. 2B, or broader spectrum emitters of light which are then filtered using well-known light filtering films and coatings into one or more narrow bands,) where these narrow bands for example comprise b1, b2, g1, g2, r1, and r2 as prior discussed. It is noted that in FIG. 5C, light source 63-1 is operated to emit spectral output 63-1-so2 combining all narrow free bands b2, g2, and r2, as well as locked bands b1, g1, and r1, whereas in FIG. 5D, light source 63-1 is alternately operated to emit spectral output 63-1-so3 that is limited to two of the locked bands b1 and g1, as well as one of the free bands r2.

In both FIGS. 5C and 5D, these emissions 63-1-so2 and 63-1-so3 are portrayed as dashed lines, where the emissions 63-1-so2 of all six bands in FIG. 5C are portrayed with thinner dashed lines indicative of a lesser emitted luminance, while the emission 63-1-so3 of FIG. 5D are portrayed with thicker dashed lines indicative of a greater emitted luminance (see especially FIG. 3G for more discussion,) and where as prior discussed the objective is that an observer 20 looking at light source 63-1 as operated in FIG. 5C perceives white light 2o-pl-7 to be substantially the same colorization (in this example “white”) and brightness as when looking at the same light source 63-1 as operated in FIG. 5D perceived as white light 2o-pl-8. (As prior discussed, the light source 63-1 and its depicted narrow bands of emission b1, b2, g1, g2, r1, and r2 are exemplary, and that in practice as taught herein, additional narrow free-bands and narrow locked-bands can be added for many purposes including accomplishing the goal of “light balancing” such that a person 20 perceives light 2o-pl-7 to be substantially the same colorization and brightness as light 2o-pl-8, and/or accomplishing the goal of controllably manipulating the perceived article 12 colorizations, as prior discussed and to be discussed more shortly.

In each of FIGS. 5C and 5D, there is shown both a piece of white paper 11 that is at least a visible light broadband reflector, and a specially coated article 12 such as a toy wand, that is coated according to the teachings provided herein and for example comprising any variation of coatings 12g-1 through 12g-10 and as such is not a visible light broadband reflector. Conceptually speaking, in FIG. 5C the emissions of blue narrow bands b1 and b2 are combinable in luminance to be perceived as the same luminance of emission b1 in FIG. 5D, where the actual amounts of emitted luminance per any given band are in practice dependent upon multiple well-understood factors and may not necessary be equal (e.g., see FIG. 3F). What is preferred is that a person 20 perceives substantially the same colorization (blue) and brightness (a function of luminance) when looking at the light source 63-1 as operated in FIG. 5C (thus 2o-pl-7) as in FIG. 5D (thus 2o-pl-10).

A careful consideration of FIG. 5C based upon the teachings provided herein will show that it is possible to apply a special coating 12g to article 12, to for example substantially absorb all locked bands b1, g1, and r1, such that this locked-band luminance emitted by source 63-1 is not substantially reflected off article 12 and thus not substantially perceived within perceived light 2o-pl-9. Conversely, it is also possible that the same special coating 12g does substantially reflect or fluoresce (in any combination of light operations) all free bands b2, g2, and r2, such that this free-band luminance emitted by source 63-1 is substantially reflected off article 12 and thus substantially perceived within perceived light 2o-pl-9. Given that these exemplary free bands are tri-color bands b2, g2, and r2, they will combine through the human vision system to be perceived as white light 2o-pl-9. With the assumption that the emitted luminance of the locked bands b1, g1, and r1 is determined so as to cause the same perceptions of brightness as the free bands b2, g2, and r3, then a careful consideration will show that in the operation of light source 63-1 as depicted of FIG. 5C, while both the paper 11 and article 12 will appear white, the paper 11 (thus 2o-pl-8) will be perceived as substantially twice as bright as article 12 (thus 2o-pl-9).

Referring now to the alternate operation of light source 63-1 as depicted in FIG. 5D, given that the perceived brightness of any given color (blue, green, or red)'s emitted free or locked bands, thus b1 compared to b2, g1 compared to g2, and r1 compared to r2, is substantially the same, and that light bands b1, g1 and r2 making up light 63-1-so3 are emitted at a luminance that is roughly 2× of their emitted luminance with respect to light 63-1-so2 of FIG. 5C, than a person 20 will perceive the white light 2o-pl-11 reflecting off white paper 11 under illumination 63-1-so3 of FIG. 5D as substantially the same color and brightness as the white light 2o-pl-8 reflecting off white paper 11 under illumination 63-1-so2 of FIG. 5C-thus achieving a goal of the present invention that a person perceives substantially no change in coloration and brightness of a non-specially-coated object when that object is at least being partially illuminated by an engineered light source 63-1 that is controllably changing its mixture of spectral bands and luminance such as exemplary spectral output 63-1-so2 versus 63-1-so3.

Referring still to FIG. 5D in comparison to FIG. 5C, unlike the substantially unchanging perceptions of reflected engineered light off white paper 11 (thus 2o-pl-11 versus 2o-pl-8,) article 12 with special coating 12g is anticipated to appear substantially red (thus 2o-pl-12 of FIG. 5D) versus substantially white (thus 2o-pl-9 of FIG. 5C,) based upon the changing of engineered light 63-1 spectral output to 63-1-so3 from 63-1-so2—thus achieving a goal of the present invention that a person perceives a substantial change in coloration and/or brightness of a specially-coated object/article 12 when that object is at least being partially illuminated by an engineered light source 63-1 that is controllably changing its mixture of spectral bands and luminance such as exemplary spectral output 63-1-so2 versus 63-1-so3.

A careful review of the depictions in FIG. 5D will show that of the emitted bands b1, g1, and r2 comprising light 63-1-so3, locked bands b1 and g1 are substantially absorbed by the special coating 12g applied to article 12, while free band r2 is substantially reflected, such that a person 20 could in practice be for example holding the toy wand 12 in a room being substantially illuminated by the light source 63-1, where the light source 63-1 is caused to change for example in accordance with an ongoing game being participated in by the person 20, and where then the person 20 perceives that their wand 12 has “magically” changed colors from white to red as the gaming system communicates with the lights source 63-1 to cause a change in emission from 63-1-so2 to 63-1-so3.

Furthermore, a careful reading of the present invention will also show that the “from” and “to” colorization can be engineered to be virtually any combination only as limited by the one or more substances comprising the coating 12g and the narrow bands of light emitted from the light source such as 63-1. There is also no limitation on the surfaces to be specially coated, such that for example “article 12” could be the walls in the room that a person 20 is walking through at a destination that is implementing a destination wide game, where the person is being tracked and the gaming system causes a change in the emission of light source 63-1 to coincide at least in part with this person tracking, the net effect of which is the person 20 controllably experiences a feeling that the walls 12 have “magically” changed color. Alternatively, the teachings of the present invention can be used in combination with a system providing direct control to the person 20, whereby for example the room wall 12 is in a home or office setting and the person operates a remote control to change the output of light source 63-1 and therefore a corresponding colorization and brightness of the wall 12.

The combination of possible “articles 12” comprising special coatings 12g, as well as light sources 63 with various possible spectral output, all being controlled by any system for accomplishing purposes based at least in part, or not at all, upon information regarding or provided by the person 20, are virtually unlimited, and therefore the present invention should not be unnecessarily limited to the specific examples of articles 12, coatings 12g, light sources 63 or even controlling systems as herein taught, but rather limited to the various and many individual and combinable apparatus and methods described herein.

Referring next to FIG. 6A, there is depicted two different examples of an engineered light source 63, namely non-filtering light source 63-2 comprising a multiplicity of individually controllable narrowband emitters, and filtered light source 63-3 comprising at least one broadband emitter being filtered by a film or material into one or more narrow bands, where those skilled in the art of light sources will understand that it is possible to combine the “individual emitters” of 63-2 with the “broad emitters”/“narrow filters” of 63-3 into a hybrid, and as such the teachings of FIG. 6A are considered to be exemplary rather than exclusive and limiting. Also depicted is non-engineered light source comprising sunlight shining through a window 64w, where window 64w further comprises a filter/coating 64w-c for filtering the broadband sunlight into one or more narrow bands. A careful consideration will show that the difference between filtered light source 63-3 and filtering window 64w is that the necessary broadband emission is essentially controllable (e.g., to turn on and off) in light source 63-3 but not in window 64w, although it would be possible for example using “switchable window technology” to at least cause the window 64w to enter a state of substantially non-transmitting at least in the visible spectrum, and as such to appear to be “turned off.”

Referring still to FIG. 6A, engineered non-filtered light source 63-2 for example controllably emits spectral output 63-2-so comprising at any time any combination of one or more narrow bands of spectral output preferably including at least u1 (e.g., in the UVA spectrum,) b1, b2, and b3 (in the blue eye response 20-srb, see FIG. 3A,) g1, g2, and g3 (in the green eye response 20-srg,) r1, r2, and r3 (in the red eye response 20-srr,) n1, n2, and n3 (e.g., in the NIR to IR spectrum). After emission, spectral output 63-2-so is “shaped” or “directed” by passing through a light shaping diffuser 73-2. Light shaping diffusers are well-known in the art, where for example Luminit with offices in St. Torrance, CA sells multiple variations of “light shaping diffusers” and “light shaping prismatics,” any and all of which are considered to be useful example of diffuser 73-2 each with various advantages and disadvantages.

A light shaping diffuser 73-2 can for example restrict the beam of light exiting the diffuser 73-2 to be a given shape (typically elliptical) of a given size (e.g., the shoulder width of a typical body,) where then the engineered spectral output 63-2-so is focused into a specific area such that an article 12 comprising a specially engineered coating 12g that is currently being illuminated within this area of the shaped spectral output 63-2-so is susceptible to colorization changes, but otherwise when the same article 12 is outside of the shaped output 63-2-so (e.g., while still being illuminated by a broadband light source,) is not substantially susceptible to colorization changes.

Referring still to FIG. 6A, there is shown a person 20 looking at a white piece of paper 11 and an article 12 that comprises a special coating 12g, where both 11 and 12 are currently being illuminated by focused spectral output 63-2-so. There is also shown a gamer 2s wearing active filtering glasses 14, all of which is discussed in the CROSS-REFERENCED RELATED APPLICATIONS, especially including U.S. Pat. No. 10,719,134 entitled INTERACTIVE OBJECT TRACKING MIRROR-DISPLAY AND ENTERTAINMENT SYSTEM filed on May 9, 2018, U.S. Pat. No. 10,861,267 entitled THEME PARK GAMIFICATION, GUEST TRACKING AND ACCESS CONTROL SYSTEM filed on Aug. 4, 2018, U.S. Pat. No. 10,974,135 entitled INTERACTIVE GAME THEATER WITH SECRET MESSAGE IMAGING SYSTEM filed on Sep. 27, 2018, and U.S. Pat. No. 11,025,892 entitled SYSTEM AND METHOD FOR SIMULTANEOUSLY PROVIDING PUBLIC AND PRIVATE MESSAGES filed on Apr. 4, 2019.

While the interested reader is directed to these related patents, in general an interactive gaming system is preferably located at a destination, such as a theme park, museum, resort, etc., and comprises multiple “game access points,” for which the present application is teaching new subject matter. Many of the game access points include providing “secret messages” or otherwise private experiences based at least in part upon the tracked game state of the interactive gaming system. In some cases, these private experiences can only be received by a game 2s when wearing active filtering glasses 14 or otherwise looking through one or more controlled active filtering lenses in any form, e.g., including a magnifying glass 15 (see FIGS. 6B, 7B, and 11 as well as the related patents for more discussion). What is taught in the prior related applications is that the timing of the activation of the various one or more active components in an active filtering lens 14 or 15 is controlled by the interactive gaming system which is also controlling the timing of “privately encoded light” or “secret messages.”

What is new in the present application includes that this privately encoded light can be provided by an engineered light source 63 emitting any combination of any one or more narrow bands (either emitted as a narrow band such as with source 63-2, or filtered after emission into a narrow band such as with source 63-2,) where what is further taught is that these narrow bands are purposefully chosen to affect the perception of the colorization of a coating 12g placed upon virtually any surface, or article (collectively “12”). Thus, the interactive gaming system as prior taught is now extended to at least have to ability to cause an article such as a toy wand 12 to appear “magically” to change color, where the holder of the wand 12 is either looking through an active filtering lens such as 14 or 15, or as prior discussed seeing without the aid of a lens 14 or 15 (thus with the “unaided eye.”) (Up until this point in the application, the provided examples discuss how to controllably cause colorization changes in article 12 without requiring active lens 14 or 15.)

Still referring to FIG. 6A, in one implementation, active glasses 14 (and therefore also magnifying glass 15 or any other implemented form of the “active lens” as taught in the prior cross-referenced art,) have the ability to be “open” and transmitting of light or to be “closed” and substantially blocking of light, all under the control of wireless electronic signals. The present figure teaches that the timing of any one or more narrow bands of light as emitted by a light source such as 63-2 can be caused to be “in-phase” (thus the narrow band is being substantially output while the lens 14 or 15 is substantially “open,”) or “out-of-phase” (thus the narrow band is either substantially output while the lens 14 or 15 is substantially “closed,” or is otherwise simply not output while the lens 14 or 15 is substantially “open.”)

In the present figure, the dashed lines depicted as originating from the light source 63, passing through shaped diffuser 73-2, and ultimately impinging upon paper 11 and article 12, are marked as being, left-to-right, narrow bands b2, b1, g2, g1, and “2×” (i.e., “double normal luminance”) of r2. Of these narrow bands, free bands b2 and g2 and locked bands b1 and g1 are being emitted at time “t1” that is out-out-phase with glasses 14 (and thus substantially blocked,) while free band r2 is being emitted at time “2” that is in-phase with glasses 14 (and thus substantially transmitted). A person 20 using the unaided eye” (thus not looking through a lens 14, 15 or similar) will perceive all of emission b2, b1, g2, g1, and 2xr2, regardless of its timing t1 or t2 of output, thus integrating all the blue, green, and red light to be substantially perceived as white light 2o-pl-14 when looking at white paper 11, but as white light with a reddish hue 2o-pl-15 when looking at article 12 (thusly based upon 1xb2+0xb1+1xg2+0xg1+2xr2, where the “Ox” terms are substantially absorbed and not perceived by person 20,) which as a careful consideration will show amounts to white with some extra red. However, gamer 2s will see only the 2xr2 red light such that the otherwise white paper 11 is perceived as red paper light 2o-pl-17, and the article 12 is also perceived to be red light 2o-pl-18.

A careful consideration will show that the additional use of actively controlled lenses such as 14 and 15 present a way to alter a gamer 2s's perception not just of a specially coated article 12, but also of a non-specially coated article such as paper 11. Further considerations will show that the affects made possible by the combination of the engineered light source 63 and the engineered coating 12g to cause colorization changes can have many possible additional combination affects when the timing of the engineered light is synchronized to be in or out-of-phase with active lenses such as 14 or 15 being looked through by a gamer 2s, where at least some of these “other affects” will be discussed in relation to upcoming figures.

Still referring to FIG. 6A but now to spectral output 63-3-so as emitted by filtered light source 63, where for example the passive filter is always passing/emitting the narrow free bands of b2, g2, and r2 through shaped diffuser 73-3, to then be collectively perceived in direct viewing as white light 2o-pl-13. Similarly, any number of narrow bands could be filtered out of a light source 63-3-so emitting a broadband light (i.e., other than b2, g2, and r2,) where this is also true for a window 64w being filtered by a coating 64w-c to create the window spectral output 64w-so in this example comprising narrow bands b1, b3, g1, g3, r1, and r3, collectively also perceived as white light, namely 2o-pl-19. A careful consideration will show that there are many ways, as well as obvious variations to these ways, for creating spectral output comprising narrow bands, for then limiting the focus of this spectral output into a limited area beam by using shaped diffusers, and then final to also modulate this light for in or out of phase transmission through an active filtering lens such as 14 or 15, where the many combination provide for virtually limitless combinations of affects, especially when combined with various possible coatings 12g for articles 12.

Referring next to FIG. 6B, there is depicted eight exemplary control signals 63cs-1 through 63cs-8 to teach the use of signal phase and amplitude in causing visual perception affects with respect to light being emitted by an engineered light source 63. The visual affects are either experienced by a person 20 seeing with the unaided eye, of a gamer 2s looking through a device or otherwise implementation of an active filter lens, such as glasses 14 or magnifying glass 15. Each of the control signals have been designated as either “sc1” (“sub-channel 1”) or “sc2” (“sub-channel 2”).

For a discussion on the teaching of a sub-channel with respect to the present invention, the interested reader is directed especially to the cross-referenced U.S. Pat. No. 11,025,892 entitled SYSTEM AND METHOD FOR SIMULTANEOUSLY PROVIDING PUBLIC AND PRIVATE MESSAGES filed on Apr. 4, 2019. In general, sub-channel 2 is herein used to refer to emitted light that is in-phase with an active lens device such as 14 and 15, an as such a gamer 2s perceives this “private light,” whereas sub-channel 1 is blocked by the active lens such that the gamer 2s does not substantially perceive, or spatially-temporally blend, what is referred to as “public light.” In practice, a person 20 not using an active lens such as 14 or 15, thus being “un-aided,” will substantially perceive the spatial-temporal blend of both the pubic and private light, corresponding to sc1 and sc2, respectively.

Still referring to FIG. 6B, first (and topmost) control signal 63cs-1 is represented as a traditional “on/off”/“I/O” digital signal for which there are many implementations, representations, and even alternatives. Such control signals whether transmitted “by wire” or “wirelessly,” are useful for synchronizing the function of electronic devices, such as an engineered light source 63 and active lenses 14 and 15. For signal 63cs-1, “on”/“1” is being interpreted as activating a light source 63 to cause a combination of spectral output on “sub-channel 1” (sc1) that will be substantially perceived by a person 20, but not substantially perceived by a gamer 2s looking through an active lens 14 or 15. Conversely, the next signal in consideration is 63cs-2 that is the “inverse” of 63cs-1, such that 63cs-2 is “on”/“1” while 63cs-1 is “off”/“0,” and vice versa. For signal 63cs-2, “on”/“1” is being interpreted as activating a light source 63 to cause a combination of spectral output on “sub-channel 2” (sc2) that will be substantially perceived by a person 20, and also substantially perceived by a gamer 2s looking through an active lens 14 or 15.

A careful consideration of an engineered light source 63 as taught herein, will show that the light source 63 preferably has individual control over any one or more emitters for generating that same frequency range of spectral output (e.g., see FIG. 3B and light source 63 comprising one or more LEDs 63e-1 emitting spectral output 63e-1-so, and one or more LEDs 63e-2 emitting spectral output 63e-2-so). Thus, unlike a traditional light source that has a signal for turning on or off the entire spectral output of a light source (typically broadband white light,) an engineered light source 63 has individual control over which narrow bands of spectral output are emitted at and over any particular duration of time. Some new LED lights in the marketplace do comprise a multiplicity of typically individually controllable LEDs, which are not typically narrow-band (where narrow-band means having a FWHM preferably at least 50% narrower than then the respective human eye color response 20-csr, see FIGS. 3A and 3B for more discussion,) but rather in these more traditional “RGB LED lights” the red, green, or blue LEDs are emitting what is herein called substantially “full-band” spectral output, where full implies a FWHM substantially wide enough to cover the entire human eye color response 20-csr.

In a traditional RGB LED light, these full-bands have a peak frequency that is preferably centered near the peak frequency of the respective color response 20-csr, whereas the presently taught engineered light 63 includes at least one narrow band of emission that may be centered, but preferably includes two or more narrow bands per each respective color (blue, green, and red,) where each of these two or more narrow bands such as b1-b2, g1-g2, or r1-r2 has a peak frequency that is offset from the center peak frequency of the respective eye response 20-csr, although this is not mandatory. What is important to see is that a narrow-band engineered light source 63 controllably emits spectral output within segments or sub-portions of the frequency range of a given eye response 20-csr, and where a tri-color-band engineered light source emits at least one and preferably two narrow-band/segment of spectral output per each of 20-srb, 20-srg, and 20-srr (see FIG. 3A).

Still referring to FIG. 6B, a careful understanding of the present invention will also show that it is valuable to individually control the narrow bands currently being emitted both for “light balancing” (see especially FIG. 3G) and for causing coating 12g colorization changes. Signal 63cs-3 represents an amplitude change to be made to the emission of a given narrow band, where this amplitude change is best thought of as a “dimming” and “brightening” affect. For example, the sc2 “on” signal 63sc-2 causes a respective narrow-band LED to turn “fully on,” whereas in some instances it is desirable to have a lesser luminance being emitted of the narrow-band while it is turned on-thus “dimmed.”

Those familiar with light sources and electronics will understand that a typical method for “dimming” light source is referred to as “pulse-width modulation,” where the light when “on” is always at full spectral output, and then dimming is thereby alternatively accomplished by shortening the amount of time (the “pulse-width”) that the light source remains “on.” Those familiar with the art will appreciate that either of the amplitude or pulse-wide methods of controlling the dimming of a narrowband emitter are possible, and as such the present invention is not intended to be limited by the particular signal implementation for dimming, but rather to be understood as teaching the dimming of individual colors emitted by a light source by any method. The amplitude signal 63cs-3 is show for the simplicity of understanding these core teachings.

Referring still to FIG. 6B, when the sc2 “on” signal 63cs-2 is electronically combined with the sc2 narrow-band amplitude control signal 63cs-3, this is represented as resulting in 63cs-4, where again dimming of the narrow-band is depicted as a lessening of amplitude but could also be implemented as a constant amplitude with a lessening of the “on” pulse-width. Signal 63cs-5 represents a typical on/off response waveform for an active lens implemented using an LCD, where the on/off slopes represent the concept that the active lens such as 14 or 15 requires a longer duration of time to switch from off-to-on or on-to-off that a typical LED. What is preferred is that the “on” sc2 signal 63cs-4 substantially overlaps the fully-on portion of the active lens response waveform 63cs-5, and that the “on” sc1 signal 63cs-1 is narrowed to minimally overlap with either the turning-on or turning-off slopes of the active lens response waveform. Those skilled in the art of active lenses and display systems will understand that especially this preference for narrowing the “on” sc1 portion of signal 63cs-1 will help to minimize what is know as “cross-talk,” or “ghosting,” which happens when public light “leaks” through glasses 14 or 15 to been perceived by the gamer 2s because the “on” public light is substantially still being fully emitted either or both while the active lenses are opening or closing.

Signal 63cs-6 shows the expected private light on sc2 to be transmitted through the active lens such as 14 or 15 to be perceived by the gamer 2s, where again it is understood that this signal and transmission is representative of a single emitted narrow band, such as b1, where there is no restriction on the number of different narrow bands (and thus different signals) such that any of b1, b2, g1, g2, r1, and r2 can be controllably emitted at any given time or over any given duration to accomplish the desired perception affect, to either a gamer 2s using active lenses 14 or 15, or to a non-gamer 2o. A careful consideration of signal 63cs-7 will show that this signal is formed by the combination of time shifting and inverting signal 63cs-6, where time shifting implies that the sc1 channel is driven to be on based upon the phase-shifted sc2 channel, where the “amount” of on/output of luminance on the sc1 channel is the inverse of the next (or prior) pulse of sc2 light.

And finally, still referring to FIG. 6B, the value of this shifted and inversed sc1 “on” signal 63cs-7 is best shown when combined with the corresponding sc2 “on” signal 63cs-6, resulting in the waveform 63cs-8 representing the combination of sc1 “on” and sc2 “on,” where the dashed horizontal line shows the spatio-temporal average light of a particular narrow band (such as b1) to be experienced by a person 20 not looking through active lenses such as 14 and 15, thus seeing both the public (sc1) and private (sc2) light. As will be understood by those familiar with the human visual system, when signals such as 63cs-1 and 63cs-2 are operated at a frequency higher than 60 hz, the on/off flashing of any corresponding lights occurs at a rate that is above what is referred to as the “flicker rate,” or “flicker threshold,” and as such a person 20 perceives the average value as shown by waveform 63cs-8, and then does not perceive any up-and-down fluctuations that happening in the emitted luminance of sc1 and sc2. In net, FIG. 6B shows at least one variation of engineered light 63 control signals for causing a gamer 2s looking through synchronized active lenses such as 14 and 15 to perceive the changing levels of any given narrow band of light (such as b1,) while also a non-gamer person 20 perceives a constant level of the same light (such as b1).

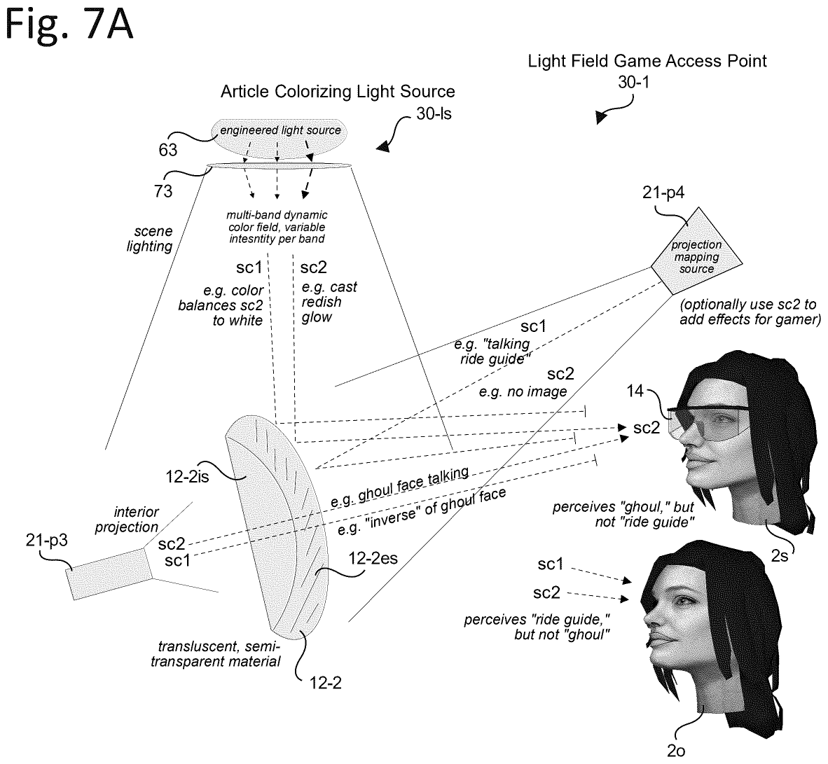

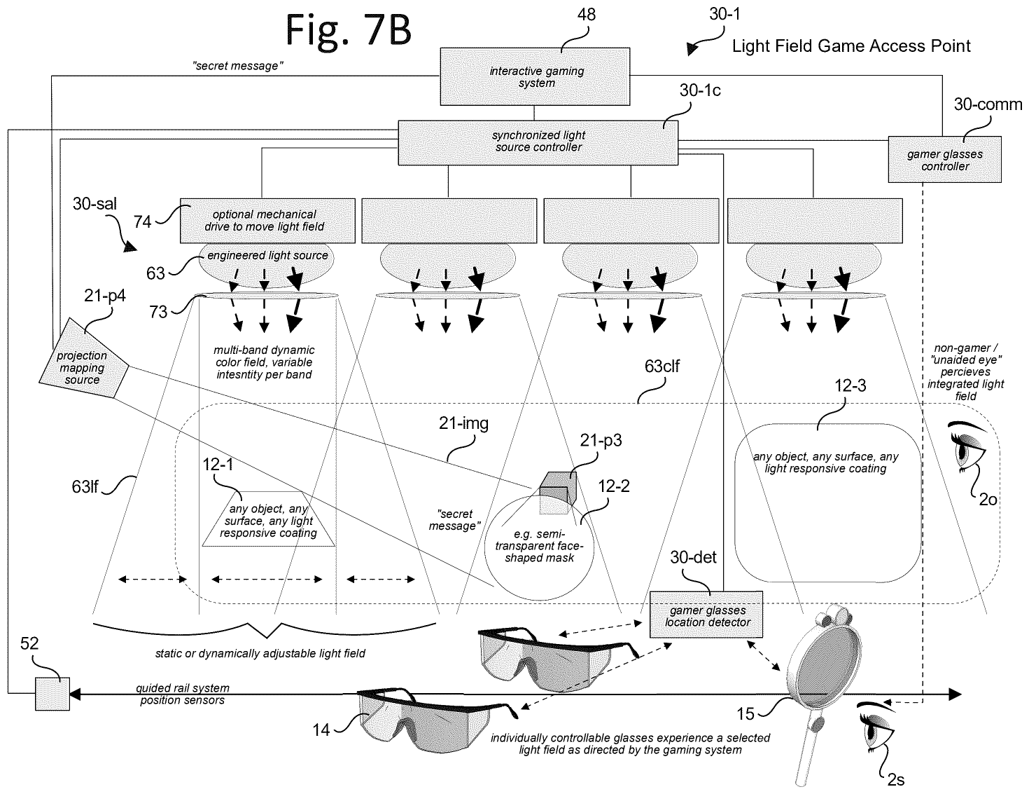

Referring next to FIG. 7A, there is shown a light field game access point 30-1 combining teachings from the cross-referenced art, especially for the emission of “secret messages”/“private images,” and the presently taught engineered light source 63, especially for controllably emitting a multiplicity of narrow-band light. The reader interested in understanding apparatus and methods for providing private images is directed first to U.S. Pat. No. 10,974,135 entitled INTERACTIVE GAME THEATER WITH SECRET MESSAGE IMAGING SYSTEM filed on Sep. 27, 2018, and U.S. Pat. No. 11,025,892 entitled SYSTEM AND METHOD FOR SIMULTANEOUSLY PROVIDING PUBLIC AND PRIVATE MESSAGES filed on Apr. 4, 2019. These teachings address apparatus and methods for providing secret images and video also referred to as “private” (vs. “public”) images and video, where these secret/private images or video are substantially only perceived by a gamer 2s looking through an active filter lens such as glasses 14 (or magnifying glass 15, not depicted,) and hence not substantially perceived by a non-gamer 2o who is either not looking through a lens 14 or 15, or who is looking through a lens 14 or 15 but the lens is not receiving the necessary control signals such as 63cs-5 (see FIG. 6B).

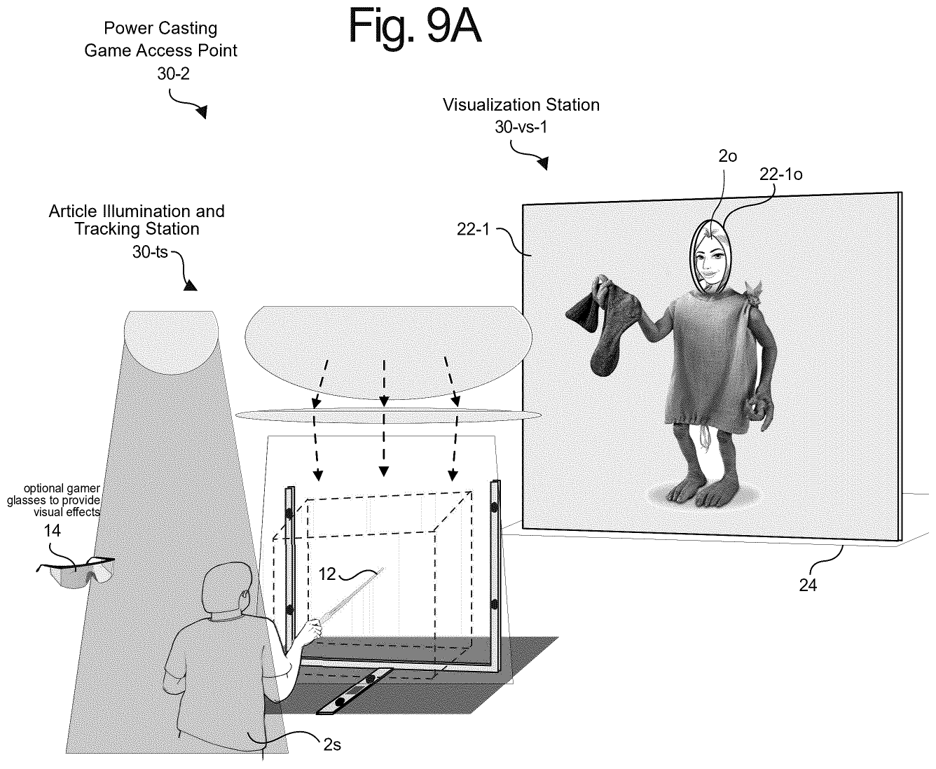

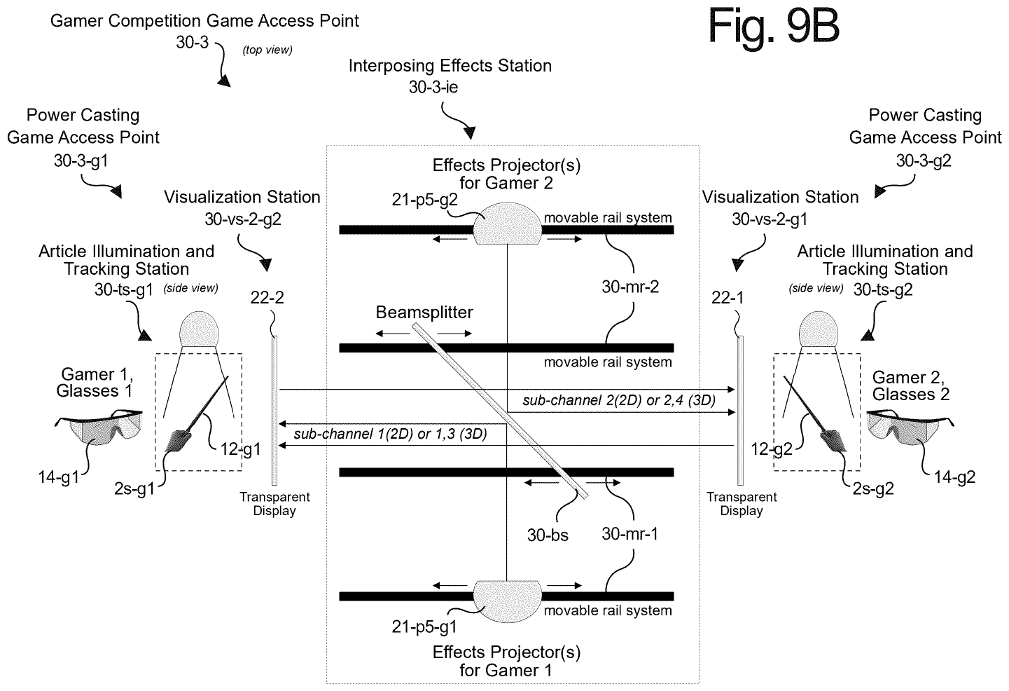

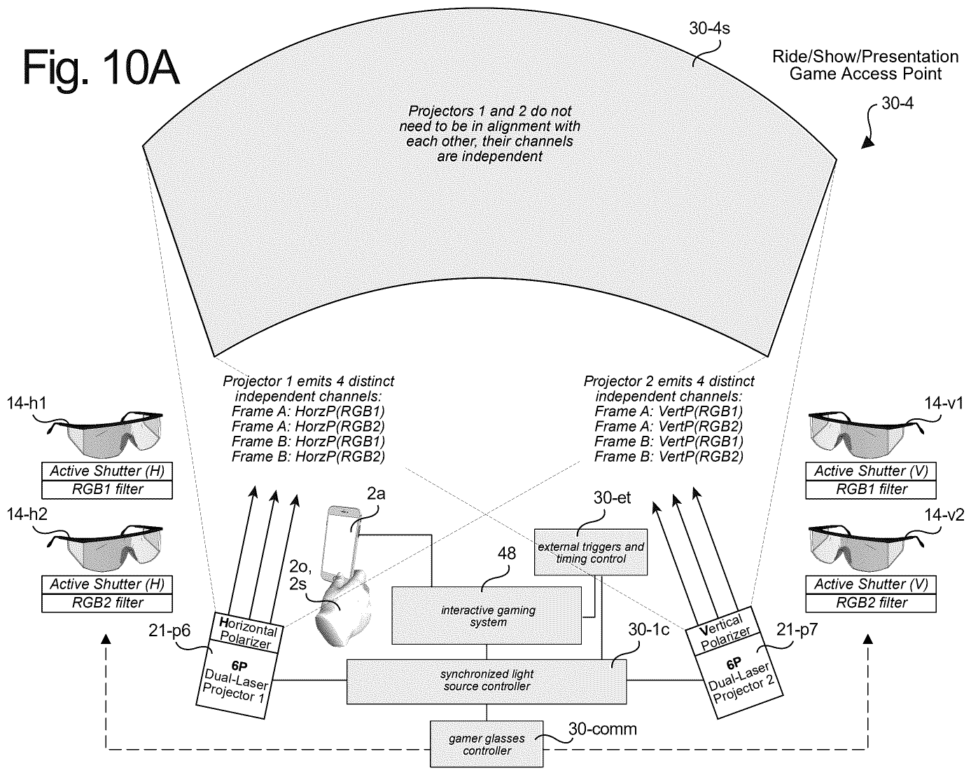

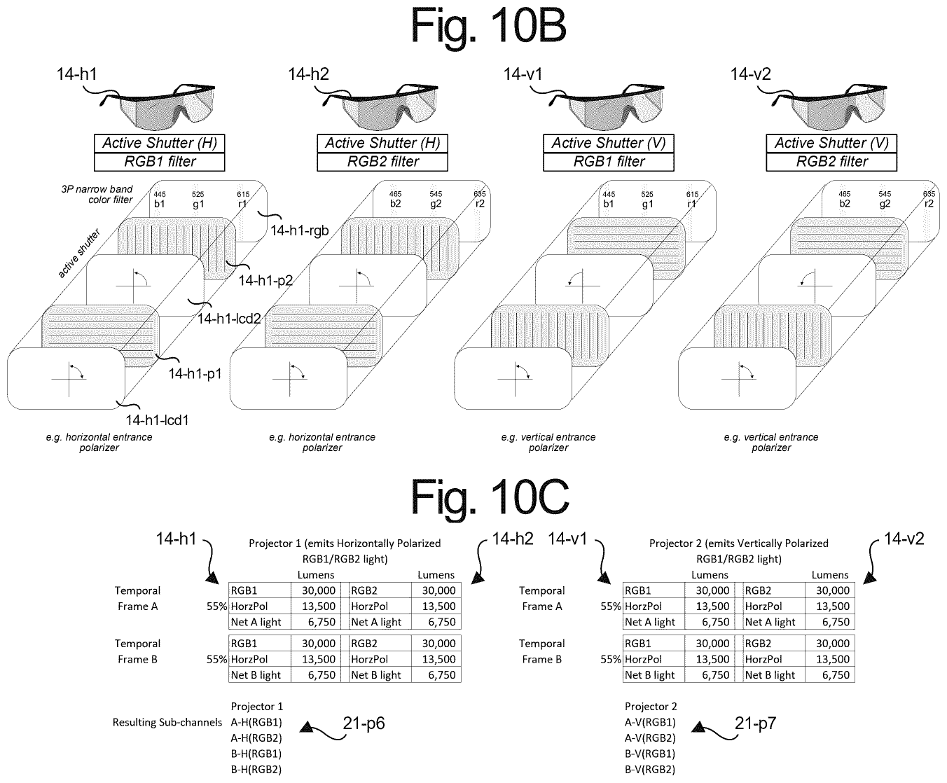

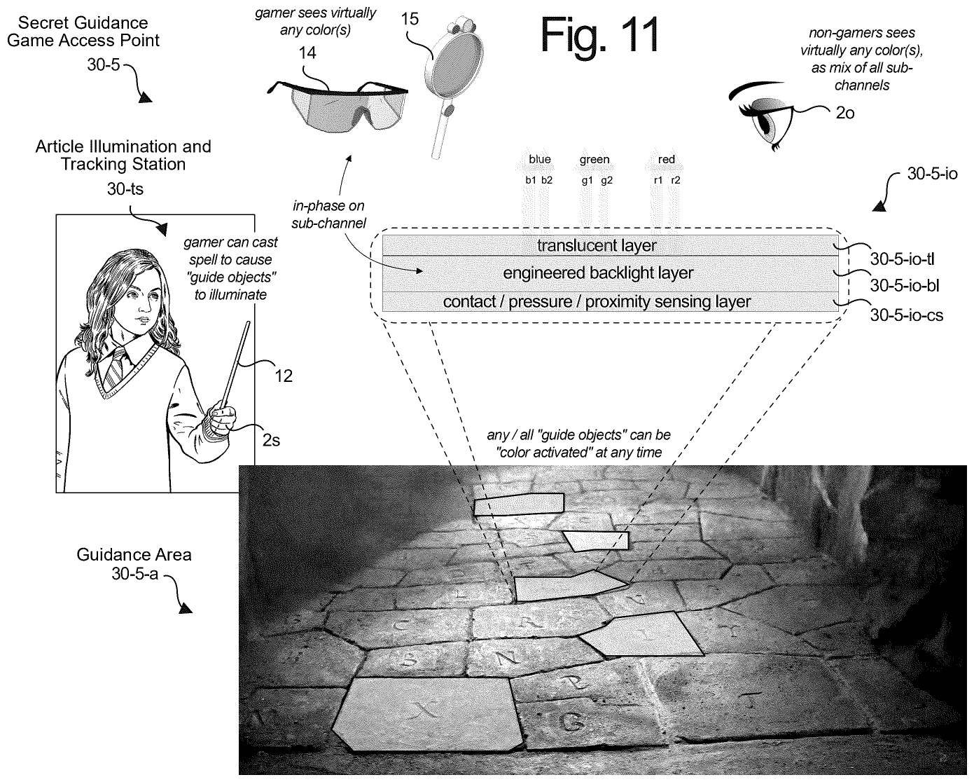

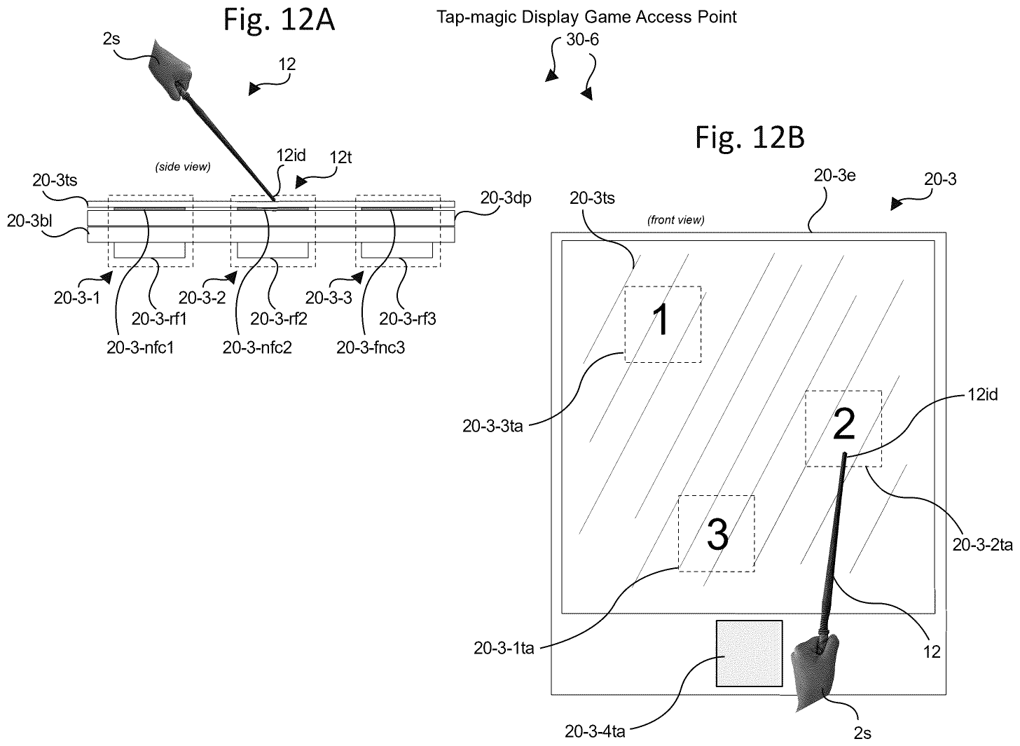

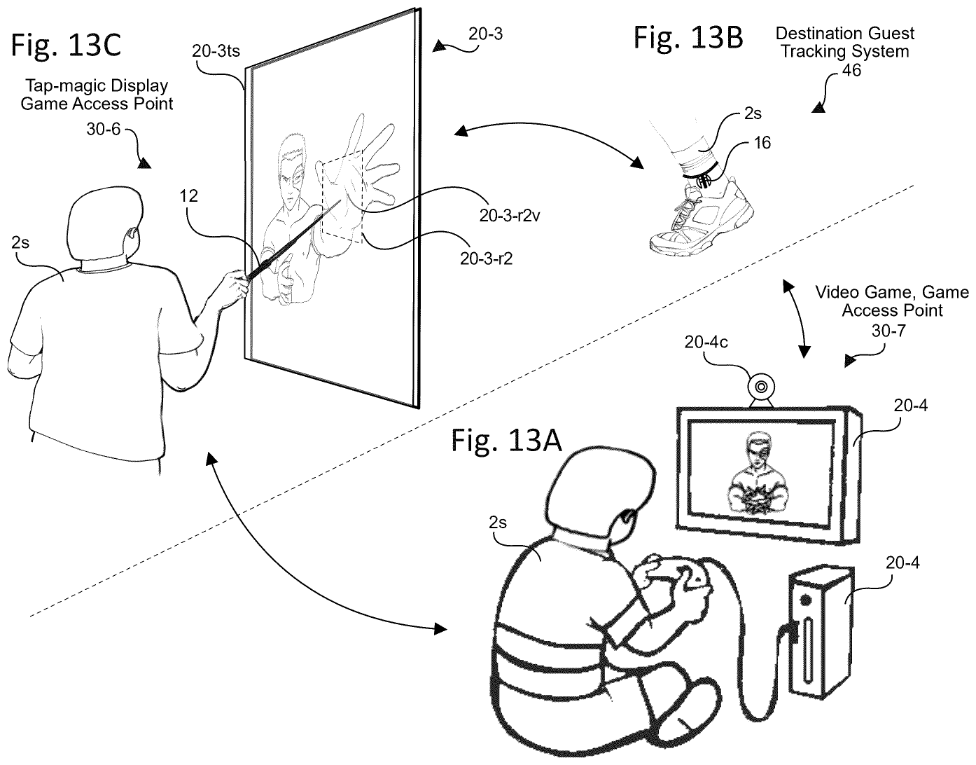

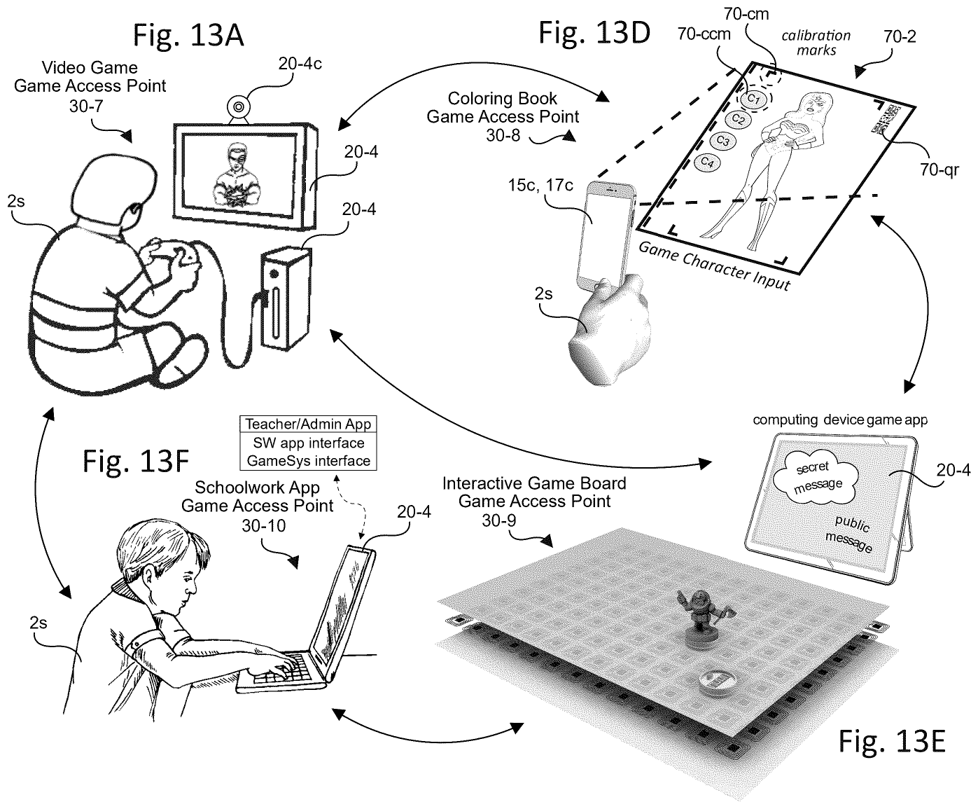

Light field game access point 30-1 is preferably used as a game access point connected to an interactive gaming system comprising a multiplicity of various types of game access points, some of which are first taught herein (see also light field game access point 30-1 further expanded in FIG. 7B, power casting game access point 30-2 of FIG. 9A, gamer competition game access point 30-3 of FIG. 9B, ride/show/presentation game access point 30-4 of FIG. 10A, secret guidance game access point 30-5 of FIG. 11, tap-magic display game access point 30-6 of FIGS. 12A, 12B, and 13C, video game, game access point 30-7 of FIGS. 13A and 13B, coloring book game access point 30-8 of FIG. 13D, interactive game board game access point of FIG. 30-9, and schoolwork app game access point 30-10 of FIG. 13F,) and others of which have been taught in the cross-referenced art, along with the apparatus and methods for the interactive gaming system.

The reader interested in a first understanding of apparatus and methods for providing game access points and an interactive gaming system is directed to U.S. Pat. No. 10,974,135 entitled INTERACTIVE GAME THEATER WITH SECRET MESSAGE IMAGING SYSTEM filed on Sep. 27, 2018, U.S. Pat. No. 10,861,267 entitled THEME PARK GAMIFICATION, GUEST TRACKING AND ACCESS CONTROL SYSTEM filed on Aug. 4, 2018, and U.S. Pat. No. 10,719,134 entitled INTERACTIVE OBJECT TRACKING MIRROR-DISPLAY AND ENTERTAINMENT SYSTEM filed on May 9, 2018. The reader interested in a first understanding of apparatus and methods for providing a coloring book game access point and an interactive game board game access point is directed to U.S. Pat. No. 10,688,378 entitled PHYSICAL-VIRTUAL GAME BOARD AND CONTENT DELIVERY SYSTEM filed on Jul. 4, 2018, and U.S. Pat. No. 10,85,450 entitled PHYSICAL-VIRTUAL GAME BOARD AND CONTENT DELIVERY PLATFORM filed on Aug. 9, 2019.

Still referring to FIG. 7A, light field game access point 30-1 is preferably operated in connection with an interactive game system for providing at least control signals for any of (1) engineered lights sources 63, (2) active lenses such as 14 and 15, and (3) public and/or private image displays and projectors including projectors 21-p3 and 21-p4, as well as video and optionally audio content for (2) active lenses such as 14 and 15, and (3) public and/or private image displays and projectors including projectors 21-p3 and 21-p4, where the control signals include but are not limited to any of 63cs-1, 63cs-2, 63cs-3, 63cs-4, 63cs-5, and 63cs-8, in any implemented form as will be obvious to those skilled in the art of electronics and communication signals.

Engineered light source 63 (in any of its various anticipated forms for emitting one or more narrow bands of light, preferably comprising one or more sets of tri-color-bands, where a set such as b1, g1, r1 includes one narrow band for each of the blue, green, and red eye spectral response frequency ranges) preferably emits its spectral output to be shaped by passing through a light shaping filter 73, such that the affects causable by the changing spectral output are substantially limited to a confined volumetric space. Public/private image/secret message projectors such as 21-p3 and 21-p4 preferably emit their image and/or video content for either transmitting through a surface to be viewed by a person 20 or a gamer 2s, such as a translucent surface 12-2, or emit their image and/or video content for reflecting off of a surface to be viewed by a person 20 or a gamer 2s, such as again a translucent surface 12-2.

Translucent surface 12-2 can be implemented using either of a passive translucent material of which many are available and well-known, or an active translucent material, such as what are known in the art as polymer dispersed liquid crystals (PDLCs). Where passive translucent materials will have a set transmissivity/translucence, active materials such as PDLC may be operated (for example using a signal such as but not limited to 63cs-1 or 63cs-2 for synchronization with private images being output on a first or second sub-channel) to be either of a 1) substantially transparent state, or 2) substantially translucent state. Using PDLCs, it is also possible to adjust the applied voltage to vary the amount of translucency, where then the surface such as 12-2 might always be translucent, just varying in the amount of translucency under control of the interactive gaming system, when for example a more opaque state is preferably for being “front-lit” by a projector such as 21-p4 (where the images emitted by projector 21-p4 reflect off material exterior surface 12-2es,) and a more translucent even substantially transparent state is preferably for being “back-lit” by a projector such as 21-p3 (where the images emitted by projector 21-p3 impinge upon material interior surface 12-2is for at least partial transmission through material 12-2).

Those familiar with “special affects” for example used in theme park settings, will understand that the surface of the translucent material 12-2, either passive or active, can be shaped, and that furthermore the images and video emitted by either of the front projector 21-p4 or the back projector 21-p3 can also be “warped”/“spatially distorted” to best fit the physical shape of the material 12-2, where this warping by image pre-processing to fit a non-planer surface is often referred to in the art as “projection mapping.”

Still referring to FIG. 7A, during an exemplary operation of a light field game access point 30-1, the control signals emitted by an interactive game system (or any other controlling system) as provided to any of the engineered light 63, the back projector 21-p3, the front projector 21-p4, or the active lenses such as 14 or 15 (not depicted) substantially cause a gamer 2s looking through the active lenses such as 14 or 15 to perceive only sub-channel 2/sc2 emissions, whereas a non-gamer 2o will perceive the temporal combination of sub-channel 1/sc1 and sub-channel 2/sc2 emissions. A careful reading of the prior cross-referenced art will show that a sub-channel such as but not limited to sc1 and sc2 can be implemented as either of spatial or temporal sub-channels.

Spatial sub-channels for example are implemented by the simultaneous emission of two spatially overlapping images, where the images are filterable by at least one optical component of the active lenses 14 or 15 (and in some cases an alternative passive implementation of the lenses 14 or 15). One well-known means for providing spatial sub-channels is the use of two orthongally polarized images, where the images may then be controllably filtered by either of active or passive polarization filters comprising lenses 14 or 15 (see the cross-reference teachings). A second well-known means is the use of two different “rgb triplets,” such as used in a 6P projection system (see the cross-references and FIGS. 2A, 2B, 2C, and 2D).

Temporal sub-channels for example are implemented by the alternating emission of two spatially overlapping images, where the images are filterable by at least one optical component of the active lenses 14 or 15. One well-known means for providing temporal sub-channels is the use temporal interleaved images, where the interleaved images may then be controllably filtered into distinct sequences by active shutters comprising lenses 14 or 15 (see the cross-reference teachings). The cross-reference teaches new ways for combining spatial-temporal sub-channels for creating 2 to 8 or more total sub-channels, where 2 sub-channels sc1 and sc2 are referenced herein, but the teaching of the present invention is extendable to providing synchronized engineered light 63 on any one or more of any number of sub-channels, and thus the present invention should not be limited to uses of only sc1 and sc2.

The careful reader will note that engineered light as taught thus far is capable of supporting both spatial sub-channels as “rgb triplets” (referred to herein as a set of “tri-color bands,”) and temporal-spatial sub-channels as alternating or changing narrow band emissions at a temporal frequency, such as 60 hz, 120 hz, 240 hz, etc. (where 60 hz provides two 30 hz sub-channels which might cause perception of flicker, but where 120 hz provides two 60 hz sub-channels which will be substantially flicker free, and 240 hz provides for example 4 sub-channels, each flicker-free).

Although not depicted, the non-polarized spectral output of any engineered light source 63 may be caused to first pass through a linear polarizer becoming for example horizontally polarized, and to pass through a liquid crystal layer that is operable to rotate the linear angle of polarization, for example alternatively rotating from the horizontal polarization at 60 hz, interleaved with a orthogonal vertical polarization at 60 hz, thus combining for temporally alternating spatially filterable 120 hz spectral output comprising horizontal and vertically polarized engineered narrow tri-color bands. Those skilled in the art of LCDs and light emission devices will appreciate by a careful consideration of the prior cross-references and the teaching herein, that many variations of spatial, temporal, and spatial-temporal sub-channels are possible. Where again, at least one goal of a sub-channel is to provide for emissions (such as sc2) of engineered light 63 for substantially transmitting through an active lens 14 or 15, where at least one other sub-channel of source 63 emissions (such as sc1) is blocked by the lens 14 or 15, and then where the combination of sub-channels sc1 and sc2 temporarily and/or spatially combines to the unaided eye of observer 20 as a different perceptual experience.

Still referring to FIG. 7A, in an exemplary use of game access point 30-1, engineered light 63 emits a substantially red color (and thus not blue or green) on sub-channel sc2 (implemented as any of a temporal, spatial, or temporal-spatial sub-channel,) and then emits a blue-green color combination (and thus not red) on sub-channel sc1. The control signals synchronizing the light 63 and active lenses 14 or 15 are controlled such that gamer 2s perceives this red sub-channel 2, whereas the non-gamer 2o perceives the temporal combination of sc1 and sc2 as substantially white light. It is further noted that a larger area surrounding the game access point 30-1 might be illuminated by a traditional white light source, such that the shaped/focused output of the perceived white light (sc1+sc2) is not substantially discernable by a person such as 20 as it effectively blends in or spatially combines with the surrounding white light, perhaps adding some increase in perceived brightness. In this use case, gamer 2s perceives translucent material 12-2 to have a red colorization, whereas non-gamer 2o perceives a substantially white or non-colored colorization.

In this use case example, projector 21-p3 is caused by the interactive gaming system to emit a private image/secret message on sc2, which is spatially mapped to conform to the shape of the translucent material 12-2, where the private image is for example a “ghoul” that transmits through the material 12-2 and the active lenses 14 or 15 to be substantially perceived by gamer 2s. The projector 21-p3 is also caused by the interactive gaming system to emit a public image on sc1, which is also spatially mapped to conform to the shape of the translucent material 12-2, where the public image sc1 is for example the inverse of the “ghoul” sc2 and transmits spatially aligned with sc2 through the material 12-2, where the active lenses 14 or 15 substantially block sc1 from being perceived by gamer 2s, and where the non-gamer 2o perceives the combination of sc1 and sc2 to be substantially white light.

Furthermore, in this same use case, projector 21-p4 is caused by the interactive gaming system to emit a public image on sc1, which is spatially mapped to conform to the shape of the translucent material 12-2, where the public image is for example a “talking ride guide” that reflects off of the material 12-2 and is blocked by active lenses 14 or 15 to be substantially not perceived by gamer 2s, whereas non-gamer 2o does perceive the public image/“talking ride guide.” The projector 21-p4 is also caused by the interactive gaming system to emit a private image on sc2 that is substantially “blank” or all black, where the private image sc2 does transmit through active lenses 14 or 15 but is substantially not perceived and thus does not interfere with the perception of the “ghoul” private image being simultaneously emitted by projector 21-p3, and where this same “blank” or black private image is perceived by the non-gamer 2o.

Those familiar with the human vision system, and as discussed in the cross-references, will understand that the human vision system of both gamer 2s and non-gamer 2o will combine this alternating 21-p4 emitted sc2 “blank” or black image with the images/light received on alternate sub-channel sc1 (from any source) as well as light received from sc2 from any source other than 21-p4 (such as 63 or 21-p3,) where the temporal combining has the net effect of dimming this other light (i.e., by reducing the average luminance received over time,) thus dimming the “talking ride guide” as perceived by non-gamer 2o.

As will also be understood, it is possible that the total luminance emitted on any given sub-channel sc1, sc2, or other, by any source including engineered light 63, back light projector 21-p3, or front light projector 21-p4, can be set differently set from any other sub-channel on any other source (i.e., 63, 21-p3, or 21-p,) where this difference in luminance causes different perceptions by any of the gamer 2s and/or the non-gamer 2o. For example, the luminance of sc1 and sc2 as emitted by 21-p3 could be the same, thus helping the ghoul images (sc1) and inverse goal images (sc2) best combine into white light as perceived by the non-gamer 2o. The luminance of sc1 as emitted by 21-p4 could be 2× or more the luminance of sc1 as emitted by 21-p3, where this increased luminance helps to offset any “washing out” of the sc1/sc2 temporally combined projections provided by 21-p3, all as will be understood by those familiar with the human vision system, by a careful consideration of the present descriptions, and also be a reading of the relevant cross-references.

And finally, with respect to the example use case of FIG. 7B, it is reemphasized that an engineered light source 63 working in combination with at least active lenses such as 14 and 15 allows for the provision of a unique gamer 2s experience of scene colorization verses the experience of a non-gamer 2o without the use of a specially engineered coating 12g. In this particular example, a commonly viewed area is illuminated by the spectral output of an engineered light source 63, where this spectral output is divided spatially, temporally (as in this example,) or spatio-temporally into at least two sub-channels, in this case sc1 and sc2. The spectral output is preferably narrowband, again meaning that for any given spectral response of the human vision system, hence any of 20-srb, 20-srg, or 20-srr (see FIG. 3A) a narrow band of spectral output of source 63 for a given color (e.g., b1 for output within response 20-srb, g1 for 20-srg, or r1 for 20-srr) is preferably less than 50% of the FWHM of the associated human vision system spectral response, where this preference then provides for having at least two narrow bands (such as b1 and b2) for emitting into a color range (such as 20-srb,) where the bands b1 and b2 do substantially overlap the spectral region of the color range's FWHM, without themselves substantially overlapping with respect to their own FWHMs. As prior discussed, these at least two narrow bands such as b1 and b2 then preferably align with the spectral response of one or more substances within a special coating 12g for operating preferably differently upon each of the given narrow bands such as b1 and b2, e.g., by absorbing, reflecting, fluorescing, transmitting, etc.

As a careful consideration of the present figure will show, this preference for emitting a narrow band within a perceived color (blue, green, or red,) is not necessary (but is still sufficient) for providing a unique colorization experience when using active lenses such as 14 or 15 in combination with the engineered light source 63 (and not therefor also relying upon a specially engineered coating 12g). For example, in the present figure's use case, the engineered light source 63 might be using mid to “full-band” (blue, green, red) LED color emitter such as more typically found in the marketplace. A mid to full-band emitter would therefore have a spectral output with a FWHM that is substantially equal to or greater than 50% of the FWHM of the particular human eye color response (20-srb, g1 for 20-srg, or r1 for 20-srr,) where such mid to full-band emitters are less adaptable for causing colorization changes in a coating 12g while additionally maintaining the perception of no substantial change in the colorization of the light source 63, all as prior discussed.

However, by causing for example the red mid-to-full band LED to emit on sc2 (e.g., a distinct “second” temporal subchannel) while then causing the blue and green mid-to-full band LEDs to emit on sc1 (e.g., a distinct “first” temporal subchannel,) a gamer 2s limited by active lenses such as 14 or 15 to receiving only sc2 then substantially perceives a red color over the shaped volume of the spectral output of source 63, while a non-gamer 2o receiving both sc1 and sc2 perceives white as the spatial-temporal combination of the red (sc2) and blue and green (sc1). Thus, the present engineered light source 63 has multiple implementations and should therefor be understood in the full range of exemplary descriptions, rather than being limited to a lesser number of the exemplary use cased provided herein.

Referring next to FIG. 7B, there is shown an expanded implementation of a light field game access point 30-1 comprising a multiplicity of shaped adjustable engineered lights 30-sal along with additional controlling components, collectively for example, as might be used for providing custom real-time effects on a ride line or on a ride at a theme park. Each shaped adjustable engineered light 30-sal (there are four (4) pictured from left to right,) comprises: (1) an optional mechanical drive 74 usable to move the resulting adjustable light field 63lf, (2) an engineered light source 63, and (3) an optional light shaping filter 73, where the controllable emitted spectral output of source 63 is then a directable, shapable, and color changeable light field 63lf. In one operation, each of shaped adjustable engineered lights 30-sal for example operates as any of a traditional “stage light” or “search light” functionality, where a multiplicity such as the four (4) depicted 30-sal lights can be aggregated as needed to cover larger and larger areas, where each light 30-sal is preferably capable of independent operation as controlled by a synchronized light source controller 30-1c.

Light controller 30-1c preferably receives directives from a controlling system that is orchestrating a “show” of light effects, where a preferred controlling system is an interactive gaming system 48 (see cross-referenced patents,) where the interactive gaming system 48 is preferably tracking the location of one or more persons 20 or gamers 2s both in terms of physical location and with respect to gamer 2s, also in terms of a current game state. At least on a theme park ride use case, any of person 20 or gamer 2s is also currently being transported on in a ride vehicle, where the vehicle is typically under some form of guidance system, where many guidance systems are known, and all are sufficient for the present teachings. At least one type of acceptable guidance system is a guided rail upon which the ride care is transported, where the current location of the ride car along the rail is detectable in any number of well-known ways including position sensors.

The prior cross-referenced art U.S. Pat. No. 10,861,267 entitled THEME PARK GAMIFICATION, GUEST TRACKING AND ACCESS CONTROL SYSTEM filed on Aug. 4, 2018, in particular teaches tracking the location of a ride car as well as determining the location of the person 20 or gamer 2s within the ride car (e.g., what seat they are positioned in,) even when for example the when ride car is not on a guided rail and is for instance a water craft floating about freely in a stream of water. This prior application discussed gathering this car and person location tracking data for input into the interactive gaming system 48, where system 48 than determined one or more “custom”/“real-time” experiences for the person 20 or at least the gamer 2s based at least in part upon any one of or any combination of the tracking data or the known game state (again, all as discussed extensively in the cross-referenced art). The cross-referenced art also discussed various means and ways for tracking the 3D location of the gamer 2s's active lenses such as 14 or 15, where then this “head tracking” or at least device tracking (including device/gamer 2s identification) was combinable with the ride car/seat/person location tracking, all of which was shown to be useable at least in part as input for determining a next-user-experience. Also shown is prior taught gamer glasses (any active lens) controller 30-comm for providing signals under direction of the interactive gaming system, again see the cross references.

The present application now extends these “custom/real-time experiences” to include colorization effects such as causing a specially coated article such as 12-1 or 12-3 to appear to “magically” change color, and/or causing an area being illuminated, or a light source itself (see FIG. 11) to appear to change color or at least be a different color as would be expected, where the colorization effects use different combinations of any of engineered light 63, special coatings 12g, and active lenses such as 14 and 15 (where it is noted that the cross-references discuss that for example a stationary window through which people are looking as they are walking for example in a ride line can also be constructed to operate as an active lens).

Still referring to FIG. 7B, the apparatus and methods discussed in relation to FIG. 7A are further incorporated into this larger expanded implementation of a light field game access point 30-1, thus in particular including back-light projector 21-p3, passive or active translucent material 12-2, and front-light projector 21-p4, where either of projectors 21-p3 or 21-p4 can provide a “secret message”/private image or video to a gamer 2s using an active lens such as 14 or 15. These apparatus and methods as discussed in relation to FIG. 7A provide for additional types of dynamic and real-time customized experiences that can be provided to either or both a person 20 or a gamer 2s that is using an active lens 14 or 15.

Those familiar with computer systems architecture will appreciate that the components as depicted are conceptual, and that other ways of arranging, sub-dividing, combining, etc. these components are possible without departing from the spirit of the present teachings. Other necessary components are not shown as would be obvious to those skilled in the necessary arts, while still yet other useful add-on components are possible, especially when considering the teachings for the prior cross-referenced art, all of which are anticipated herein such that the present depiction should be consider as illustrative of components useful for providing a specific set of customizable lighting effect experiences, rather than describing all possible components, experiences, or mix of experiences.

Referring next to FIG. 8A, there is depicted an article illumination and tracking station 30-ts comprising the combination of an article colorizing light source 30-ls working in synchronization with an article tracking station 30-ot and optionally one or more area lighting 63-3 (also then synchronized). Article colorizing light source 30-ls comprises engineered light 63-2 controllably emitting combinations of preferably narrow bands of light such as u1 (an ultraviolet band,) b1, b2, g1, g2, r1, r2 (all visible light bands,) and n1, n2 and n3 (infrared bands,) where at least some of the emissions are preferably synchronized to be in-phase (see also FIG. 8C) with the capturing of data by the tracking station 30-ot, where the capturing is accomplished using for example any combination of one or more 2D or 3D cameras (or otherwise preferably any of 2D/3D sensor technology well-known in the art) represented as 30-ot-cam1 through 30-ot-cam.

The one or more tracking sensors 30-ot-cam1 through 30-ot-cam form a tracking volume 30-tv in which a gamer 2s is required to move an article 12 such as a toy wand in order to provide input to the system, and preferably an interactive gaming system 48 (not depicted). The cross-referenced art including U.S. Pat. No. 10,719,134 entitled INTERACTIVE OBJECT TRACKING MIRROR-DISPLAY AND ENTERTAINMENT SYSTEM filed on May 9, 2018, as well as other well-known art, has provided teaching for at least using one or more cameras or depth sensing technologies to generate data within the tracking volume 30-tv sufficient for estimating the 3D location, pose (orientation,) and movement of the article 12, where this information has been prior taught to be useable for interpretation as gamer 2s command input, in some cases referred to as “spells” for example when the article 12 is a wand.

These sensors/cameras 30-ot-cam1 through 30-ot-cam4, along with an RFID reader 30-ot-rf, are preferably affixed in some arrangement to a permanent or at least rigid structure (hidden or apparent to the gamer 2s's view,) such as a representative mount 30-ot-mt of some size, material, and formation, where RFID reader 30-ot-rf is capable of reading the electronic tag 12id embedded in the tip of the article 12 (see FIG. 1B). Station 30-ot optionally includes light absorbing (or even retro-reflecting) materials 30-ot-ab to reduce diffuse reflections and gamer 2s optionally wears active lens glasses 14 that are synchronized to be in phase with the engineered light 63-2.

Light source 30-ls also preferably uses a light shaping filter 73-2 to limit the emitted light to be substantially covering the tracking volume 30-tv associated with the tracking station 30-ot within which article 12 is moved about (gesticulated) as an indication of commands, “spells,” and otherwise game inputs. A careful understanding of the present invention will show that by changing the spectral output of light source 63-2, substantially limited to the tracking volume 30-tv, it is possible to cause colorization changes to the article 12 in real-time even as the article is gesticulated, where at least some of the changes in colorization of article 12 are preferably based at least on part upon the tracking data determined by station 30-ot and/or in part upon a current game state if using an interactive gaming system 48, and more specifically at least in part upon a “successfully completed prescribed motion” interpretable for example as a “spell.”

Still referring to FIG. 8A, each of one or more optional area lighting 63-3 preferably comprises light shaped filter 73-3 and for example illuminates a volume outside of the tacking volume 30-tv. This outside volume illuminated by any of lighting 63-3 is near or substantially adjacent to, but preferably not overlapping with, the tracking volume 30-tv, such that the outside volume includes the body of the gamer 2s (where the gamer's hand holding the article 12 is then extended into and gesticulated within the tracking volume 30-tv and thus correspondingly substantially outside of any area lighting 63-3). Any of exemplary lighting 63-3 is preferably out-of-phase with the emissions of engineered light 63-2 and therefore also tracking sensors such as 30-ot-cam1 through 30-ot-cam2, where “in-phase” and “out-of-phase” are well known terms in the art of image processing and scene illumination. In-phase traditionally meaning that the scene lighting (in this case 30-ls) is substantially turned on when the sensors (such as 30-ot-cam1 through 30-ot-cam2 are substantially capturing data,) whereas out-of-phase is traditionally the opposite (see also FIGS. 8B and 8C).

Active lenses such as glasses 14 may optionally be worn by gamer 2s, where glasses 14 are then in-phase with at least some of the spectral output of article colorization light source 30-ls, and where, as prior discussed (see especially FIGS. 6A, 6B, and 7A,) additional colorization effects are made possible. For example, when a sub-channel 2 (sc2) of light source 63-2 is synchronized to provide a “private” colorization transmitted through glasses 14, while a subchannel 1 (sc1) provides a “compensating” colorization that is blocked by glasses 14, the gamer 2s substantially perceives the private colorization (sc2) effect while simultaneously a bystander (20 not depicted) watching gamer 2s perceives a combination colorization effect that is the spatial-temporal combination of the private (sc2) and compensating (sc1) sub-channels, all as prior discussed.

Still referring to FIG. 8A, but now also in combination with FIG. 1B, the operation of article tacking station 30-ot is discussed with respect to the data structures available in exemplary article 12, where these data structures comprise (i) static article characteristics data stored within electronic tag 12t detectable via wireless sensing means 30-ot-rf, and (ii) dynamic article form and movement data, preferably including a multiplicity of markers (such as 12m and 12t-r) detectable via image processing based upon images captured by one or more camera/sensors such as 30-ot-cam1.

The preferable station 30-ot comprises an electronic tag reader 30-ot-rf (of which many sufficient alternatives are well-known in the art) for reading information from, and optionally writing information to, electronic tag 12id of article 12. When approaching the preferred article tracking station 30-ts, a gamer 2s first causes the portion of the article 12 being used for the electronic storage of (i) static article characteristics data (e.g., tip 12t comprising tag 12id) to be brought into sufficient proximity of the tag reader 30-ot-rf, such that the station 30-ts is then able to obtain/electronically read the stored data, where the stored article 12 data preferably includes at least one unique identifier usable for determining for example the “type of article” 12 (e.g., a “Voldermort” vs. “Harry Potter” wand) and/or a “specific article” 12 (e.g., “serial number xyz”).

Those familiar with wireless tag reading such as enabled using different RFID frequencies will understand that “proximity” is an equipped parameter and easily ranges between 10 cm when using low frequency RFID to 12m when using ultra-high frequency (UHF) RFID frequencies, and where what is known in the art as the shape/read-field of an RFID antenna can also have a significant effect on what is “proximal” enough for tag 12id detection. Thus, the present invention should not be unnecessarily limited with respect to the distance between the tip ID 12id and the reader 30-ot-rf, for example to a “touch”/contact or near contact, but rather includes any arrangements available using known, or to become known, tag reader technologies.

As will also be understood, the electronic tag 12id can be implemented in other “wireless signal” technologies including NFC (near-field communications) that is typically limited to detection within roughly 4 cm. Three advantages with respect to the objects of the present invention for using NFC as opposed to RFID include: (i) that it requires a closer “touch” proximity thus helping to preclude false “swipe-near-by” reads made from an insufficient distance, (ii) that a typical mobile device such as a smartphone or tablet includes an NFC reader but does not include an RFID reader, and as such an NFC readable article tip 12t could then be “tapped” to a smartphone running a game app to use for gaming functionality, and (iii) transparent NFC antennas have been produced that can for example be embedded between a traditional finger-touch capacitance layer and a display such as an LCD (to be discussed further in relation to FIGS. 12A and 12B). Given the broad range of sufficient wireless technology, preferred or otherwise, the present invention should not be limited to a particular wireless technology, but rather understood in a functional sense to be transferring information by wireless means between the article 12 and any of a game access point device, such as a smartphone, tablet, a display (see FIGS. 12A, 12B, 13C,) and the present object tracking station 30-ot.

Referring to FIG. 8A, those skilled in the art of object tracking systems will recognize that object tracking is typically confined to a spatial (not necessarily geometric as depicted) tracking volume 30-tv as determined by the arrangement of one or more tracking sensors 30-ot-cam1 (where sensors 30-ot-cam1 are for example any of a 2D or 3D camera, a “time-of-flight” sensor such as Analog Devices ADTF3175 1 megapixel sensor that detects pixel depth to within 3 mm over distances between 4 centimeters to 4 meters, a 2D or 3D camera combined with structured lighting, a wireless sensor for wi-fi signal detection using an active wireless signal such as Bluetooth, or any other well-known “local positioning system” (LPS) solution or combinations thereof). A preferred object tracking system 30-ot uses one or more of any combination of time-of-flight sensors such as the ADTF175 and/or 2D or 3D cameras (the one or more combination represented as 30-ot-cam1 through 30-ot-cam4, and 30-ot-cam5-below 30-ot-cam3 but not labeled) that are sufficient for sensing article 12 dynamic article form and movement data (ii) including markers 12m when using 2D or 3D cameras, although any 3D position and orientation (pose) tracking solution is sufficient. Regardless, any number of object tracking sensors such as 30-ot-cam1 through 30-ot-cam5 for establishing sufficient tracking volume 30-tv, as well as electronic tag reader 30-ot-rf, are preferably mounted on sensor mount 30-ot-mt, where mount 30-ot-mt is not limited with respect to form, material, size, or otherwise any of its characteristics, as many variations are possible (thus the present depiction of 30-ot-mt is exemplary and not limiting).

Again, referring to FIGS. 8A and 1B, a careful consideration will show that it is possible to implement a special coating for application on article 12 comprising areas of non-visible narrow frequency band response for use as one or more of markers 12m, where for example markers 12m absorb, reflect, or fluoresce in the UV or IR region outside of the visible spectrum such that markers 12m are substantially not visible to a person 20. As a careful consideration will also show, and as will be understood by those familiar with coatings and image capture and processing, it is possible that the article 12 can be coated for a uniform visible spectrum response across the entire surface of article 12, including shaft 12s comprising markers 12m, thus appearing as a single colorization to a person 20 at any given time as illuminated by any visible light spectral output of an engineered light 63, while also comprising non-visible spectrum response markers in limited locations (such as the depicted shaft 12s bands 12m-r1, 12m-r2, and 12m-r3) that are detectable by a camera 30-ot-cam capable of sensing in the non-visible portion of the spectrum (such as UV and IR).

Especially as discussed with respect to FIG. 3H, use of a multispectral or hyperspectral camera (e.g., capable of sensing a majority of narrow bands u1, b1, b2, g1, g2, r1, r2, n1, and/or n2) is advantageous for segmenting (a) the foreground article 12 with a first distinct visible colorization (such as narrow bands b2, g2, and r2 comprising a sufficiently high reflectance such as 40% reflectance, while narrow bands b1, g1, and r1 comprise a sufficiently low reflectance such as 0% reflectance,) and a first distinct non-visible colorization (such as narrow bands u1 and n2 comprising a sufficiently high reflectance such as 40% reflectance, while narrow band n1 comprises a sufficiently low reflectance such as 0% reflectance,) and (b) its markers 12m with a second distinct non-visible colorization (such as narrow bands u1 and n2 comprising a sufficiently low reflectance such as 0% reflectance, while narrow band n1 comprises a sufficiently high reflectance such as 40% reflectance,) from (c) the background including the skin and clothes of the gamer 2s with a third distinct visible or non-visible colorization (such as any of neighboring narrow band combinations b1-b2, g1-g2, r1-r2, or n1-n2 comprising a sufficiently high difference in reflectance, e.g., greater than 20%).

A typical “multispectral” camera as sold by Spectral Devices of Ontario, Canada captures the visible frequency bands of red, green, and blue along with a near infrared (NIR) band, where these frequency bands often have a FWHM of roughly 50 nm or more centered at their respective peak frequency, all as will be understood by those familiar with the concepts of sensor spectral response. However, custom multispectral devices can be manufactured at least by Spectral Devices to sense even narrower frequency bands, e.g., with FWMH's of 20 nm centered at their respective peak frequency. This allows sensing different intensities in “6P” narrow bands centered at for example 445 nm, 465 nm, 525 nm, 545 nm, 615 nm, and 635 nm (see discussions especially related to FIGS. 2B, 3A, 3C, 3D (“9P”), 3F, 3H, and 3I regarding engineered light 63 emissions in narrow bands corresponding to special coatings 12g,) and additionally in one or more non-visible bands centered for example at 350 nm, 780 nm, or 800 nm. Companies such as Spectricity of Belgium are currently developing what are referred to alternatively as “hyperspectral” sensors with the ability to sense up to 100 different narrow bands, where each narrow band can be 5 to 30 nm in FWHM, centered at a peak frequency located over the spectral range from 350 nm (UV) through visible light to 1000 nm (NIR).

Still referring to FIGS. 1B and 8A, what is important to see is that a tracking volume 30-tv is established and apparent to the gamer 2s, and that the combination of the static dataset (i) provided to the station 30-ot by the use of electronic tag 12id and the dynamic dataset (ii) provided to the station 30-ot by use of at least article markers 12m (as well as preferably tip reflector 12t-r) work in combination to enable cross-article generalized article gesture tracking. (All as will be discussed further in the ensuring specification.)

What is also important to understand is that the static dataset (i) is provided before the commencement of article 12 tracking within the tracking volume 30-tv. As prior stated, static data (i) preferably includes information for identifying the physical characteristics of the article 12, such as size, shape, color, where for example this physical characteristics data is either stored in electronic tag 12id or is associated (for example in a database external to article 12) with one or more unique IDs (such as an article class ID or article type ID) that are stored in tag 12id, where system 30-ts subsequently receives, retrieves or otherwise determines the physical characteristics data associated with the article 12 based at least in part upon computer processing of the one or more unique IDs read from article 12, for example where processing includes accessing a database.

Static data (i) regarding the article preferably also includes information regarding any of tracking markers 12m including relative or absolute sizes and locations with respect to other markers 12m and or the article 12 itself as well indications of the expected visible and non-visible (tracking energy) spectral responses of any given marker 12m, where spectral response information for example comprises visible coloration (preferably within one or more given lighting condition(s) such as “natural,” “florescent,” “incandescent,” or “LED,” each with an associated spectral output) expressed in a color scheme such as “rgb” of “hsi,” or the anticipated absorption/reflection/transmissivity centered at a given peak, with a given fullwidth at half maximum, all information of which will be well understood by those familiar with marking compounds, object tracking, image processing, lighting systems, light sensors and spectral response curves.

As will also be understood by those familiar with image processing, it is desirable for an article tracking station 30-ot included in a game access point such as 30-2 (see FIG. 9A) to be adapted to determine characteristics of the current ambient lighting, for example using lighting condition sensors (not depicted, but well-known) for providing input to help adjust/control any of cameras 30-ot-cam1 through 30-ot-cam5 (where light sensors are also often embedded in cameras,) where for example if the ambient light includes a component of variable lighting such as from a typical outdoor setting, this variability is preferably sensed and characterized for use in the generalized algorithm because it is known to effect the spectral response of the article 12 and its markers 12m or reflector tip 12t. It is also possible to design the lighting available or activated at the tracking station 30-ts to optimize the conditions for article 12 gesticulation tracking. Optimizing includes real-time control of either the visible frequencies or non-visible tracking energies/frequencies being emitted by article colorization light source 30-ls (either comprised within or under the control of) the tracking station 30-ts,) at least the lighting substantially illuminating the tracking volume 30-tv, and/or controlling the timing of the sensing and capturing of tracking volume 30-tv data regarding the article 12 by a sensor such as 30-ot-cam1, where controlling the timing includes aligning the phases of emitting visible or non-visible frequencies of light with the timed exposure and sensing of the light (e.g., image capturing,) referred to herein as being “in-phase.”

Still referring to FIG. 1B in combination with FIG. 8A, electronic tag 12id preferably also includes gamer characteristics static data (i) that is either stored in electronic tag 12id or is associated (for example in a database external to article 12) with one or more unique IDs (such as an gamer ID, avatar ID or gamer ticket number) that are stored in tag 12id, where system 30-ts subsequently receives, retrieves or otherwise determines the gamer characteristics static data (i) associated with the article 12 based at least in part upon computer processing of the one or more unique IDs read from article 12, for example where processing includes accessing a database.

Gamer characteristics may include physical characteristics of the gamer, preferably measured prior to a set-period of gamer activities (e.g., a day of theme park activities or 2 hours of video gaming,) where the measured characteristics are not expected to change within the set-period (e.g., day at park, gaming session,) where preferably the interactive gaming system operating in a current game modality (such as theme park activity gaming, video gaming, interactive board game, etc.) is adapted to detect the beginning and end of the set-period for associating with the gamer characteristics, and where gamer characteristics include for example current within set-period gamer facial image(s), skin color and clothing. Again, such characteristics are preferably pre-measured by the system prior to a set-period of gaming and therefore before the gamer engages in any article 12 gesticulation for detection and use as gamer input by the system (such as via a game access point 30-2) during the set-period, where some characteristics are anticipated to change more frequently (such as clothing) versus less frequently (such as skin color) and can therefore be pre-measured at differing frequencies.

Still referring to FIG. 1B and FIG. 8A, it is even possible that a game access point in used by a modality of the multimodal interactive gaming system, such as power casting point 30-2 (FIG. 9A) or a computer and screen for running a video game access point 30-7 (FIG. 13A,) is adapted with one or more sensors such as a 2D or 3D camera/imaging sensor for scanning or otherwise capturing gamer characteristics substantially just prior to the set-period, and for example just after the gamer has used the article 12 to provide static characteristics such as a gamer ID (e.g., by causing the tip 12t of the article 12 to come into sufficient proximity of an access point tag reader such as 30-ot-rf,) where then the game access point (comprising an object tracking station 30-ot) uses the just captured characteristics to aid in article 12 gesticulation tracking and optionally also either stores on electronic tag 12id or associates in an database external to article 12 any of the captured gamer characteristics (for optionally later use by any modality of the multimodal interactive gaming system).

The present invention anticipates for example that a gamer 1 playing a video game (access point 30-7, FIG. 13A) as a mode of a multimodal game has gamer characteristic data determined by the video game computing apparatus 20-4 available to that mode (see for example FIG. 13A, where the gaming mode is a video game executed on computer equipment 20-4 for example including a camera 20-4c (or otherwise any sensor for determining gamer characteristics,) where any of the determined gamer characteristics are then stored in an external database in association with a gamer ID, where the external database is then for example accessed by another gaming mode (such as a theme park game access point 30-2) of the multimodal game, where for example the characteristic data include any one of or any combination of 2D or 3D facial images or data, skin color measurements, and current gamer clothing characteristics, and where the measurement characteristics are defined as sensed in relation to any of the visible or non-visible spectrum and/or in a relation to known or sensed ambient lighting conditions.

Referring next to FIG. 8B, there is shown a conceptual arrangement of an article colorization light source 30-ls illuminating a tracking volume 30-tv of an article object tracking station 30-ot, where the tracking volume 30-tv is being sensed by at least one camera such as 30-ot-cam capturing temporally alternating images such as “image A” and “image B” (see FIG. 8C,) and were each of images A and B comprise spatially overlapping representations of light sensed from the visible spectrum with light sensed from the non-visible spectrum. Tracking volume 30-tv is a volume of space preferably sensible by at least one such camera 30-ot-cam, as well as other possible sensor types as previously discussed and/or currently known within the art or to become known, where for example in FIG. 8A five (5) such cameras 30-ot-cam are portrayed (i.e., 30-ot-cam1 through 30-ot-cam4, plus 30-ot-cam5 depicted below 30-ot-cam3 but not labeled).

As those familiar with object tracking systems will appreciated, tracking volume 30-tv is defined as an intersection of the fields-of-view of all combining sensors, where this combined intersection is portrayed as geometric but in practice is indefinite in shape. However, as will also be appreciated, some portion of the tracking volume 30-tv is optimal for sensing and what is desirable is that a gamer 2s substantially understand the location of this optimal tracking volume 30-tv for inserting their article 12, such as a wand, to be then gesticulated and tracked for providing commands and game input. It is possible and more traditional, that some combination of physical structure(s) and/or visual markings are provided to the gamer 2s for demarcating tracking volume 30-tv.

The present invention teaches additionally, and preferentially, that tracking station 30-ot is used in combination with a article colorization light source 30-ls, and that the article 12 comprising a special coating 12g, such that when the article is detected as being present within tracking volume 03-tv by the tracking station 30-ot, station 30-ot is capable of communicating with light source 30-ls to cause a change in the output of engineered light 63-2, which then in turn causes a visual change in the appearance of special coating 12g on wand 12 as perceived by the gamer 2s. For example, when a gamer 2s substantially first inserts their article 12 into tracking volume 30-tv, the present system acts to cause the article 12, optionally based at least in part upon any of prior sensed static data (i), to change in colorization such as become “more red,” “lighter,” “darker,” “only green,” etc.

Still referring to FIG. 8B, light source 63-2 preferably emits multiple narrow bands of blue, green, and red light to be first filtered/focused through a light shaping lens 73 such that it is possible and preferred that the volume substantially illuminated by light source 63-2 is always withing tracking volume 30-tv, and then also preferably less than tracking volume 30-tv to some extent, thus encouraging the gamer 2s to insert article 12 fully into tracking volume 30-tv to then be “colorized,” all as a careful consideration will show. A careful consideration will also show that while camera sensors such as 30-ot-cam are likely positioned looking at some angle out through volume 30-tv and towards gamer 2s, thus having potentially “infinite” fields-of-view, light source 63-2 is preferably and normally expected to be situated substantially above volume 30-tv, thus especially using light shaping filter 73 helping to create a “vertical column” for limiting 30-tv although sensors such as 30-ot-cam technically “sense-beyond” this vertical column.

Referring now to both FIGS. 8A and 8B, it is portrayed that for example the gamer 2s and any other bystanders are standing outside of the tracking volume 30-tv, themselves being substantially illuminated by a separate out-of-phase light source such as 63-3 (preferably comprising light shaping filter 73-3,) while article 12 is illuminated by the in-phase light source 63-2. Those familiar with imaging systems and lighting will appreciate that this arrangement has the imaging effect of darkening the background of images A and B being captured by a camera such as 30-ot-cam, while also lighting the foreground comprising article 12 and possibly some of gamer 2s such as their hand and arm as depicted.

Referring now exclusively to FIG. 8B, a preferred sensor being a camera 30-ot-cam, preferably comprising the ability to capture spatially overlapping representations of at least a portion of the tracking volume 30-tv, where a first representation is formed based upon the visible spectrum and is depicted as captured by visible light sensor 30-ot-cam-vl, while a second representation is formed based the non-visible (e.g., “near infrared”/NIR) spectrum and is depicted as captured by visible light sensor 30-ot-cam-ir. Those familiar with imaging systems will understand that there are multiple known ways for capturing substantially simultaneous images of a substantially spatially overlapping volume such as 30-tv, including that camera 30-ot-cam comprising two distinct cameras (e.g., then potentially being a combination of 30-ot-cam1 and 30-ot-cam2 as depicted in FIG. 8A). However, it is preferred and well-known that full-spectrum light can be captured through a single lens 30-ot-cam-In which is then for example passed through what is referred to as a “frequency beam splitter” 30-ot-cam-bs, where the beam splitter 30-ot-cam-bs then causes substantially only visible light to transmit to sensor 30-ot-cam-vl and only non-visible/NIR light to transmit to sensor 30-ot-cam-ir.

Other possible arrangements are also well known where the full spectrum light entering lens 30-ot-cam-In is alternatively passed through what is referred to as an “intensity beam splitter” such that for example substantially 50% of the full spectrum light is transmitted to sensor 30-ot-cam-vl while the remaining 50% is transmitted to sensor 30-ot-cam-ir, and where then sensor 30-ot-cam-vl is further adapted to include a light filter for substantially transmitting only the visible spectrum while sensor 30-ot-cam-ir is further adapted to include a light filter for substantially transmitting only the non-visible NIR spectrum, all as will be well understood by those familiar with cameras and sensors. Thus, the presently depicted and preferred arrangement of core components of camera 30-ot-cam should be considered as exemplary, rather than as limiting the current invention as many other well-known arrangement are possible.

Still referring to FIG. 8B in at least one alternative arrangement, either or both of sensors 30-ot-cam-vl and 30-ot-cam-ir are further adapted to include what is often referred to as “micro-lenses” used to create a “light field,” (30-ot-cam-lf1 and 30-ot-cam-lf2, respectively,) where as is well-known, light fields typically sacrifice spatial resolution to gain some amount of depth information, thus providing data useful for at least determining that a surface is angled in a certain orientation. And finally, it is also noted that sensors 30-ot-cam-vl and 30-ot-cam-ir are preferably capable of substantially detecting light in at least one visible narrow band (such as b1, b2, g1, g2, r1, or r2, by sensor 30-ot-cam-vl) and one non-visible narrow band (such as n1, n2, by sensor 30-ot-cam-ir). This ability to sense narrow bands within a wider spectrum such as the visible spectrum or NIR spectrum, is well-known and accomplished using what are often referred to as multi-spectral or hyper-spectral cameras. While it is not the purpose of the present invention to teach the details and differences in the various well-known types of cameras, sensors, lenses, splitters, filters, etc., as the present invention relies upon existing camera component technologies, the particular components or their equivalents as depicted are considered to be a preferrable and useful arrangement.

Referring next to FIG. 8C, there is shown a table describing a preferred dataset, as captured by exemplary camera 30-ot-cam, where the dataset is used for image processing by the article object tracking station 30-ot. The table is divided into three sections including “Image A,” “Image B,” and “Threshold A/B affect,” where each of these three sections includes a column labeled “Visual” and a column labeled “NIR.” The Visual column represents data captured by visible light sensor 30-ot-cam-vl, whereas the NIR column represents data captured by visible light sensor 30-ot-cam-ir. The first labeled row of the table limits that row and the next four rows to describing sensed image data that is “Inside Tracing Vol” 30-tv (thus including article 12 and therefore including all of the “foreground” with some “background” such as a gamer's hand that is holding the article,) whereas the last labeled row is limited to describing sensed image data that is “Outside Tracing Vol” 30-tv (thus not including article 12 and therefore all “background.”)

Those familiar with image processing in general, and object tracking specifically, will recognize the importance “segmenting” image data to accurately differentiate between the image pixels representing the “foreground of interest” (the article 12 such as a wand) and the “background”/everything-else. The present invention teaches a combination approach to “best segmenting” including: 1) limiting the tracked object to a specified tracking volume 30-tv, 2) separately illuminating the tracking volume 30-tv using a light source 63-2 that is preferably in-phase with the capturing of the images to be processed, such that at least the article 12 (foreground) is more brightly illuminated, 3) separately illuminating the surrounding non-tracking volume thus excluding 30-tv using a light source 63-3 that is preferably out-of-phase with the capturing of the images to be processed, such that at least the non-article 12 (background) that is not within the tracking volume 30-tv is less brightly illuminated, 4) using a special coating 12g on the article 12, where the coating 12g can be caused to appear to change color by changing the frequencies of light being emitted by the in-phase lighting 63-2, such that the gamer 2s has a visual indication that the article is properly located within the tracking volume 30-tv, 5) using a special coating 12g on the article 12g, where the coating comprising markings 12m that are substantially not perceived by the gamer (in the visible spectrum) but can be detected by the camera 30-ot-cam in the non-visible spectrum such as near infrared (NIR), 6) using a special coating 12g on the article 12g, where the “reflectance” of coating 12g across the visible and non-visible portions of the spectrum has at least one substantial “net reflectance change” within a “reflectance band” (frequency frequency) over which the gamer's skin type is typically expected to have a substantially different “net reflectance change,” such that any pixels representative of the gamer's skin (background) that are at least present within the tracking volume 30-tv are more readily distinguishable from any pixels representing the article 12 (see FIG. 3H for more discussion,) 7) using a special coating 12g on the article 12g, where the “reflectance” of coating 12g across the visible and non-visible portions of the spectrum has at least one substantial “net reflectance change” within a “reflectance band” (frequency frequency) over which typical clothing is expected to have a substantially different “net reflectance change,” such that any pixels representative of the gamer's clothing (background) that are present at least within the tracking volume 30-tv are more readily distinguishable from any pixels representing the article 12 (see FIG. 3H for more discussion,) and 8) changing the spectral emissions of tracking volume 30-tv in-phase light source 63-2 to be different in alternating “A/B” (or similar) images, such that at least the pixels representative of markers 12m on article 12 are caused to have substantially different detected pixel values in a first image (such as A) as compared to a second image (such as B) (herein referred to as “blinking”).

Still referring to FIG. 8C, alternating images “A” and “B” are preferably captured at a higher combined frame rate, e.g., 120 “frames (images) per second” (“fps,”) and thus each of images A and images B sharing this combined frame rate will also be of a higher individual frame rate, in this case 60 fps, where those familiar with the image processing for object tracking of faster moving objects will appreciate that higher framerates have the effect of minimizing the “movement” of the same pixels (foreground or background) between captured images, and where a careful consideration of the present use case will show that it is expected that an article 12 (toy wand) will be tend to be gesticulated with faster motion. Although the present example is being taught with two alternating frames A and B, each sharing a combined frame rate, those skilled in the art will understand that current cameras are already capable of significantly faster frame rates of 240 fps, 1,000 fps, and even higher. A careful consideration of the present teachings will also show that the advantage of creating sequential images with limited foreground pixel motion between images, where the light source 63-2 is caused to substantially change a foreground pixel's detected value (thus “blink”), can be extended to more than alternating “A/B” images, for example to alternating “A/B/C” images, etc.

Those familiar with image processing will also understand that as image frame rates are increased, the corresponding “integration time” (sometimes referred to as “exposure time”) of any given image necessarily decreases, where then this decrease reduces the time available to the sensor for absorbing/collecting photons of light, and where this reduction in absorbed photons is a direct reduction of the “signal” which can have a negative impact on the image processing algorithm. There are many well-known ways of offsetting this decrease of signal ranging from opening the lens aperture to let more light reach the sensor, to increasing what is known as the “electronic gain” that then effectively amplifies the reduced signal after it is captured to an increased signal, both approaches (as well as other approaches) having well-known negative tradeoffs.

Those familiar with image processing will also understand that by using a separate light source 63-2 that is in-phase with camera 30-ot-cam, and therefore timed to be emitting light when the sensors 30-ot-cam-vl and 30-ot-cam-ir are timed to be integrating light (and otherwise preferably turned off), where this light source 63-2 preferably emits at least some frequencies in the non-visible portion of the spectrum such as NIR, it is possible to substantially increase the at least the non-visible (e.g., NIR) light being “flashed” from the light source 63-2 as a means for providing more “signal”/NIR photons during the shortened integration times. It will also be understood that “blinking” A vs. B includes providing an increased illumination of at least one narrow frequency band during one captured frame (e.g., “A”), while then providing a decreased illumination of the same at least one narrow frequency band during the next captured frame (e.g., “B”), and that the temporal combination of increased frame A illumination and decreased frame B illumination is an average illumination that is substantially less than the brightest (e.g., frame A) levels, where often the average emitting light over a time period is of most interest when considering issues of human eye safety, and thus blinking also has an advantage in this eye-safety regard.

Still referring to FIG. 8C, the preferred engineered light source 63-2 emits spectral output comprising two or more narrow bands within each eye response blue, green, and red, all as prior discussed and for example including the emission of some combination of visible narrow bands b1, b2, g1, g2, r1, r2, as well as a non-visible narrow band such as n1 all emitted during integration and capturing of image A, and then some combination of visible narrow bands b1, b2, g1, g2, r1, r2, as well as a non-visible narrow band such as n2 all during integration and capturing of image B (see the row labeled “Inside Tracking Vol”). As a careful reading of the present invention and a consideration will show, by emitting some combination of at least b1 or b2, and g1 or g2, and r1 or r2, where the relative emitted luminance of the “1”'s and “2”'s may be different (see FIG. 3G,) it is possible to cause a gamer 2s to perceive the combined emission of light source 63-2 as being substantially “white” during the ongoing capturing of images A and B (see the columns of the present table under “Image A,” “Image B,” and “Thresholded A/B affect” labeled “Visual Appearance,” i.e., to a person such as gamer 2s).

Staying within “Image A”/“Visual Appearance,” while the light emitted by source 63-2 appears white (i.e., “Inside Tracking Vol,”) it is also possible that the “Article A: surface” also appears white, or at least cream, for example assuming that the special coating 12g on the article 12 reflects (b1, g1, r1) while for example absorbing (b2, g2, r2) as indicated in the “Image A”/“In-Phase Lighting (radiance limited)” column of the table. A careful reading of the present invention will teach that for example substantially doubling the luminance of b2, g1, and r2, while also reducing the luminance of b1, g2, and r1 to zero will still cause the perception of white light emitting from source 63-2, while then also cause the article 12 coating 12g to substantially only reflect “g1” (and not “b1” or “r1”) and thus article 12 appears to gamer 2s to be substantially green, where many other combination of visual effects are possible as taught and/or implied herein.

It is noted that by causing the article 12 to appear to change color such as from white to green when spatially located within tracking volume 30-tv, the system is providing important visual confirmation to the gamer 2s, where many other real-time changes to colorization are possible as the gamer 2s gesticulates article 12 within volume 30-tv, such as turning the article from green to a red or blue color after the gamer 2s “flicks” the article tip 12t in a specific command motion, e.g., a “V” motion, and thus it is important to see that the present invention provides an important new means for visual feedback to the gamer 2s as the gamer 2s engages the interactive gaming system in general, and a game access point such as 30-2 (of FIG. 9A,) 30-3 (of FIG. 9B,) or 30-5 (of FIG. 11) in particular.

Still referring to FIG. 8C, the “Visual Appearance” of “Article A: marker” (12m) will be “not apparent” to gamer 2s, as the marker(s) 12m are preferably formed using a top fluorescer layer that absorbs “n1” energy (to be fluoresced as n2, thus labeled under the “radiance limited” column as “f (n2)”) but otherwise transmits substantially all visible energy, as will be appreciated by a careful reading of the present invention as well as an understanding of non-visible marking substances including fluorescers. As will also be appreciated from a careful consideration, the apparent visual appearance of the gamer's “skin (nearby)” to the article 12, such as their hand that is within tracking volume 30-tv, will be substantially the “normal color,” especially as the bands b1-b2, g1-g2, and r1-r2 combine to provide “white light.” Likewise, “clothing (nearby)” (i.e., within the tracking volume 30-tv) is expected to appear substantially the “normal color,” while it will also be understood that some color variation will be possible as compared to being illuminated in sunlight, but that due to the broader spectral response (thus slowly changing over a wider frequency range) of the colorization substances of typical clothing (and skin,) changes to the color of the clothing (and skin) will not be as pronounced as will changes to the colorization of the article 12 (since the coating 12g has narrower spectral responses changing “more quickly” over a narrow frequency range aligned to be in or out of the emitted spectra of light, all as prior discussed). Hence, “nearby skin and clothing” is shown as “radiance limited” to substantially equally reflecting or absorbing b1 and b2, and likewise equally reflecting or absorbing g1 and g2, and finally also equally reflecting or absorbing r1 and r2, worded in the table as “r/a equally (all pairs),” (where again, “equally” should be understood as preferably at least “substantially similar.”)

Still referring to FIG. 8C, and now specifically to column “Image A”/“NIR appearance” (thus the non-visible “appearance” to a sensor such as 30-ot-cam-ir,) the “Article A: surface” will be detected by sensor 30-ot-cam-ir as substantially “very dark” as its coating 12g has been specially crafted to only reflect the “n2” narrow energy band, which is not presently emitted by light source 63-2 during the capturing of image A. However, although narrow energy band n2 is not currently being emitted during image A, band n1 is being emitted, where energy band n1 is then absorbed and reradiated (fluoresced) as n2, and thus “Article A: marker” (12m) do “appear” to sensor 30-ot-cam-ir as “bright (n2)” (and also “dark (n1)”). Since sensor 30-ot-cam-ir is preferably a multi-spectral sensor capable of sensing for example the “non-visible colors” of n1 and n2, both “skin (nearby)” and “clothing (nearby)” are expected to appear to multi-spectral sensor 30-ot-cam-ir as “bright (n1), dark (n2)” and “normal (n1), dark (n2),” respectively. As shown in FIG. 3H, human skin of at least the Caucasian and African types reflects/absorbs substantially equally n1 and n2 (thus labeled in the table as “r/a equally (all pairs)”), where any particular given clothing is likewise expected to reflect or absorb both n1 and n2 substantially the same/“equally.”

As a careful consideration will show, given the functionality of the present teachings, it is possible to “segment” or otherwise differentiate pixels representing “nearby skin and clothing” as opposed to pixels representing markers 12m or pixels representing article surface that is not a marker 12m by for example using an algorithm that finds the relative differences between sensor 30-ot-cam-ir n1 vs. n2 pixel neighbors. Hence, neighboring n1 and n2 pixels within sensor 30-ot-cam-ir representative of skin and clothing will have a higher (“brighter”) n1 pixel value as compared to a lower (“darker”) n2 pixel value. Conversely, neighboring n1 and n2 pixels within sensor 30-ot-cam-ir representing the markers 12m will have a lower (“darker”) n1 pixel value as compared to a higher (“lighter”) n2 pixel value. And finally, neighboring n1 and n2 pixels representing the surface of article 12 that is not a marker, skin, or clothing, are expected to have neighboring n1 and n2 pixels within sensor 30-ot-cam-ir with a lower (“darker”) n1 pixel value and a lower (“darker”) n2 pixel value.

Still referring to FIG. 8C, a careful review of the “In-Phase Lighting (radiance limited)”/“Inside Tracking Vol” table cell for “Image B” vs. “Image A” will show that the difference is the emission of “n2” by light source 63-2 during the integration and capturing image B vs. the emission of “n1” during image A. As can also be seen in the row Article A: marker, n2 energy is substantially absorbed by the coating 12g substances comprising marker(s) 12m, and thus in the NIR Appearance as sensed by sensor 30-ot-cam-ir, the markers 12m appear to be “dark (n1), dark (n2).” Since image B is captured under “n1”=off/“n2”=on, lighting, skin (nearby) now appears to be “dark (n1), bright (n2),” while clothing (nearby) now appears to be “dark (n1), normal (n2).”

A careful consideration will show that using neighboring pixel differences, an algorithm is able to segment marker 12m pixels from nearby skin and clothing pixels, similar to the discussion above for image A. Furthermore, a careful consideration of the differences between the n1/n2 spectral responses of the article surface, the article markers, nearby skin, and nearby clothing, can be compared between time sequential images A and B, where pixels representative of the article surface will tend to be “identical” (as shown in the “Threshold A/B affect”/“NIR Appearance” column of the present table,) whereas article marker 12m pixels will appear to “blink” in the “n2” narrow band (while being substantially identical in the n1 narrow band). Furthermore, nearby skin and clothing will tend to blink in both the n1 and n2 bands. Thus, those familiar with image processing will recognize several possible algorithms for differentiating/segmenting article 12 surface (12s including 12m) from article 12 markers (12m) from nearby skin and nearby clothing, where these multiple possible algorithms are made possible by the specific apparatus and methods described herein, or otherwise made obvious by the present teachings as many variations are possible.

Still referring to FIG. 8C, and now specifically to the bottom row labeled “Outside Tracking Vol,” many pixels captured by sensors 30-ot-cam-vl and 30-ot-cam-ir are expected to be of objects that are beyond or otherwise outside of the tracking volume 30-tv (thus pure “background,” see FIG. 8B image 30-ot-cam-img) where then these out-of-volume 30-tv pixels are being substantially illuminated by “out-of-phase lighting” source 63-3 such that the resulting pixel values will tend to be consistently lower (“darker”) than any pixels representing objects such as article 12 (surface and markers) as well as nearby skin and clothing that are currently spatially located within volume 30-tv and therefore being illuminated by in-phase lighting 63-2. Those familiar with image processing will also appreciate how this taught arrangement is additionally useful for better segmenting the “meaningful foreground” (e.g., the article 12 surface and makers 12m) from the background (e.g., the nearby skin and clothing as well as anything outside of the tracking volume 30-tv).

Additional algorithmic advantages will be apparent based upon the use of the presently taught apparatus and methods, where for example the article surface can also be made to “blink” in “Visual Appearance” between images A and B at least within any one or more of the visible narrow bands such as b1, b2, g1, g2, r1, and r2, where this blinking is caused by the turning on and off of the representative narrow bands emitters (e.g., LEDs within light source 63-2,) and where the human vision system of gamer 2s will integrate this high-frame-rate “A/B” blinking so as to temporally average the changing visible colors, thus being substantially unable to see the same “visible light blinking” that is detectable by sensor 30-ot-cam-vl. Thus, the presently described apparatus and methods as well as discussed segmenting algorithms should be considered as exemplary, as many variations are possible. The present table should also be considered as exemplary, as at least several variations in coatings are possible, all as prior discussed. For example, the narrow band n1 could also be a u1 band that is absorbed and emits either of an n1 or n2 frequency, or any other non-visible frequency, with many alternatives upon consideration.

Referring next to FIG. 9A, there is shown a perspective drawing of a power casting game access point 30-2 comprising an article illumination and tracking station 30-ts for interacting with a gamer 2s to determine one or more commands such as a spell based upon the gamer 2s's tracked gesticulations of an article 12. See the prior FIGS. 8A, 8B, and 8C for more discussion on the apparatus and methods associated with station 30-ts. What is important to see for power casting game access point 30-2 is that it builds upon article illumination and tracking station 30-ts to add additional gamification apparatus and methods, where this modular approach to building new game access points with different gamer 2s and non-gamer 2o experiences will be shown in other variations with respect to upcoming FIGS. 9B and 11, and where the careful reader will see the generalization and be able to apply station 30-ts to additional new variations of game access points.

Still referring to FIG. 9A, article illumination and tracking station 30-ts serves to track the gesticulations of an article 12 by a gamer 2s, where these tracked gesticulations are translated by the system into commands or otherwise data input, where such commands or data input are for example interpreted as “spells,” “blessings,” or “curses,” to be cast upon the non-gamer 2o. The power casting game access point 30-2 is preferably in communication with the interactive gaming system (see especially the cross-referenced U.S. Pat. No. 10,974,135 entitled INTERACTIVE GAME THEATER WITH SECRET MESSAGE IMAGING SYSTEM filed on Sep. 27, 2018,) where commands and data input can preferably interpreted with respect to an on-going game. All game access points preferably include means for determining the gamer 2s (or at least the anonymous “avatar” representing gamer 2s, see U.S. Pat. No. 10,974,135 above,) where also the present game access point 30-2 preferably also has sufficient means for identifying the non-gamer 2o. Regarding the determination of the “gaming identity” of gamer 2s, this for example can be comprised as electronic data held within article 12 as stored electronic data in electronic tag 12id, where then as prior discussed any electronic data on the tag 12id is readable by tracking station 30-tv for example using a reader 30-ot-rf, where the electronic data may either directly identify the gamer 2s's “gaming identity” or may alternatively be for example an unique article 12 id which is then used by the interactive gaming system to “look up” or retrieve from a database the associated “gamer identity” “registered” with the article 12 id, all as will be understood by those familiar with software and database systems.

Similarly, if the gamer 2s is also using gamer active filter(s) lenes such as glasses 14 or magnifying glass 15, generally referred to as “mobile gaming devices” all as discussed in the cross-referenced patent U.S. Pat. No. 10,974,135, the tracking station 30-ts is preferably also equipped with wireless means (such as Bluetooth) for communicating with any mobile gaming device for determining the gamer identity or information usable at least in part by the interactive gaming system for determining gamer identity. It is also noted that non-gamer 2o may actually also be a gamer 2s with a gamer identity that is also determined by the game access point 30-2 using any of available means, and in this way the actual special effects that can be implemented by game access point 30-2 can be at least in part dependent upon any combination of the gamer 2s's identity and associated game state and/or the non-gamer 2o's gamer identity and associated game state.

Still referring to FIG. 9A, it is preferred that non-gamer 2o stands behind the display surface 22-1, where the display surface 22-1 can be implemented using either of a display technology or a projector technology, where with a projector (not depicted) the display surface 22-1 is used to reflect images emitted by the projector, all as a careful consideration will show. Once advantage of using a projector/passive surface combination is that the passive surface acting as the display surface 22-1 can be of any 2D or 3D shape and more easily supports having at least one “hole” for the non-gamer 2o to insert for example their head (such as opening 22-10) or perhaps their arm(s) or leg(s). Using a custom shaped 2D or 3D surface, the projected images may then also be “projection mapped” onto the custom shaped 2D or 3D display surface 22-1, creating an even more unique and exciting visualization effect(s). Alternatively, display surface 22-1 can also be any of display technology such as LCD or OLED, where many of the newer display technologies are also flexible and can be shaped to some extent (e.g., curved).

Still referring to FIG. 9A, regardless of the technology chosen for implementing the display surface 22-1, again either of a display emitting from and as surface 22-1 or projector reflecting off a surface 22-1, and regardless of the type, location, and number of openings such as 22-10, it should be seen that a gamer 2s uses the article illumination and tracking station 30-ts to preferably identify themselves and also to entering one or more commands or otherwise data input, where the commands or data input are preferably communicated to an interactive gaming system for determining a response in accordance with a current game state, or where alternatively the game access point 30-2 determines a response, and where the response includes at least causing a change to the visualization perceived by a person when looking at display surface 22-1. In at least one example, the non-gamer 2o is “turned into” a game character (such as “dobby” from the Harry Potter stories, as depicted,) or is “exploded” or colorized, or any of limitless effects.

Those familiar with display technology will also understand that a display used as display surface 22-1 can be a “transparent display,” such that gamer 2o is visible to the gamer 2s (and other surrounding bystanders) looking through the display surface 22-1, where then any visualization change to the transparent display acting as surface 22-1 can be implemented in such a way to only partially cover the non-gamer 2o, thus “augmenting” the non-gamer 2o. It is even possible that visualization station 30-vs-1 or otherwise game access point 30-2 is further adapted to comprise at least one camera for capturing current images of non-gamer 2o, such that these captured images can be used at least in part by the game access point 30-2 and/or the interactive gaming system to determine a specific visualization. Those familiar with materials useable for a creating a 2D or 3D display surface 22-1 for used with a projector, will also understand that this material may be transparent, semi-transparent, or even “switchable” from a substantially transparent state to a substantially opaque state, thus even using a projector type display surface 22-1 is it possible to create augmentation type visualization effects.

And finally, still referring to FIG. 9A, it is also anticipated that visualization station 30-vs-1 comprises a floor 24 onto which non-gamer 2o is standing while gamer 2s is “casting spells” to create new “visualizations”/“augmentations” on surface 22-1, where using any of well known technology, floor 24 can be implemented to provide haptic/vibration/tactile feedback to the non-gamer 2o in coordination with the timing of any visualization. Many variations of power casting game access point 30-2 are possible, for example where visualization station 30-vs-1 further includes additional surrounding engineered lighting or audio systems for creating additional visual and audio effects. Thus, the present depiction of power casting game access point 30-2 should be considered as exemplary rather than as limiting the apparatus and methods to those described, where a critical feature includes creating some sort of visualization effect that appears to be “applied to” a non-gamer 2o in response to an action taken by a gamer 2s.

Referring next to FIG. 9B, there is shown a top view of the preferred components of a gamer competition game access point 30-3 comprising at the highest level of conceptualization two opposing power casting game access points 30-3-g1 (depicted on the left and being used by a first gamer 2s-g1) and 30-3-g2 (depicted on the right and being used by a second gamer 2s-g2,) as well as an interposing effects station 30-3-ie. Each of power casting game access points 30-3-g1 and 30-3-g2 operate as described in relation to FIG. 9A, where the non-gamer 2o described in FIG. 9A is now a competing gamer such that the two gamers 2s-g1 and 2s-g2, respectively, are attempting to cast spells, and otherwise compete with each other in real-time, where the effects are being visualized by each of visualization stations 30-vs-2-g1 (shown on the right as controlled by the first gamer 2s-g1 using casting station 30-3-g1) and 30-vs-2-g2 (shown on the left as controlled by the second gamer 2s-g2 using casting station 30-3-g2). Interposing effects station 30-3-ie comprises a first projector 21-p5-g1 for emitting projections to be reflected off beamsplitter 30-bs and received as visualizations by the first gamer 2s-g1, and a second projector 21-p5-g2 for emitting projections to be reflected off beamsplitter 30-bs and received as visualizations by the first gamer 2s-g2. Interposing effects station 30-3-ie comprising projectors 21-p5-g1 and 21-p5-g2 as well as beamsplitter 30-bs are preferably mounted on a movable rails system such that station can be moved back-and-forth between the two gamers 2s-g1 and 2s-g2 to create increased effects.

Still referring to FIG. 9B, the display surfaces 22-1 and 22-2 of visualization stations 30-vs-2-g1 and 30-vs-2-g2, respectively, are preferably transparent displays of which several possible technologies are well-known and more are expected to become available, where surfaces 22-1 and 22-2 may be flat (as depicted) or curved for different effects. Shown for optional use in FIG. 9A, active filter lenses 14-g1 are necessary for use by first gamer 2s-g1 and active filter lenses 14-g2 are necessary for use by first gamer 2s-g2. Lenses 14-g1 are synchronized to be open for example on a first subchannel (sc1) 63cs-1 (see FIG. 6B) and alternatively closed on a second subchannel (sc2) 63cs-2, whereas lenses 14-g2 are synchronized to be conversely open on the second subchannel (sc2) 63cs-2 and alternatively closed on the first subchannel (sc1) 63cs-1. Likewise, visualizations are presented on transparent display 22-1 in synchronization with the first subchannel sc1 such that these visualization are substantially only perceived by the first gamer 2s-g1 when looking through currently open glasses 14-g1, and not the second gamer 2s-g2 who is looking through currently closed glasses 14-g2, and visualizations are presented on transparent display 22-2 in synchronization with the second subchannel sc2 such that these visualization are substantially only perceived by the second gamer 2s-g2 when looking through currently open glasses 14-g2, and not the first gamer 2s-g1 who is looking through currently closed glasses 14-g1, all as a careful reading of the present invention and a careful consideration will make clear.

Referring still to FIG. 9B, likewise, visualizations are emitted by projector 21-p5-g1 in synchronization with the first subchannel sc1 such that these visualization are substantially only perceived by the first gamer 2s-g1 when looking through currently open glasses 14-g1, and not the second gamer 2s-g2 who is looking through currently closed glasses 14-g2, and visualizations are emitted by projector 21-p5-g2 in synchronization with the second subchannel sc2 such that these visualization are substantially only perceived by the second gamer 2s-g2 when looking through currently open glasses 14-g2, and not the first gamer 2s-g1 who is looking through currently closed glasses 14-g1. Those familiar with active shutter glasses will understand that glasses 14-g1 being worn by first gamer 2s-g1 and open to receive visualizations synchronized to subchannel sc1, will transmit all visualization light such that the gamer 2s-g1 perceives a combination of visualizations emitted by display 22-1 and transmitting directly through the beamsplitter 30-bs that is preferably aligned at a 45° angle and visualizations emitted by projector 21-p5-g1 and reflecting off beamsplitter 30-bs, all as will be understood by those familiar with beamsplitters that are also well known for use in creating special effects such as “pepper's ghost” that is a type of hologram. A similar consideration will show that second gamer 2s-g2 will perceive a combination of the visualizations from display 22-2 and projector 21-p5-g2.

Those familiar with active shutter glasses will also recognize by operating both lenses of each pair of glasses 14-g1 and 14-g2 in synchronicity, each of first gamer 2s-g1 and 2s-g2 will perceive 2D visualizations. It is possible in various ways to provide each or both of gamers 2s-g1 and 2s-g2 with 3D visualizations using well known techniques that essentially allow the left and right lenses of either or both glasses 14-g1 and 14-g2, respectively, to transmit different images, either simultaneously or in temporal sequence (see cross-referenced U.S. Pat. No. 11,025,892 entitled SYSTEM AND METHOD FOR SIMULTANEOUSLY PROVIDING PUBLIC AND PRIVATE MESSAGES filed on Apr. 4, 2019 for significant teachings on types of displays, projectors, and active lenses for creating various effects incorporated herein). For example, if a transparent display such as 22-1 or 22-2 was an OLED display, and the OLED display was further adapted to comprise a polarizer film on its surface facing inwards towards the interposing effects station, where for example the polarizer film linearly polarized every even row of pixels in the display at a first rotation such as horizontal, while the polarizer film linearly polarized every odd row of pixels in the display at a second orthogonal rotation such as vertical, then it is possible to further adapt with properly oriented polarizers the active lenses 14-g1 and/or 14-g2, respectively, such that for example the left lenses only transmit the horizontally polarized “even row” light while the right lenses only transmit the vertically polarized “odd row” light thus simultaneously presenting two different images to each eye of a gamer such as 2g-s1 and 2g-s2, respectively, causing a well-known 3D effect if the images are properly crafted.

As discussed in relation to FIGS. 2A, 2B, and 2C, it is also possible to create transparent displays where for example every even row of pixels is a first “r1g1b1 triplet” while every odd row of pixels is a second “r2g2b2 triplet,” and then where the left lenses of glasses 14-g1 and/or 14-g2 are filtered to only transmit the first r1g1b1 triplet while the right lenses are filtered to only transmit the first r2g2b2 triplet (see FIG. 2C for an example,) as is well known in the art for also creating a 3D effect. In still yet another alternative, displays 22-1 and 22-2 are operated at a higher frame rate such as 240 hz that supports four (4) temporal subchannels (sc1, sc2, sc3, and sc4) each operating at a preferred flicker-free 60 hz, and where then for example the first gamer 2s-g1 receives a current image through the left lenses of glasses 14-g1 synchronized with the first subchannel sc1 (while the right lenses are at the same time closed to sc1,) while gamer 2s-g1 also receives a current image through the right lenses of glasses 14-g1 synchronized with the third subchannel sc3 (while the left lenses are at the same time closed to sc3,) and where both the left and right lenses are both closed to subchannels sc2 and sc4, thus presenting two different images to each of the gamer 2s-g1's left and right eyes for causing the well-known 3D effect. The same temporal approach for example provides a 3D visualization to second gamer 2s-g2 using subchannels sc2 and sc4, as a careful consideration will show.

Still referring to FIG. 9B, those familiar with 2D and 3D image viewing systems will understand that there are many technologies and even combined spatial/temporal approaches such that the present invention should be seen as providing either of 2D or 3D images to a gamer without restriction as to the specific technologies implemented as each of many known technologies are possible for use with the present invention and have known tradeoffs and advantages. A careful consideration will also show that the same or similar variations in technologies are possible for projectors 21-p5-g1 and 21-p5-g2, such that the gamers 2s-g1 and 2s-g2, respectively, may likewise be made to received 2D or 3D images using interposing effects station 30-3-ie.

As a careful consideration will show, there are many useful variations of game access points such as 30-2 and 30-3, where for example access point 30-3 is limited to only include a visualization station 30-vs-2-g1 and not an article illumination and tracking station 30-ts-g2, such that first gamer 2s-g1 is not “playing against” a second gamer 2s-g2 but rather is playing against what is often referred to in video games as an “NPC”/“non-player character” that is being generated to “compete with” the gamer 2s-g1, and where these computer generated images can be output by either of display 22-2 (which then is optionally not a transparent display and also could be a projector as described in relation to FIG. 9A) or projector 21-p5-g1. As a careful consideration will also show, it is not necessary for gamer competition game access point 30-3 to include an interposing effects station 30-3-ie in order to still provide exciting visualizations to two competing gamers 2s-g1 and 2s-g2.

In yet another variation of access point 30-3, a plurality of non-gamers or otherwise “bystander” teammates are able to stand and watch the competition between gamers 2s-g1 and 2s-g2, where these teammates for example are using their smartphones with a gamming app to operate an app in real-time as input to the interactive gaming system directly, or to the access point 30-3, where the inputs are used at least in part to cause changes or otherwise effect the visualizations being provided to each of the gamers 2s-g1 and 2s-g2, or used at least in part to change the current game state (such as “healing” a particular gamer 2s-g1 and 2s-g2,) where the game state is also used at least in part to determine current visualizations. Thus the presently depicted preferred components of the gamer competition game access point 30-3 should not be unnecessarily limited as in general what can be seen is that inputs from each competing gamer are determined in real-time for providing to a current “game processor” (i.e., the connected interactive gaming system or simply the game access point 30-3 operating on its own) where then these inputs are used at least in part to provide outputs such as but not limited to various 2D, 3D, and holographic visualizations, for example also including other effects such as audio, tactile or haptic, smoke, or in general any of the well-known or to become known techniques for causing sensory experiences.

Referring next to FIG. 10A, there is depicted a ride/show/presentation game access point 30-4 that also preferably functions at least in part under the control of an interactive gaming system 48 to provide visual experiences to any combination of non-gamers 20 and gamers 2s. Dark rides are well-known at least in the theme park industry and typically comprise ride cars for seating multiple people 20, 2s for transportation along a guided rail system and throughout multiple structures (e.g., buildings) comprising some combination of physical “real” objects/scenery combined with one or more projection surfaces 30-4s for projecting visual imagery to be viewed by the people 20, 2s during their transportation. In a typical dark ride experience, at least all concurrently experiencing people 20, 2s perceive the same visual experience, even if in some cases they are wearing traditional active filter lenses, for example so as to be perceiving “3D” visual experiences. While the remaining discussion will consider game access point 30-4 with respect to the more complex use case of a dark ride (at least additionally involving automated transportation throughout a series of visual experience locations, each comprising a distinct projection surface 30-4s,) a careful consideration will show that removing the transportation aspect causes people 20 and 2s to be stationary and substantially fixed in relative position in front of one or more projection surfaces 30-4s, thus being akin to what is traditionally referred to as a show, movie, presentation, etc. Hence, the present teachings should not be limited to the more complex use case involving transported movement, but rather understood to be providing apparatus and methods for providing simultaneous different visual experiences to two or more people such as 20 and 2s, preferably based at least in part upon the current state of an on-going game.

Still referring to FIG. 10A, and again specifically to the more complex dark ride use case, it is well known and useful to accurately understand the current physical location of a transportation vehicle with respect to a projection surface 30-4s as a means for best coordinating the projection of visualization (typically 2D/3D video) from projectors such as 21-p6 and 21-p7. Means for this determining of accurate current physical location of a transport vehicle are well-known in the art and not the subject matter of the present teaching, as all current means are acceptable for the present purposes. These acceptable means for determining current position are presumed to be in communication with or to comprise external triggers and timing control 30-et, where then control 30-et is in communications with and provides real-time information for use by the interactive gaming system 48, and where gaming system 48 at least in part uses real-time vehicle location information to determine and provide controls signals, information, content, etc., to any of the other key components of access point 30-4 as will be discussed.

Those familiar with dark rides in general and presentations presented off a projection surface 30-4s will understand that there are a well-known multitude of means and methods for providing at least one simultaneous visual experience to any one or more people such as 20 and 2s currently viewing the surface 30-4s, where this at least one simultaneous experience is typically provided using only a single projector such as either of 21-p6 or 21-p7, but not both. Those familiar with 3D projection systems will further understand that by using two spatially and temporally synchronized projectors such as 21-p6 or 21-p7 it is possible to present two simultaneous left-eye and right-eye slightly offset images such that people 20 and 2s perceive 3D. The interested reader is directed to cross-reference U.S. Pat. No. 11,025,892 entitled SYSTEM AND METHOD FOR SIMULTANEOUSLY PROVIDING PUBLIC AND PRIVATE MESSAGES filed on Apr. 4, 2019, where the present inventors present significant teachings for variations with respect to both displays, projectors, and associated active filter lenes such as glasses 14, where these variations provide different visual experiences than traditional 2D or 3D.

Still referring to FIG. 10A, for the present purposes, it is assumed that the reader is familiar with well-known PRIOR ART “6P dual laser” technology such as discussed in relation to FIGS. 2A, 2B, and 2C, where a useful technology example is sold by Christie as the “3916 Dual-Head Projector,” and where dual-head refers to the simultaneous emission per each “image frame” of both a “left-eye” image (e.g., using the “r1g1b1 triplet”) and a “right-eye” image (e.g., using the “r2g2b2 triplet). In the present application, the nomenclature “Frame A” is referring to a first image being emitted by a projector 21-p6 or 21-p7, where these first “Frame A” images are preferably synchronized to be emitted at substantially the same time and for substantially the same duration after which they are followed by a second “Frame B.” Each of Frame A (and likewise Frame B,) being emitted simultaneously by 21-p6 and 21-p7 is directed to substantially overlap the same projection surface 30-4s. Furthermore, as prior stated, each of Frame A (and likewise Frame B,) comprises the simultaneous spatial mixture of r1g1b1 light (determined by a first one of the “dual heads”) and r2g2b2 light (determined by a second one of the “dual heads,”) and thus each of Frame A as emitted by projector 21-p6 is herein depicted as comprising “Frame A: (RGB1)” and “Frame A: (RGB2),” and then temporally followed by “Frame B: (RGB1)” and “Frame B: (RGB2).” A careful reading of U.S. Pat. No. 11,025,892 will show that this cross-referenced art described each of these distinct rgb triplet light images as “spatial subchannels” and each of the Frame A/B images as “temporal subchannels,” such that as depicted a projector 21-p6 is considered to be capable of providing at least four (4) spatio-temporal subchannels, e.g., sc1, sc2, sc3, and sc4.

Prior U.S. Pat. No. 11,025,892 taught the combining of traditional “color filtering lenses” used for filtering for example the rgb1 triplet to pass through the left lens (from an external perspective, see FIG. 2C,) and the rgb2 triplet to pass through the right lens, but now filtering both the left and right lens to both transmit either the same rgb1 triplet or the same rgb2 triplet. At first consideration, this appears to have limited applicability, but as a careful consideration will show, this then allows a single 6P dual-head projector to provide two different simultaneous video content as the same time to be reflected off the same surface 30-4s. The prior U.S. Pat. No. 11,025,892 also taught combining “color filtering” with “active shutters,” where active shutters are well-known for allowing for example Frame A to be transmitted to the left eye (thus the left eye electronic shutter is caused to be opened will the right eye electronic shutter is caused at the same time to be closed,) while then Frame B is transmitted to the right eye (keeping the left eye shutter closed while the right eye is open).

When combining the color filtering with the active shutter, just as both eyes were filtered to pass the same “spatial light” (either rgb1 or rgb2,) the prior patent showed that both left and right active shutters should be opened and closed together, thus passing either Frame A (but not B,) or Frame B (but not A). As a careful consideration will show, the prior referenced patent combined color filters with active shutters to provide four (4) simultaneous spatial-temporal subchannels, where each subchannel can carry its own continuous video experience. What was necessary is that a “content controller” would provide or cause the four distinct video experiences to be mixed into the combination of 4 spatial-temporal subchannels (again, see the prior U.S. Pat. No. 11,025,892).

U.S. Pat. No. 11,025,892 also discussed combining passive polarizers in active filtering glasses 14, thus along with color filters and active shutters. Thus by changing the orientation of the polarizers within the existing active shutters (all as will be well understood by those familiar with LCD technology,) it is possible for one set of glasses to have active shutter lenses that are “open” and set to transmit for example light of a first linear polarization such as horizontal, while then also having a second set of glasses with active shutter lenses that are “open” and set to transmit for example light of a second linear polarization such as vertical. In this sense, the same underlying active shutter technology can be constructed to function as transmitting for example a “horizontally aligned spatial subchannel” or transmitting a “vertically aligned spatial subchannel” (see FIG. 10B for more discussion). As also shown in U.S. Pat. No. 11,025,892, it is possible to filter light being emitted by a “6P dual-lens” projector such as used for example as 21-p6 or 21-p7 to be either of horizontally polarized (thus 21-p6) or vertically polarized (thus 21-p7). Given this final consideration, it can be seen that projector 21-p6 provides four (4) distinct spatio-temporal subchannels (“Frame A: HorzP (RGB1), Frame A: HorzP (RGB2), Frame B: HorzP (RGB1), and Frame B: HorzP (RGB2),) while then projector 21-p7 provides a different four (4) distinct spatio-temporal subchannels (“Frame A: VertP (RGB1), Frame A: VertP (RGB2), Frame B: VertP (RGB1), and Frame B: VertP (RGB2),) thus eight (8) subchannels in all (sc1 through sc8, where each subchannel supports is own video experience).

Those familiar with the various technologies referred to with respect to the present FIG. 10A and the U.S. Pat. No. 11,025,892 will understand that glasses such as 14-h1 and 14-h2 do not necessarily need to be constructed to pass horizontal linearly polarized light when their active shutters are open, as some other linear orientation such as “45 degrees” is also possible, and where it is even possible and useful to add additional quarterwave plates to the projector and glasses to transform the linearly polarized light to circularly polarized light. Regardless, whatever the underlying first linear orientation of polarization for example used for glasses 14-h1 and 14-h2, it is understood to be best that glasses 14-v1 and 14-v2 use an underlying second linear orientation of polarization that is “orthogonal” to the first linear orientation, all as will be well understood by those familiar with the necessary arts.

Still referring to FIG. 10A, interactive gaming system 48 preferably provides timing and control signals to synchronized light source controller 30-1c and gamer glasses controller 30-comm, such that an individual pair of glasses 14-h1, 14-h2, 14-v1, or 14-v2 remains associated with a distinct spatial temporal subchannel (sc1 through sc8). As prior mentioned, gaming system 48 preferably ensures that each of the subchannels sc1 through sc8 is also best synchronized with any transport vehicle by receiving external triggers and timing control 30-et information usable at least in part to control subchannels sc1 through sc8. What is also anticipated is that a person such as non-gamer 2o or gamer 2s might also be using an app on a mobile device 2a such as a smartphone to interact in real-time with the gaming system 48 during the dark ride/show/presentation, where for example such people 20, 2s interaction might cause gaming system 48 to switch a particular persons 20, 2s subchannel, thus causing a change to the current/real-time experience, where the person providing input via device 2a may or may not be the same person that is caused to switch subchannels.

As a careful consideration of cross-referenced U.S. Pat. No. 11,025,892 will further show, glasses using color filters and active filters were taught to be further adapted to include an additional entrance LCD that acted as a “light rotator” for example changing incoming horizontally polarized light to be vertically polarized, or vice versa. Thus, using this “light rotator” is possible to cause glasses 14-h1 that are adapted to transmit horizontally polarized (RGB1) light to function as glasses 14-v1 that are adapted to transmit vertically polarized (RGB1) light, thus the single pair of glasses supports real-time switching between at least two (2) of the eight (8) spatial-temporal subchannels. As a careful consideration will show, any of active shutter glasses 14-h1, 14-h2, 14-v1, and 14-v2 can also be operated to allow a person to receive either or Frame A or Frame B, each being a different temporal subchannel. Thus, it can be seen that any pair of glasses 14-h1, 14-h2, 14-v1, or 14-v2, support a single person 20 or 2s being dynamically switched by the interactive gaming system between up to four different subchannels. It is possible that a person 20 or 2s be directly selecting which of the four (4) possible subchannel they wish to be currently receiving (thus device 2a serves as a “content selector,”) or that they are automatically switched for example as a part of a game, or otherwise some combination thereof.

And finally, those familiar with entertainment in general, and dark rides in particular, will understand that the ability to provide up to eight (8) simultaneous different visual (with associated audio, see U.S. Pat. No. 11,025,892) experiences provides great advantages to theme parks for altering the experiences of its guests, especially when the video experiences on the dark ride or in the show/presentation/movie are tied to an ongoing game and where the experiences can be altered in real-time during the video-audio experience.

Referring next to FIG. 10B, there are shown the key components of each of glasses 14-h1, 14-h2, 14-v1, and 14-v2. Using active filter glasses 14-h1 (shown on the left) as an example, glasses 14-h1 comprise five (5) key components including: (1) an entrance liquid crystal panel 14-h1-lcd1 that acts as a “light rotator,” for example optionally rotating an image formed from horizontally polarized light to then be vertically polarized light, or vice versa, (2) a first linear “p1” polarizer 14-h1-p1 fixed at a first linear angle of rotation such as “horizontal” as depicted, where this filter is then understood to substantially (and “naturally”) transmit only horizontally polarized images as emitted by projector 21-p6 as opposed to vertically polarized images emitted by projector 21-p7, and where it is understood that “light rotator” component (1) can be operated to effectively switch glasses such as 14-h1 from “naturally” transmitting horizontal images as emitted by projector 21-p6 to “naturally” transmitting vertical images as emitted by projector 21-p7, thus functioning as glasses 14-v1, (3) a second liquid crystal panel 14-h1-lcd2 that acts as a “light shutter” for rotating the linearly polarized light transmitting through polarizer “p1” by either “zero degrees” or “ninety degrees,” (4) a second linear “p2” polarizer 14-h1-p2 traditionally aligned at an angle orthogonal to the “p1” polarizer 14-h1-p1, where those familiar with LCDs (traditionally the components 2, 3, and 4 in combination) used as active shutters will understand that when “light shutter” component (3) is operated at “zero degrees” rotation, the horizontal light transmitting through polarizer “p1” will be “extinguished” or “blocked” by orthogonal polarizer “p2,” and thus the glasses are “closed” for transmission, whereas when the “light shutter” is operated at “ninety degrees” rotation, the horizontally polarized “p2” light is transformed into vertically polarized light to be substantially transmitted through vertical polarizer “p2,” and thus the glasses are “open” for transmission, and finally (5) an “RGB1” triplet light filter for example passing “b1,” “g1,” “r1” and thusly rejecting “RGB2” triplet comprising “b2,” “g2,” “r2.”

Still referring to FIG. 10B, a careful comparison of glasses 14-h1 to 14-h2 will show that only component (5) is different, and specifically comprises an “RGB2” triplet light filter for example passing “b2,” “g2,” “r2” and thusly rejecting “RGB1” triplet comprising “b1,” “g1,” “r1.” A careful comparison of glasses 14-h1 to 14-v1 will show that the sequence of the “p1” and “p2” polarizers in glasses 14-h1 has been reversed be “p2” first along the optical path followed by “p1,” or more importantly reversed to first transmit vertically polarized light followed by the transmitting horizontally polarized light. Those familiar with LCDs and traditional active shutter glasses will understand that both 14-h1 and 14-v1 include the “active shutter,” but that 14-h1 naturally transmits horizontal 21-p6 emitted light while 14-v1 naturally transmits vertical 21-p7 emitted light. In a typical use case for active shutter glasses, all glasses would typically be set to naturally transmit the same linear angle of polarization, where this same linear angle of polarization is matched to any projector(s) and thus all projector(s) emit the same linear angle.

A consideration of the teachings herein will show the advantages of using projector(s) 21-p6 emitting images with a first linear angle of polarization (e.g., horizontal) combined with using projector(s) 21-p7 emitting images with a second linear angle of polarization (e.g., vertical) that is substantially orthogonal to the first linear angle, including then the ability to reflect spatio-temporal coincident images comprising substantially different video content off the same projection surface 30-4s to be separately received by different persons 20 or 2s based upon the type of glasses 14-h1, 14-h2, 14-v1, and 14-v2 that each person is wearing, where as explained the present teachings thus support a combined eight (8) different subchannels of content.

As can be seen from the present depiction, glasses 14-v2 comprise an RGB2 color filter as opposed to the RGB1 filter used in glasses 14-v1. Given the presence of optional component 1, the entrance “light rotator,” only two distinct pair of glasses are required such that glasses 14-h1 can be operated to function like glasses 14-v1 and likewise glasses 14-h2 can function as 14-v2, where then each of 14-h1 and 14-h2 can be seen to support up to 4 distinct subchannels of different spatio-temporal coincident video content. Those familiar with dark rides will understand that this allows for guests that are non-gamers 20 or gamers 2s to wear either of active filter glasses 14-h1 and 14-h2 and then be possibly presented with up to four (4) different ride experiences, thus providing significant economic advantage to a dark ride operator and also providing a more interesting ride experience to the person with the possibility for combining with an interactive gaming system 48, all as taught herein.

Referring next to FIG. 10C, there is two tables, one on the left considering the distribution of luminance for a projector 21-p6, and a second table on the right considering projector 21-p7. In a typical commercial 6P dual-lens projector such as sold by Christie as the “3916 Dual-Head Projector,” each head emits images with 30,000 lumens; thus each Image A or Image B comprises two spatial subchannels, an RGB1 subchannel with 30,000 lumens and an RGB2 subchannel with 30,000 lumens, a combined luminance of 60,000 that is twice as bright as a traditionally projector. By placing the horizontal polarizer to be on the exit path of the light being emitted from projector 21-p6, and given the typical light loss of 55%, this 30,000 lumens of RGB1 or 30,000 lumens of RGB2 is reduced to 13,500 lumens for RGB1 and 13,500 lumens for RGB2, still quite bright depending on other factors such as the size of the surface 30-4s, the distance from the surface 30-4s to the expected viewers 20 or 2s, as well as the ambient lighting levels, all as will be well understood by those familiar with at least movie theater systems. Using an active shutter to then divide this 13,500 lumens of RGB1 and 13,500 lumens of RGB2 into a “Frame A” and “Frame B” subchannel than results in another roughly 50% reduction yielding a final 6,750 lumens of estimated light for each of the four (4) subchannels being emitted by projector 21-p6. While this is approaching a lower limit of brightness, what will also be appreciated by those familiar with modern 6P projector systems is that the laser light input into the system is a variable and can be increased, such that each lens emits 60,000 lumens, thus doubling each subchannel from a net 6,750 lumens back up to 13,500 lumens, when can then be further increased as needed but is sufficient for many small to large dark ride screens. And finally, as will be clear, the rightmost table describing projector 21-p7 has a similar understanding as for the 21-p6 table.

Referring in general to FIGS. 10A, 10B, and 10C, those familiar with projectors, 6P technology, types of 3D technologies, etc., will appreciate that there are many possible variations to the exemplary apparatus depicted. It should therefore be understood that a presently taught advantage for dark rides is the use of projectors emitting multiple spatio-temporal subchannels, dividing total emitted light (lumens) for example by means comprising color filtering, linear polarization, or active shuttering to create subchannels selectable or viewable based upon filtering lenes and preferably active filtering lenses such that a person can be switched between two or more subchannels preferably in connection with an interactive gaming system. A careful consideration will show that while the present depiction provides for eight (8) subchannels, it is also possible to achieve additional temporal subchannels (such as A, B, and C,) thus reaching for example ten (12) subchannels, or to reduce from eight (8) to only four (4) subchannels, e.g., by not using the temporal A/B subchannel or by not using the horizontal and vertical polarizers covering projectors 21-p6 and 21-p7, respectively.

Referring next to FIG. 11, there is shown a combined perspective view and component view of a secret guidance game access point 30-5 comprising a guidance area 30-5-a being approached by a gamer 2s, where the gamer 2s's goal is to cross the area 30-5-a along a select path of steps, where the gamer 2s is able to use an article 12 to provide commands (such as a “spell”) and otherwise data input via an article illumination and tracking station 30-ts, and where the tracking station 30-ts provides the gamer 2s input preferably to an interactive gaming system 48 (not depicted) and/or to the game access point 30-5, such that the gamer 2s input is used at least in part to determine visualization changes to the guidance object components comprising the guidance area 30-5-a for providing an indication of a potential path through the area 30-5-a.

Guidance area 30-5-a includes one or more guidance objects, such as illumination objects 30-5-io that are embedded into the area 30-5-a floor, similar to a tile. Each illumination object tile 30-5-io preferably comprising a top translucent layer 30-5-io-tl, placed over or affixed on top of a engineered backlight layer 30-5-io-b1, which is then placed over or affixed on top of a contact/pressure/proximity sensing layer 30-5-io-cs. Top translucent layer 30-5-io-tl preferably performs two key functions, first to transmit engineered light from the adjoining middle backlight layer 30-5-io-b1 to any combination of non-gamers 20 and gamers 2s, and second to provide a contact surface for the people 20 and 2s to walk upon, where this contact surface can then also include physical markings such as symbols or letters coinciding with an on-going game. It is even possible for the translucent layer 30-5-io-tl to be an active layer such as some form of a transparent display whereby for example the symbols or letters can be changed over time in accordance with the on-going game.

Still referring to FIG. 11, middle backlight layer 30-5-io-b1 is preferably an engineered light source 63 that is capable of emitting restricted frequency bands (narrow or wide) at least maximally limited to a specific color range (see for example 20-srb (blue), 20-srg (green), and 20-srr (red) in FIG. 3A,) such that the backlight layer 30-5-io-b1 can emit various mixtures of blue, green, and red light to create a large range of colors, all as will be well understood by those familiar with lights and color systems. If for example, top layer 30-5-io-tl is implemented as a form of an LCD display, it is then possible that middle backlight layer 30-5-io-b1 could alternatively simply emit “white light” that is then converted via the LCD display as layer 30-5-io-tl into various possible colors, all as will be understood by those familiar with display systems. It is also possible that the top and middle layers are combinable into for example a single image emitting layer such as by using an OLED, perhaps including a protective coating for contacting with the person 20 and 2s's feet, but where otherwise the function of providing “engineered” light limited to at least combinations of blue, green, and red is accomplished.

Those familiar with displays such as LCDs and OLEDs will also understand that is it possible to implement more narrow color filters for individual pixels such that the “blue color” could actually comprise some pixels for emitting a “b1” narrow band and other pixels for emitting a “b2” narrow band, with a similar consideration for g1, g2, r1, and r2 pixels. This b1, b2, g1, g2, r1, r2 “6P” implementation of either a top layer 30-5-io-tl (such as an LCD) or a combined middle 30-5-io-b1 and top layer 30-5-io-tl (such as an OLED) then allows the illumination object 30-5-io to cause lighting effects all as described herein that can at least cause different visual perceptions of objects that include a specially coating 12g. When simply using a middle layer backlight 30-5-io-b1 with a translucent top layer 30-5-io-tl comprising either a passive material or a switchable active material that can even implement degrees of translucence (see the discussion describing translucent, semitransparent material 12-2 in relation to FIG. 7A, especially using active PDLCs-polymer dispersed liquid crystals,) it is possible to use for example an array of specially coated LEDs (where the coatings are color filters for example limiting the light to any of b1, b2, g1, g2, r1, r2, narrow bands) such that the conditionally activated LEDs can emit any combinations of b1, b2, g1, g2, r1, r2 that are then mixed together though a traditional arrangement of for example a waveguide and diffuser, etc., all as will be understood by those familiar with backlight systems especially used for LCD displays.

Referring still to FIG. 11, it is noted that all of the functionality described for example with respect to light field game access point 30-1 can be either directly implemented (e.g., by treating material 12-2 of FIG. 7A to be an illumination object 30-5-io, either embedded into the floor of area 30-5-a or onto a wall or suspended from a ceiling of area 30-5-a, thus virtually any configuration,) or combined with the specific teachings of FIG. 11, therefore creating a combined game access point implementing the teachings of both 30-1 and 30-5. Thus, by describing each of game access points such as 30-1, 30-2, 30-3, 30-4, 30-5, and 30-6 separately, the present invention is not meant to exclude any combination of these access points in whole or as components into new variation access points.

A careful consideration of the teachings provided herein will therefore show that the guidance area 30-5-a is usable for example with special coatings 12 to cause colorization effects to articles 12 that are any surface, and not just for example a toy wand or in general an object held or carried by a gamer 2s. The teachings of area 30-5-a are also usable with active filtering lenses such as glasses 14 and magnifying glass 15, such that the light emitted by a/any illumination object 30-5-io could be cause to be seen by only one or more selected gamers 2s looking through a filtering lens 14 or 15, where the “secret message”/“secret illumination guidance” can be based upon various spatial and temporal techniques all as mentioned herein and/or as described in the cross-referenced art. For example, it is possible that the illumination object 30-5-io is implemented as shown comprising a “floor tile” that is perceived by a gamer 2s looking through a lens 14 or 15 to appear to change color, such as turning red, where in one implementation the red illumination by object 30-5-io is provided on a “sc2” subchannel synchronized to the “opening” or “transmission” of lenses 14 and/or 15, and where object 30-5-io provides a compensating blue and green light on the “sc1” subchannel such that a non-gamer 2o perceives the temporal combination of sc1 and sc2 blue, green, and red light as simply being a white color, all as will be understood by a careful reading of the present invention and by those familiar with displays and the human vision system. This same approach can be taken where the illumination object 30-5-io is alternatively implemented as a “streetlight” in a outdoor or indoor setting of a destination such as a theme park.

Thus, the present secret guidance game access point 30-5 with its area 30-5-a and illumination objects 30-5-io should be considered exemplary and not limited to any particular type of area (such as indoor or outdoor,) or any particular type of illumination object (such as a floor tile as depicted, or a lamp, or an object embedded in the area, etc.,) where many fun and exciting variations are possible. The access point 30-5, like all other access points described herein or in the cross-referenced art is preferably in communication with an interactive gaming system 48, and as such providing its experiences to any of non-gamers 20 or gamers 2s in coordination with a connected network of multiple game access points distributed throughout a destination, even within traditional isolated experiences provided by the destination such as rides, dark rides, presentations, exhibits, walking areas, shops, restaurants, etc., where then the possible combination of experiences is virtually limitless providing in total a “destination gamification layer” for enhancing the guest experience at a given destination.

Referring next to FIG. 12A, there is shown a sideview of a tap-magic display game access point 30-6, where the display 20-3 is preferably providing game content to the gamer 2s, and where the gamer content is conditional based at least in part upon the detection of a location such as 20-3-1, 20-3-2, or 20-3-3 on the display 20-3 where the gamer 2s taps their article 12 such as a toy wand. Display technologies are well-known, and the present teachings do not limit the type of display technologies used, such as LCD vs OLED, where the preference is the use of a public-private display as taught especially in the cross-referenced art U.S. Pat. No. 11,025,892 entitled SYSTEM AND METHOD FOR SIMULTANEOUSLY PROVIDING PUBLIC AND PRIVATE MESSAGES filed on Apr. 4, 2019.

Regardless of being a public-private display as opposed to a public-only display (see the cross reference for more understanding,) display panel 20-3dp with optional backlight 20-3bl (if using for example an LCD technology) are anticipated to require some amount of “depth” (or thickness from the sideview,) where this depth and the type of materials comprising at least display panel 20-3dp, but also as importantly optional backlight 20-3bl, are known to effect the wireless signal strength and therefore necessary distance between a preferred electronic tag reader 20-3-1, 20-3-2, or 20-3-3 and the anticipated article tip 12t that must be detected as data for at least in part determining video/audio content to be provided by access point 30-6.

Still referring to FIG. 12A, display 20-3 comprises optional touch sensitive layer 20-3ts (using any of well-known technologies) substantially affixed to display panel 20-3dp, where depending upon the display panel 20-3dp technology, display 20-3 may further comprise an optional backlight 20-3bl, all of which will be well understood by those familiar with “end product displays,” also comprising some form of an enclosure with electronics such as 20-3e (see FIG. 12B). There are two main technologies for implementing wirelessly readable electronic tag 12id embedded within article tip 12t, both as prior discussed in relation to FIG. 1B, and namely RFID and NFC. NFC is a preferred technology as discussed and those familiar with NFC readers used in displays will recognize that another advantage of NFC technologies is that the NFC antennas and readers have already been optimized for used embedded within displays, such as manufactured by Sharp Electronics Corporation of Japan. The interested reader is also directed to the research paper entitled “Integrated Transparent NFC Antennas on Touch Displays,” Sugita, et al., ITE Trans. on MTA Vol. 6, No. 4, pp. 280-285 (2018). The research paper describes a “transparent NFC antenna” (depicted herein as 20-3-nfc1, 20-3-nfc2, and 20-3-nfc3) for mounting directly between the traditional touch panel (depicted herein as 20-3ts) and the traditional display panel (depicted herein as 20-3dp). It is noted that the surface area of the embedded transparent NFC antenna is significantly less than the total surface area of the display panel 20-3dp, and that multiple transparent NFC are described as being used within a single display for creating multiple NFC read points.

Still referring to FIG. 12A, it is also possible to use RFID wireless technology rather than NFC technology for implementing one or more readers 20-3-1, 20-3-2, and 20-3-3, such as RFID readers 20-3-rf1, 20-3-rf2, and 20-3-rf3, again using well known RFID reader technology. A consideration for using such RFID technology especially in combination with a backlight such as 20-3bl, is the use of a backlight frame that is made of an RF transmissive material, such as an industrial plastic, as opposed to the more traditional metal material.

Referring next to FIG. 12B, there is shown a front view of display 20-3 used in a tap-magic game access point 30-6. The front view illustrates the tap-areas 20-3-1ta, 20-3-2ta and 20-3-3ta that exist in display 20-4 corresponding to underlying readers 20-3-1, 20-3-2 and 20-3-3, where underlying readers 20-3-1, 20-3-2 and 20-3-3 may be for example implemented as either of RFID (20-3-rf1, 20-3-rf2, or 20-3-rf3, respectively) or the preferred NFC readers (20-3-nfc1, 20-3-nfc2, or 20-3-nfc3, respectively,) and where readers 20-3-1, 20-3-2 and 20-3-3 (of any technology) are each capable of detecting the electronic tag with id 12id preferably embedded within article tip 12t within a certain proximity such that the game access point 30-6 is able to at least read and preferably also write information to the electronic tag 12id. Like preferably all other game access points described herein, as well as the game access points described in the previous related cross-references, each game access point such as 30-6 comprises one or more means for determining the identification of a gamer 2s (for example by first detecting a “mobile gaming device” such as an article 12 that comprises at least a unique ID,) where the gamer 2s is currently standing in front of/about to engage with the game access point. (See especially “gamer device detection” in U.S. Pat. No. 10,974,135 entitled INTERACTIVE GAME THEATER WITH SECRET MESSAGE IMAGING SYSTEM filed on Sep. 27, 2018.)

Although the means for “gamer device detection” are not specifically discussed herein, the current application takes advantage of this Prior Art understanding, and furthermore anticipates taking advantage of what the related cross-references taught with respect to the concept of “summoning a gamer to a specific game access point” all as a part of the functioning of the interactive gaming system 48 (not depicted) as well as a companion “gamer/guest tracking system” (see especially U.S. Pat. No. 10,861,267 entitled THEME PARK GAMIFICATION, GUEST TRACKING AND ACCESS CONTROL SYSTEM filed on Aug. 4, 2018).

Thus, the in preferred usage of a tap-magic game access point 30-6, the gamer 2s is playing an on-going game for example at a destination such as a theme park or museum, where they have been summoned to the access point 30-6, and where once the gamer 2s is detected to be situated substantially in front of the access point 30-6, the interactive gaming system causes the display 20-3 to present an image/video comprising information substantially located within each of the possible tap-areas such as 20-3-1ta, 20-3-2ta and 20-3-3ta, for example but not limited to displaying a code, symbol, picture, or even a number such as “1,” “2,” or “3,” as currently depicted.

Still referring to FIG. 12B, gamer 2s must then make a decision as to which of the one or more tap areas such as 20-3-1ta, 20-3-2ta and 20-3-3ta they will tap, where it is also anticipated that the display 20-3 might provide a visible and/or audible indication of an “amount of time remaining” within which the gamer 2s must select and tap a tap area or lose the current opportunity. Reading and/or writing information to an electronic tag 12id using a reader technology (such as RFID or NFC) is well-known in the art and will not be further discussed, suffice it to say that any exchange of information between the reader and the tag 12id can happen within milliseconds and is therefore essentially perceived by gamer 2s to be “instantaneous.”

Preferably this “instantaneous” exchange of information provides either the game access point 30-6 and preferably also the interactive gaming system 48 with real-time information including the specific tap-area 20-3-1ta, 20-3-2ta and 20-3-3ta that was engaged by the gamer 2s, where then in at least one anticipated game response this determined information is used at least in part to cause a change to any of image/video or audio information provided by the display 20-3 to the gamer 2s. In still yet other possible interactions, information is written onto the gamer 2s's article 12 via the electronic tag 12id, where the gamer may or may not be aware of this information and/or its meaning, and also may or may not be informed by the game access point 30-6 display 20-3 that such an exchange has taken place. Thus, the gamer 2s's interaction with the display 20-3 of game access point 30-6 should not be limited to any particular response by the access point 30-6, as many responses are possible.

Still referring to FIG. 12B, display enclosure 20-3e is also depicted as including other possible tap-areas such as 20-3-4ta that is for example located below the display panel 20-3-dp, and where for example tap-area 20-3-4ta is preferably visually recognizable as a tap area by the gamer 2s. A careful consideration of the teachings provided both herein and with respect to the cross-referenced art, will show and make evident that any one or more game access points, either in “whole” or as components may be combined with other game access points. For example, it is possible to combine an article colorizing light source 30-ls with any game access point using an article 12 or at least a surface coated by a coating 12, where when light source 30-ls is combined with the present tap-magic game access point 30-6, after the detection of a tapped location 20-3-1ta, 20-3-2ta and 20-3-3ta a game response might include the change in article illumination resulting in the perception of a change in the article 12's color.

As will also be clear, an article tracking station 30-ot could be used in combination with or in place of readers 20-3-1, 20-3-2, 20-3-3, and 20-3-4, such that the game access point 30-6 alternatively uses a tracking station 30-ot to determine the location tapped by the gamer 2s, where this location preferably still corresponds to some presented visualization (such as but not limited to “1,” “2,” and “3” as prior discussed). In still yet another variation, a careful reading of the cross-referenced art especially including U.S. Pat. No. 10,974,135 entitled INTERACTIVE GAME THEATER WITH SECRET MESSAGE IMAGING SYSTEM filed on Sep. 27, 2018, and U.S. Pat. No. 11,025,892 entitled SYSTEM AND METHOD FOR SIMULTANEOUSLY PROVIDING PUBLIC AND PRIVATE MESSAGES filed on Apr. 4, 2019, will show that it is possible for a game access point 30-6 to project images (“public” and/or “private”) onto virtually any surface (possibly even using “projection mapping” for non-planer surfaces,) where these either public images or private images (“secret messages”) may comprise indications of “tap-areas” for detecting interaction with an article 12 using for example wireless reader technologies such as NFC or RFID as presently depicted, or using cameras and other tracking devices (see especially FIGS. 8A and 8B,) such that the presentation of the visualizations (e.g., like “1,” “2,” and “3” or some variant) can be made using projectors rather than a display 20-3, and may even be provided as a “secret message”/private images only visible to the gamer 2s when using an active filtering device such as glasses 14 or magnifying glass 15.

Thus, the present game access point 30-6, like all other game access points discussed herein, should be considered as exemplary of key teachings and not as simply limited to these key teachings, where again multiple key teachings from the multiple game access points described both herein and within the cross-referenced art may be combined to create interesting and useful new types of game access points, all as a careful consideration will make clear.

Referring next to FIG. 13A through 13F, there are shown an anticipated range of modalities of a multimodal game, where the modalities comprise: 1) a video game as depicted in FIG. 13A, 2) a physical-virtual game conducted by an interactive gaming system at a location comprising one or more game access points, where conducting the game further includes tracking the locations and destination interactions of a gamer, as depicted in FIG. 13B, 3) a tap-magic display game access point 30-6 as depicted in FIG. 13C representative of any number of possible game access points such as but not limited to 30-1, 30-2, 30-3, 30-4, and 30-5 all as described herein, where the any game access point such as 30-6 is preferably engaged by a gamer as a part of a physical-virtual game conducted by an interactive gaming system, 4) a game character input means such as a coloring book page depicted in FIG. 13D, where input is captured and processed by a computing device such as a smartphone 15c or tablet 17c, where “game character” is generally representative of any game data for example including game setting, game mood, game difficulty, etc., that can be represented preferably as an image to be colored in, where the colors chosen by the gamer with respect to the colored area of the image are determinable and interpretable as game data, 5) an interactive game board as depicted in FIG. 13E for tracking one or more players in game board play, and 6) a schoolwork app executing on a computing device for interaction by a gamer related to an educational curriculum.

Collectively, FIGS. 13A through 13F represent typically “isolated” or “siloed” experiences by a person, where the present teaching describes sharing information from each modality with other modalities such that a person (now “a gamer” 2s) experiences these prior typically isolated experiences to be meaningfully connected and/or affecting each other. For example, a gamer 2s playing a favorite video game typically accumulates a game state at least comprising indications of completed tasks with various success measurements, where then any of these indications represent a general class of game modality data usable as input into any other modality of a cross-modality, multimodal game. Hence, a gamer 2s playing a video game (a) such as depicted in FIG. 13A, where the game play may be only between the gamer and the game, or may include other gamers (often referred to as a “multiplayer game,”) is then causing the determination of game modality data that may for example (b) affect an upcoming visit to a destination such as a theme park, (c) affect upcoming play of an interactive board game, (d) affect upcoming work or assignments associated with an educational system, thusly abstracted as “a schoolwork app,” or (e) affect the images or otherwise representations printed or presented on a display for “coloring in” as a means for providing multimodal game choices and input.

As will also be understood by those familiar with video games (a), a video game environment is to some extent based upon “real-world” physics such that the represented video game character interactions with other characters and the virtual environment appear/seem to the gamer 2s to be more less intentionally “realistic” (note that “interactions” are typically described by virtual forces, often referred to as “video game physics,” such as virtual gravity and are necessarily different from “visualizations” such as the look of a character or setting). The present invention teaches that any of this typically “internal” video game data for defining any of these video game interactions or visualizations are exchangeable as game modality data, both either as output to another modality of the multimodal game (such as a destination physical-virtual game (b), an interactive board game (c), an educational/“schoolwork” app (d), or a image coloring/filling-in system (e)), or as input from any of these other modalities (b) through (e).

For example, playing a video game (a) provides modality game data that can affect the level of game play experienced within a destination physical-virtual game (b), where “leveling up” on a video game at home increases the game advantages or opportunities of the game when visiting a theme park and engaging in a related physical-virtual game (b). Likewise, playing or participating in a destination physical-virtual game (b) can transfer “credits” or “powers” to an associated video game (b), thus each modality is affecting the other modality increasing the gamer 2s's perception of “continuous engagement.” In another example, a video game (a) provides an option to the gamer 2s to request that a character, object, scene, etc., is output visualization data that can for example be used to print a “coloring book page,” or otherwise to digitally represent the equivalent “coloring book page” in a computer app (collectively “image coloring/filling-in system (e)”). A gamer 2s may then color or otherwise fill-in this video game (a) provided visualization, where then this physical coloring or filling-in is determinable for example by taking an image using a smartphone 15c or tablet 17c for comparison analysis to the original digital representation (see especially cross-reference U.S. Pat. No. 10,85,450 entitled PHYSICAL-VIRTUAL GAME BOARD AND CONTENT DELIVERY PLATFORM filed on Aug. 9, 2019), or otherwise this virtual coloring or filling-in using a computer app is determinable by the computer app as any number of possible modal game inputs, including for example the skin and clothing colors to be used for a video game character, where then this resulting (e) modal game information is input back into the video game (a) and used to alter the experience of the game 2s when using the video game.

In yet another example, any resulting image coloring/filling-in system (e) data is usable as input to a “schoolwork app” (d) game modality, thus simply the completion of the coloring or filling-in can be used as input, or even the measured choices and effectiveness (i.e., is the coloring “within the lines,” etc.) is usable as schoolwork app input. Thus, a chain is shown between a video game (a), to an image coloring/filling-in system (e) such as a printed coloring book or a coloring app, to a “schoolwork app” (d). Upon completion of an assignment in a schoolwork app (d), the results of the assignment (such as a level of completion status, percentage of correct answers, time-of-day engaged, time duration spent, etc.) may then become usable modal game information for input into for example an interactive board game (c), thus for example enabling new levels of game overlay play (see U.S. Pat. No. 10,688,378 entitled PHYSICAL-VIRTUAL GAME BOARD AND CONTENT DELIVERY SYSTEM filed on Jul. 4, 2018 and U.S. Pat. No. 10,85,450 entitled PHYSICAL-VIRTUAL GAME BOARD AND CONTENT DELIVERY PLATFORM filed on Aug. 9, 2019) or new levels of game questions provided in association with some or any game overlay, all possibly related directly to the schoolwork, or even credits or points additionally awarded to the gamer 2s thus advancing their interactive board game status in some respect.

This interactive board game play (c), comprising new play represented by additional board game overlays or “levels” of the board game, can be directly related to video game play (a), which often comprises what are known as “game levels,” “lands,” and “instances” each associable to game overlays, as well as homework assignments for a schoolwork app (d) that is also typically conducted over a series of progressing “levels.”

When for example a gamer 2s is playing a video game (a) on a game console (see FIG. 13A,) it is possible to capture images of the gamer 2s using a console connected camera such as 20-4c, where this camera 20-4c then collects information about the gamer 2s such as the gamer's face and skin colors that are useable as information to for example be associated with the gamer's article electronic tag 12id of the article 12 they will be using for example at a game access point such comprising an article tracking station 30-ot. Thus, a careful consideration will show that in one modality such as a video game (a) personal gamer 2s data is gathered for use in another modality such as a physical-virtual game (b), where this person gamer data is herein referred to as “(i) static article characteristics data” that for example is useful for identifying the gamer (i.e., through facial recognition) or segmenting the gamer's skin from the article 12 during article 12 tracking (see FIGS. 1B, 3H, 8A, 8B, and 8C), and where the collection of this static gamer 2s information is “transparent” or minimally invasive to the gamer 2s, even remaining fully private in association with a gamer ID/avatar ID (see U.S. Pat. No. 10,861,267 entitled THEME PARK GAMIFICATION, GUEST TRACKING AND ACCESS CONTROL SYSTEM filed on Aug. 4, 2018).

As a careful consideration of the prior cross-referenced art and the present specification especially including FIGS. 13A through 13F will show, video games (a), destination physical-virtual games (b), interactive board games (c), educational “schoolwork” assignments (d), and image coloring/filling-in system (e) can all be treated as single modalities in a multimodal game, whereby a single gamer 2s has an enhanced “continuous experience” across each of the modalities because (a), (b), (c), (d), and (e) modal game data is exchanged between modalities creating “affects,” where many types of modal game data are possible and where many modal game affects are possible depending upon the game modality, all of which will be clear to the careful reader and to those familiar with the various modalities described herein.

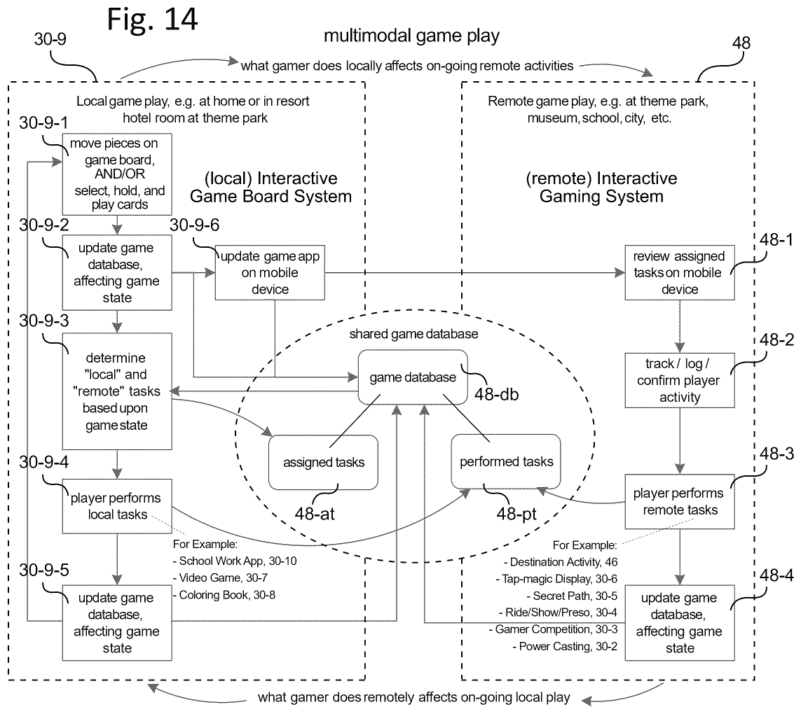

Referring next to FIG. 14 there is shown a flow diagram of multimodal game play comprising a first mode game access point 30-9 that is any of an interactive board game (see especially the cross-referenced PRIOR ART of U.S. Pat. No. 10,688,378 entitled PHYSICAL-VIRTUAL GAME BOARD AND CONTENT DELIVERY SYSTEM filed on July 4th and U.S. Pat. No. 10,857,450 entitled PHYSICAL-VIRTUAL GAME BOARD AND CONTENT DELIVERY PLATFORM filed on Aug. 9, 2019) or an interactive card game (see the aforementioned PRIOR ART as well as the cross-referenced continuation-in-part of the present application that is U.S. Provisional Application 63/533,159, entitled SYSTEM FOR DIGITIZING PHYSICAL CARD GAMES TO PROVIDE VIRTUAL EXTENSIONS filed on Aug. 17, 2023.) What is important to see about the interactive game being used as a first mode game access point 30-9 of a multimodal game is that it represents a social activity conducted by one or more gamers typically “locally” situated around a “game board” with the intention of having experiences related to and “confined by” the expectations of the game board being played. For example, the gamer(s) playing with the interactive game access point 30-9 are not typically then also expecting to be having a concurrent “ride experience” at a theme park (such as a tracked destination activity 46) or a concurrent video game experience 30-7 that essentially requires being present at a computing device 20-4 capable of providing the isolated video game to the gamer(s). In this description, “locally” is meant to infer both in a “non-destination” (such as a gamer's home versus a theme park,) although locally could be in a resort room at a destination or even in what are known as “gaming café's,” and as such “locally” should be taken as a typical private environment where board and card games are played but without any necessary limitations.

Still referring to FIG. 14, representative first mode game access point 30-9 operates as a flow of process steps such as the preferred 30-9-1 through 30-9-6 (to be discussed shortly,) where within this flow information being processed by the access point 30-9 representative of a current “game state”/“activity state” is preferably written/stored into a shared game database 48-db in a process step such as 30-9-2 (“update game database”) currently depicted, where sharing implies providing access to any other of many possible second mode game access points such as but not limited to typically “local” access points of schoolwork app 30-10, video game 30-7, coloring book 30-8 or typical “remote” access points of a tracked destination activity 46, a tap-magic display 30-6, a secret path 30-5, a ride/show/presentation 30-4, a gamer competition 30-3 or a power casting 30-2, where “remote” typically refers to “public locations” such as theme and amusement parks, cruise ships, museums, theaters, etc., but where such limitations are not necessary for the proper functioning of the present teachings.

Those familiar with computing systems, network communications, shared databases, etc., will appreciate that providing and maintaining a shared (often referred to as “centralized”) database can be problematic such as by requiring a real-time communication path to the database that is typically “always on,” such as an ideal internet connection, where this problem of a shared database requiring a communication path is addressable in many ways including having local “decentralized” copies of the database 48-db for providing “intermittent” updates to the shared “centralized” database 48-db that are transmitted when the communication path is available. Such considerations and variations are well understood in the marketplace and are not the focus of the present invention as any such implementation of storing game-state data for access by any two or more game access points are acceptable and will have well understood tradeoffs.

Still referring to FIG. 14, in addition to, or alternatively from, a first (such as 30-9) or any mode of a game access point providing communicated information such as game state updates to a shared database 48-db (for example in step 30-9-2,) is the provision by the any game access point of assigned tasks to shared dataset 48-at presently depicted as occurring in step 30-9-3 for determining “local” and “remote” tasks based upon game state. What is different about assigned tasks 48-at is preferably that the task(s) comprise some minimal amount of information for example designating one or more gamer(s), a game access point (type and possible specific instance) and then any other particular restriction on the activity performed at the game access point, such as dates/times, difficulty levels, game access point settings, etc., where this minimal information is designed to provide all information sufficient for conducting the task, but not necessarily for representing the completeness of the current game state as might typically include accumulated points, tasks completed, and/or even other open assigned tasks.

The present description of “assigned tasks” as a shared “dataset” as opposed to a shared “database” is meant to describe the task data as comprising one or more datum where all datum is related to the task (such as being associated with a unique task ID) but otherwise limited to datum required for sufficiently describing the task, and thus dataset is being used as a more constricted term than database, but where those familiar with computer systems and data structures will understand that this distinction is arbitrary as any larger or smaller combination of datum can be provided as a database of which there are many types, and thus the type of data storage discussed herein for any of 48-db, 48-at or 48-pt is exemplary and should not be interpreted as limiting the present invention.

What is important to see is that for example while one or more gamers are playing an interactive board (or card) game 30-9 the access point preferably determines in a (possibly repeatable) step depicted as 30-9-3 that one or more tasks are to be assigned to one or more gamers based at least in part upon the current game-state, where such assigned tasks 48-at may be any one of or any combination of local or remote tasks to be performed in the same or preferably a different mode of the multimodal game, along with possibly some combination of task-defining information and/or restrictions. These assigned tasks 48-at might then be transmitted to some form of portable electronic storage such as a well-known “USB stick” or perhaps memory storage provided on a game device such as glasses 14, magnifying glass 15, or even an article 12 such as a toy wand, where this electronic data storage is preferably passive such as the herein exemplary embedded RFID or NFC tags 12t-r. Thus, after playing at least a portion of a first mode of a multimodal game one or more tasks are generated and assigned to one or more gamers as assigned tasks 48-at to be performed at some subsequent time and/or place using preferably a different mode of the multimodal game, where as a careful consideration will show, this continuation of tasks and performances across multiple modes of a game contributes to a sense of connectedness and relevance for the gamer.

As will be discussed at a later point, using presumably a different mode of the multimodal game, a gamer ultimately completes an assigned task 48-at where such completion information is then used at least in part to generate a performed tasks dataset 48-pt, where those familiar with data structures will also understand that not only can assigned tasks 48-at and performed tasks 48-pt be incorporated into a game database 48-db (thus not requiring a separated data representation as depicted in the present figure,) but that also assigned tasks 48-at and performed tasks 48-pt could be combined into a single task dataset. What will also be understood from a careful consideration is that task data (assigned or performed) can be more private to a gamer as opposed to game-state data and thus separating this task data is even preferable down to the individual gamer level, thus for example datasets 48-at and 48-pt are “per gamer” and even encrypted such that only a gamer with proper credentials (of which there are many well-known privacy control systems) can access their personal task data.

Still referring to FIG. 14, and now to the detailed flow steps related to an interactive board (or card) game 30-9, game play includes step 30-9-1 for moving game pieces on a game board, and/or selecting, holding, or playing cards, where the interactive game board 30-9 digitizes/tracks these “game mechanics” for updating the game database and/or affecting the game state in step 30-9-2. As described in both the referenced PRIOR ART and the referenced continuation-in-part, the game board can be any of an active or passive game board and preferably is in communications with a “game app” being executed on a computing device such as a tablet or smartphone, where the game app processes the on-going digitized game mechanics as transduced by one or more game parts such as “game piece bases,” where either of the game parts such as the game board and/or the game piece bases may update either of the game database 48-db or communicate the transduced or otherwise digitized data to the game app, such that the game app either solely or in combination with the other game parts updates the game database in step 30-9-6.

Interactive board game 30-9 preferable has access to game rules (not depicted,) wherein preferably based at least in part upon any of game rules and at least in part upon any of the game state 48-db, and possibly in part upon any of performed tasks 48-pt, one or more tasks are determined for one or more gamers during game play and output as assigned tasks 48-at during step 30-9-3, all as prior discussed. Possibly some of tasks 48-at assigned during interactive game play 30-9 are optionally performed substantially “interleaved” with game play, where for example the assigned gamer leaves the current modality of 30-9 to for example perform a schoolwork app 30-10 assignment 48-at, or a video game 30-7 assignment 48-at, or a coloring book assignment 30-8, and after completion of which (recorded by the various other modes of play as performed tasks 48-pt) returns to game play where in step 30-9-5 the “interrupted”/“paused” current interactive game board play then updates the game database or game state based upon any of the performed tasks 48-pt and cycles back to step 30-9-1 to continue until all of the interactive game is completed. Thus, it can be seen that performing a task in potentially another mode of the multimodal game can have an affect on a current mode of game play such as the interactive board game 30-9.

Still referring to FIG. 14, a typically local mode modality such as an interactive board game 30-9, a schoolwork app 30-10, video game 30-7, or coloring book 30-8 may be the “first mode” (such as the depicted 30-9,) or a second “local mode” or even a second remote mode to be completed at some substantially different physical location and/or time. The present figure depicts as a second mode of the multimodal game a remote interactive gaming system 48 executing at a destination such as a theme park, museum, school, city-site, etc. In at least one operation of a second mode of a multimodal game, the second mode comprises an app running on a computing device operated by the gamer, where in a first step 48-1 the app assesses current tasks assigned to the gamer and preferably present a user interface for conveying such information.

The game app processing with the second mode is preferably in communication with any other computing apparatus associated with the game access points comprising or in communication with the second mode (such as a tap-magic display 30-6, a secret path 30-5, a ride/show/presentation 30-4, a gamer competition 30-3 or a power casting 30-2) such that like the description associated with first mode 30-9, these second modes 1) transduce/digitize one or more gamer “mechanics”/physical movements, where the resulting information is used at least in part to update the shared game database 48-db, either directly or using the associated game app, 2) determine for one or more gamers one or more assigned tasks 48-at preferably based at least in part upon any of game rules and at least in part upon any of the game state 48-db, and possibly in part upon any of performed tasks 48-pt, and 3) update performed tasks based at least in part upon assigned tasks 48-at and at least in part upon the game database 48-db comprising the current game state. As a careful consideration will show, interacting with a second mode of a multimodal game such as game access points located at a destination, by performing an assigned task 48-at or otherwise simply interacting with any of the access points associated with the second mode, the second mode of the multimodal game can have an effect on a first mode of a multimodal game such as the interactive board game 30-9.

And finally, still referring to FIG. 14, the exemplary second mode of an interactive gaming system 48 executing at a remote destination, tracks/logs/and otherwise confirms player activities in step 48-2 (see for example the referenced PRIOR ART U.S. Pat. No. 10,861,267 entitled THEME PARK GAMIFICATION, GUEST TRACKING AND ACCESS CONTROL SYSTEM filed on Aug. 4, 2018 and U.S. Pat. No. 10,974,135 entitled INTERACTIVE GAME THEATER WITH SECRET MESSAGE IMAGING SYSTEM filed on Sep. 27, 2018). The tracking of step 48-2 ultimately provides information indicative of the performance of an assigned task by a gamer in step 48-3, such that performed tasks dataset 48-pt is updated, while then in step 48-4 the interactive gaming system updates the game database 48-db comprising the game state.

### CONCLUSION AND RAMIFICATION

Thus the reader will see that the present invention teaches: (1) means for providing controllable passive and active color-changing surfaces, (2) means for improving gamer gesture detection when the gamer is using an article (such as a wizard's wand or light saber) to gesticulate commands and data input at a game access point, (3) means for improving the gamer's integrated and continuous perception of physical-virtual (PV) interaction, and (4) means for improving the perception of continuous gaming experiences between various modes of a multimodal interactive game.

Regarding (1), means for providing controllable passive and active color-changing surfaces, teachings were provided that relied upon a wirelessly powered switch, for example embedded in an article such as a wand comprising a special coating including a layer of electrically switchable electrochromic or electrophoretic material. Of interest are both the considerations of maintaining a sufficient embedded energy source and a sufficient wireless communication device. Small, embedded batteries are well known in the field, as are also wirelessly chargeable batteries, and then furthermore energy harvesting devices that can receive wireless energy specifically for the purpose of generating sufficient power to operate the electrochromic or electrophoretic material. There is currently a significant amount of research and development going into small embeddable batteries, wireless charging of batteries, and energy harvesting, such that the present invention should not be limited to the technological solutions either specifically mentioned herein or currently in the market, but rather it will be understood that any combination of one or more of these existing or yet to be commercially available means are sufficient.

The interested reader is for example directed to the company Powercast that specializes in RF energy harvesting claiming to convert RF to DC power with an industry leading 80% (see their product PCC110 chip). Its also noted that at least two of the Powerharvester Receiver Chipsets are roughly equal in size or smaller than 2 mm×2 mm×1 mm, easily fitting into an article such as a wizard's wand.

For an example of state-of-the-art and up-and-coming wireless communication technology, the interested reader is directed to the TechXplore article entitled “New chip brings ultra-low power Wi-Fi connectivity to IoT devices,” published on Feb. 18, 2020. Amongst other things, the article states: “The device, which is housed in a chip smaller than a grain of rice, enables Internet of Things (IoT) devices to communicate with existing Wi-Fi networks using 5,000 times less power than today's Wi-Fi radios. It consumes just 28 microwatts of power. And it does so while transmitting data at a rate of 2 megabits per second (a connection fast enough to stream music and most YouTube videos) over a range of up to 21 meters.” The careful reader will understand the benefits of this type of technology for use with articles with special coatings such as taught herein, including a wizard's wand, and otherwise mobile devices such as the herein discussed active filtering glasses, where the articles or mobile devices are in communication with a game access point, the interactive gaming system, or otherwise any communication system.

The present inventors also note considerable research and development in the fields of dyes, which in addition to nano-particles are being engineered with respect to their light scattering and absorption properties to create specific bands of “light operation” yielding a distinct spectral response. For example, the interested reader is directed to the Journal of Research of the NIST, volume 118 (2013), and specifically the article entitled “Measurement of Scattering and Absorption Cross Sections of Dyed Microspheres,” authored by Gaigalas, et al. A careful consideration of this articles FIGS. 3, 4, 5, 7, and 8 will show several spectral responses with narrow bands within the visible spectrum and with FWHM's of less than 50 nm, even down to 20 nm. These microspheres include the operations of scattering, absorbing, and fluorescing.

Regarding specially coated surfaces, the present invention anticipates both multiple special coatings (such as a coating “1” and a coating “2,” each operative to change the perception of colorization based upon different sets of free bands,) and the creation of additional colorization effects through the use of different spatial arrangements of these multiple special coatings. For example, a single surface (such as a wall,) might comprise a first coating in a first distinct spatial location (such as the majority of the wall) as well as a second coating in a second distinct spatial location (such as a rectangle in the middle of the wall and therefore the middle of the first coating,) such that changes in the engineered light can cause different colorizations to the first distinct spatial location from the second spatial location, where a person then perceives the shapes of these different locations. This is anticipated to be useful for revealing logos or wording that is otherwise hidden on a surface, where the surface around the logo or wording comprises a first coating while the logo or wording itself comprises a second coating, and where under certain spectral outputs of an engineered light the two distinct spatial areas with distinct coatings appear to have substantially the same colorization (and thus the symbol or wording is not visually apparent,) while under certain other spectral outputs the two distinct areas are perceived as different colorizations thus causing the effect of making the symbols and wordings “appear” (and “disappear”).

Also as discussed, special coatings can be applied to virtually any surface, where the present invention anticipates use on “hard” materials such as plastic toys including for example LEGO bricks, and Disney Lightsabers, as well as “soft” materials such as toy stuffed animals, sneakers, purses, and clothing. In the cross-referenced art U.S. Pat. No. 10,688,378 entitled PHYSICAL-VIRTUAL GAME BOARD AND CONTENT DELIVERY SYSTEM filed on Jul. 4, 2018, examples of interactive jewelry were provided for use with an interactive game board and interactive gaming system, where the present teachings extend this type of interactive “gaming” wearables (or in another prior example, figurines) to include special coatings capable of changing colorizations via exposure to engineered light sources, and/or including engineered light emitters (such as “mid”-band LEDs covering for example the colors of red, green and blue, or even narrow band LEDs covering increments of red, green, and blue,) where the emission of these engineered light sources is timed with an active filter such as glasses or a magnifying glass to cause the colorization of the wearable, figurine, etc., to appear to be different when looking through the active filter as opposed to simultaneously not looking through the active filter.

Like the special coatings that are responsive to engineered light, the combination of engineered light emitting a multiplicity of narrow bands within each of the blue, green, and red spectral response of the human eye, timed in coordination with an active filtering lens such as glasses, has many anticipated uses beyond those described herein. For example, this combination can be used to send encoded visual information. In one implementation, the light source emits a single field of light (like a lamp or flash light) that is perceived as a distinct color (such as “white light,” or perhaps red light) by a person not wearing compatible and enabled active filter glasses, whereas the person wearing compatible and enabled active filter glasses can be made to receive some different and interpretable sequence of light, for example flashes of red light (while other people only see white light) that is interpretable as morse code.

It is further possible using a spatial light modulator such as a modified LCD panel placed over the engineered light so as to first receive this light, to then modulate this light, and then to emit this engineered and further modulated light for viewing by synchronized active filter glasses. In such an arrangement, it is possible to cause the final emitted engineered and modulated light to have a selectable linear angle of rotation (as determined by the activation of the engineered light's modified LCD, thus acting as a first “rotator”) timed in sequence with the operation of the liquid crystal panels(s) in the active filter glasses (where the first of one or more LCD panels in the glasses is thus acting as a second “rotator” “paired” with the first rotator,) where if the second rotator is caused to be spatially aligned with the first rotator, a person looking through the glasses will receive substantially all of the emitted engineered modulated light, and where if the second rotator is caused to be spatially orthogonal with the first rotator, the person will receive substantially none of the engineered modulated light with various possible steps of transmission based upon the degree of alignment, all as will be well understood by those familiar with LCD technology.

A careful consideration will then show that the active glasses which preferably also comprise a second LCD panel (as depicted in FIG. 10B) act both as an entrance rotator for the entering engineered and modulated light as well as an active shutter, the combination allowing for transmitting some amount of light from “zero” to “maximum” for each “frame” (e.g., a flash of 240^{th} of a second of some selectable combination of blue, green, and red bands) of the engineered light, where the combination of spatial and temporal filtering by the glasses in coordination with the emission of specific narrow or otherwise bands of blue, green, and red during any given frame/flash allow significant opportunities for transmitting encoded information.

In still yet another variation, this arrangement of an engineered/modulating light for emitting spatio-temporal combinations of bands of blue, green, and red light (for example combinations of b1, b2, g1, g2, r1, and r2 light) can be synchronized with a multispectral or hyperspectral camera, such that a person viewing the engineered/modulated light stream, and being unable to substantially distinguish between flashes of b1 vs b2, g1 vs g2, r1 vs r2, etc., would perceive a certain visual experience while the multi/hyperspectral camera would sense the different bands and be able to interpret these changing combination of bands, with possible varying intensity, and possible sequencing as encoded information. This same multi or hyperspectral camera can then also be added to the active filter lenses for detecting this encoded information and causing one or more augmentations to appear on the active filter lenses for viewing by the person using any of many well-known AR glasses augmentation technologies. It is then yet also possible to further equip the active filter lenses with an engineered light or an engineered/modulated light such that two gamers, each wearing such fully and further equipped active filter lenses to perhaps provide information to a gaming app paired with their glasses where the information is then encoded and flashed to the second gamer's glasses to be received at a distance and without otherwise being substantially detectable. Any particular game access point could also be equipped to provide encoded streams of engineered light for receiving by any of a active filter lens or a multi or hyperspectral camera. Those familiar with military uses cases will also recognize the opportunity of engineered and modulated light streams to provide secure information.

In yet another variation, a backlighting for an LCD display comprises LEDs for emitting engineered light comprising various narrow bands of blue, green, and red (e.g., b1, b2, g1, g2, r1, and r2) and in coordination with the individual images modulated by the LCD display at a preferable higher frame rate of 120 to 240 frames per second (where each image/frame comprises a multiplicity of individual sub-pixels of red, green, blue controlled by values typically ranging from 0 to 255 in an “8-bit” system.) various images/frames may be emitted using a first triplet such as b1, g1, r1, while other images are emitted using other triplets of any combination, such as b2, g2, r2 or b1, 92, r1, etc. Those familiar with LCD technology will understand that any given blue, green, or red sub-pixel within the LCD display can retain the traditional color filter that substantially passes the “full-band” of blue, green, or red, where a full-band comprises substantially all lesser narrow bands, and that causing the engineered backlight to emit any combination of narrow bands for backlighting a given next image/frame it is possible to cause a video stream to emit visually “identical” images (to a person) comprising information encoded in the different combinations of the narrow bands, where again any engineered backlight comprising “sub-bands”/narrow bands of blue, green, or red will pass through the corresponding traditional sub-pixel “full-band” color filter to be visually perceived as blue, green, or red, regardless of being any of b1/b2, g1/g2, or r1/r2, respectively.

When using active filtering glasses, it is then possible to for example spell out words within a sub-set of the total possible images, where some images are transmitted by the glasses and others are blocked, and where a person not wearing any glasses simply see normal images, such as a movie or advertisement (video or still). Alternatively, a multispectral or hyperspectral camera that is timed to capture images in coordination with the emitting display, can capture and differentiate different patters of the narrow bands b1, b2, g1, g2, r1, and r2 comprising each temporal image/frame, where there are virtually limitless possibilities for encoding information in the sequenced combination of the narrow bands in relation to other bands and the image content itself.

Regarding (2), means for improving gamer gesture detection when the gamer is using an article (such as a wizard's wand or light saber) to gesticulate commands and data input at a game access point, many teachings were provided that implemented the use of special coatings, non-visible markers, and otherwise image processing to best track the movements of an article. Those familiar with object tracking will understand that there are several other well-known methods for tracking objects other than using coating reflectivity combined with image processing. For example, the articles could have embedded active light emitters, emitting any combination of visible and non-visible light for example through a translucent outer material or otherwise an outer material than only transmitted limited frequency ranges such as non-visible infrared, even preferably using different narrow band (e.g., b1, b2, g1, g2, r1, r2) emitters such that the article appeared to be emitting a certain uniform colorization to a bystander (whose eyes are temporally integrating the emitted narrow bands of light) but otherwise comprise distinct non-uniform markings when interpreted by a multi or hyperspectral camera and/or a camera timed to be in or out of phase with the various emissions for the article.

In another example, the article includes embedded wireless energy transmitters, of which many types including Bluetooth and wi-fi are known, and where then these signals are then received by multiple antenna of a local position system for movement calculation. Inversely, the article may comprise an embedded computing element for receiving and analyzing signals through one or more embedded antenna, where then the transmitters are external to the device and the device determines its own local position and movement calculations. In either case, the use of signal triangulation and distance-to-source as well as other algorithms are well-known and may be employed to determine article gesticulation without the use, or in combination with the use of the preferred herein taught image processing.

Regarding (3), means for improving the gamer's integrated and continuous perception of physical-virtual (PV) interaction, many other types of “sensory outputs” are well known that can be controllably combined for example with any of the lighting effects described herein, within any of the game access points described herein. For example, a secret guidance game access point might further comprise means for causing tactile experiences as a gamer is attempting to cross through a setting in accordance with secretly provided illumination. Such tactile means might comprise soft projectiles triggered by the contact/pressure/proximity sensors, where an additional object of the gamer is to cross through the setting while be hit by only some minimum of projectiles. It is also possible to use air guns or even paint balls as tactile devices. Alternatively, other visualization devices can be timed for combination with engineered lighting, such as holograms, where then even the hologram can comprise combinations of narrow bands emitted on one or more sub-channels for causing private visual experiences.

Regarding the use of holography, the present application has presented a solution that employs the well know “pepper's ghost” effect, but as those familiar with holography will understand, there are many other types and apparatus and methods that can be alternatively and even advantageously used in addition to or instead of the described hall-mirrors and projectors.

Those familiar with “focused audio” such as provided by companies like Holosonic will also understand that it is possible to direct sound to certain individuals, where the sound can be interpreted as guidance or a message independent of or in combination with the private guidance lighting described herein.

Another anticipated means for improving the gamer's integrated and continuous perception of physical-virtual (PV) interaction is to use a game app (as also described in the cross-referenced art) for example collecting information about the gamer's experiences at a destination such as a theme park preferably in combination with an interactive gaming system, preferably in further combination with a gamer location tracking system (again, all as prior described in the related art and herein,) where this collected information is then used by the interactive gaming system and/or game access point to in some way alter an experience at the game access point. For example, when a gamer is competing at a competition game access point with another gamer, it is anticipated that each gamer may have multiple other gamers surrounding them “in support,” where these other gamers have a game app that is sharing information with the game access point and is at least in part enabled by the current game state of any combination of the gamer or other support gamers. Thus, these support gamers are able to interact with their apps while watching the competition in order to “heal” the competing gamer and thus increase that gamer's chances of prevailing, where again the “healing powers” of a “supporting” gamer are preferably indicative of a current level of achievement of this supporting gamer as being tracked at the example destination, or otherwise as determined in any modality of gamer play. Alternatively, a supporting gamer may for example “collect” or “earn” points in any of the gaming modalities which are then given, credited, or otherwise transferred to the competing gamer during a game access point competition or task, thus the perception of both continuity of experience across and within modalities, as well as the perception of shared experience/“teamwork,” is promoted by the taught system.

Regarding 4), means for improving the perception of continuous gaming experiences between various modes of a multimodal interactive game, teachings were provided for capturing game modality data at a game access point related to “gamer”/person activities carried out in any of several game modalities, typically at “game access points,” where this game data is then communicated to other game access points or otherwise apparatus for conducting the next continuing gamer/person experience in any of the several possible other modalities. This “game modality data” was shown to support the transfer of modality context (e.g., environment settings such as colors, scenes, virtual physics, as well as self-selected character(s), objects, “powers,” etc.,) where the transfer of any one or more of these or similar context data allows the receiving modality to adapt the gamer's experience to reflect experiences in connected game modalities.

Game modality data also comprises current achievement levels across any of the distinct modalities, where achievement levels may be directly relatable such as a current game level in a video game is directly relatable to a current level in a destination physical-virtual game, where then the game setting, storyline, current mission, characters encountered, personal “avatar”/character attributes are all maintained allowing the gamer to feel as if they have for example left the game console of the video game (“at home”) and entered into the game itself at a gaming destination such as a theme park, museum, or escape room. Indirectly relatable achievement levels can also be used to create a sense of joint-meaning in two related modalities. For example, completing a level of work at a certain threshold of competence when using a schoolwork app can then be used as data for setting opportunities for experiences in another modality, such as the interactive board game, where for example the challenge questions presented by the board game when landing on a certain location reflect the determined achievement levels from the schoolwork app.

A careful consideration will also recognize that game modality data can also include when (e.g., year, month, day, time-of-day) certainly modalities are engaged and if applicable with whom the modality is shared (e.g., players in a team at a destination, or opponents in an interactive board game). Any of this modality usage data can then be further adapted to provide opportunities (or limitations of opportunities) within other modalities, for example, an interactive board game comprising a multiplicity of game overlays may restrict the game play of a given overlay to a specific geolocation and even time of day (such as only allowing a specific theme park game overlay to be played within a resort hotel room during evening hours,) where it will be understood that the game app associated with the interactive board game (see U.S. Pat. No. 10,688,378 entitled PHYSICAL-VIRTUAL GAME BOARD AND CONTENT DELIVERY SYSTEM filed on Jul. 4, 2018 and U.S. Pat. No. 10,85,450 entitled PHYSICAL-VIRTUAL GAME BOARD AND CONTENT DELIVERY PLATFORM filed on Aug. 9, 2019) is preferably executed on a mobile computing device such as a smartphone or tablet that is able through multiple means such as GPS or wi-fi to confirm the current geolocation and time of day. It is even possible to then also limit “teammates” chosen for example during interactive board game play while in a resort room at a theme park to continue to be teammates when participating in the theme parks interactive game experience, where for example points are shared, accumulated and usable across these (and other) modalities, and where uses include “leveling up,” purchasing “in-game gear,” purchasing real-world products, obtaining opportunities to have special theme park experiences or play certain game overlays. For example, and related to the teachings for a ride/show/presentation game access point capable of providing multiple simultaneous video/audio experiences, points accumulated while playing an interactive board game overlay restricted to a theme park hotel room could for example allow a gamer to select a “premium” (otherwise non-available) video/audio experience when next engaging the theme park ride/show/performance

Thus, the careful reader will see that the teachings of the present invention have great ability for creating enhanced gamification experiences across any number of different modalities, where the experiences in any one game modality have continuity and meaning with regard to experiences in another modality. Many apparatus and methods for determining critical “modality-state”/“game-state” data have been taught both in the prior cross-referenced art and within the present specification. Many apparatus and methods (generally “game access points”) for providing new and exciting physical, physical-virtual, and virtual experiences have also been discussed, where these apparatus and methods are both adaptable based upon game modality data including the current game state and combinable to for “hybrid” experiences or otherwise hybrid game access points. Therefore, the teachings of the present invention should be understood both in the sense of specific implementations and in the sense of structures for supporting extended implementation and combinations of implementation that have not necessarily been detailed or discussed herein but none-the-less are made obvious as anticipated by the present figures and specification.

While only certain features of the invention have been illustrated and described herein, many modifications and changes will occur to those skilled in the necessary arts. It is, therefore, to be understood that the appended claims are intended to cover all such modifications and changes as fall within the true spirit of the invention.

We claim:

1. (canceled)

2. A visual augmentation system for allowing a first person to substantially perceive visual effects augmenting the view of a second person, comprising:
a first visualization station comprising a first surface for providing first visual effects, and
a first power casting game access point in communications with the first visualization station, where the first person provides one or more first person inputs to the first power casting game access point, and where the first visual effects made apparent for viewing on the first surface by the first person are determined based at least in part upon the one or more first person inputs.

3. The system of claim 2 wherein the first surface for providing the first visual effects comprises either a display for emitting the visual effects or a physical surface for reflecting the visual effects as the visual effects are emitted by a projector onto the first surface, where the display comprises a transparent display or a non-transparent display, and the first surface optionally comprises one or more openings allowing the first person to see directly through the first surface.

4. The system of claim 3 further comprising:
one or more first articles held by, worn, or otherwise present with the first person for use in providing the first person inputs to the first power casting game access point, where the first power casting game access point either or both (i) receives wireless information from the one or more first articles for use at least in part in determining the first person inputs, and (ii) substantially tracks the motion of any of the one or more first articles being used by the first person in at least two dimensions for determining any of article gesticulation information, and where the first power casting game access point determines the first person inputs based at least in part upon any one of or any combination of (i) and (ii).

5. The system of claim 4 further comprising:
an interactive gaming system for conducting a physical-virtual game, where the interactive gaming system is in communications with the first visualization station and the first power casting game access point, where the first power casting game access point provides any one of or any combination of the first person inputs, (i), and (ii) to the interactive gaming system, where the interactive gaming system optionally determines any one or more of the first person inputs based at least in part upon any one of or any combination of (i) and (ii),
and where the interactive gaming system determines the first visual effects to be provided based at least in part upon any one of or any combination (a) the first person inputs, (i), and (ii), and (b) a game state maintained by the interactive gaming system in association with the physical-virtual game, and
optionally comprising a first pair of filtering glasses worn by the first person, where the first visual effects perceived by the first person while looking through the first pair of filtering glasses are not substantially perceivable to any other person not wearing a similarly controlled pair of first filtering glasses.

6. The system of claim 5 wherein:
either or both of any of the one or more first articles and the optional first pair of filtering glasses are further adapted to comprise electronically determinable identification information for use at least in part as first person inputs (i);
where the second person optionally carries one or more second articles similar to first articles for at least providing second person inputs (i) at least comprising identification information, and
where the visual augmentation system is further adapted to electronically scan the any of the one or more first and second articles and the optional first pair of filtering glasses to determine and provide either or both of the first and second identification information to the interactive gaming system for affecting the game state.

7. The system of claim 6, wherein the first surface of the first visualization station is a transparent surface comprising a transparent display for emitting the first visual effects or otherwise a transparent medium for either reflecting or transmitting the first visual effects emitted by the projector, where the transparent surface allows the first person to see through the first surface to view the second person, further comprising:
a second visualization station substantially similar to the first visualization station and comprising a second surface for providing second visual effects, where the first and second visualization stations are separated and aligned to form a continuous viewing corridor interposed between the first and second visualization stations, where the first person substantially stands next to the first visualization station on the side opposing the viewing corridor and the second person substantially stands next to the second visualization station on the side opposing the viewing corridor such that the first and second person view each other first looking through the nearest respective first or second surface, into the viewing corridor, and then through the farthest respective first or second surface, and
optionally comprising a second pair of filtering glasses substantially similar to the first pair of filtering glasses and being worn by the second person, where the second visual effects perceived by the second person while looking through the second pair of filtering glasses are not substantially perceivable to any other person not wearing a similarly controlled pair of second filtering glasses.

8. The system of claim 7 wherein the first visual effects seen only by the first person optionally comprise second visual effects to be seen only by the second person, the second visual effects seen only by the second person optionally comprise first visual effects to be seen only by the first person such that either or both of the first person and the second person perceive respective first or second visual effects being provided by either or both of the first surface and the second surface.

9. The system of claim 7, further comprising:
a second power casting game access point substantially similar to the first power casting game access point, where the second person provides one or more second person inputs to the second power casting game access point for providing to the interactive gaming system, and
one or more second articles held by, worn, or otherwise present with the second person for use in providing the second person inputs to the second power casting game access point, where the second power casting game access point either or both (i) receives wireless information from the one or more second articles for use at least in part in determining the second person inputs, and (ii) substantially tracks the motion of any of the one or more second articles being used by the second person in at least two dimensions for determining any of article gesticulation information, where the second power casting game access point determines the second person inputs based at least in part upon any one of or any combination of (i) and (ii), where the second power casting game access point provides any one of or any combination of the second person inputs, (i), and (ii) to the interactive gaming system, where the interactive gaming system optionally determines any one or more of the second person inputs based at least in part upon any one of or any combination of (i) and (ii), and where the interactive gaming system determines the first visual effects to be provided based at least in part upon any one of or any combination (a) the second person inputs, (i), and (ii), and (b) the game state maintained by the interactive gaming system in association with the physical-virtual game.

10. The system of claim 9, further comprising:
a virtual image generator for substantially simultaneously emitting additional first and second visual effects synchronized with the first and second visual effects emitted by either or both of the first and second visualization stations, where the virtual image generator is substantially interposed between the first and second visualization stations such that both the first and second gamer perceive the additional first and second visual effects as appearing to be at least behind the visual effects emitted by the respective visualization station closest to the respective gamer.

11. The system of claim 10, wherein the virtual image generator is mounted on a rail system for moving the virtual image generator back and forth within the corridor and between the first and the second visualization stations such that the additional first and second visual effects appear to be coming closer to and farther away from the first and second person as the virtual generator is moved back and forth upon the rails.

12. The system of claim 11, wherein the virtual image generator comprises a holographic display or pepper's mirror illusion such that the additional first and second visual effects appear to float in the air within the corridor as the first and second additional first and second visual effects are being viewed by either of the first or second persons when looking through the respective first and second visualization systems.

13. The system of claim 9, further comprising any one of or any combination of:
either or both of a first and second game access point floor, where the first and second person stands upon the respective first and second floor while providing any of the respective person inputs, where the interactive gaming system is in communications with the first and second game access point floors for at least in part causing any of movement, vibration, haptic, or tactile effects to be emitted by the first and second floor so as to be experienced by the respective first and second person;
either or both of one or more first and second game access point cameras for capturing images of the respective first and second person, where the one or more cameras capture images for providing to the interactive gaming system for use at least in part in determining any of the first and second visual effects, and
a surrounding public audio-visual effects system for emitting any one of or any combination of audio effects and lighting effects, where the any effects are substantially perceivable by both the active gamer and the at least one other gamer, where the interactive gaming system is in communications with the surrounding additional public audio-visual effects system for at least in part causing any of the audio effects and lighting effects based at least in part upon any one of or any combination of the gamer input and the game state.

14. The system of claim 9, wherein each or both of the first or second power casting game access points comprises:
an article tracking station comprising one or more sensors for use at least in part in determining any of the at least two-dimensions (2D) of movement data or further any of three-dimensions (3D) of movement data respective of any portions of the person and the one or more articles, where the 2D or 3D movement data is used at least in part to determine the person inputs, and where the one or more sensors comprise any of a multispectral or a hyperspectral camera, a time-of-flight sensor, an active wireless signal detector for determining the local position of the active signal, and
wherein:
any of the one or more articles being used by the person to provide person inputs is optionally further adapted to comprise any one of or any combination of visible or non-visible coatings, appliques, applied markers, wireless signal emitters for providing or for use at least in part in determining any of the 2D or 3D movement data, and an RFID for providing article identification data;
either or both of the first and second power casting game access points optionally comprises any one of or any combination of:
an RFID reader for determining the article identification data by reading the article RFID, where the article identification data is provided to the interactive gaming system for use at least in part in updating the game state;
an article colorizing light source for controllably emitting engineered light for substantially illuminating a tracking volume within which the person performs gesticulations using the one or more articles for providing person inputs, where the emitted engineered light comprises any one of or any combination of a first band of red light (r1) substantially perceived by the person to be red, a second band of red light (r2) also substantially perceived by the person to be red, where the second band of red light (r2) has a center/peak frequency that is different from the first band of red light (r1), a first band of green light (g1) substantially perceived by the person to be green, a second band of green light (g2) also substantially perceived by the person to be green, where the second band of green light (g2) has a center/peak frequency that is different from the first band of green light (g1), a first band of blue light (b1) substantially perceived by the person to be blue, a second band of blue light (b2) also substantially perceived by the person to be blue, where the second band of blue light (b2) has a center/peak frequency that is different from the first band of blue light (b1), and any band of substantially non-visible light comprising a center/peak frequency that is different from each and all of the visible light bands (r1), (r2), (g1), (g2), (b1), and (b2), where any of the article visible or non-visible coatings, appliques, and applied markers are further adapted to be substantially more or less absorptive, reflective, or fluorescent with respect to any one or more of the specific bands of visible or non-visible light as compared to any other of the one or more of the specific bands of visible or non-visible light for use in either or both (i) determining the 2D or 3D motion data by the one or more sensors comprising the multispectral or a hyperspectral cameras, and (ii) causing the visual appearance of the one or more articles to be substantially altered as perceived by the person;
a synchronized area lighting for emitting light comprising any of traditional light or the engineered light for substantially illuminating any of the surrounding area wherein the person is situated that is substantially not the tracking volume such that the surrounding area and the tracking volume are substantially illuminated by different controllable light sources, where the emissions of light by the light sources for illuminating the surrounding area are (i) optionally synchronized with respect to the timing of the one or more sensors comprising the article tracking station, and (ii) optionally synchronized with respect to the timing of the engineered light emissions by the article colorizing light source, and
where either or both of the first and second pairs of light filtering glasses are further synchronized with respect to the emission of light by either or both of the article colorizing light source and the synchronized area lighting such that the visual perception of the either or both first or second person is substantially altered based at least in part upon the timed emission of either of the tracking volume illumination or the surrounding area illumination, and where the either or both of the first and second pairs of light filtering glasses comprise any combination of active light filtering or passive light filtering.

15. A physical-virtual gaming system for allowing an active gamer to engage in a physical-virtual game with at least one other gamer, where the active gamer provides gamer inputs, and where the active gamer perceives special visual effects augmenting the view of the at least one other gamer based at least in part on the gamer inputs, comprising:
an interactive gaming system in communications with a game access point being used by the active gamer, where the interactive gaming system receives gamer input from the game access point and maintains a game state based at least in part upon the gamer input, and where the interactive gaming system determines the special visual effects based at least in part upon either one or both of the gamer input and the game state;
at least one article for use by the active gamer for providing the gamer input, where the gamer input comprises any one of or any combination of identification information and commands determined based at least in part upon article movement data;
a pair of light filtering glasses to be worn by the active gamer, where the light filtering glasses either allow or disallow the transmission of a filterable stream of images, and
a game access point, comprising:
a visualization station comprising a transparent display for emitting at least one of the filterable stream of images comprising the special visual effects, where the active gamer while wearing the pair of filtering glasses is positioned to look through the visualization station in order to see the at least one other gamer such that the special visual effects transmitted through the pair of light filtering glasses appear to augment the view of the at least one other gamer, and
an article tracking station for either or both receiving from the at least one article any of the gamer inputs and otherwise determining the gamer inputs based at least in part upon detected movement of the at least one article.

16. The system of claim 15 comprising at least two active gamers including a first gamer using a first game access point and a second gamer using a second game access point, where the visualization station of the first game access point is arranged in accordance with the visualization station of the second game access point to form a continuous viewing corridor interposed between the first and second visualization stations, where the first active gamer substantially stands next to the first visualization station on the side opposing the viewing corridor and the second active gamer substantially stands next to the second visualization station on the side opposing the viewing corridor such that each active gamer views the other active gamer by first looking through the nearest respective first or second visualization station, into the viewing corridor, and then through the farthest respective first or second visualization station, where the interactive gaming system receives gamer inputs respective of the first and second active gamers from the respective first and second game access points, where the interactive gaming system determines at least two distinct filterable streams of images for provision to each or both of the first and second visualization stations such that each of the first and second active gamers wearing respective first and second pairs of light filtering glasses substantially perceive different augmentations overlaid upon the current view of the other respective active gamer.

17. The system of claim 16 further comprising:
a virtual image generator for emitting or projecting at least one additional filterable stream of images comprising additional special visual effects, where the additional special visual effects are perceivable to either one or both of the first or second active gamers and appears to float within the corridor, where optionally the virtual image generator is mounted on a rail system for moving the virtual image generator back and forth within the corridor and between the first and the second visualization stations such that the perceived floating images appear to be coming closer to and farther away from the first and second active gamer as the virtual generator is moved back and forth upon the rails, and where the interactive gaming system determines any of the additional special visual effects and movement information for at least in part controlling the movement of the virtual generator on the rail system based at least in part upon either one or both of the gamer input and the game state.

18. The system of claim 15 where the pair of light filtering glasses comprise either or both of active filtering or passive filtering, where active filtering comprises using an active shutter and passive filtering comprises using any of narrow band light filtering or polarization filtering, and where the filterable stream of images comprises emissions restricted based upon the temporal domain for filtering by the active shutter, restricted based upon the color domain for filtering by the narrow band light filtering, and restricted based upon angles of polarization for filtering by the polarization filtering.

19. The system of claim 15 where the game access point further comprises any one of or any combination of:
a game access point floor, where the active gamer stands upon the floor while providing any of the gamer inputs, where the interactive gaming system is in communications with the game access point floor for at least in part causing any of floor effects to be emitted by the floor to be experienced by the active gamer, where the floor effects comprise any one of or any combination of movement, vibration, haptic, or tactile effects, and where the interactive gaming system determines the floor effects based at least in part upon any one of or any combination of the gamer input and the game state;
one or more game access point cameras for capturing images of the active gamer, where the one or more cameras capture images for providing any of information to the interactive gaming system for use at least in part in determining any of the special visual effects, and
a surrounding public audio-visual effects system for emitting any one of or any combination of audio effects and lighting effects, where the any effects are substantially perceivable by both the active gamer and the at least one other gamer, where the interactive gaming system is in communications with the surrounding additional public audio-visual effects system for at least in part causing any of the audio effects and lighting effects based at least in part upon any one of or any combination of the gamer input and the game state.

20. The system of claim 15 wherein:
the article tracking station comprises one or more sensors for use in detecting the movement of the at least one article, where the detected movement is interpreted as any of two-dimensional (2D) or three-dimensional (3D) movement data respective of any portions of the active gamer and the at least one article, where the 2D or 3D movement data is used at least in part to determine the gamer inputs, and where the one or more sensors comprise any of a multispectral or a hyperspectral camera, a time-of-flight sensor, an active wireless signal detector for determining the local position of the active signal, and
where the at least one article is optionally further adapted to comprise any one of or any combination of visible or non-visible coatings, appliques, applied markers, and wireless signal emitters for providing or for use at least in part in determining any of the 2D or 3D movement data, and an RFID for providing article identification data.

21. The system of claim 20 wherein the game access point further comprises:
an article colorizing light source for controllably emitting engineered light for substantially illuminating a tracking volume within which the active gamer holds and moves the at least one article, where the emitted engineered light comprises any one of or any combination of a first band of red light (r1) substantially perceived by the active gamer to be red, a second band of red light (r2) also substantially perceived by the active gamer to be red, where the second band of red light (r2) has a center/peak frequency that is different from the first band of red light (r1), a first band of green light (g1) substantially perceived by the active gamer to be green, a second band of green light (g2) also substantially perceived by the active gamer to be green, where the second band of green light (g2) has a center/peak frequency that is different from the first band of green light (g1), a first band of blue light (b1) substantially perceived by the active gamer to be blue, a second band of blue light (b2) also substantially perceived by the active gamer to be blue, where the second band of blue light (b2) has a center/peak frequency that is different from the first band of blue light (b1), and any band of substantially non-visible light comprising a center/peak frequency that is different from each and all of the visible light bands (r1), (r2), (g1), (g2), (b1), and (b2);
where any of the at least one article visible or non-visible coatings, appliques, and applied markers are further adapted to be substantially more or less absorptive, reflective, or fluorescent with respect to any one or more of the specific bands of visible or non-visible light as compared to any other of the one or more of the specific bands of visible or non-visible light for use at least in part in either or both determining the 2D or 3D motion data by the one or more sensors comprising the multispectral or a hyperspectral cameras, and causing the visual appearance of the one or more articles to be substantially altered as perceived by the active gamer, and
where the game access point optionally comprises:
synchronized area lighting for emitting light comprising any of traditional light or the engineered light for substantially illuminating any of the surrounding area wherein the active gamer is situated that is substantially not the tracking volume such that the surrounding area and the tracking volume are substantially illuminated by different controllable light sources, where the emissions of light by the light sources for illuminating the surrounding area are either one or both optionally synchronized with respect to the timing of the one or more sensors comprising the article tracking station, and optionally synchronized with respect to the timing of the engineered light emissions by the article colorizing light source, and
where the pair of light filtering glasses are further synchronized with respect to the emission of light by either or both of the article colorizing light source and the synchronized area lighting such that the visual perception of the active gamer is substantially altered based at least in part upon the timed emission of either of the tracking volume illumination or the surrounding area illumination, and where the pair of light filtering glasses comprise any combination of active light filtering or passive light filtering.
